(19) United States
(12) Patent Application Publication
(10) Pub. No.: US 2017/0250796 A1
(43) Pub. Date: Aug. 31, 2017

(54) Trans Vernam Cryptography: Round One

(71) Applicant: Gideon Samid, Rockville, MD (US)

(72) Inventor: Gideon Samid, Rockville, MD (US)

(21) Appl. No.: 15/436,806

(22) Filed: Feb. 18, 2017

Related U.S. Application Data
(60) Provisional application No. 62/297,127, filed on Feb. 18, 2016.
(60) Provisional application No. 62/336,477, filed on May 13, 2016.
(60) Provisional application No. 62/339,921, filed on May 22, 2016.
(60) Provisional application No. 62/374,804, filed on Aug. 13, 2016.
(60) Provisional application No. 62/418,217, filed on Nov. 6, 2016.
(60) Provisional application No. 62/428,464, filed on Nov. 30, 2016.
(60) Provisional application No. 62/435,772, filed on Dec. 18, 2016.
(60) Provisional application No. 62/457,162, filed on Feb. 10, 2017.

(51) Int. Cl. H04L 9/00; H04L 9/06; H04L 9/08

(52) U.S. Cl. CPC H04L 9/002; H04L 9/0819; H04L 9/0656; H04L 2209/08

(57) ABSTRACT

This invention establishes means and protocols to secure data, using large undisclosed amounts of randomness, replacing the algorithmic complexity paradigm. Its security is credibly appraised through combinatorics calculus, and it transfers the security responsibility to the user who determines how much randomness to use. This Trans-Vernam cryptography is designed to intercept the Internet of Things where the ‘things’ operate on limited computing capacity and are fueled by fast draining batteries. Randomness in large amounts may be quickly and conveniently stored in the most basic IOT devices, keeping the network safe.

### BRIEF DESCRIPTION OF THE DRAWINGS

The skilled artisan will understand that the drawings, described below, are for illustration purposes only. The drawings are not intended to limit the scope of the present teachings in any way.

FIG. 1 illustrates an example of 3D Tensorial Cryptography.

### DETAILED DESCRIPTION

Modern cryptography suffers from a largely ignored fundamental vulnerability, a largely suppressed operational limitation, and a largely overlooked un-readiness for its future largest customer.

The ignored fundamental vulnerability is expressed in the fact that modern ciphers are effective only against an adversary who shares, at most, the mathematical insight of the ciphers designers. It is an open question how vulnerable modern ciphers are to a smarter, more insightful mathematician. Furthermore, it takes just a single “Alan Turing caliber mind” to bring the entire national crypto strategy to its knees, as Alan Turing did to Nazi Germany. And no one knows if the adversary has not been fortunate to have a mathematical prodigy within its ranks.

The largely suppressed operational limitation is effected in keeping security control in the hands of the cipher designers, denying it from the owners of the protected secrets. Crypto users are locked to a limited choice of certified ciphers. Both the design and the implementation of these ciphers may include a backdoor compromising the integrity of the user. Users who are limited to the choice of certified ciphers, are experiencing a growing unease that sends many to use rogue ciphers which have not been sufficiently vetted.

The overlooked un-readiness for its future largest customer is the state of having no good answer to Internet of Things cryptography where the majority of the security devices are too simple and cheap to include an expensive sophisticated computer, and they are normally equipped with a small battery or solar panels, allowing for limited computing energy to be expended.

The combinations of these three issues is a call for a paradigm innovation, which is what is proposed herein. Trans Vernam cryptography is a novel approach where security is built not through algorithmic complexity but through algorithmic simplicity combined with large secret quantities of randomness. The security of randomness-based cryptography is hinged on combinatorics—sound and durable, and is immunized against any adversarial advantage in mathematical understanding. To the extent that the adversarial computing capacity is credibly appraised, so is the vulnerability of the cryptogram. With sufficient randomness the user can create terminal equivocation that would frustrate even an omnipotent cryptanalyst.

A Trans-Vernam cipher allows its user to determine the level of its security by determining the amount of randomness used. Modern technology experiences Moore's law with respect to memory. Astronomical amounts of randomness may be effectively and cheaply stored on even simple and cheap devices.

The 100 years old Vernam cipher is the original unbreakable cipher where sufficient quantities of randomness are processed in most simplified bit operations. Vernam has many shortcomings, which the Trans-Vernam successors overcome.

### Algorithmic Non-Complexity, Open-Ended Key Space: A Useful Cryptographic Variety Trans-Vernam Ciphers: Perfect Secrecy Revisited

Abstract: Vernam cipher is famous for its “impractical key”; little recognized for its bucking of the trend—before and since—to frustrate the cryptanalyst with piled on algorithmic complexity. Algorithmic complexity inherently implies increased vulnerability to hidden adversarial discovery of mathematical shortcuts (even if it turns out that P<NP). Algorithmic complexity stands naked before the prospective onslaught of quantum computing. Algorithmic complexity chokes, slows down, and otherwise burdens nominal encryption/decryption (e.g. increased power consumption). By contrast, Vernam processing is proportional to the size of the message, is so utterly simple that it does not face risks like using “weak primes” or vulnerable substitution tables. And Vernam offers perfect secrecy, which we ignore today not because of the size of the key, but because of key management: the tedium of resupply of fresh bits for every message. We propose to revisit the Vernam philosophy, we present Trans Vernam ciphers which allow communicating parties to use, and reuse a fixed (albeit large) key, and conveniently communicate with perfect secrecy, or as close to it as they like.

### 0.0 Introduction

Cryptographic textbooks make due, yet passing, mention of the almost 100 years old Vernam cipher. Some texts even detail Claude Shannon's proof of its perfect secrecy, but quickly move on towards orthodox cryptography where keys are short and processing is complex—the exact opposite of Vernam. Let's have a bird's eye view of the post Vernam century.

No lesser authority than Adi Shamir has summarized the present state of affairs as a panelist in RSA Security Conference, 2015: “Cryptography is Science, Cryptanalysis is Art”. Indeed. What a succinct way of saying: cryptographers build models of reality, in the pastures of which they satisfy themselves with security metrics, while cryptanalysts target the gap between such models, which are built on assumptions (some explicit, some implicit) as is the method of science—and reality itself which is invariably richer, more complex, more mysterious, and more yielding to artistic inquiries. Alas, the only purpose of cryptography is to frustrate the cryptanalyst, not to marvel at mathematical elegance. And with that background the ongoing trend to devise increased algorithmic complexity as a means to protect information does deserve a critical examination.

### What Else is There?

Vernam is there: Vernam frustrates the cryptanalyst with the bulk of its large assembly of sufficiently randomized bits, bits which are processed in the simplest possible way to give one confidence that no mathematical shortcut is to be worried about. Alas, Vernam per se is unwieldy, but not necessarily because of the size of its key, but by the tedium of supplying fresh bits for every message. Consider n parties conversing in mutual exposure, but exchanging many bi lateral messages. They could all share a large Vernam key stock and drain its bits per messages used. But then all parties will have to follow up on every communication off this key, how unrelated to them, so that they can “keep the needle” on the spot from where to count the next bits. Now Shannon proved that to achieve perfect secrecy the key space is limited at its bottom by the message space, but this requirement can be satisfied by allowing all the communicating parties to share one large enough key, and reuse it, time and again, without violating Shannon's constrains.

Relocating complexity from the process to the key is a welcome prospect for the emerging Internet of Things: memory is cheap, battery processing power is expensive.

All in all let's have another look at Vernam, and the cryptographic philosophy it represents.

### 1.0 Trans-Vernam Cipher

### Definition

We define a “Trans-Vernam cipher” (TVC), as follows: Let M=M_{TVC} be a Vernam message space of size |M|=|M_{TVC}|. Let the key space K_{TVC} be equal or larger than the message space: |K_{TVC}|≧|M|, and equal to the ciphertext space, C: |C_{TVC}|=|K_{TVC}|≧|M_{TVC}|. For every message mεM_{TVC}, there is one key kεK_{TVC} which encrypts m to a given ciphertext cεC_{TVC}. For every ciphertext cεC_{TVC} there is one kεK_{TVC} that decrypts c to a given mεM_{TVC}. The user of the TVC will uniformly choose a key from K_{TVC}.

### The Trans Vernam Cipher Perfect Secrecy Theorem:

A TVC offers perfect secrecy defined as satisfying the condition that the probability for a given message to be the one encrypted, is the same whether the cryptanalyst is in possession of the ciphertext, or not: Pr[M_{TVC}=m]=Pr[M_{TVC}=m|C_{TVC}=c], or say: knowledge of the ciphertext offers no cryptanalytic benefit.

### Proof:

Expressing Bayes relationship:

Pr[M_{TVC}=m|C_{TVC}=c]=Pr[C_{TVC}=c|M_{TVC}=m]*Pr[M_{TVC}=m]/Pr[C_{TVC}=c] (1-1)

Per definition of the TVC, given any mεM_{TVC}, there is a key kεK_{TVC} such that m encrypt into any cεC_{TVC}:

Pr[C_{TVC}=c|M_{TVC}=m]=1/|K_{TVC}| (1-2)

We can write:

Pr[C_{TVC}=c]=ΣPr[C_{TVC}=c|M_{TVC}=m]*Pr[M_{TVC}=m] for all mεM_{TVC} (1-3)

Substituting (1-2) in (1-3):

Pr[C_{TVC}=c]=(1/|K_{TVC}|)ΣPr[M_{TVC}=m] for all mεM_{TVC} (1-4)

Clearly: ΣPr[M_{TVC}=m] for all mεM_{TVC}=1, hence:

Pr[C_{TVC}=c]=1/|K_{TVC}| (1-5)

Substituting (1-2) and (1-5) in (1-1):

Pr[M_{TVC}=m|C_{TVC}=c]=(1/|K_{TVC}|)*Pr[M_{TVC}=m]/(1/|K_{TVC}|)=Pr[M_{TVC}=m] (1-6)

which per our definition is the case of perfect secrecy.

### 2.0 Reuse of a Key While Maintaining Perfect Secrecy

We show ahead how a Trans-Vernam cipher of key space, K, which is at least n times larger than the message space M, (|K|≧n*|M|) can be used to encrypt n messages (of same bit size) without losing its perfect secrecy.

From the standpoint of Shannon's proof of secrecy, such setup is permissible since it obeys the condition that the key space will not be smaller than the total message space.

The above re-use setup is analogous to having a Vernam “key stock” of bit count n*t, used t bits at a time to encrypt n successive t-bits long messages. The practical difference is that in the reuse setup the communicating parties use the same key and need not be burdened by book-keeping as to the next random bits to use.

We first analyze Vernam where one uses the same key k, to encrypt two messages (1,2) of size t bits each. If that fact is known then a computationally unlimited cryptanalyst in possession of the two corresponding ciphertexts may prepare a table of |M|=2^{t} tuples of m₁-m₂ candidates corresponding to the |K|=2^{t} choices of key. We can write then:

Pr[M₁=m₁∩M₂=m₂|K₁=K₂=k & C₁=c₁ & C₂=c₂]≦2^{-t} (2-1)

While:

Pr[M₁=m₁∩M₂=m₂|K₁=K₂=k]=2^{-2t} (2-2)

(2-1), and (2-2) indicate that the knowledge of the ciphertexts impacts the probabilities for various messages, and hence re-use of a Vernam key implies less than perfect secrecy. This can be readily extended to n>2 messages of size t bits each:

(2-3):

$$Pr [ {M}_{1} = {m}_{1} ⋂ {M}_{2} = {m}_{2} ⋂ … {M}_{n} = {m}_{n} \vert {K}_{1} = {K}_{2} = … {K}_{n} = k \& {C}_{1} = {c}_{1} \& {C}_{2} = {c}_{2} \& … {C}_{n} = {c}_{n} ] \neq Pr [ {M}_{1} = {m}_{1} ⋂ {M}_{2} = {m}_{2} \vert {K}_{1} = {K}_{2} = … {K}_{n} = k ] .$$

We repeat the same analysis with two messages of t bits each, encrypted via a TVC key space of size 2^{-2t}. A computationally unbound cryptanalyst will prepare a table of tuples of m₁-m₂ corresponding to decrypting c₁ and c₂ via each of the |K|=2^{2t} keys. All the possible 2^{t} values for m₁ will be represented as the first entry of a tuple, because of the construction of the TVC. But since there are 2^{2t} tuples it is necessary that every tuple where the first item is mᵢ (i=1, 2 . . . 2^{t}) is paired with the 2^{t} possibilities for the second entry in the tuple. In other words, the computationally unbound cryptanalyst will deduce from the identity of c₁ and c₂ a list of possible m₁-m₂ combination which is exactly the list that the cryptanalyst would compile without knowledge of c₁-c₂, which by Shannon's definition is a state of perfect secrecy.

The above logic can be readily extended to n t-bits long messages:

### The TVC Key-Reuse Perfect Secrecy Theorem:

A TVC with key space of size 2^{tn} or higher can be reused n times to encrypt n t-bits long messages while maintaining perfect secrecy.

In the context of encrypting n t-bits long messages, we write the Bayes relationship:

$$Pr [ {M}_{1} = {m}_{1} ⋂ {M}_{2} = {m}_{2} ⋂ … {M}_{n} = {m}_{n} \vert {K}_{1} = {K}_{2} = … {K}_{n} = k \& {C}_{1} = {c}_{1} \& {C}_{2} = {c}_{2} \& … {C}_{n} = {c}_{n} ] = Pr [ {M}_{1} = {m}_{1} ⋂ {M}_{2} = {m}_{2} ⋂ {M}_{n} = {m}_{n} \vert {K}_{1} = {K}_{2} = … {K}_{n} = k ] * Z / Y$$

### Where:

Z=Pr[C₁=c₁∩C₂=c₂∩ . . . Cₙ=cₙ|K₁=K₂= . . . Kₙ=k & M₁=m₁ & M₂=m₂ & . . . Mₙ=mₙ]

And:

Y=Pr[C₁=c₁∩C₂=c₂∩ . . . Cₙ=cₙ|K₁=K₂= . . . Kₙ=k]

We shall prove that Z/Y=1, which would affirm that the probability of any set of n (t-bits long) messages is the same whether the respective ciphertext is known or not—the definition of Shannon perfect secrecy.

The number of possible combinations of n t-bits long messages drawn out of a message space of size 2^{t} and all encrypted with the same key: k, is: 2^{tn}, which by construction is the size of the key space (|K|). Each TVC key would encrypt the n messages to n corresponding ciphertexts. There are |K| keys that could have been selected by the user, so the probability for each tuple of n ciphertexts is uniformly 1/|K|, hence: Z=1. Note that if the key space was smaller than some message tuples would have to share the same key, and the latter statement about the uniformity of the probability will not be true.

The expression for Y may be constructed as:

Y=ΣΣ . . . ΣPr[C₁=c₁∩C₂=c₂∩ . . . Cₙ=cₙ|K₁=K₂= . . . Kₙ=k]*Pr[M₁=m₁∩M₂=m₂∩Mₙ=mₙ] . . . for m₁, m₂, . . . mₙεM

Substituting with Z form above:

Y=Z*ΣΣ . . . ΣPr[M₁=m₁*Pr[M₂=m₂]*Pr[Mₙ=mₙ] . . . for m₁, m₂, . . . mₙεM

However, for i=1, 2, . . . n:

ΣPr[Mᵢ=mᵢ]=1 . . . for mᵢεM

Hence Y=Z, which proves the theorem.

### Relocated Cryptographic Complexity

The complexity equivalence between data storage and data processing has been long established, and it may be readily applied to accommodate Trans-Vernam ciphers by building them with algorithmic complexity limited into polynomial class, P with the size of the key. Vernam is a case where computational complexity is linear with the size of the key, and is the lowest limit because it is also linear with the size of message.

There are other ciphers [7,11,13] where the algorithmic complexity is so simple that very large keys are tenable.

### Unbound Key Spaces

Vernam cipher surrenders to its cryptanalyst the size of its key. A Trans Vernam cipher may regard its key space as a part of the secret. We consider a cipher with unbound key space. In particular we define a “Natural Cipher” as one where

(i) an arbitrary t-bits long message mεM will be encrypted to an arbitrary ciphertext c E C, using an encryption algorithm E, such that a corresponding algorithm D=E⁻¹ will reverse c to m, and where both E and D take in a shared natural number as key, and where,
(ii) encrypting m with an arbitrary natural number N as key: k=N, will result in a ciphertext c(N,m) such that m=Dₖ(Eₖ(m)), and where also:
(iii) For every mεM where two keys k₁, and k₂ satisfy:

Eₖ₁(m)=Eₖ₂(m′)

There exists another message m′εM where m≠m′ such that:

Eₖ₁(m)≠Eₖ₂(m′)

Clearly a natural cipher will have an infinite number of keys that encrypt a given mεM to a given ciphertext cεC:

[m,c]:k₁,k₂, . . .

And hence given that a user encrypted n messages using the very same key, k, and given that the cryptanalyst secured the knowledge of (n−1) of these messages, and the knowledge that all n messages used the same key, the cryptanalyst will nonetheless not be able to unequivocally determine the value of the n-th message, even if he is computationally unbound. This challenge may be regarded as the greatest challenge for a cipher, (especially for n-->∞), and no bound key space cipher can meet this challenge.

### Implementation Notes

Trans Vernam ciphers may be used either to project perfect secrecy, or to project credible intractability through a measured distance from perfect secrecy. The algorithmic non-complexity of Vernam and Trans-Vernam ciphers may be used in situations where computational power is limited while memory is cheap. A very large key can be set as a static implementation in software, firmware or hardware, and a very simple non-complex algorithm will use it, according to the re-use secrecy theorem.

A multi party shared key communication may be conducted using a large Trans Vernam key that would allow for a well measured quantity of communication to be conducted with full mathematical secrecy. The key could be comprised of say, 128 GByte of randomness packed into a USB stick that is latched into the computing machine of each party, and is providing guaranteed mathematical secrecy for back and forth messages between the parties that total up to 128 Gbyte. It is the fact that every bi-lateral, trilateral or other communication between all or some of the parties can be conducted with full mathematical secrecy while using and reusing the same (very large) key, that gives this protocol the practicality that Vernam lacks (while honoring Shannon's key size limitation).

It must be noted that despite the mathematical secrecy guaranteed for the above described setting, there exist a practical vulnerability: should the message of any of these communications become known, then it would reveal the key and in turn will expose all (n−1) remaining messages.

Implementing the natural cipher will require the user to uniformly choose a key in a preset range from a low integer, L, to a high integer, H. However, L and H will be part of the key secrecy. A cryptanalyst will clearly realize that some integer H has been selected by the user, but will be frustrated by the fact that computational burden, O(N), to use natural number N as key obeys: lim O(N+1)/O(N)=1 for N->∞, so there is no leakage of the value of H.

### Hyper Key Space

### Imagine the Infinite Set of Positive Integers as the Key Space for a Symmetric “Thought Cipher”

### Interesting Attributes*Two Embodiments

A symmetric “thought-cipher” (TC) defined over an infinite key space, a finite message space and a finite ciphertext space will have an infinite number of keys that encrypt a given plaintext, p, to a given ciphertext, c, but no two of these keys necessarily encrypt a different plaintext, p′≠p, to the same ciphertext c′ (≠c). Clearly there is no concern for some hidden mathematical insight (into c, and p) that will determine the key that was actually used. Such a TC enjoys a unique level of security: a cryptanalyst in possession of n−1 tuples of p-c-k (plaintext-ciphertext-key), will not be able to uniquely determine the plaintext that corresponds to a given n^{th} ciphertext, even if the cryptanalyst is assured that all n messages were encrypted with the same key. For a TC to be feasible, its encryption and decryption effort will have to be polynomial in the key size parameter. This is not the case in today's mainstay ciphers, and so we build complying ciphers to enjoy the equivocation advantage of the TC.

### Introduction

We define a thought cipher, TC, as an encryption algorithm TCe and a corresponding decryption algorithm TCd defined over a finite plaintext message space P and a corresponding finite ciphertext message space C. The key space is defined as the infinite set of positive integers, N. Any plaintext pεP when processed by TCe with any positive integer, kεN, as a key, will yield a ciphertext cεC. And any ciphertext cεC when processed by TCd with any positive integer kεN as a key, will yield a plaintext message, pΣP. By definition we require that for a TC:

p=TCdₖ(TCeₖ(p))

The glaring difference between a TC and a mainstay cipher today is that for the latter a pair of plaintext-ciphertext (p-c) uniquely defines their cryptographic key, k, while the infinity of the TC key space requires that for at least one pair of (p,c) there will be infinite number of matching keys.

In order to exploit the benefits offered by a TC it seems desirable to add the following conditions for a TC: for every pair (p,c) there will be an infinite number of matching keys, kᵢ (i=1, 2, . . . ∞), such that:

c=TCeₖᵢ(p) for i=1,2 . . . ∞

The above definition allows for trivial embodiments. Given any fixed-size key cipher one could map the infinite set of positive integers to it by padding with zeros of smaller keys, and hashing to size larger keys. This trivial embodiment is of no much interest. We therefore add the “construction condition” to the definition of a TC:

For every pεP where two keys k₁, and k₂ satisfy:

TCeₖ₁(p)=TCeₖ₂(p)

There exists another message p′εP where p≠p′ such that:

TCeₖ₁(p)≠TCeₖ₂(p)

For TC to be operational we need to impose the condition that the computational load of encryption and decryption will be polynomial with the key size. Clearly this disqualifies all the mainstay ciphers. By contrast, the old Vernam's One-Time_pad cipher is O(key size). Similar ciphers will be presented ahead.

### Motivation

Today's ciphers admit their size to their cryptanalyst, enabling a raw, or an accelerated brute force attack. This state of affairs makes today's ciphers vulnerable to their underlying assumptions about (i) computational powers of the cryptanalyst, and (ii) her mathematical insight. There is no “built in” need to betray key size to the cryptanalyst, so why not avoid it, and practice effectual key obfuscation?

If so, why not start with maximum obfuscation, and go from there. Namely, let's define a theoretical cipher that works with an infinite key space operating on finite message spaces (plaintext and ciphertext), as we have done above.

The essential implication of a TC is that knowledge of a matching pair of plaintext and ciphertext does not identify the key used to generate one from the other, since there are infinite number of keys that accomplish it. All those keys can be rank ordered k₁<k₂<k₃ . . . and one might argue that the smallest key, k₁, is the one actually used because there is a small chance that a pair of an arbitrary plaintext and an arbitrary ciphertext would have a small key matching them, simply on account of the fact that there are few small keys, compared to many large keys.

This argument will guide a cryptanalyst to search for keys from k=1, 2, 3, . . . and on, say from small integers to large integers, and perhaps even stop at the lowest integer that satisfies the key condition, assuming that's the one. Alas, the TC user will also realize this logic, and may respond by selecting, say, k₁₀, as opposed to k₁ in a list of keys that match the same p-c pair. And what is more, the TC user does not have to identify all the nine keys that are smaller than k₁₀—this labor may be left to the cryptanalyst, the TC user can pick a key large enough to be the 10th key, or so, in the list of matching keys.

How high can the TC user go? Now, even though the TC is polynomial with respect to key size, there is a practical size limit (albeit, a soft limit) as to how large the selected key may be without overburdening the encryption/decryption process. Let's designate this limit as Hₖ. The implication is that the theoretical infinity of the key space has been reduced to Hₖ limit. Only that unlike the case with mainstay ciphers today, Hₖ is not made public, and it depends on the computational powers of the using parties.

We consider now a brute force cryptanalyst working her way from small integers up.

When should she stop? If an integer M was a reasonable key that the user could have used, then M+1 cannot be ruled as ‘unreasonable’, and hence there is no compelling argument to stop at M—any M . . . Which in turn means that a user could fire off randomized bits and send the cryptanalyst on a wild goose chase after a non-existent key.

The cryptanalyst will either find a false key, and interpret in the bits a wrong message, or she will keep on searching for a key until she runs out of resources.

Let E_{ed} reflect the acceptable computational effort for encryption and decryption, as chosen by the TC user, and accordingly he chose key size H. The cryptanalyst will have to expend a corresponding effort E_{b} for her brute force cryptanalysis of 1, 2, 3, . . . H.

Obviously E_{b}>>E_{cd}. If E_{ed}=O(H) then E_{b}=O(H²). This implies that by per case choice of a key, the TC user could control the required brute force analysis effort to identify the used key. A user of a common cipher does not have this flexibility.

Nominal brute force analysis relies on the statistical expectation of having only one key that decrypts a given ciphertext to a plausible plaintext, namely one that makes sense in the language of the writer. All other keys will decrypt the same ciphertext to a clearly non-plausible plaintext. The larger the message is, compared to the key, the greater the statistical expectation for a clear rejection of all the wrong keys. Alas, this conclusion hinges on the fixed size key space. The TC features a key space that is larger than the message space, and hence it claims a non-negligible chance for a misleading plausible plaintext to be fished out in the brute force cryptanalysis effort. How many? We clearly face the Vernam limit of allowing any n-bits message to be generated from some key, and all the n-bits long plausible messages will have to be listed as plaintext candidates; listed, but not sorted out.

We conclude then that the infinity of the key space (i) stretches the effort into an open ended analysis of larger and larger keys, and (ii) replaces the unequivocal plaintext candidate with a series of plausible candidates, without offering the cryptanalyst any means to sort them out. Together this amounts to a considerable advantage for the TC user.

### The Persistent Key Indeterminability

The infinity of the keys creates an extreme situation: a TC user uses the same key over n messages. The cryptanalyst somehow knows the identity of (n−1) of those messages, and finds a key k′ that matches all n−1 plaintexts with their corresponding ciphertext. The larger the value of n, the more likely is it that the key used on all n messages, k, is k′ (k=k′), but it is never a certainty. There may be two (or more) distinct keys that match the (n−1) plaintexts with their corresponding ciphertext, while decrypting the n-th ciphertext to two (or more) distinct plaintexts that the cryptanalyst cannot distinguish between them.

### Equivoe-T

Equivoe-T [ ] is a cipher where any positive integer serves as a transposition key. The cipher admits all n! permutations as a ciphertext (for every value of n). The plaintext space, P, and the ciphertext space C are both of size |C|=|P|=n! For a given permutation regarded as a plaintext, p, let's designate kᵢⱼ as the j-th key that encrypts p into permutation i, where i=1, 2, . . . n!, and j=1, 2, . . . ∞. The keys are organized by size, namely: kᵢⱼ<kᵢⱼ₊₁. The user of the Equivoe-T cipher is encrypting p into permutation i, using key j, such that:

kᵢⱼ>max(k₁₁,k₂₁, . . . kₙ₁)

The cryptanalyst testing the natural numbers: 1, 2, 3 will eventually reach kᵢⱼ but on her way she will also encounter k₁₁, k₂₁, . . . kₙ₁. So that the cryptanalyst will have to regard any of the n! permutations as a potential plaintext. That means that the only information given to it by the ciphertext is the identity of permutation items, not their order. If only one permutation makes sense then the cryptanalyst will nail it, but nonetheless, will not be able to ascertain whether the user used key kᵢ₁, kᵢ₂, . . . given that the user encrypted p to permutation i. This is important since the user might keep working with the same key for the next message.

### Equivoe-G

Equivoe-G [ ] is a cipher where the key is a graph with letter marked vertices and letter marked edges. The plaintext is expressed as a travel path on the graph written as a sequence of vertex letters, and the ciphertext is expressed as a series of edges that reflects the very same pathway. The size of the key is the size of the graph. For small graphs and large messages (long travel pathways), the pathway will have to bounce back and force, revisiting vertices and edges alike. For a sufficiently large graph the travel path would visit each vertex and each edge only once. The latter is the Vernam equivalent of Equivoe-G. Any in-between sizes require some vertices and edges to be revisited. Clearly there is no limit as to how large the graph is. Also, clearly the effort to encrypt or decrypt depends only on the size of the message, not on the size of the graph (the key), much as walking a distance of 10 miles takes essentially the same time whether the trip is taking place in an open field, or as back and forth trajectory in a small fenced yard.

### Implementation Notes

The use of this hyper-key space is enabled at a minimum by using a key space larger than the message space. So it is easy to implement for small messages. As argued herein, by using a sufficiently large key size it is secure to use the same key over and over again. A great convenience for practitioners.

When security is top concern one might drift to the mathematical secrecy offered by Vernam, but arguably the hyper key space is a better choice. With Vernam one has to use strictly randomized bits for the key, with a hyper-key any key is good. The hyper key can be expressed as a result of a computation key=A*B*C, where A, B, and C are spelled out.

The two presented embodiments of hyper-key space are based on simple, fast, and undemanding computation. This suggests their advantageous use in the burgeoning Internet Of Things (IOT) where passive memory to write a long key on is cheap, while battery consuming computation is expensive.

Potentially the hyperspace strategy can be interjected before or after a more common encryption, it may be flexible enough to be used for real time applications, like secure radio or phone communication. And on the other hand it may adapt to applications where highly secure large files are exchanged. In these applications one could wait a few milliseconds, or even seconds, to complete encryption, or decryption and hence a very large key can be used to fully project the cryptanalytic defense of this strategy.

### Summary

Admittedly this paper challenges a long established cryptographic premise: the fixed size (short) key, with a key space much smaller than the message space. Most cryptographic texts use Vernam as the high limit reference point where the key space is so impractically large that it equals the message space. And in that light, it sounds outrageous and nescient to suggest a hyper-key-space larger than Vernam. This idea sounds especially ridiculous when one is wedded to the prevailing practice in which even a modest increase in key size creates a computational nightmare for plain encryption and decryption.

Like with all challenges to entrenched concepts, this cryptographic strategy is likely to face shrugged shoulders, and ridicule. And while it is too early to assess how far, and how impactful this strategy will become, it appears sufficiently sound to attract an unbiased examination by the cryptographic community.

This is especially so since the ‘thought cipher’ (TC) described herein is supported with two distinct embodiments: two ciphers where the encryption and decryption effort is proportional to the size of the key (a polynomial of degree 1), and it allows for very large keys to be employed and offer their user a noteworthy cryptanalytic defense.

### A Trans-Vernam Cipher N as a Key Space

Abstract: The perfect secrecy offered by Vernam's cipher is considered impractical because Vernam requires a key that depends on the size of the encrypted message, and to the extent that the combined sizes of the messages keeps growing, so is the size of the key. We present here a Vernam equivalence in the sense that an n-bits long ciphertext can be generated from any of the 2̂n possible plaintexts, while using the natural numbers: 1, 2, . . . as the key space, thus allowing a user the choice of key size, (and encryption/decryption computational effort), and correspondingly burdening the cryptanalyst with absence of a limit as to how many key candidates to evaluate. This, so designated, Trans-Vernam cipher is based on an ultimate transposition cipher where an arbitrary permutation of n items, Pn (plaintext) is transposed to an arbitrary permutation of the same, Cn (ciphertext), using any natural number N as a key, K, and hence there are infinite number of keys all transposing Pn to the same Cn. Conversely, every natural number M regarded as a key, will transpose Pn to a matching permutation C′(M,n), and every natural number L regarded as a key will reverse transpose Cn to a matching plaintext P″(L,n). While there are only n! distinct keys, there are m!>n! distinct keys for a message comprised of m>n permuted items, and hence two natural numbers encrypting Pn to same Cn will not encrypt Pm to the same Cm. With Vernam a chosen plaintext situation leads directly to the key; with Trans-Vernam extracting the key from combined knowledge of the plaintext and the ciphertext is rather intractable. Trans-Vernam is on one hand very similar to Vernam, but on the other hand it offers interesting features that may be determined to be rather attractive especially in the post-quantum era.

### Introduction

The commonplace cryptographic key today is a fixed size bit string, with a fixed key space, inviting brute force cryptanalysis for any plaintext exceeding Shannon's unicity distance, [Shannon 1949] which practically means that brute force cryptanalysis will work on every ciphertext. Since brute force cryptanalysis is usually EXP class intractable, then seemingly everything is under control. What is often overlooked is that brute force cryptanalysis is the worst-case cryptanalytic scenario; more efficient strategies are there to be found. And for the omnipresent common ciphers we use, the incentive to find such a strategy is very high, and hence very powerful, lavishly funded crypto shops are obviously busy at it, and should they succeed, (perhaps they already did), they would hide this fact with as much zeal as Churchill's when he sacrificed dearly to conceal the cryptanalysis of Enigma.

Say then that this fixed key size security strategy is not worry free. Or say, one is well motivated to explore a new take on the cryptographic key, which is what led to this work.

We chose for this effort the most basic, most elemental, most ancient cipher primitive: transposition. Unlike its “twin:” substitution, transposition is not dependent on some X v. Y table, not even on a defined alphabet. While its efficacy is indeed limited when applied to short plaintexts, with its factorial key space, its EXP class intractability insures a very formidable key space even for moderate count of transposed elements.

Historically transposition ciphers exploited only a tiny fraction of the huge transposition key space: rotational shifting, writing a message in columns, and reading it out in rows, are known examples (e.g. Scytale cipher, [Stallings 2002]). So we first searched for what we designated as “The Ultimate Transposition Cipher” (UTC), one that would encrypt any sequence of n items to any other sequence of the same items.

Having identified a UTC, we have added a small step so that it can be applied over a bit string such that any arbitrary n-bits long string can be decrypted to any other n-bits long string (simulating substitution with transposition steps).

Once such Vernam-equivalence was achieved we noticed interesting advantages about the new cipher: the key could be represented by any natural number. Namely any sequence of n items, when transposed using a natural number N, will yield a permutation on the same. Since the set of natural numbers is clearly larger than n! there are infinite keys matching any pair of permutations, one regarded as plaintext, the other as ciphertext.

These two facts lead to startling conclusions: brute force is defeated here, and having knowledge of a finite number t pairs of plaintext-ciphertext, all encrypted with the same key K, does not allow one to unequivocally infer the plaintext of a (t+1) ciphertext also encrypted with K.

This is the bird's eye view of the Trans-Vernam cipher. Let's take a closer look

### The Ultimate Transposition Cipher (UTC)

We define:

First: A Nominal Transposition Cipher (NTC). The Nominal Transposition Cipher will be defined as an algorithm of the form: C=E_{K}(P), where P is a plaintext comprised of n ordered data elements, and C is the corresponding cipher comprised of the same n elements in some other order; and where E is the encryption algorithm that operates on P and on K, where K is regarded as the encryption key, and is a natural number: KεN. An NTC will have a corresponding decryption algorithm, E⁻¹, such that P=E⁻¹_{K}(C).

An NTC key, K, has a key space of size |K|. If |K|<n! then the NTC is a non-ultimate transposition cipher (nonUTC, or NUTC). That is because the cipher will not allow a given permutation to be encrypted to all the possible n! permutations.

An Ultimate Transposition Cipher (UTC) is a nominal transposition cipher where a given plaintext P may be encrypted to any arbitrary permutation of P. A UTC will have a key range |K|≧n! We may therefore write: for P and C, two arbitrary permutations of the same n elements, there is a key, K such that: C=UTC_{K}(P), and P=UTC⁻¹_{K}(C). UTC, and UTC⁻¹ are the UTC transposition and reverse-transposition.

### Equivoe-T (EqT)

Equivoe-T [Samid 2015 A] is a UTC where the key space stretches over all the natural numbers: |K|=N: K₁=1, K₂₌₂, K₃=3, . . . Kₙ=n, and hence for any pair of arbitrary permutations P (plaintext) and C (ciphertext) there exist ∞ matching keys that perform the same encryption and decryption between P and C.

Equivoe-T (Zero Version) (EqT₀) operates as follows: the pre-transposition permutation, P, forms a set designated as the “from” set. Next to which there exists an empty set designated as the “to” set. An arbitrary natural number r, called the “repeat counter” is used to count the items in the “from” set by order, and to keep counting from the beginning after reaching the end of the “from” set. Any item in “from” where the r count stops, is migrated to the “to” set, where the incoming items are placed in the order of their arrival. The repeat counter counts only the remaining items in “from” which loses all its items that way, one by one. After having stopped n times, the “repeat counter”, r, managed to migrate all the n items in “from” (originally populated by the pre-transposition permutation) to the “to” set (originally empty, and when done, populated by the post-transposition permutation, C).

Remark: Many variations are possible. For instance: switching the counting direction after every count.

### Illustration 1:

let P=ABCDEFGH (n=8); let the “repeat counter” r=11: the resultant transposition will be: CGEFBHAD; for r=234 we get: BHECFGDA; and for r=347876 we have: DHBCAFEG.

### Illustration 2:

let P=ABCDEFGHIJKLMNOPQRSTUVWXYZ; for r=100 we get: VUZHTNMSGDJACRBEYFOQKIXLWP, and for r=8 we get: HPXFOYISCNAMBRGWTLKQVEDUJZ

As defined, the repeat removers range is the natural numbers (N). Alas, a list of n permutation items has only n! variations. Hence there are infinite numbers of repeat removers which encrypt a given plaintext P to a given ciphertext C. Every pair (P,C) projects to an infinite series of repeat removers: R₁, R₂, . . . . Consider two such consecutive removers, Rᵢ, Rᵢ₊₁. They are separated by a natural number X which is the smallest number divided by 2, 3, . . . , n. Obviously n! is divided by 2, 3, . . . n but n! is not the smallest such number: n!>X=Rᵢ₊₁−Rᵢ. We may define the “sub-factorial” of n (n!) as the smallest number that divides 2, 3, . . . n:

n!=X|X=0 mod k for k=2,3, . . . n

We shall now construct the sub-factorial expression:

n!=ΠPᵢⁿ^{ᵢ}

where Pᵢ is the i-th prime number, and nᵢ is the power to raise Pᵢ such that:

Pᵢⁿ^{ᵢ}≦n and Pᵢⁿ^{ᵢ}⁺¹>n

### Proof:

For all primes Pᵢ>n nᵢ=0 so Pᵢⁿ^{ᵢ}=1. For all Pᵢ≦n: n!=0 mod Pⁿ^{ᵢ} Hence, we may write:

kn!=Y₁Y₂ . . . YₘΠPᵢⁿ^{ᵢ}

where k is some natural number and Y₁, Y₂, . . . Yₘ are all the numbers in the range {2,n}which are factored into more than one prime number. Such a composite may be written as:

Yj=ΠPᵢ^{z(j,i)}

Where i runs through all the primes smaller than n, and z(j,i) is the power to which Pᵢ is raised in the Yⱼ expression.

For every Yⱼ, and for every Pᵢ in the expression of that Yⱼ, we can write:

z(,j,i)<nᵢ

Because Pᵢⁿ^{ᵢ}⁺¹>n and Yⱼ≦n. And hence for every prime Pᵢ raised by nᵢ, nᵢ will be larger than any z(j,i) for all i and j. In other words, the expression ΠPᵢⁿ^{ᵢ} will include sufficient Pᵢ multiplicands to insure:

ΠPᵢⁿ^{ᵢ}=0 mod Yj for j=1,2, . . . m

And because the primes P₁, P₂, . . . are all distinct, we conclude:

n!=ΠPᵢⁿ^{ᵢ}

which proves the validity of the construction.

Clearly the key space of EqT₀ is less than n! (n!<n!), so that EqT₀ is a non-UTC.

The following table shows in numbers the message codified in:

Lim(n/n!)=0 for n→∞

Which is based Gauss proof that the average density of primes is diminishing towards a zero limit:

| n | n! | n_{!} |
|---|---|---|
| 2 | 2 | 2 |
| 5 | 120 | 60 |
| 10 | 3628800 | 2520 |
| 15 | 1307674368000 | 360360 |
| 20 | 2432902008176640000 | 232792560 |

### Ghost Dressing:

We shall now introduce a process known as “ghost dressing” which amounts to peppering ‘ghosts’ (added items used for the EqT transposition and removed afterwards) between the items in the P permutation. By peppering G ‘ghosts’ into the pre-transposition permutation, we increase that permutation list to (n+G) items, designated as “ghost dressed pre-transposition permutation:” P_{g} (|P_{g}|=n+G). We now copy P_{g} to the “from” set, choose a repeat counter, r, and perform the migration of the (n+G) items from the “from” set to the corresponding “to” set (The EqT₀ migration procedure only now over n+G items). When done the “to” set contains the same (n+G) items that formed the “from” set. The “to” set now exhibits the post-transposition order.

Next, we scrub off all the G ghosts, and copy out the remaining n items in their recorded order. This ‘ghost dressed’ transposition is regarded as the nominal Equivoe-T.

It has been shown in [Samid 2015 A] that the nominal Equivoe-T transposition is a UTC.

### Illustration

Let us examine the plaintext P₄=XYZW. Using the repeat counter, r=1, 2, 3, . . . we compute only 12 distinct permutations.

| C R | |
|---|---|
| XYZW | 1 |
| YWZX | 2 |
| ZYWX | 3 |
| WXZY | 4 |
| C R | |
| XZWY | 5 |
| YXWZ | 6 |
| ZWXY | 7 |
| WYXZ | 8 |
| C R | |
| XWYZ | 9 |
| YZW | 10 |
| ZXXW | 11 |
| WZYX | 12 |

We shall now ghost-dress P with a single ghost. Writing: P^{g}=*XYZY. The ghost-dressed plaintext has a period of 5!=2²3¹5¹=60, which is quite larger than the space of complete transposition of n=4 elements (which is 4!=24), so it is possible for this ghost-dressed plaintext to be encrypted into the full range of the original 4 element. When we encrypt P^{g} with the range of removers r from 1 to 60 we tally: (each ciphertext is followed by its generating remover).

*XYZW 1; XZ*WY 2; Y*WXZ 3; ZYWX*4; W*YZX 5; *YXWZ 6; XW*YZ 7; YXWZ*8; ZWY*X 9; WXY*Z 10; *ZXYW 11; X*WZY 12; YZW*X 13; Z*YXW 14; WYXZ*15; *WXZY 16; XYW*Z 17; YWZX*18; ZXYW*19; WZX*Y 20; *XWYZ 21; XZWY*22; Y*ZWX 23; ZYX*W 24; W*XYZ 25; *YWZX 26; XWZ*Y 27; YXZ*W 28; ZWXY*29; WX*ZY 30; *ZWXY 31; X*ZYW 32; YZXW*33; Z*XWY 34; WY*XZ 35; *WZYX 36; XYZW*37; YWX*Z 38; ZX*YW 39; WZ*YX 40; *XZWY 41; XZY*W 42; Y*XZW 43; ZY*WX 44; W*ZXY 45; *YZXW 46; XWYZ*47; YX*WZ 48; ZW*XY 49; WXZY*50; *ZYWX 51; X*YWZ 52; YZ*XW 53; Z*WYX 54; WYZ*X 55; *WYXZ 56; XY*ZW 57; YW*ZX 58; ZXW*Y 59; WZYX*60;
All in all: 60 distinct permutations. When we ghost-wash these permutations we indeed extract all the 24 permutations that cover the entire key space for n=4 permutation elements. So in this example, ghost-dressing the plaintext with a single ghost allowed for the migration algorithm, powered by ghost-dressing to function as a complete transposition cipher.

### Equivoe-T Key Representation

The Equivoe-T key is comprised of the value of the repeat counter, r, and the number of ghosts, gᵢ to be inserted before item i in the n-items permutation, where:

Σgᵢ=G for i=1,2, . . . n

We shall redesignate these items as follows: r will be called k₀, and gᵢ will be called kᵢ. The Equivoe-T key K is now comprised of k₀, k₁, k₂, . . . kₙ

For all i=0, 1, 2, . . . n we can write: 0<kᵢ<∞ and hence |K|→∞>n!

We shall now represent K as a natural number N as follows:

N will be built as a bit string where the leftmost bit is 1. It will be followed by (k₁+1) zeros. Next we plant a “1” followed by (k₂+1) zeros. And so on, kᵢ will be represented by the bit “1” concatenated to the right of the N bits that were assembled to represent k₁, k₂, . . . kᵢ₋₁, and followed by (kᵢ+1) zeros. When all the n values (k₁, k₂, . . . kₙ) are processed the bits assembled into the developing N will be concatenated with a “1” and then followed by the bit representation of the repeat counter. This concludes the construction of N.

It is easy to see that N can be unequivocally reverses to K={k₀, k₁, . . . kₙ}. Counting the zeros followed the first ‘1’ and deducting one will identify k₁, same for the count of zeros after the ‘1’ that followed the first group of zeros, and similarly all the way through to kₙ. Since the repeat counter, k₀ begins with ‘1’ on the left, it will be clear from which bit to read it: from the 1 that is concatenated to the ‘1’ that seals the zeros identifying kₙ.

To insure that any natural number, N, can be unequivocally interpreted as a key for any size of permutation list, n, we need to add: (i) In the event that there is no repeat counter, r, it is interpreted as r=0, and we can agree:

C=P=Eᵣ₌₀(P)=Eᵣ₌₁

(ii) If N indicates ghosts to be added for v<n items on the list, of n permutation items, then for the last (n−v) items there will be no ghosts: kᵢ=0 for i=v+1, v+2, . . . n (iii) If N indicates ghosts to be added for v>n items on the list of n permutations, then the ghosts indications for the non-existing items will ignored.

It is now easy to see that every natural number N may be interpreted as a key, K for any value of n—count of transposed items. In the bit representation of every natural number the leftmost bit is one. If the next bit right of it is also one then the entire N is k₀, the repeat counter, and k₁, k₂, . . . kₙ=0. If the second bit on the left is a zero followed by one then we conclude k₁=0. If what follows is t zeros then we conclude k₂=t−1. If the left most x bits in N include n bits identified as ‘1’ and these n bits never appear as two next to each other (no ‘11’) then the total number of ‘ghosts’ G=k₁+k₂+ . . . kₙ is: (x−2n) because n bits in x are one, and first zero next to each ‘1’ does not count.

We have thus proven that every natural number N may be interpreted as one and only Equivoe-T key K, and in turn every key may be written as a natural number N.

The natural number key is comprised of two parts: one part indicating the number of ‘ghosts’ to be inserted in different location in the plaintext, and the other part indicates the value of the repeat counter, r. Hence the effort to encrypt a plaintext of size n bits with a key K=N is proportional to log(N) for the first part, and to N for the second part, or say, the computation effort N_{comp} abides by:

O(log N)<N_{comp.}<O(N)

Or say, the one thread of hope for the cryptanalyst of Trans-Vernam is that unlike the situation with the original Vernam, where effort-wise all keys are equally likely, with Equivoe-T, smaller keys are more likely than larger ones.

Representing both the plaintext and the key as a bit-string will suggest a seemingly very powerful one-way function: Trans-Vernam Square: K*²=EqT_{K}(K) using a natural number K as key and as plaintext P=K.

### Trans-Vernam Cipher

A UTC can be applied to any sequence of items, large or small, uniform or not. The order of the items in the plaintext will not be compromised by the known order in the ciphertext regardless of the nature of these items, and regardless of the computing resources of the cryptanalyst. In [Samid 2015, A] this point is further elaborated on.

Here we will focus on applying UTC over a bit string, or say, regarding individual bits as the entities to be transposed. Since bits come only with two flavors, one and zero, we don't have the full n! range for ordering n bits. The number of distinct permutations varies according to the ratio between the flavors. Say then that the number of possible ciphertexts of a given bit-wise plaintext depends on the bits in the plaintext, and is not an a-priori known quantity (n!/n₁!n₀!) n₁ and n₀ is the number of ones and the number of zeros respectively in the string). To rectify this inconvenience, and to build a cipher that is functionally equivalent to Vernam, we need a special design because a Vernam ciphertext comprised of n bits may be matched with all the possible (2ⁿ) distinct n-bits long string.

We consider a plaintext P (an original plaintext) comprised of a string of n bit. We define P′ as the ‘P complimentary string of size n bits’ as follows:

P′=P⊕{1}ⁿ

Namely P′ is a result of flipping every bit in P. We now construct the pre-transposition plaintext, P* as follows:

P*=P∥P′

P* is a concatenation of the original plaintext and its complementary string, and it is 2n bits long. By construction we have the same number of ones (n₁) and zeros (n₀) in P*:

n₀=n₁=n

Let C=UTC_{K}(P*). The intended reader of C will use her knowledge of K to reproduce P*=UTC⁻¹(C), ignore the rightmost n bits, and read the original plaintext P. But the cryptanalyst will identify 2ⁿ keys corresponding to all the possible n-bits long string (2ⁿ). That is because the transposed 2n bits string has sufficient bits of either flavor to account for all the possible strings, from {0}ⁿ to {1}ⁿ, permutations of P.

A UTC so applied will be called a Trans-Vernam cipher, or TV-cipher. Just like with the original Vernam, the probability of any possible string to be the sought after plaintext is the same with or without the knowledge of C, given no outside information regarding the keys:

Pr({0,1}ⁿ|C)=Pr({0,1}ⁿ)

However, with the original Vernam one would assign higher probability to plaintext generated with low entropy keys, and for Trans-Vernam one might assign higher probability to plaintexts generated with smaller keys.

Shannon required the key space to be as large as the plaintext space for mathematical security to be present, and indeed, the key space for a trans-Vernam cipher is larger than the key space for Vernam:

|K_{Trans-Vernam}|>|Kᵥₑᵣₙₐₘ|

(2n)!/(n!*n!)>2ⁿ

As may be readily shown: multiplying each side of this inequality by n! we have:

2n*(2n−1)* . . . *(n+1)>}2ⁿn!

rewriting:

2n*(2n−1)* . . . *(n+s)* . . . *(n+1)>(2n)*(2(n−1))* . . . 2s . . . (2*1)

We compare the terms by order and find that for s=1, 2, . . . n we have:

(n+s)>2s

because for all values of s except s=n we have n>s, which proves the above inequality.

A TV cipher shares with Vernam the situation whereby every single possible n-bits long plaintext has a non-zero probability to be the plaintext that encrypted into the given ciphertext. But further than that Vernam and Trans-Vernam differ.

With Vernam having the plaintext and the ciphertext, extracting the key is trivial. With Trans-Vernam this may be intractable, depending on the nature of the underlying UTC.

While no n-bits long string has a zero probability to be the plaintext, Vernam will surrender to a cryptanalyst if a highly probable plaintext will be associated with low-entropy key. A similar vulnerability will be sustained by a Trans-Vernam cipher depending on the nature of the UTC.

With the original Vernam every pair of plaintext-ciphertext commits to a single key, K.

By contrast with Trans-Vernam every pair of plaintext-ciphertext is associated with a large number of keys! This is because for every plaintext candidate string comprised of n bits, the rightmost n bits of the 2n reverse-transposed string may be found in any of their possible distinct permutations. For a plaintext candidate comprised of {1}^{x}, and {0}^{n-x}, there will be n!/(x!*(n−x)!) keys, which ranges from a count of 1 for a plaintext in the form of {0}ⁿ or {1}ⁿ, to a count of n!/(0.5n)!*(0.5n!). for a plaintext in the form {0}^{0.5n}, {1}^{0.5n}.

This implies that even if a cryptanalyst has possession of both plaintext and ciphertext, she will not know which key was actually used, which also means that the user could have used the same key again!

### Transposition Size and Secrecy

Since the number of unique keys is n!, it is clear that the number of transposed items (the transposition size), n, is a critical security factor. Indeed it may be made secret, so that a large m bits plaintext may be divided to n parts of various sizes, if so desired, and these n parts will be transposed. Further, each of the n items may be divided to n′ sub-items, which in turn may be transposed, and once again, if there are enough bits in the string. The result of this procedure may be re-transposed using a different protocol, etc.

While there are only n! distinct keys, to transpose n items, there are m!>n! distinct keys for a message comprised of m>n permuted items, and hence two natural numbers encrypting Pₙ to same Cₙ will not encrypt Pₘ to the same Cₘ.

### Illustration:

for EqT, transposing P=XYZW, we get:

WXYZ=EqT(r=7,g2=1)=EqT(r=25,g1=1)

However, for P=XYZWU, we get:

XYUZW=EqT(r=7,g2=1)≠UXYZW=EqT(r=25,g1=1)

### Equivoe-T Based Trans-Vernam Cipher

We turn now to the Trans-Vernam cipher that is based on a particular UTC, the Equivoe-T.

The Equivoe-T based Trans-Vernam cipher (TV(EqvT)) claims the entire field of natural numbers as its key space. And hence, in theory a user could select one key (one natural number) and use it forever. The idea being that a cryptanalyst in possession of any finite instances (t) of plaintext-ciphertext pairs, all associated with the same key, will still be looking at an infinite number of possible keys that could be used to encrypt these t pairs, and hence will face an infinite entropy as to identity of the plaintext in the (t+l) instance in which the very same key was used.

What disturbs this startling analysis is the fact that unlike Vernam where the effort to use all the possible keys is the same, with this Trans-Vernam cipher the computational effort to use a natural number N as a key, N_{compute}, is between O(log N)<N_{compute}<O(N) and it behooves on the cryptanalyst to assume that the user has restrained himself to “reasonable” N=key values. This suggests a cryptanalytic strategy to test keys by order 2, 3 . . . .

On the other hand, the user is well advised to increase her security by using a large N=key, and furthermore pepper the Trans-Vernam messages with pure random garbage as a powerful distractor, since the cryptanalyst will keep trying larger and larger keys, always suspecting that the “real key” will be exposed very soon, just climbing up a bit through the natural numbers ladder.

Alternatively a user could use the ‘unbreakability’ of the trans-Vernam cipher to send through it the key (natural number) to be used in the next session.

### Summary Notes

The Trans-Vernam cipher may be viewed as an attempt to re-visit the Vernam's notion of cryptography by durable equivocation, rather than by erosive intractability. The idea of having any natural number as a key offers an interesting variability, opening the door for a host of practical applications.

A Network of Free Interacting Agents Cannot Prevent a Minority of Agents from Assuming Control

Abstract: The Bitcoin protocol highlighted the idea of “pure network control” where interacting agents determine as a networked community their path, and all decisions are derived from the congregated power of the network; no minority, no few agents are allowed to “be in charge” and lead the network. It's the ancient Greek idea of democracy applied anew with a smart interactive protocol. The motivation is clear: whenever a minority becomes the power elite, they act selfishly, and the community at large suffers. In this thesis we show that under a given model for interacting agents, it is impossible for the community of agents to manage their affairs for the long run without surrendering power to few “agent leaders”. This result may cast a long shadow with respect to many relevant disciplines: a hierarchical structure of authority is a must in any environment where free agents interact with an attempt to well manage the network as a

### 1.0 Introduction

In modern life we have developed many situations where a group of intelligent, interacting agents operate as a network with a goal and a plan. Such networks have been traditionally managed via strict hierarchy. Alas, the phenomenal success of the Internet has excited the imagination of many towards a network of autonomous agents who obey an agreed upon protocol, and manage themselves without surrendering power to any subset, any minority, any few.

Bitcoin is an example of a payment protocol designed to frustrate any minority, even a large minority from taking over, and subjecting the community to their will. The issue excited an enduring debate over the success of the protocol per its minority-defying goal, and more recently, the more abstract question came to the fore.

In the last few years the concept of “swarm intelligence” has been coined to suggest that dumb agents acting in unison will exhibit group intelligence way above the individual intelligence of the swarm constituents. The swarm is flexible, robust, decentralized and self organized. But its intelligence is a virtual assembly of the building block intelligence. A swarm is case of network integration, time and again, against the same odds—it is not what the case before us is.

Unlike a swarm, an environment of interacting free agents is an assembly of rather dissimilar agents who wish to improve their lot by acting together, and the question before them is: can these free agents manage themselves without surrendering power and freedom to a sub-network, a few within them?

More precisely, given a network of interacting dissimilar agents, can the network act without hierarchy as effectively as with an honest, wise and impartial hierarchy?

To make this question answerable in logical mathematical terms, one needs to erect a model within its terms the conclusion will emerge.

We therefore define ahead a model for the network, then offer a mathematical analysis of the model, which leads to the summary conclusion expressed in the title.

### 2.0 Modeling the Multi-Agent Environment

We offer the following base model:

An agent is defined as an abstract mathematical entity, associated with m resources, where each resource is measured by a positive number:

A<-->(r₁,r₂, . . . rₘ)

The survival value of an agent is measured via m non-negative coefficients e₁, e₂, . . . eₘ, as follows:

V(A)=Σeᵢ*rᵢ

where i=1, 2, . . . m. Since each agent faces different challenges, each agent survival depends on a different combination of resources, this combination is expressed by the survival value coefficients e1, e2, . . . em unique to each agent. Because of this variance in survival threats and variance in value coefficients, the agents find it mutually advantageous to trade surplus resources with against deficient resources. Over time the values of the various resources may vary, some may go up, other may go down, but at any time point, t, the value of the agents is measured by the value formula: V(A,t)=Σeᵢ*rᵢ(t).

A multi-agent environment (MAE) is a collection of n agents, all share the same r resources, but with different value coefficients.

The MAE is defined as a tax-levying entity, as well as an endowment entity. Both taxation and endowments are done with currency, money. Each attribute has a unit price. So if the MAE levies a tax liability of x money units on a particular agent then that agents has to convert some resources to raise the money and transfer it to the MAE. Similarly, an endowment receiving agent will convert the ‘cash’ to getting more of some resources such that the total gain will equate to the amount of endowment.

This situation assumes a free trade among the agents, a trade that is determined by supply and demand. An agent wishes to increase the attributes that contribute the most to its survival value V. At each instant of time t, each of the m resources has a per unit cost of cᵢ(t), and with these m cost values, the monetary value (wealth) of a given agent i=1, 2, . . . n is computed to be:

W(Aᵢ)=Σcⱼ*rᵢⱼ for j=1,2, . . . m

The dynamics of the environment is measured by clock ticks. Each “tick” the values of the resources may change owing to the survival effort of each agent, having to use resources to meet its challenge. The model will introduce “death value”—a threshold survival value such that if an agent sinks below it, it is considered eliminated—dead. The MAE will act so as to minimize the number of eliminated (killed) agents, and increase their value. The MAE does so by levying taxes and providing endowments as it sees fit.

To lay out the model we need not be concerned with the exact optimal management formula for the network; we assume it is well defined.

The question is now: can such an MAE operate optimally by keeping the power with the total community of agents, and not within a subset thereof? The MAE has no monetary resources of its own, every unit of currency it offers as endowment, had to be previously raised by levying taxes.

### 2.1 Model Dynamics

It has been shown that any complex decision may be represented as a series of binary options, we therefore choose to model the MAE as an entity presented with a binary question, regarding taxes or endowment. At this point we will not characterize the type of questions received, but assume that they have been reduced to binary options. The questions to be voted on have two consequences: the tax levying formula will change in some way and so will the endowment formula.

The MAE wishes to prevent any minority of agents from taking control, and so it establishes an agreed upon voting mechanism, by which every agent votes on every binary option question brought before it. The voting options are: “+1” in favor of the proposed step; “−1” disfavor towards the proposed step, and “0” no interest in voting.

Each agent is voting according to its own interest, in an attempt to increase its survival values according to its own survival coefficients.

### 2.2 Statistical Analysis

A question is put up for voting. The n agents all vote {+1,0,−1} according to their own interests. The decision comes down based on straight count of pro and con, or say on algebraic summary of the votes. If the summary is positive the positive option is decreed as accepted by the MAE, if the summary is negative then the negative option is selected, and if the summary is zero then, it is as if the question was not put up for a vote.

Given no a-priori reason to lean towards one side or another, chance are that the votes are close. In other words, it is statistically highly unlikely for a landslide win. It is much more likely to extract a thin win. This means that about half of the agents are disappointed with the summary result.

More binary options questions are coming forth, and each of them is decided by a narrow margin on statistical dictates. And each time there are about half of the voters disappointed.

Statistically speaking after q binary questions put up for votes, there are some who are thoroughly disappointed because they have lost q, or nearly q times. The chance for an agent to be disappointed q times in q questions is 2^{-q}. Therefore there are n*2^{-q} agents in that same status.

The q-times disappointed (over q questions), as they move about and communicate with other agents, may in due course find each other, and form a block, united by their disappointment. Their shared fate will suggest to them that acting as a block, in unison, will be mutually helpful. Note: the bonding communication will occur also among those who were disappointed q−1 times over q questions, (or q−2 times, if q is large enough) but we ignore this added factor because it will needlessly complicate the mathematical argument.

The agents then come up with the “Tipping the Scale” (TTS) strategy, as follows: the members of the newly formed block, the q-times disappointed, will devise a question to be put before the community. They will agree on a question to which all the members of the block find it to their advantage to vote in one, and the same way (whether pro or con). This TTS-question is then forwarded to the MAE for community voting.

Chances are that the non-united agents, counting n*(1−2^{-q}), will split more or less evenly between pro and con. This amounts to having about 0.5n(1−2^{-q}) votes against the preferred decision of the block, and 0.5n(1−2^{-q})+n*2^{-q} voting for the preferred decision of the block.

For proper values of n, and q this TTS strategy, will indeed tip the balance in favor of the block.

### Example

let n=1000, and q=4, the block will be comprised of 1000*2¹⁶=63 members.

The count of votes against the preferred decision of the block will be: (1000−63)/2=468, and the count for the block's side: 468+63=531. This considerable advantage of 531:468 will increase once the agents who were disappointed only q−1 and q−2 times are added to the calculus.

The success of the block to win a favorable decision will encourage its members to repeat this strategy to better serve their interests. In subsequent votes over other questions (not the TTS questions), the block members will evenly prevail or fail, but their block success will keep the block well cemented, and with their strength, growth will follow.

The statistical dictate for developing a small group of consistently disappointed agents will be in force after the forming of the above described block. And so another block will be formed, and a third, etc. So over time, the uniform collection of unattached agents will evolve to segmented agents.

This will lead to further fusion of the existing blocks via the well known “birthday mechanism”: let there be two blocks with n₁, and n₂ members respectively. The Birthday Principle claims that the chances for these two blocks to find a shared agent is counter intuitively high. Such a member will serve as a fusion point and create a combined block comprised of (n₁+n₂) agents. The fused blocks will grow again, and again, and over time will construct larger and larger blocks.

As blocks succeed, the un-unionized agents become disadvantaged and rush to form blocks themselves. So given enough time the community of freely interacting agents will be parceled out to power blocks. As they struggle, they coagulate in order to prevail, until one block assumes control to the point that it can bring for a vote the ‘democracy killer question’.

The “Democracy Killer” Question:

The network control paradigm calling for an up or down vote of the agents on every posed question is hinged on the freedom of any agent to bring for a vote any question what so ever. The community as a whole votes on each question, but the kind and type of questions to be voted on should not be curtailed. The reason is simple: let an agent Aᵢ wish to raise a binary question for community vote. Who will have the authority to prevent this question for submission for a vote? The community cannot do so because it depends on the nature of the question, and anyway the community expresses its opinion by communal vote . . . . In other words, any conceived mechanism to prevent any which way question is based on someone other than the network, the community having the power to decide what is brought up for a vote. Albeit, a large enough block of agents may tilt the communal vote in its direction, so it can bring a ‘democracy killer’ question, like: giving the power to reject questions brought up for vote, to a particular agent, even on a temporary basis. Such a ‘democracy killer’ question will pass by the same mechanism described above. And once so, that ruling block will have the ability to prevent opposing blocks from repeating the ‘trick’ used so far, because their questions will be rejected, and not submitted for a vote. Note: the power to pass the “killer question” is considerable, since presumably the vote to reject this proposal will be overwhelmingly positive. So only a large enough block can cause it to come to pass.

### 2.3 Network Operation

The n agents face challenges which they try to meet using their available resources. Statistically speaking some agents will have a surplus of resource i and a shortage of resource j, while another agent will have the symmetric situation: a surplus of resource j and a shortage of resource i. It will be mutually advantageous for the these two agents to exchange resources, to trade.

This efficacy of exchange if extrapolated to all the n communicating agents, will point to an optimal allocation of the m resources such that all, or most agents will be in a best position to meet their own challenges. Such optimal allocation will require (i) an agreed upon ranking formula—to rank different allocation solutions, and (ii) a resource allocation entity with complete visibility of the current status in terms of available resources to all the agents, and the challenges they meet. That resource allocation entity (RAE) will be impartial and with ultimate power over the agents to take and give any measure of any of the m resources to any and all the n agents.

The practical problem is that such an RAE is not available, and anyone projecting itself to be one is readily under suspicion for trying to grab power. So what is the second best strategy?

The answer is to build an enforceable protocol that would involve the fair and equal input from all participating agents. The protocol will determine which agent loses which resources in favor of other agents, and which agent gains which resources on account of others. Since such a protocol is theoretically attractive but practically deficient for lack of means of enforcement, the agents may wish to apply the concept of money: a network issued notes that will facilitate trade. The presence of money will create market determined pricing for the m resources. On top of this money framework, all that the network will have to do is to levy taxes and allocate endowments, all in terms of money, and thereby affect the trade towards an optimum.

The network decisions discussed in this thesis are taxation and endowment decisions. If these decisions are taken by a minority of agents rather than the community of agents as a whole then the resultant resource allocation will be far from optimal, endangering the survival of the network and its member agents as a group.

### 3.0 Informal Description of the Thesis

The thesis regards the behavior of a community of interactive free agents wishing to gain mutual advantage by organizing into a network, or say, a community. They wish though to prevent any minority of agents from getting control and subjugating the rest of the group. To achieve this the agents agree that any decision that will be legally enforceable will have to pass by a majority of voting agents.

The thesis argues that such a protocol will not last, and minority control will rise and become a reality. This will happen due to the statistical fact that for any series of q questions to be voted on, there will be a subset of agents who share the same fate of having the community voted against them (opposite to their vote), each and every time.

This shared fate serves as a unifier and motivates these agents to bind together to change their lot through the power of coordination.

It is important to note that the presence of a subset of shared-disappointment agents is a generic phenomenon, it does not depend on the nature of the agents, nor on the particular lines of communications between the agents.

It is another statistical fact that owing to the randomized distribution of attributes and resources among the agents, most voted-on questions are not determined by a landslide, but by a narrow margin. The block of the shared-disappointment agents will devise a question under the guideline that this question is such that the members of the block all wish to vote in the same direction. The block will then pose this question for a vote, and since the non block members agents will distribute about evenly in their “pro” and “con” votes, the unified vote of the block will tilt the balance in favor of the block.

This effective move by the block will further unify and augment the block, and it will be applied time and again, effectively wrestling control and power from the network as a whole and tucking it in the bosom of the members of the unified block.

The statistical principles that lead to this thesis are broad and generic, they apply to human agents, robotic-agents, software modules, Internet addresses, biomedical tissues—any community of intelligent mutually communicating entities.

### 4.0 Conclusion

The stark conclusion of this thesis is that the bitcoin attempt, and similar efforts to create a network of smart mutually communicating entities that resist any attempt to control it by any minority of entities, or an external power—are hopeless. A gradual process of shifting power from the community as a whole to the bold minority for control—is a statistical must.

And therefore a smart community should rather pre-plan for methods and protocols to surrender power to a controlling minority such that the chances for abuse will be minimized. Such strategy will be addressed in a coming paper.

### 5.0 Application to Networks of Computing Entities

The operational conclusion of this thesis towards the Internet, or any other network of computing entities is to construct a resource-exchange network protocol with built-in hierarchy, as opposed to the idealistically and impractical ‘flat’ approach. The built in network authority will make an on going sequence of decisions in which some entities are taxed and some are being endowed, for the benefit of the network as a whole. For this application to be effective it is necessary to define computational currency, to be passed around for every service and every transfer of resources. The network authority will tax and endow that media—the network currency—in its quest to conduct the network as close as possible to the optimal network state.

### 6.0 Biomedical Applications

The phenomenon of Cancer is one where a small group of cells act selfishly, and at the end brings down the entire organism. The evolution of a controlling brain over the entire body is another example where highly developed ‘intelligent’ entities: biological cells interact in a framework of a mutually supportive network, and where resources are exchanged. Such environments are embodiments of the network model presented here, and are subject to its conclusions, as starting hypotheses.

### REFERENCES

Olfati-Saber, R.; Thayer Sch. of Eng., Dartmouth Coll., Hanover, N.H.; Fax, J. A.; Murray, “Consensus and Cooperation in Networked Multi-Agent Systems” Proceedings of the IEEE 2015 Volume:95 Issue:1
Nedic, A.; Dept. of Ind. & Enterprise Syst. Eng., Univ. of Illinois, Urbana, Ill.; Ozdaglar, A. “Distributed Subgradient Methods for Multi-Agent Optimization” Automatic Control, IEEE Trans . . . >Volume:54 Issue:1 http://ieeexplore.ieee.org/xpls/abs_all.jsp?arnumber=4749425
Yiguang Honga, Guanrong Chenb, Linda Bushnellc, “Distributed observers design for leader-following control of multi-agent networks” Elsevier, Automatica Volume 44, Issue 3, March 2008, Pages 846-850

### Creative Randomization: An Overlooked Security Tool

Security breaches happen when a hacker relies on the expected reaction of the target organization. Organizations chase efficiency, predictability, streamlining. Hackers abuse the same. To fight them practice creative randomized inspections: check all procedures however detailed of some side department, randomly pick up employees for in-depth background check, switch protocols without notice, change secret visibility to individuals unannounced. This very practice puts the jitters in the attackers, and it remedies in part the vulnerability due to predictability of the defending organization.

### Biometrics in Full Steam

In 2010 The United States and Israel managed to rip apart hundreds of Iranian centrifuges, and slow down the march towards an Iranian bomb—the genius (or genie rather) of Stuxnet. The sense of success and triumph lifted everyone on the good side of cyberspace. It has taken a while for us to realize that we have just given our adversaries the idea and the technology to hit us in kind: down airplanes, crash trains, create sustained blackouts. Technology runs on ‘cool’, accelerates virally, develops a growing momentum, and few cerebral writers are powerless to stop it.

Biometric security has gained an enormous momentum since my first warnings. By now millions of us have surrendered our biological patterns, exposing our fingerprints, facial features, palm layout, iris, ocular vein structure, even our heartbeat pattern. And once this information is out there, in a hackable state, your identity is at much greater risk than if you just lost a card, or a PIN, or digital cash. Anything issued to you, even you social security number, can be replaced to prevent your data thief from stealing your identity time and again. You cannot be issued a new set of fingerprints, no new face (some of us would definitely like that), nor iris. Every biological identifier is reduced to a data signature so that when you put your thumb on the concave spot on your phone, the reading can be compared. What exactly is being compared? It's not your thumb per se, it is the mathematical signature computed from the sensory input that reads your fingerprint, it is that signature that is compared to the stored signature. So that a hacker who has your thumb signature can fool the system. Clean and simple, so different from the Hollywood version where thumbs are being chopped off, and placed on readers, dripping blood.

When you climb on an airplane, or pass a secure access point, you may be inspected to insure that you expose your own iris, or press your own palm on the reader. But when you are called to supply biometric from the privacy of your own home—your ability to cheat is staggering. There is something about the complexity of the biometric data that assures us that it is really secure. And has it has been shown so many times any measure of security however effective as such, may become a negative security factor when its efficacy is exaggerated. Hype kills the security potential of any defense. One bank executive was so happy to report to me that now he feels safe to keep the most delicate bank secrets in his travel laptop since “nobody has his thumb!”

The technology gave rise to modern crime novels where the victim's biometrics was used to place biological markers in the crime scene and secure a false conviction. The bad guys seem to have more imagination . . . . What about the ultimate biometric—our DNA? With the biometric momentum gushing ahead, our entire biological makeup will be as safe as the government computers with the millions of stolen personal files of top secret individuals . . . .

A colleague who knows my strong opinions on biometrics has raised eye brows witnessing me using Apple pay for our coffee and pastries. I blushed a bit, stuttered: “it's research,” I said, “as a payment professional I need to know, you know . . . ” He just stared at me until I had to admit, hey, it's cool! indeed it is, and convenient too. But like rich milkshakes, irresistible at the moment, with accumulating damage further down the road. The convenience of biometrically secured payment is very costly in the long run. It would be best if we could hold off for a little longer until digital cash relieves us from the need to prove who we are every time we buy a dollar worth of goods.

We don't hire you to lecture us on security doom, my clients say: solutions please for the reality as it is! Here is what can be done. Let's look deeper into the essence of biometric security: we read, then digitize a biological parameter which in its essence is invariably richer, more detailed, more refined than the digitized image one captures, stores, compares etc. Say then that if I have stolen your fingerprint, I have stolen really the projection of your fingerprint on the digital recording framework I have set forth. I have no record of the gap between my record and your thumb! (or between my record, and your iris, palm, etc.). This distinction is crucial: it serves as a basis for voiding my theft of your fingerprint. Should you upgrade your biometric reader, and should the authenticating databases switch to the greater resolution image, then the former low resolution will not work—you identity will be safe. It works like a camera image: the scene ahead is much more detailed than any photograph thereof. And a picture taken with a low resolution camera cannot pass as a high resolution image.

This principle can be reapplied as many times as necessary, the challenge is organizational: we need to upgrade the readers, and upgrade the databases. It's not a one user strategy. It's a national initiative. I use this column to call upon major cyber security organizations, across the board privacy advocacy, and proactive government offices to think ahead, humbly, with the expectation that our biological identifiers will be compromised and put us at grave risk. A schedule, a plan, a public program is so essential. We are the target of cyber warfare from predators large and small planet-wide. Nobody is as vulnerable as us, woe to us, if our biological definition is wholesale compromised!

Recovery from Data Theft

### Voiding the Compromised Data in Favor of a Higher Fidelity Version.

Digital data may be changed to analytic curve, which is then digitized through a given resolution. If compromised, the curve is re-digitized in greater fidelity, and algorithms set to receive the compromised data will do so only via the higher fidelity input. effective for data that in principle cannot be changed, like biometric.

Pre Poetry: Prime Poetry, or Killer Poetry?

My Poetry-Writing Software v. ‘Real’ Poets

I am a published poet. My work was published by a highly respected world wide publisher. Alas, it is a single poem that I inserted in my technology hard cover “Computer Organized Cost Engineering” . . . . For many years I was anxious to protect my no-nonsense engineering reputation and remained a closet poet, until I contemplated symbiosis: to write poetry writing software.

The challenge is to abstract the process in which a mundane topic is expressed poetically; construct a mathematical framework that would take in a term like “love”, “yearning”, “pain”, or perhaps “road, “sunshine”, “chair”, “pencil”, or some combination thereof, and weave a sequence of lexical entries (dictionary words) designed to evoke a “poetic satisfaction” in readers.

The beauty of this artificial intelligence challenge is that I don't need to go into the elusive essence of what evokes poetic satisfaction in readers, I have a list of highly regarded poems, and their respective pedestrian entity they describe, and all I have to do is discern the constructive pattern between that input and the output.

Does this make me a super poet? I must admit that anyone I ran it by, was appalled by this initiative, it's not prime poetry it is killer poetry some exclaimed?

Alan Turing contemplating artificial intelligence proposed the famous dialogue test: if you can't tell whether you communicate with a human or a machine, then the machine qualifies from being assigned human roles. Similarly if poetry readers can't tell whether a human or software produced the poem they enjoy reading, then this software should not be disqualified as an AI poet.

It is up to humans to prove their superiority over the machine. So while I labor on my program and feel very poetic about it because it leads me into the deepest creases in the tissue that poetry is made of, if a traditional poet derides me ‘engineering’ then it is a challenge for him or her to write such poetry that a reader will readily point out and say, this poem was humanly produced, and not machine introduced.

So we both have our challenge, let's go forth, and let the best human (or the best machine) win!

### Layered Security Id

The concept of a fixed identification id may be augmented to a layered id such that a low-level id is used for less critical purposes, and a higher level id is used for critical purposes. Since there are more non-critical cyber actions than critical ones, chances are that a low-level id will be compromised, and will expose the victim to low-level fraud, while keeping the victim's critical actions secure. The ‘layered’ construct means that the high level id will function as a low-level id for non-critical purposes (a situation that does not apply when two independent id are used). We lay out a cryptographic framework to accomplish this vision, extend it to more than two levels, and expand it to special applications. two ways:

1. approval hierarchy BitMint
2. DNL homomorphic encryption, layered document reading

### Threat Analysis:

You deserve a credible quantified statement of the most likely and most harmful threats that you face. Only people who planned such threats themselves will do a good job for you. Remember: threat analysis is the most crucial step in cyber security. If your assailant has more imagination than your threat analyst then you will be a victim of a successful attack, which was not imagined by your analyst. Nobody has AGS expertise. Bring us on board. People with grave cyber security concerns do.

Cryptographic Variety Defense:

The severe vulnerability of orthodox cryptography is that it is based on a few well known ciphers, which for many years now have become a focused target for top cryptanalytic shops. Some of them secretly compromised, the rest are soon to be. And be sure that the more difficult and the more costly the cracking of a cipher, the more vigorously guarded the fact that this cipher lost its efficacy. People with grave cyber security concerns come to AGS to fit them with cryptographic variety. Once fitted, our clients are inherently secure against such ‘unpublished’ cracking of any of the ‘highly recommended’ orthodox ciphers. Ask for our white paper: “Unorthodox Cryptography”

### A New Security Paradigm for Internet Banking

The energy and innovation that springs out in the field of internet finance has so much momentum that we tend to ignore the painful facts that cyber security is seriously lacking. Billions are being stolen, wholesale violations of privacy are norm, and recent accounts point to internet banking having become a prime target in strategic cyber war plans among hostile nations. We argue that security must be re-thought, and we challenge the creative minds in the world to give it top attention. We also propose a candidate for a new security paradigm. It is based on the concept of “tethered money:” keeping money in digital format secure with cryptographic locks. To steal or abuse this money it would be necessary to compromise its crypto-defense. That defense is housed in a few secure locations, which will be defended by the best security people to be found. By contrast, today money and identify data is kept in a large variety of financial institutions, some of them have lax security, and become the target of the most able assailants. By narrowing the defense perimeter to a few defensible hubs, the battle for the integrity of internet banking will be tilted towards the good side. We discuss the proposed paradigm with some technical details.

### Wireless Phonecharge: Pay-As-You-go Digital Cash Counterflow is the Only Solution, and the Last Barrier

Wireless phone and tablet charging is hard to monetize because it may happen in short spouts, with the source only aware of how much energy is broadcast, not how much is taken in by any particular battery. Any account based payment will not be practical because most sessions deal with non-recurring macro even nano payments. The BitMint counterflow solution by contrast, allows for counter-parallel flow of money-bits commensurate with electromagnetic power absorption. The pay stream starts as the energy flow begins, and it terminates when the energy intake terminates. And upon termination the deal is concluded, the charger has no more money to invoice, and the charged party, has no more invoices to honor.

### In Support of Cryptographic Variety: Randomization Based Cryptanalysis

Randomized input is the foundation of modern cryptography, specifically a cryptographic key is a uniform random variable. This fact becomes the foundational premise of institutional cryptanalysis. Unlike ‘elegant cryptanalysis’ which is the pursuit of academic cryptographers, cyber-war institutions pursue a “chip away strategy” that over time increases cryptanalytic efficiency. This gradual encroachment of security amounts to ongoing erosion of the theoretical intractability that is computed and argued in favor of the recommended ciphers (symmetric or asymmetric).

The concept of randomization based cryptanalysis (RBC) is simple—the execution requires institutional prowess. The principle: cryptography based on a uniform random variable, is associated with a cipher text space, where a proportion, p satisfies some condition or term, t, where t can be proven to guarantee that some r keys from the key space are excluded as candidates for the particular key that generated this ciphertext. The larger the value of r, the smaller the key space left for brute force cryptanalysis.

The hunt for key-excluding terms is on one hand laborious, and on the other hand open-ended. The cryptanalyst will look for terms t that appear in high frequency, p(t), in cipher texts generated from a uniformly selected key, and such t that compute to a large number of excluded keys, r. The higher the values of p(t), and r the more effective the strategy of probing each ciphertext for compliance, and applying the reduced brute force space accordingly. Large cyber institutions devote enormous amount of mental energy to hunting for key-excluding terms, and the longer a cipher is in service, the more key-excluding terms are found by the adversary.

Cipher users may look for such mathematical shot cut variability on their own, and then choose keys that don't lead to key exclusions, but they don't know if their cryptanalyst found these vulnerabilities, or others.

### Triple Book Entries:

The standard double entry accounting now complemented with the third—triangular accounting: the digital coin carries its history.

### Wireless Phonecharge: Pay-As-You-go Digital Cash Counterflow is the Only Solution, and the Last Barrier

Wireless phone and tablet charging is hard to monetize because it may happen in short spouts, with the source only aware of how much energy is broadcast, not how much is taken in by any particular battery. Any account based payment will not be practical because most sessions deal with non-recurring macro even nano payments. The BitMint counterflow solution by contrast, allows for counter-parallel flow of money-bits commensurate with electromagnetic power absorption. The pay stream starts as the energy flow begins, and it terminates when the energy intake terminates. And upon termination the deal is concluded, the charger has no more money to invoice, and the charged party, has no more invoices to honor.

### Idea Twitter

to build a twitter like system where anyone could post a money making idea, and pay p$ for the right, payable to the twitter organizer. Anyone reading an idea can decide to lend a vote of confidence that it would make money, and pay v$ for registering his vote. If the idea makes money, then the poster will pay “homage” to the voters. the organizer pockets the voting money and posting money of the majority of ideas that go nowhere. since this is a lot they might pre pledge a percentage of revenue to go for education, universities, etc. Or as grants and payment to the most successful ideas in the system.

The voting fee, v, will be a function of the number of voters, n, who have voted so far: v=v(n). Such that v(n+1)>v(n).

The poster will pledge to pay to his voters the sum of up to x$ by gleaning from the top of the revenue stream owing to that idea, a percentage p %. If the revenue is such that p % of it is less than x$, then the poster pays less. The poster can change his pledge up or down at any point and that would apply to the following voters.

The organizers will divide the x$ per idea according to the rank of each voter, so that the first to vote a confidence vote, will get the same or more than the second. The sum $y received by the voter who voted after t−1 previous voters, y(t) will be higher or the same from the next: y(t)>=y(t+1). So early voters pay less and get paid more. all voters register with the organizer and can vote only once per idea at a time. One will be allowed to vote again, only after m other voters voted. So if Alice is the t-th voter on a given idea, she will be allowed to vote again only after m other voters voted, and her next vote will be ranked as (t+m). This is to prevent artificial priming of an idea.

Ideas with many voters, attract more voters, but because the voting fee is now higher, and the returns lower, people will hesitate. Then the poster can up the ante and pledge more money for the voters, to overcome their hesitation.

The public record of a given idea will be used by the poster to convince an investor, and also will stimulate others to come up with similar ideas, may be better one, and overall improve society's innovation.

the posted ideas will have to be specific enough to be patentable, perhaps pass a check by a patent attorney, rudimentary check. perhaps covered by a provisional filing to prevent stealing.

Voters who voted on ideas that produced revenue would be marked and the public will know on any idea how many ‘good voters that succeeded before’ are voting on each idea.

A voter will have to wait for more voters before he can vote again.

idea poster registers with website but identity not exposed, so not personality impact just the idea itself, perhaps to limit just to say 1000 words, no graphics to help search.

### Reorganizing Data to Depend on Small Data to be Encrypted

TVC ciphers don't work very well to encrypt large databases because of the size of the key. so we need first to identify key data in the database, of small amount to be encrypted in an unbreakable way. or to extract from the large database small amounts of data to be so encrypted. so the question is how to extract key data. for numbers we can encrypt the n leftmost digits. for text—to encrypt words in proportion to how rare they are in use. so common words like to, when, or, more—etc will be excluded from the expensive secure encryptions. but words like plutonium will be encrypted.

This hybrid encryption can be conducted without a priori coordination with the receiver. The user will scan the plaintext, and identify in it ‘critical nuggets’. They will be marked automatically, and their start and finish points (borders) will be marked. The intended reader as well as the assailant will know which segments are encrypted via mathematical secrecy, but only the intended reader will read it right. The user and the intended reader will both use the trans-vernam cipher.

For example: Plaintext: “Jerry told me that he thinks that the gold has been melted and mixed into an innocent looking statue of copper and magnesium alloy”

The crypto software has a list of ‘the most frequent words in the English language’, and by some arbitrary decision the software is guided to mark in a plaintext all the words that are less frequent than the f most frequent words. (the higher the value of f, the most limited the use of the TVC cipher). As a result the plaintext will be marked as follows:

“Jerry told me that he thinks that the [[gold]] has been [[melted]] and mixed into an innocent looking [[statue]] of [[copper]] and [[magnesium alloy]]”
where the double brackets identify the TVC encrypted text. The rest of the text may be encrypted with a common cipher, with the double bracket left in place. An assailant may crack the nominal cipher but not the TVC and read:
“Jerry told me that he thinks that the [[?????]] has been [[???????]] and mixed into an innocent looking [[?????]] of [[??????]] and [[?????????????]]”

### Accessioe

Background: Homomorphic Encryption emerged as a modern cryptographic challenge.

The idea being to repackage data such that it could be analyzed and inferred upon without being fully exposed. The guiding principle is: To allow processors to see in data everything they need for their purpose, and nothing else.

The conventional approach is to encrypt data such that the ciphertext retains the properties needed for the data processor. We propose to handle this challenge differently. Data is encrypted in such a way that different readers, using different keys decrypt the ciphertext to a tailored plaintext that exposes everything each processor needs for its purpose, and nothing else. Accessioe tailored decryption keys don't have to be pre-identified before the encryption is effected. Hence, at any time a new data processor may be added, and be given a tailored decryption key that would expose only the data needed for its purpose.

Organizational Management: Oftentimes an operational document within a large organization is kept in various versions. Higher ranked readers see a more detailed version. The burden to joggle and maintain the same document in various security levels is prohibitive. The Accessioe solution is to maintain a single document (encrypted), and provide each reader with the proper key. Such document could be readily broadcast in the open since only key holders will be able to read it, and read only what they need to know. Public Data Management: In a modern democracy there are various forms of “sunshine laws” insuring access to large amounts of government data. Albeit, most government databases mix private data with public data, so that in practice most often either the public is denied access to public data, or private citizens have their private information alarmingly exposed. Accessioe is a perfect means to effect a fair and balance solution to enhance freedom, justice and sound governance.

### Cryptographic Tensors

### Avoiding Algorithmic Complexity; Randomization-Intensified Block Ciphers

Casting block ciphers as a linear transformation effected through a cryptographic key, K, fashioned in tensorial configuration: a plaintext tensor, Tₚ, and a ciphertext tensor, T_{c}, each of order n+1, where n is the number of letters in the block alphabet: Tₚ=T^{β}_{/1, /2, . . . /n}; T^{β}_{/1, /2, . . . ln} All the (n+1) indices take the values: 1, 2, . . . t. Each tensor has tⁿ⁺¹ components. The two tensors will operate on a plaintext block p comprised of t letters, and generate the corresponding ciphertext block of same size, and when operated on the ciphertext block, the tensors will generate the plaintext block: We indicate this through the following nomenclature: [p]{TₚT_{c}}[c]. The tensors are symmetrical with respect to the n letters in the alphabet, and there are (t!)₂₍ₙ₊₁₎ distinct instances for the key: |K|=|TₚT_{c}|

### Introduction

The chase after a durable algorithmic complexity is so ingrained in modern cryptography that the suggestion that it is not the only direction for the evolution of the craft may not be readily embraced. Indeed, at first glance the idea of key spaces much larger than one is accustomed to, sounds as a call in the wrong direction. Much of it is legacy: when cryptography was the purview of spooks and spies, a key was a piece of data one was expected to memorize, and brevity was key. Today keys are automated, memory is cheap, and large keys impose no big burden. As will be seen ahead one clear benefit from large keys is that they are associated with simple processing, which are friendly to the myriad of prospective battery-powered applications within the Internet of Things.

We elaborate first on the motivation for this strategic turn of cryptography, and then about the nature of this proposal.

### Credible Cryptographic Metric

Modern cryptography is plagued by lack of credible metric for its efficacy. Old ciphers like DES are still overshadowed by allegations of a hidden back door designed by IBM to give the US government stealth access to world wide secrets. AES: Nobody knows what mathematical shortcuts were discovered by those well funded cryptanalytic workshops, who will spend a fortune on assuring us that such breakthrough did not happen. Algorithmic vulnerabilities may be “generic”, applicable regardless of the particular processed data, or they may be manifest through a non-negligible proportion of “easy instances”. While there is some hope to credibly determine the chance for a clear mathematical (generic) shortcut, there is no reasonable hope to credibly determine the proportion of “easy cases” since one can define an infinity of mathematical attributes to data, and each such attribute might be associated with an unknown computational shortcut. The issue is fundamental, the conclusion is certainly unsettling, but should not be avoided: Modern cryptography is based on unproven algorithmic complexities.

The effect of having no objective metric for the quality of any cryptographic product is very profound. It undermines the purpose for which the craft is applied. And so the quest for a credible cryptographic metric is of equally profound motivation.

We may regard as reference for this quest one of the oldest cryptographic patents: the Vernam cipher (1917). It comes with perfect secrecy, it avoids unproven algorithmic complexity, and its perfect security is hinged on perfect randomness. This suggests the question: can we establish a cryptographic methodology free from algorithmic complexity, and reliant on sheer randomness?

Now, Shannon has proven that perfect secrecy requires a key space no smaller than the message space. But Shannon's proof did not require the Vernam property of having to use new key bits for every new message bits. Also Shannon is silent about the rate of deterioration of security as the key space falls short of its Shannon's size. Vernam's cipher suffers from a precipitous loss of security in the event that a key is reused. Starting there we may be searching for a Trans Vernam Cipher (TVC) that holds on to much of its security metrics as the key space begins to shrink, and what is more, that shrinking security metrics may be credibly appraised along the way. Come to think about it, security based on randomized bits may be credibly appraised via probability calculus. A TVC will operate with an objective metrics of its efficacy, and since that metric is a function of sheer randomness not of algorithmic complexity, it becomes the choice of the user how much randomness to use for each data transaction.

Mix v. Many: Let's compare to block ciphers: an “open ended key-size cipher”, OE, and a “fixed key size cipher” FK. Let |p| be the size of the plain message, p to be handled by both ciphers. We further assume that both ciphers preselect a key and use it to encrypt the message load, p. The security of FK is based on a thorough mixing of the key bits with the message bits. The security of the open-ended key size is based on how much smaller the key is compared to a Vernam cipher where |k_{OE}|=|p| and secrecy is perfect.

Anticipating a given p, the OE user may choose a sufficiently large key to insure a desired level of security. While the FK cipher user will have to rely on the desired “thorough mixing” of each block with the same key. It is enough that one such mixture of plaintext bits and key bits will happen to be an easy cryptanalytic case, and the key, and the rest of the plaintext are exposed. We have no credible way to assess “thoroughness of mixture”. The common test of flipping one plaintext bit and observing many ciphertext changes may be misleading. As we see ahead all block ciphers may be emulated by a transposition based generic cipher, and arguably all same size blocks may be of “equal distance” one from the other. By contrast, the OE user can simply increase the size of the key to handle the anticipated plaintext with a target security metric.

### Tensor Block Cryptography

Let p be a plaintext block of t letters selected from alphabet A comprised of n letters. We shall describe a symmetric encryption scheme to encrypt p into a corresponding ciphertext block c comprised also of t letters selected from the same alphabet A. c will be decrypted to p via the same key, K.

We shall mark the t ordered letters in the plaintext p as: p₁, p₂, . . . pₜ. We shall mark the t ordered letters of the corresponding ciphertext c as c₁, c₂, . . . cₜ. We can write:

p={pᵢ}^{t};c={cᵢ}^{t};c=enc(p,K);p=dec(c,K)

where enc and dec are the encryption and decryption functions respectively.

The key K is fashioned in tensorial configuration: a plaintext tensor, Tₚ, and a ciphertext tensor, T_{c}, each of order n+1, where n is the number of letters in the block alphabet:

Tₚ=T^{β}_{l1,l2, . . . ln}; T^{β}_{l1,l3, . . . ln}

All the (n+1) indices take the values: 1, 2, . . . t. Each tensor has tⁿ⁺¹ components. The two tensors will operate on a plaintext block p comprised of t letters, and generate the corresponding ciphertext block of same size, and when operated on the ciphertext block, the tensors will generate the plaintext block: We indicate this through the following nomenclature:

The tensors are symmetrical with respect to the n letters in the alphabet, and there are (t!)²⁽ⁿ⁺¹⁾ distinct instances for the key: |K|=|TₚT_{c}|

For each of the t arrays in each tensor, for each index i₁, i₂, . . . iⱼ, . . . iₜ we will have: iⱼ₁=1, 2, . . . d₁, iⱼ₂=1, 2, . . . d₂, . . . iⱼₜ=1, 2, . . . dₜ, where, d₁, d₂, . . . dₜ are arbitrary natural numbers such that:

d₁*d₂* . . . dₜ=n

Each of the 2t arrays in K is randomly populated with all the n letters of the A alphabet, such that every letter appears once and only once in each array. And hence the chance for every components of the tensors to be any particular letter of A is 1/n. We have a uniform probability field within the arrays.

Tₚ is comprised of t t-dimensional arrays to be marked: P₁, P₂, . . . Pₜ, and similarly T_{c} will be comprised of t t-dimensional arrays to be marked as C₁, C₂, . . . Cₜ.

Generically we shall require the identity of each ciphertext letter to be dependent on the identities of all the plaintext letters, namely:

cᵢ=enc(p₁,p₂, . . . pₜ)

for i=1, 2, . . . t.

And symmetrically we shall require:

pᵢ=dec(c₁,c₂, . . . cₜ)

for i=1, 2, . . . t.

Specifically we shall associate the identity of each plaintext letter pᵢ (i=1, 2 . . . t) in the plaintext block, p, via the t coordinates of pᵢ in Pᵢ, and similarly we shall associate the identity of each ciphertext letter cᵢ (i=1, 2, . . . t) with its coordinates in Cᵢ.

We shall require that the t coordinates of any cᵢ in Cᵢ will be determined by the coordinates of all the t letters in p. Andy symmetrically we shall require that the t coordinates of any pᵢ in Pᵢ will be determined by the coordinates of all the t letters in c.

To accomplish the above we shall construct a t*t matrix (the conversion matrix) where the rows list the indices of the t plaintext letters p₁, p₂, . . . pₜ such that the indices for pᵢ are listed as follows: i, i+1, i+2, . . . i+t−1 mod t, and the columns will correspond to the ciphertext letters c₁, c₂, . . . cₜ such that the indices in column cⱼ will identify the indices in Cⱼ that identify the identity of cⱼ. In summary the index written in the conversation matrix in row i and column j will reflect index j of plaintext letter pᵢ, and index i of ciphertext letter cⱼ.

Namely:

$$\begin{matrix}. & c 1 & c 2 & c 3 & & ct \text{-} 1 & ct \\ {p}_{1} & 1 & 2 & 3 & … & t \text{-} 1 & t \\ {p}_{2} & 2 & 3 & 4 & … & t & 1 \\ {p}_{3} & 3 & 4 & 5 & … & 1 & 2 \\ & & & & … & & \\ {p}_{t} & t & 1 & 2 & … & t \text{-} 2 & t \text{-} 1\end{matrix}$$

The conversion matrix as above may undergo t! rows permutations, and thereby define t! variations of the same.

The conversion matrix will allow one to determine cᵢ, c₂, . . . cₜ from p₁, p₂, . . . pₜ and the 2t arrays (encryption), and will equally allow one to determine p₁, p₂, . . . pₜ from c₁, c₂, . . . cₜ and the 2t arrays (decryption).

Key Space:

The respective key space will be expressed as follows: each of the 2t matrices will allow for n! permutations of the n letters of the alphabet, amounting to (n!)^{2t} different array options. In addition there are t! possible conversion matrices, counting a key space:

|K|=(n!)^{2t}t!

### Iteration

Re-encryption, or say, iteration is an obvious extension of the cryptographic tensors: a plaintext block may be regarded as a ciphertext block and can be ‘decrypted’ to a corresponding plaintext block, and a ciphertext block may be regarded as plaintext and be encrypted via two tensors as defined above to generate a corresponding ciphertext. And this operation can be repeated on both ends. This generates an extendable series of blocks q₋ᵢ, q₋₍ᵢ₋₁₎, . . . q₀, q₁, . . . qᵢ, where q₀ is the “true plaintext” in the sense that its contends will be readily interpreted by the users. Albeit, this is a matter of interpretation environment. From the point of view of the cryptographic tensors there is no distinction between the various “q” blocks, and they can extend indefinitely in both directions. We write:

[q₋ᵢ]{TⁱₚTⁱ_{c}}[q₋₍ᵢ₋₁₎)]{T⁻⁽¹⁻¹⁾ₚT⁻⁽ⁱ⁻¹⁾_{c}}[q⁻⁽ⁱ⁻²⁾]

### Variable Dimensionality Iteration

The successive block encryptions or decryptions must all conform to the same tonsorial dimensionality, and be defined over t-dimensional arrays. However the range of dimensionality between successive tonsorial keys may be different.

Let every tonsorial index have t components, such that for a given set of TₚT, tensors, each index is expressed through t dimensions such that the first dimension ranges from 1 to d₁, the second dimension ranges from 1 to d₂, . . . and index i ranges from 1 to dᵢ. (i=1, 2, . . . t). As we had discussed we can write:

d₁*d₂* . . . dₜ=n

When one iterates, one may use different dimensionality: d′₁, d′₂, . . . d′ₜ for each round, as long as:

d′₁*d′₂* . . . d′_{t′}=n

So for n=120 and t=2 the first application of tensor cryptography might be based on 2 dimensional arrays of sizes 20*6, while the second iteration might be based on 15*8. And for t=3 one could fit the 120 alphabet letters in arrays of dimensionalities: 4*5*6, or perhaps in dimensionalities.

It is noteworthy that dimensionality variance is only applicable for base iteration. It can't be carried out over staggered iteration.

### Staggered Iteration

Let tensor cryptography be applied on a pair of plaintext block and ciphertext block of t₁ letters each:

[p₁,p₂, . . . pₜ₁]{TₚT_{c}}[c₁,c₂, . . . cₜ₁]

Let us now build an iterative plaintext block by listing in order t₂ additional plaintext letters, where t₂<t₁, and complement them with (t₁−t₂) ciphertext letters from the ciphertext block generated in the first round: cₜ₂₊₁, cₜ₂₊₂, . . . cₜ₁ and then let's perform a tensor cryptography round on this plaintext block:

[pₜ₁₊₁,pₜ₂₊₂, . . . pₜ₁₊ₜ₂,cₜ₂₊₁,cₜ₂₊₂, . . . Cₜ₁]{T′ₚT′_{c}}[cₜ₁₊₁,Cₜ₁₊₂, . . . Cₜ₁₊ₜ₁]

In summary we have:

[p₁,p₂, . . . pₜ₁₊ₜ₂]{TₚT_{c}}{TₚT_{c}}{T′ₚT′_{c}}[c₁,c₂, . . . cₜ₂,Cₜ₁₊₁, . . . cₜ₁₊ₜ₁]

A reader in possession of the cryptographic keys for both iterations will readily decrypt the second ciphertext block cₜ₁₊₁, . . . cₜ₁₊ₜ₁ to the corresponding plaintext block: pₜ₁₊₁, pₜ₂₊₂, . . . pₜ₁₊ₜ₂, cₜ₂₊₁, cₜ₂₊₂, . . . cₜ₁ Thereby the reader will identify plaintext letters pₜ₁₊₁, pₜ₂₊₂, . . . pₜ₁₊ₜ₂. She will also identify the identity of the ciphertext letters: cₜ₂₊₁, cₜ₂₊₂, . . . cₜ₂₊ₜ₁, and together with the given c₁, c₂, . . . cₜ₂ letters (from the first round), she would decrypt and read the other plaintext letters: p₁, p₂, . . . pₜ₁.

However, a reader who is in possession only of the key for the iteration (T′ₚT′_{c}) will only decrypt plaintext letters pₜ₁₊₁, pₜ₂₊₂, . . . pₜ₁₊ₜ₂, and be unable to read p₁, p₂ . . . pₜ₁. This in a way is similar to the plain staggered encryption, except that this is clearly hierarchical the plaintext letters in the first round are much more secure than those in the second round. Because the cryptanalyst will have to crack twice the key size, meaning an exponential add-on of security.

Clearly this staggering can be done several times, creating a hierarchy where more sensitive stuff is more secure (protected by a larger key), and each reader is exposed only to the material he or she is cleared to read. All this discrimination happens over a single encrypted document to be managed and stored.

This ‘discriminatory encryption’ happens as follows: Let a document D be comprised of high-level (high security) plaintext stream π₁, another plaintext stream 712 with a bit lower security level, up to π_{z}—the lowest security level. The π₁ stream will be assigned t₁ letters at a time to the first round of tonsorial cryptography. π₂ stream would fit into the plaintext letters in the second round, etc. Each intended reader will be in possession of the tonsorial keys for his or her level and below. So the single ciphertext will be shared by all readers, yet each reader will see in the same document only the material that does not exceed his or her security level. Moreover every reader that does not have the multi dimensional array corresponding to a given letter in the plaintext block will not be able to read it. Some formal plaintext streams might be set to be purely randomized to help overload the cryptanalyst.

While it is possible to apply such staggered iteration with any other block ciphers, this one is distinct in as much as it exhibits no vulnerability to mathematical shortcut and hence the security of the deepest plaintext stream is protected by the many layers of security in the document.

### Discriminatory Cryptography, Parallel Cryptography

Staggered Iteration Tensor Cryptography, is based on a hierarchy of arrays forming the key which may be parceled out to sub-keys such that some parties will be in possession of not the full cryptographic key, but only a subset thereto, and thus be privy to encrypt and decrypt corresponding script parts only. This discriminatory capability will enable one to encrypt a document such that different readers thereto would only read the parts of the document intended for their attention, and not the rest. This feature is of great impact on confidentiality management. Instead of managing various documents for various security clearance readers, one would manage a single document (in its encrypted form), and each reader will read in it only the parts he or she is allowed to read.

The principle here is the fact that to match an alphabet letter aεA, to its t coordinates: a₁, a₂, . . . aₜ in some t-dimensional array M, it is necessary to be in possession of M. If M is not known then for the given a, the chance of any set of subscripts: a₁, a₂, . . . aₜ is exactly 1/n where n is the number of letters in A. And also in reverse: given the set of coordinates: a₁, a₂, . . . aₜ, the chance for a to be any of the n alphabet letters is exactly 1/n. These two statements are based on the fundamental fact that for every arrays in the tensor cryptography, the n alphabet letters are randomly fitted, with each letter appearing once and only once.

In the simplest staggered iteration case t=2, we have 2 letters blocks: p₁p₂<->c₁c₂, where the encryption and decryption happens via 2t=4 matrices: P₁, P₂, C₁, C₂. Let Alice carry out the encryption: p₁p₂->c₁c₂. Alice shared the four matrices P₁, P₂, C₁, C₂ With Bob, so Bob can decrypt c₁c₂->p₁p₂. And let it further be the case that Alice wishes Carla to only decrypt c₁c₂ to p₁, and not to p₂. To achieve that aim, Alice shares with Carla matrix P₁, but not matrix P₂.

Carla will be in possession of the conversion table, and so when she processes the ciphertext: c₁c₂ she identifies the coordinates of both p₁ and p₂. Carla then reads the identity of p₁ in array P₁ in her possession. But since she has no knowledge of P₂, she cannot determine the identity of p₂. Furthermore, as far as Carla is concerned the identity of p₂ is given by flat probability distribution: a chance of 1/n to be any of the possible n letters.

With David Alice shared everything except matrix P₁, so David will be able to decrypt c₁c₂ to p₂ and not to p₁.

All in all, Alice encrypted a single document which Bob, Carla, and David, each read in it only the parts intended for their attention.

In practice Alice will write document D comprised of part D₁, and D₂. She will pad the shorter document. Such that if |D₁|>|D₂|, Alice will add ‘zeros’ or ‘dots’ or another pad letter to D₂ so that: |D₁|=|D₂|, and then Alice will construct plaintext blocks to encrypt through tensor cryptography. Each block will be constructed from two letters: the first letter from D₁, and the second letter from D₂. The corresponding ciphertext will be decrypted by Bob for the full D=D₁+D₂, while Carla only reads in it D₁ (and remains clueless about D₂), while David reads in the very same ciphertext D₂ only (and remains clueless about D₁).

Clearly D₁ and D₂ don't have to be functionally related. In general tensor cryptography over t-dimensional arrays (hence over t-letters blocks) may be used for parallel cryptography of up to t distinct plaintext messages.

Discriminatory tensor cryptography can be applied over non-iterative mode, where each plaintext letter in a t-letters block is contributed from a different file, or a different part of a given document (security discrimination), or it may be applied via the staggered iteration. The former is limited to t parallel streams, and its security is limited to ignorance of the mapping of one t-dimensional array comprised of n letters. The latter may apply to any number of parallel streams, files, or document parts, and the different secrets are hierarchical, namely the deepest one is protected the best. Also the staggered iteration implementation may allow for different volumes over the parallel encrypted files. The above can be described as follows: Let D be a document comprised of D₀ parts that are in the public domain, and some D₁ parts that are restricted to readers with security clearance of level 1 and above, and also of D₂ parts that are restricted to readers with security level 2 and above, etc. Using tensor cryptography one would share all the t ciphertext matrices (C₁, C₂, . . . Cₜ), but only matrices P₁, P₂, . . . Pᵢ with all readers with security clearance of level i or above, for i=1, 2, . . . t. With this setting the same document will be read by each security level per its privileges.

There are various other applications of this feature of tensor cryptography; for example: plaintext randomization, message obfuscation.

In plaintext randomization, one will encrypt a document D as g letters i,j,l, . . . (i,j,l=1, 2, . . . t) by order, while picking the other (t-g) letters in the t-letters plaintext block as a random choice. Upon decryption, one would only regard the g plaintext letters that count, and ignore the rest. This strategy creates a strong obfuscation impact on the cryptanalytic workload.

In message obfuscation the various parallel messages may be on purpose inconsistent, or contradictory with the reader and the writer having a secret signal to distinguish between them.

Use Methods:

The fundamental distinction of the use of tensor cryptography is that its user determines its security level. All predominant block ciphers come with a fixed (debatable) measure of security. The user only selects the identity of the key, not to cryptanalytic challenge. Tensor cryptography comes with a security level which depends on the size of the key, and a few algorithmic parameters which are also determined in the key package. One might view tensor cryptography as a cipher framework, which the key, selected by the user determines its efficacy.

Tensor cryptography may be used everywhere that any other block cipher has been used, and the responsibility for its utility has shifted from the cipher builder to the cipher user.

The user will counter balance speed, key size, and security parameters like life span of the protected data, and its value to an assailant. Sophisticated users will determine the detailed parameters of the cryptographic tensors; less sophisticated users will indicate rough preference, and the code will select the specifics.

Since the size of the key is unbound, so is the security of the cipher. It may approach and reach Vernam or say Shannon perfect secrecy, if so desired. Since the user is in control, and not the programmer of the provider of the cipher, it would be necessary for the authorities to engage the user on any discussion of appropriateness of the use of one level of security or another. It will be of a greater liability for the government, but a better assurance of public privacy and independence.

Staggered cryptography and staggered iterations offer a unique confidentiality management feature for cryptographic tensors, and one might expect this usage to mature and expand.

The fact that the key size is user determined will invite the parties to exchange a key stock, and use randomized bits therein as called for by their per session decision. The parties could agree on codes to determine how many bits to use. It would easy to develop a procedure that would determine alphabet, dimensionality and array from a single parameter: the total number of bits selected for the key.

Cryptographic tensors work over any alphabet, but there are obvious conveniences to use alphabets comprised of n=2ⁱ letters: i=1, 2, 3, . . . which are i=log(n) bits long. Dimensionality t, will be determined by integers 2^{x}₁, 2^{x}₂, . . . 2^{x}ₜ, such that: x₁+x₂+ . . . xₜ=i

Cryptanaysis:

Every mainstay block cipher today is plagued by arbitrary design parameters, which may have been selected via careful analysis to enhance the efficacy of the cipher, but may also hide some yet undetected vulnerabilities. Or better say “unpublished” vulnerabilities, which have been stealthily detected by some adversaries. To the best of my knowledge even the old work horse DES has its design notes barred from the public domain. The public is not sure whether the particular transpositions offer some cryptanalytic advantage, and the same with respect to the substitution tables, the key division, etc. And of course more modern ciphers have much more questionable arbitrariness.

By contrast, the cryptographic tensors were carefully scrubbed off from as much arbitrariness as could be imagined. Security is squarely hinged on the size of the key, and that size is user determined. The algorithmic content is as meager as could be imagined. In fact, there is nothing more than reading letters as coordinates (or say indices, or subscripts), and relying on an array to point out to the letter in it that corresponds to these coordinates. And then in reverse, spotting a letter in an array, and marking down the coordinates that specify the location of that letter in the array. The contents of the array (part of the key) is as randomized as it gets, and no faster method than brute force is envisioned.

Of course, small keys will be brute force analyzed faster, and large keys slower. If the user has a good grasp of the computing power of his or her adversaries then she should develop a good appraisal of the effort, or time needed for cryptanalysis. So a user who wishes to encrypt a networked camera trained on her sleeping toddler while she is out at local cafe, then all she needs is for a cipher that would keep the video secret for a couple of hours. AES may be an overkill, and a battery drainer.

Coupling the cryptographic tensors with the ultimate transposition cipher (UTC) [ ] would allow for a convenient way to increase the size and efficacy of the cryptographic tensors to any degree desired. An integer serving as an ultimate transposition key may be part of the cryptographic tensor key. Such transposition key may be applied to re-randomize the n letters of the alphabet in each of the 2t arrays, as often as desired. It may be applied to switch the identities of the 2t arrays, even every block. So that the array that represents the first plaintext letter, Pᵢ, will become some cipher array, i: Cᵢ, etc. The ultimate transposition number may be applied to re-arrange the rows in the conversion table. By applying this transposition flexibility as often as desired the user might readily approach Shannon security as often as desired.

The cryptographic tensor cryptanalyst will also be ignorant about the selection of an alphabet and its size (n), the size of the block (t), and whether or not iteration has been used. Given that all these parameters may be decided by the user in the last moment and effected by the user, right after the decision, it would be exceedingly difficult even to steal the key, not to speak about cryptanalysis. In reality the parties would have pre agreed on several security levels, and the user will mark which security level and parameters she chose for which transmission.

Of course iteration will boost security dramatically because the key size will be doubled or tripled. And hence the use of staggered iteration will allow for the more sensitive data to be known only to the highest security clearance people. And that data will enjoy the best security.

Randomization of plaintext letters will also serve as probability booster of cryptanalytic effort.

In summary, cryptographic tensors being arbitrariness-scrubbed, stand no risk of algorithmic shortcut to be compromised, and they allow only for brute force cryptanalysis, which in itself faces lack of any credible estimate as to the effort needed.

And since every secret has a value which provides a ceiling for the profitable cryptanalysis, the lack of such a credible cryptanalytic estimate is a major drawback for anyone attempting to compromise these tensors.

Towards a Generic Block Cipher with Preset Bound Breakability

Proposing a generic setup of substitution-transposition primitives that may emulate every block cipher, and operates with a key selected by the user from a series of monotonic rising key sizes, up to Vernam (Shannon) mathematical security, where the breakability of shorter keys is bound by durable combinatoric computation, immunized against the possibility of a mathematical shortcut that overshadows all complexity-hinged block ciphers. The proposed GBC is defined over several matrices of size: u*v=2ⁿ, where all n-bits long strings are randomly placed, and transposed as needed. No algorithmic complexity is used, only guided matrix to matrix substitution. The idea of the GBC is to exploit the cryptography benefit of symmetric substation-transposition ciphers to their theoretical limit, and to pass control of security metric to the user to adjust for the prevailing circumstances, up to perfect secrecy.

### Introduction

Block ciphers are the working horse of cryptography, a plaintext string comprised of n bits is encrypted into a cipher string comprised of n′ bits where, in most cases n=n′. Encryption and decryption are carried out with the same or very similar key. DES, and its successor AES are the most prominent examples. Alas, DES and AES, as well as virtually all other block ciphers, are based on arbitrary parametric choices which, some suspect, hide latent mathematical vulnerability. Even if such vulnerabilities were not put there by design as conspiracy theorist argue, these vulnerabilities may be hidden there unwittingly. And since triple-DES and AES are so common, they become a highly prized target for world class cryptanalytic shops, bent on identifying these hidden vulnerabilities. Needless to say that such exploitation of vulnerabilities may already have happened. Those who did crack, say AES would put an inordinate amount of effort to hide this fact, and keep us untouched by suspicion of the truth. Only if we naively believe that national ministries for information warfare and similar others have not yet cracked AES would be continue to use it, as we do. The generic block cipher remedies this vulnerability.

Another attribute of all common block ciphers is the fact that they all come with a fixed size key (AES may use three key sizes, but once a cipher is selected, the key size is fixed). A fixed key size implies fixed security. Normally a user needs to secure data of low sensitivity, data of medium sensitivity, and data of high sensitivity. Using a fixed security cipher implies that at least two of these data categories are either over-secured, or under-secured. A GBC will allow the user to ‘dial up’. or ‘dial down’ the security provided for each data category to create a good match. This security adjustment will take place by choosing larger or smaller keys.

A third attribute of the GBC is that it encrypts several, t, plaintexts in parallel, resulting in a single ciphertext, that in turn decrypts back to the t generating plaintexts. The co-encrypted plaintexts may be unrelated, or related. If unrelated then, the benefit is in efficiency and improved security owing to the linkage in the encryption (and decryption) process. If related then the benefit depends on the relationship. For example, a block of size tn bits may be co-encrypted by regarding each consecutive n bits as a separate plaintext stream, and combining the t stream into a linked ciphertext.

A clear advantage of the parallel encryption is for document management. A document may contain several levels of secrecy such that each intended reader should be allowed to read at his level or below, but not above. The GBC allows an organization to write, transmit, and store a single document in its encrypted form, while all intended readers see in it only what they are allowed to see. This offers a crucial document management efficiency, especially critical for complex project management and for intelligence dissemination.

In summary: GBC remedies the common risk for block ciphers (mathematical breach), it shift the control over security level to the user, who can adjust it per the situation, and if enables parallel encryption of several plaintexts into a single ciphertext that decrypts only to the plaintexts which that key holder was allowed to read.

### Definition and Constructs

Given an alphabet A comprised of n letters, one would define a block cipher over A, as a cipher that encrypts a fixed size block comprised of q letters from A, to the same size block of q letters of alphabet A. A proper block cipher is a cipher with a key space K of size |K|, such that each key, kεK operates on any block (plaintext block) to generate a matching block (ciphertext block), such that the same key decrypts the ciphertext block to its generating plaintext block.

The number of possible blocks b=n^{q}. These b blocks may be listed in b!permutations. A key kεK may be regarded as a transposition key, that changes permutation πᵢ of the b blocks to some other permutation πⱼ of the same blocks 1<=j,j<=b!. This interpretation is based on the procedure where a given block bₚ, standing at position l (1<=l<b) in permutation πᵢ, will be replaced with its matching ciphertext block be generated via a key, k in the matching permutation πⱼ. In other words, any block in position l in permutation πᵢ will encounter its corresponding ciphertext block in the same position l in permutation πⱼ. That is because every block functioning as a plaintext will point to a unique block as a ciphertext, otherwise some ciphertexts will face equivocation as to which is the plaintext that generated them, and hence that cipher will not qualify as a proper block cipher.

A Complete Block Cipher (CBC):

A proper block cipher will be regarded as ‘complete’ over an alphabet A and block size q if for every two arbitrary permutations πᵢ, and πⱼ, there is a key kεK that transposes πᵢ to πⱼ. Since there are b! permutations, then a complete block cipher will have to have a key space K such that |K|>=0.5b!(b!−1).

It is easy to see that DES, AES, and their likes are not CBC. For AES, the first level: the key space |K_{AES}|=2¹²⁸ while the block size is b=128 bits, so b!=(2¹²⁸)! Each of the b! permutations may be transposed with each of the 2¹²⁸ keys This defines b!*b transpositions much less than the required: 0.5b!(b!−1). In fact AES is a negligible fractional size compared to a complete block cipher over the same block size, and over the same binary alphabet.

The First CBC Theorem: all proper not-complete block ciphers are a subset of a complete block cipher. Proof: All the |K_{non-CBC}| keys of a non-CBC transpose a block listing πᵢ to some block listing πⱼ. Hence any CBC will have a matching key for each key of the non-CBC, and then some.

The Second CBC Theorem: All instances of CBC are equivalent to each other. Proof: Given two block listing permutations πᵢ, and πⱼ. A CBC regarded as “CBC′” will, by definition feature a key k′&ᵢⱼ that would transpose πᵢ to πⱼ. Albeit, any other CBC designated as “CBC*”, by definition will also have a key k*ᵢⱼ that would transpose the same plaintext listing to the same matching ciphertext listing. So while these two keys may be quite different, and the CBC may be exercised via different algorithms, their “black box” operation is the same. They are equivalent.

A Group Representation of a CBC: Given some starting permutation π₁, it can be operated on with a CBC key k₁ᵢ to transpose πᵢ to another permutation πᵢ, which in turn may be operated on with another CBC key kᵢⱼ that would transpose πᵢ to πⱼ. However, by the definition of the CBC, it would include a key k₁ⱼ that would transpose π₁ to πⱼ. We can write:

kᵢⱼ*kₗᵢ=kₗⱼ

Since the effect of each CBC key₁ is to move the rank of each block l (1<=l<=b) some x₁ₗ ranking slots up or down, and key₂ will move the same block l x₂ₗ up or down then the net result is independent of the order of applying these keys, therefore we can write:

(kⱼᵣ*kᵢⱼ)*k₁ᵢ=kⱼᵣ*(kᵢⱼ*k₁ᵢ)

Also, by definition of the CBC any arbitrary permutations πᵢ and πⱼ may exchange status plaintext-ciphertext, therefore every kᵢⱼ has a matching kⱼᵢ such that:

kᵢⱼ*kⱼᵢ=kⱼᵢ*kᵢⱼ=k₀₀

where k₀₀ is defined as the “no effect” encryption, where the ciphertext equals the plaintext, as applied to any permutation.

Clearly:

kᵢⱼ*k₀₀=k₀₀*kᵢⱼ=kᵢⱼ

Which identifies the CBC keys as a group (even an Abelian group, using the same arguments used for proving the association attribute). And as such it lends itself to various applications of asymmetric cryptography, especially by exploiting some CBCs which are one-way functions versus others (although functionally equivalent) which are two-ways functions.

### GBC—The Concept

The motivation for GBC is the emerging cryptographic approach to increase the role of randomness at the expense of unproven algorithmic complexity. All the mainstay block ciphers in use today are based on a fixed (rather short) key, and a particular algorithmic complexity, which by its very nature is susceptible to yet uncovered mathematical insight offering a fatal computational shortcut. By contrast, ciphers who accept varying size keys, and operate with algorithmic simplicity will hinge their security on the randomness of the adjustable size key, and hence will escape the risk of a mathematical shortcut, and instead sustain a computational intractability defense which may be objectively appraised through combinatorics.

We are looking at a block cipher environment where a message comprised of m letters of a certain alphabet (a message block) is encrypted to ciphertext of same size, written in the same alphabet, which may be decrypted to the generating message (bijection).

The vehicle for randomness, given a cipher that operates on some alphabet A comprised of u*v=n letters (u,v positive integers) is “the alphabet matrix”: a u*v matrix where each letter a from some alphabet A (aεA) comprised of u*v letters, is found once, and only once in M.

We assume that the letters in A have a pre-agreed order. When these letters are marked into the alphabet matrix with that order in tact, we regard this matrix as “the zero permutation” of the alphabet matrix: M⁰. We agree to count the element row after row starting with the upper one. Using the “ultimate Transposition cipher” [ ] or any other means we may assign a natural number T ranging from 1 to (u*v)! to mark any of the (u*v)! possible distinct alphabet matrices. The designation M^{T} will denote an alphabet matrix at transposition T.

We define “an encryption set” as a set of 4 alphabet matrices designated as P₁, C₁, and C₂, and P₂

We define “a double substitution act” as an act where two elements, one from C₁, and one from C₂ substitute for two elements, one from P₁ and one from P₂:

{p₁εP₁,p₂εP₂}-->{c₁εC₁,c₂εC₂}

Accordingly a message m written in alphabet A comprised of letters p₁, p₂, . . . pₙ may be encrypted using the a GBC encryption set by processing a double substitution act: p₁p₂->c₁c₂, p₃p₄->c₃c₄, . . . .

Decryption operates in reverse:

{c₁εC₁,c₂εC₂}-->{p₁εP₁,p₂εP₂}

Substitution and reverse substitution are controlled by the following relationship:

Let p₁ be written in P₁ in row i and column j: p₁=p₁ᵢⱼ. Let p₂ be written in P₂ in row j and column k: p₂=p₂ₖₗ. These two plaintext letters will be substituted by c₁ written in C₁ in row i column 1, and by c₂ written in C₂ in row k column j.

{p₁ᵢⱼεP₁,p₂ₖₗεP₂}<-->{C₁ᵢₗεC₁,c₂ₖⱼεC₂}

Lemma 1:

This double-substitution cipher operates as a complete block cipher for blocks comprised of two letters of the A alphabet. A ‘complete block cipher’ will have a key that encrypts any possible block to some other block, and because of bijection this implies that any two letters block may be decrypted to some other two letters blocks.

Theorem 1:

The double-substitution cipher may be made equivalent to any block cipher for two letters blocks.

Proof: Let an arbitrary block cipher operate on two letters blocks, for letters of the A alphabet. Accordingly that Arbitrary Block Cipher (ABC) will use some key, K to encrypt any of the possible (u*v)² blocks, each to some other block from the same set.

We need to show that there are 4 alphabet matrices: P₁, P₂, C₁, C₂ such that the same encryption occurs with them as with the ABC.

Let's first assume that some choice encryption set of four matrices as above has been occupied by the n=u*v letters per each matrices, and that all blocks (pairs of two A letters) have been encrypted in the same way as in the ABC. In that case the double-substitution encryption is equivalent to the ABC. Let's now retract our assumption and assume that only (n−1) blocks were properly fitted but the last one can't be fitted because the only two letters (one in C₁ and one in C₂) that are left unused, are the pair:

c_{1i′T}εC₁,c_{2k′j′}εC₂

And at least one of the following equations is true: i≠i′, j≠j′, k≠k′, and l≠l′. In that case the two unused elements in C₁ and C₂ will decrypt to

p_{1i′j′}εP₁,p_{2k′l′}εP₂

which have already been properly accounted for (while their corresponding C₁, and C₂ elements are still unused). This contradiction eliminates the possibility that n−1 block are properly mapped while the last one is not.

We move backwards now to the case where n−2 blocks are properly mapped, and 2 pairs of unused elements are left in each of the four matrices. In that case either there is such a combination where one of the left two pairs is properly fitted, in that case we bounce back to the former state, which we have already proven to be impossible, so all pairs fit, or that there is no fit among the two pairs according to the double-substitution algorithm. In that case the matrix matching elements in C₁ and in C₂ for one pair of elements one in P₁, and one in P₂ will point to different pair in P₁ and P₂, alas this pair has already been matched, while its corresponding elements in C₁ and C₂ are still unused. Again a contradiction that eliminates that assumption.

We can now regress back to the case where n−3 pairs are properly matched, and repeat with the same logic. Then continue to n−4, n−5, etc, until we reach, if necessary the case of one pair fitting, which is clearly possible.

This proves that the double-substitution encryption is a generic block cipher for blocks that are comprised of two letters of some alphabet A.

Note that this proves that DES, AES, etc. will find their double-substitution cipher equivalent. DES for example will be interpreted as a two letters block where the respective alphabet is all the bit strings of 32 bits long.

Note that the double-substitution key space: |K|=((u*v)!)⁴ is much larger than the the plaintext-ciphertext pairs: (u*v)².

### Multiple Substitution Iteration

Denoting double-substitution in short as follows:

[p₁,p₂][c₁,c₂]

we may extend the double-substitution to triple substitution as follows:

[p₃,C₂][c₃,c₄]=[p₁,p₂,p₃][c₁,c₃,c₄]

And similarly extend the same to t-substitution:

[pₜ,c₂ₜ₋₄][c₂ₜ₋₃,c₂ₜ₋₂]=[p₁,p₂ . . . pₜ][c₁,c₃ . . . ,c₂ₜ₋₂]

This procedure amounts to a block cipher encrypting a block comprised of t letters from the A alphabet p₁, p₂ . . . , pₜ to a ciphertext block of t letters from the same alphabet: c₁, c₃ . . . , c₂ₜ₋₂. The key for this cipher is comprised of 2t alphabet matrices.

Theorem 2

The t-substitution cipher may be made equivalent to any block cipher for t letters blocks.

Two proves: Proof #1: Very similar to the proof of theorem 1. Suppose the t-substitution fits an arbitrary block cipher (ABC) that encrypts a block of t letters from the A alphabet to a ciphertext block of t letters of the same alphabet. Then all is well. Now suppose that the last unused pair of elements in matrix Pₜ and matrix C^{2t-4} does not fit with the last unused pair of element in matrices C₂ₜ₋₃ and C₂ₜ₋₃. That would imply that the pair in C₂ₜ₋₃ and C₂ₜ₋₃ that does fit with the pair in Pₜ and matrix C₂ₜ₋₄ is matched with another (wrong) pair in these two matrices, which contradicts our previous assumption, so it can not happen.

Now we start regressing, assume that the last two pairs don't fit, same argument as above: contradiction. And again as we regress leading to the inevitable conclusion that any proper block cipher operating with a block of t letters of some alphabet A may be faithfully emulated with a t-substitution cipher.

Proof 2: The first pair encryption: [p₁,p₂][c₁,c₂] is fully compatible with the emulated ABC by virtue of theorem 1. So for the next pair: [p₃,c₂][c₃,c₄], and so on to the last pair.

The key space for the t-substitution cipher is: |K|=((u*v)!)^{2t}, while the message space is much smaller: |M|=(u*v)^{t}—fully compatible with Shannon mathematical secrecy condition.

Illustration: Let the alphabet A be the hexadecimal numeric system: 0, 1, . . . F which may also be represented as all possible 4 bits long letters: {0000}-{1111}. Let us encrypt a block comprised of 44 letters using only a double-substitution cipher. The message space (number of distinct blocks) will be: |M|=16⁴⁴=9.6*10⁵²; the key space: |K|=16!⁴=1.92*10⁵³. It figures then that a block of 44 hexadecimal letters or less (704 bits or less) may be encrypted with a simple double-substitution cipher while allowing for Shannon mathematical secrecy.

Given a randomized transposition of the matrices even a simple double-substitution cipher may provide mathematical secrecy for an indefinite encrypted message.

The schematics of multiple-substitution cipher is as follows:

### Iteration Configuration

The above described iteration is only one possible variation. Here is a second one:

[p₃,c₁][c₃,c₄]=[|p₂,p₃][c₂,c₃,c₄]

In other words, instead of matching p₃ with c₂, it is matched with c₁. In the next iteration, p₄ may be matched wither with c₃, or with c₄, and so on. For i iterations there are 2ⁱ possible combinations, that are distinct, but share the same properties. The user will have to specify which of the various iteration sequences should be used. This selection may, or may not be part of the secrecy of the cipher.

### Plaintext Randomization

Any plaintext in the series of message streams P*₁, P*₂, . . . p*ₜ may be replaced with a random variable: a uniform selection of a letter a from alphabet A:

P*ⱼ={aεA by random selection}^{r}

where r is the count of letters in plaintext stream P*i. And 1<=i<=t. We say that stream P*i has been randomized.

If all the streams have been randomized then a cryptanalyst will search in vain for the non existent meaningful plaintexts. If (t−1) plaintext streams are randomized then the remaining non-randomized stream will be very well protected. Even if a single stream is randomized, it will be very effective in confusing the cryptanalyst. We assume a cryptanalyst hunting the key by brute force testing all possible keys (if he knows the exact iteration configuration), against the known ciphertexts. Naturally a randomized plaintext will keep the cryptanalyst searching through all possible combinations for the plaintext stream.

In the case of a simple double-substitution, P*₂ may be randomized, and hence the cipher will only encrypt P*₁. In this configuration it will take a long time (will require a long encrypted version) for the frequency cryptanalysis to become productive.

### Single-Substitution

Given three alphabet matrices: P₁, C₁, and C₂

### Emulating Odd Size Block Ciphers:

At the least GBC needs to divide the intended block into two equal parts (that is to establish a minimum double substitution cipher). But in general GBC works well with blocks of size 2ⁿ, that can be divided to as many sub blocks as desired. However, in order to be regarded as a generic block cipher the GBC will need to be able to emulate all block sizes, including blocks comprised of odd number of bits.

GBC will do it by extending the emulated odd-block cipher, of size z bits to a higher bit size x, where x=2ⁿ, where n is such that z>2ⁿ⁻¹. The extended cipher will operate on a x size block, and will operate as follows: The rightmost z bits from the x bits string will be fed into the odd-size block cipher and the remaining (x−z) bits will be left padded to the z bits of ciphertext generated by the odd size block cipher. This will define an x size block cipher which GBC can emulate, and derive from it the emulation of the odd-sized block cipher.

### GBC as Group

The GBC form groups per block and per cryptographic configuration, as seen ahead.

Given a t-substitution GBC defined over an alphabet A of u*v letters. For every instant of 2t alphabet matrices, (featuring 2t*u*v letters) any t letters block is encrypted to a t-letters ciphertext. There are b=(u*v)^{t} t-letters size blocks for the plaintext space and for the ciphertext space:

|P|=|C|=b=(u*v)^{t}

The GBC key, K, (which is the contents of the 2t alphabet matrices) is mapping any plaintext block to a unique ciphertext block. We may agree on an order of the (u*v) letters, and hence assign them numbers from 1 to u*v. Based on such numbering we may list the all the b blocks in order. We regard this order as the base order, or the unit order of the GBC block space, and mark it as B₁. The b distinct blocks may be ordered in b! possible ways: B₁, B₂ . . . B_{b!}. By applying the GBC key, K to all the blocks in some Bₚ order (1<=p<=b!), one will generate the same blocks, now organized as the matching ciphertexts, in an order designated as B_{c} (1<=c<=b!). Block listed in position i in Bₚ when encrypted with K, will generate some other block, which will be listed in position in B_{c}. By applying K to all the blocks in Bₚ one generates a transposition of Bₚ, which we regard as B_{c}. Let K=Kᵢ be the GBC key used for this transposition of the blocks. We may designate this transposition as Tᵢ. Another GBC key, Kⱼ, will be designated as transposition j: Tⱼ. There are ((u*v)!)^{2t} such transpositions.

### Generic Block Cipher Framework

Nominally ciphers process key bits with message bits to generate the ciphertext. Albeit, the key could be used in a more abstract way: it provides random data, and it shapes the encryption and decryption algorithm. We may use the term cipher framework to describe such a configuration.

To construct a GBC one would need to specify the alphabet A, the dimensions of the alphabet matrices: u, v; the size of the block, t, which also defines the cipher as a t-substitution algorithm, and the permutation of A over the 2t alphabet matrices. The GBC key may be defined as:

K<sub<GBC=[A,t,u,v{Tᵢⱼ}ₜ]

where 0<=Tᵢⱼ<=(U*v)! expresses the permutation number T*j that defines the permutations of the letters in A in matrix Tᵢ*. As mentioned, we may use any complete transposition cipher to apply the natural number T*&ndexj over the base permutation of the letters in A, and generate any of the possible (u*v)! permutations.

By opting for a cipher framework we give the user the power to choose the fitting cipher algorithm for his or her needs.

Illustration:

Let A be Base-64, hence comprised of all the 6 bits long strings: {0,0,0,0,0,0} to {1,1,1,1,1,1}. Let u=v=8 so that all 2⁶=64 letters in A fit in the alphabet matrices. Let t=10, hence the, the processed block will be 60 bits long. The cipher framework will require 2t=20 matrices, each with a random distribution of the Base-64 letters. Each matrices will have 64*6=384 bits, and the full key will have 20*384=7680 bits.

### Cryptanalysis

GBC is constructed with zero algorithmic complexity. Computation is comprised of look-up tables, and value exchange, nothing more. Security is built via the size of the randomness used. It can be of such (secret) size that any desired length of plaintext will be encrypted with mathematical secrecy. A the same time, the GBC framework may be operated without mathematical secrecy but rather hinged on intractability.

Alas, unlike all mainstay block cipher, the GBC does not rely on unproven unbreakability of computational complexity, but rather on durable, reliable probability and combinatorics calculation. As long as the alphabet matrices are randomly filled, the likelihood of comprising the cipher is well computed and is well managed.

Intractability is managed by (i) the size of randomness used (the size of the alphabet matrices); by (ii) introducing any number of randomized plaintexts, and by (iii) changing the randomness in the alphabet matrices by applying transposition every so often.

### Applications

By virtue of being a generic block cipher capable of emulating any other block cipher, the GBC merits consideration for any situation where a complexity based block cipher is used since the GBC is immunized against a surprise mathematical shortcut. And since its operation is very easy on computational power, the GBC should be used especially in cases where power is scarce.

Owing to its special structure of tying together several plaintext stream, the GBC can be applied for situations where several readers are allowed to read at different levels of secrecy within a given document.

### Document Management Cryptography

### Document Management Cryptography

### Version Management, Archival, and Need-to-Know Efficiency

Abstract: Project management implies a maze of documents that easily get out of hand, hamper efficiency, snap tight nerves, and is altogether agonizing. Solution: a single set of project documents, where each document is inclusive of all relevant information: basic (visible to all), restricted (visible to middle and upper management), and sensitive (visible to upper management only). The documents are sent, received and stored in one way (encrypted). Each echelon decrypts each document with its own key so that the decrypted version exposes only what that reader is meant to see. Similarly each echelon adds, writes to each document such that higher echelons can read it, all lower echelons will read only if marked for their attention. No restriction on number of echelons. This order allows for today's maze of project documents to function as intended, while managed with a fraction of the effort because no matter how many echelons are involved, there is only one single document to send, receive, store, and retrieve. Instead of document variety, we offer key-variety. Document Management Cryptography simplifies the drudgery of document management, makes the work environment more pleasing, and much more profitable.

Introduction:

To understand what DMC is about, let's describe a generic project management environment comprised of a project manager, an executive team, middle management, and staff. (There may be more echelons, but the three are enough for our purpose). As the project evolves it is expressed through a growing number of documents. The project documents include: 1. public domain project data (public), 2. widely shared non-public project data (staff), 3. management restricted data (management), 4. executive grade sensitive data (executive). Usually the basic parameters of the project may be announced and become “public”. Work plans, schedules, quantitative computation is data worked out the staff (“staff” data); Considerations, risk analysis, expectations, cost figures, HR data is developed by middle management, (“management”), and above that there are financing data, risk sharing, high level business scenarios that are the purview of the top echelon (“executive”). Data exposure is clear upward, and opaque downward. It is therefore that document management is dividing documents according to their data contents. This implies separation. Executive data is written into ‘executive-only’ documents, management data is written to management and executive only documents, and staff data is written into non-public documents. It is a management burden to keep these categories apart. There are many reported situations where confidentiality was inadvertently breached when an executive holding documents of executive level mixed with management level, and further mixed with staff level and public domain levels. One document slips to the wrong category, “spills the beans”, often without a trace.

Apart from mistakenly crossing categories, there arises the challenge of “version management”. Let document D₁ be a staff document, containing data S₁. Let document D₂ be a management document, containing S₁ and management data M₁. At a later point in time S₁ is updated (new version). The project management team now has to insure that the update S₁ to S′₁ will be carried out in D₁ and in D₂. And possibly in D₃—the executive document containing S₁. Since there are several documents that contain the same staff data S₁, it is a burden to insure a uniform update.

So why not separate the data so that each project document will contain only data contained in that category? This is not practical because the data tends to be intertwined. For example cost data of various elements of the project may be marked and identified over a description of these elements. The cost data may be ‘management level’ and the ‘elements’ description may be staff level.

Not only is version and exposure management a daunting challenge while the project is ongoing, it remains so when the project is concluded, but the data must be retained for any future accounting, tax auditing, and general good management practice. One has to insure that the data sensitivity considerations are honored indefinitely after the project has concluded.

This headache and burden of sorting out documents according to their data exposure requirement is growing exponentially with the size of the project. There are more documents because there are more parts, there are more versions because the project lasts longer, and there are more echelons of management and supervision because of the increased complexity.

It is this very issue of version and exposure management of project data that is addressed by the Document Management Cryptography.

### The Concept

The underlying idea of DMC is to handle one document only. One document to be shared by all, one document to send, to receive, to store by all levels, and echelons, and even by the public.

On its face this principle will violate the requirement for data exposure management.

It certainly looks that way, but it is not. In fact, the generated, transmitted and stored document has zero exposure per se. Not the public, not the staff, not management, and not even the executive echelon will be able to read it. The reason: it is encrypted!

And each echelon is given a reading key with which the encrypted document is decrypted to show in plain language only the data proper for that echelon.

Imagine the project manager writing the initial project plan. It contains some basic parameters to be exposed to the public (P), some project details needed by the staff, some restricted data aimed at the middle management (M), and then some sensitive data to be read by the executive team (E).

As the document leaves the project manager's desk, it is encrypted. And the cryptogram is spread out to everyone involved. When the press gets a hold of that project document they can read only the P portion. When a member of the staff comes around she uses her staff key, and the encrypted document is decrypted for her, showing only the public data and the staff data (P+S). A middle manager will approach the very same document and see in it the public portion, the staff data, and the management data (P+S+M). And every executive will use his executive key and read in the very same document the public portion, the staff data, the management information, and the executive material.

When each document reader concludes the reading, the decrypted version dissolves, and disappears, and only the encrypted version is kept, ready to be re-invoked at any time, maintaining the data exposure regimen every time it is used.

And what if a staff member is taking the document generated by an executive, and wishes to add, elaborate, modify? He would do so in plain language, of course, modifying only the parts that he can see (what does not decrypt is not visible to the reader), and save it with a different name before distributing the modified document to its proper distribution list. The revised document will be seen with the revisions and modifications by all staffers, all managers and all executives. The managers and the executives will see the changes side by side with the restricted and sensitive data that the staffer did not see.

All in all, the normal project development is taken place and every document is maintained once and interpreted differently as if the system were to handle a multitude of documents to honor data exposure requirements.

For example, a staffer may send a manager a document that the manager misplaced. The manager, using his management key will be able to read in that document the management only stuff that the staffer was blind toward.

The DMC simply relocates the data exposure discrimination to a new device called a “reading key” which allows the system to deal manage, transmit and store one and only version.

### Operation:

The nominal operation of the DMC may be divided to categories:
Writing & Reading DMC documents
D Storage & Retrieval Management

### Writing and Retrieving DMC Documents

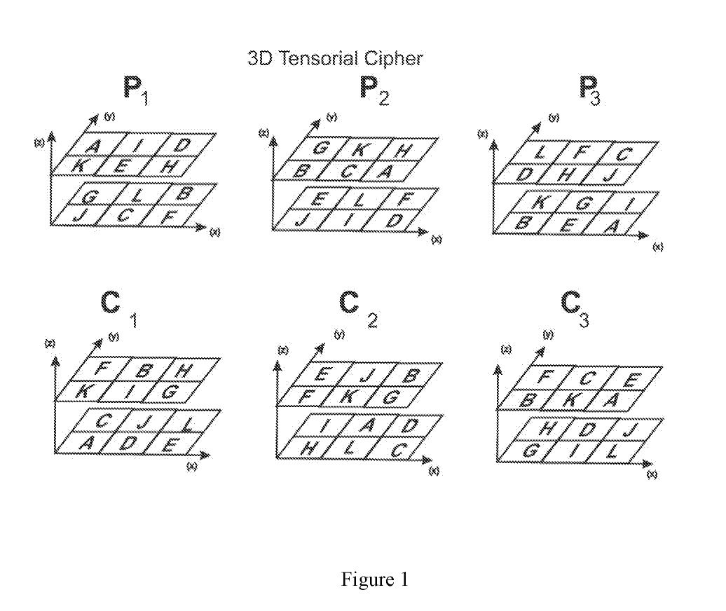

There are three categories of writers: executives, managers, and staffers. Executive writing is depicted in FIG. 1: Executive Aron is writing project document (d) comprised of information at staff level, (s), information for managers, (m) and material for fellow executives (e). Document (d) is encrypted using DMC and its encrypted version (d′) is produced. (d′) is routed to all project people—same document. The copy that is being accessed by execute Bill is decrypted with Bill's executive reading key that opens up the full document (d) for Bill's attention. The copy of (d′) that is accessed by manager Charlie is decrypted with the manager's key, and exposed before Charlie the (d) document without the executive information in it. Respectively Staffer David reads the same copy with his staffer's key, and what he sees is only the (s) data—designed for his attention.

FIG. 2: Manager Alice writes document (d). Nominally Alice is expected to only write to her level (managers) and below (staffers). As above the encrypted document (d′) is read for its m and s information by all managers and executes, while staffers see only the s-information.

As a matter of policy a company might encourage all project people to report to higher echelon anything they deem important and that does not get properly addressed at their level. Using DMC a staffer would be able to address management or the executive level, and the same for managers towards executives. This is a mechanism to ‘whistle blow’ and otherwise communicate discreetly with higher ups. One should notice that if a staffer writes for an executive she herself would not be able to read back what she wrote because she does not have the executive key.

It's clear from this operation that a writer will be expected to designate with respect to anything he writes, what is the level of project exposure associated with that writing.

### Storage and Retrieval Management

Project documents will all be stored in their encrypted form, and a key management system will have to be setup to allow each to read at his or her level, when retrieving an old document. Over time old documents might be relaxed as to their restrictions, and eventually everyone will be given the executive key to read sufficiently old papers. cryptography

The Document Management Cryptography may be accomplished in various schemes. We present two:
The exponential method
The rubber method

Multiplicative DMC generates an encrypted document of size 2^{t}|p| where |p| is the size of the unencrypted file, the plaintext, p, and t is the number of echelons served by the DMC. The price paid for the benefits of the DMC is a considerably larger file for both transmission and storage.

The rubber method is based on U.S. Pat. No. 6,823,068. The encrypted file is somewhat larger than |p|, but is requires more preparation for each document.

The DMC exponential method is based on alphabet A comprised of a=u*v letters, (u,v positive integers). All the letters of the alphabet are listed in a random order in u*v matrix: u rows and v columns. This is called the base matrix: M1.

Matrix M1 associated with two matrices: M1u and M1v, each of size u*v. M1u is placed next to M1 and M1v is placed above or below M1. M1u is called the horizontal key of matrix M1, and M1v is called the vertical key of M1. M1 together with its horizontal and its vertical keys (three matrices altogether) are called the “M1 key set”, and M1 is its base.

Mu (the horizontal key of M1) may be regarded as a base for its own key set. Its horizontal key would be regarded as M1vu, and its vertical key would be regarded as M1vv (M1vu and M1vv are both u*v matrices).

My (the horizontal key of M1) may be regarded as the base for its own key set. Its horizontal key would be regarded as M1vu, and its vertical key would be regarded as M1vv (M1vu, and M1vv are both u*v matrices).

The nomenclature continues with the same order, accordingly one could properly interpret matrices designated as M1vuuvv, and M1uuvvuuuv, . . . etc.

We now describe The DMC Exponential of the First Order:

Any letter mᵢⱼ in the A alphabet appears in matrix M1 in row i and column j. When mᵢⱼ appears in the plaintext, it is replaced by two letters: the first letter is a random selection from row i in matrix M1u, and the second is a random selection from column j in matrix M1v.

As described the M1 key set will enable encryption of any plaintext of any length written in the A alphabet. The size of the so generated ciphertext is twice the size of the plaintext, because any letter of the plaintext was replaced with two ciphertext letters.

Because of the random selections a given plaintext p will be encrypted to n different cipher texts c₁, c₂, . . . cₙ if encrypted n times. And the longer the plaintext the lower the odds that any two of the n ciphertexts will be identical, even for high n values.

Decryption proceeds symmetrically. The intended reader will read in the ciphertext two letters at a time. Find which row in Mu the first letter is written—i, and which column the second letter in the ciphertext is written in matrix Mv—j, and then retrieve mᵢⱼ in M as the corresponding plaintext letter.

By construction it is clear that all the c₁, c₂, . . . cₙ ciphertexts will decrypt to the same generating plaintext p.

The M key set is the key to execute the DMC Exponential method of the 1st order.

We will now describe the DMC Exponential method of the 2nd order:

We consider two plaintexts p₁ and p₂ of the same length: |p₁|=|p₂|. We shall encrypt p₁ letter by letter as described above (in the DMC Exponential of the 1st order), with one important change. Instead of selecting random letters from M1u and M1v respectively, we will select letters as guided by another u*v matrix, M2. As follows:

Let a be the first letter in p₁, and let b be the first letter in p₂. let a be in position (i,j) in M1 (row i and column j). To encrypt a we need to select a letter from row i in M1u, and a letter from column j in M1v.

Let row i in M1u be:

g₁,g₂, . . . gᵥ

And let column j in M1v be:

h₁,h₂, . . . hᵤ

Let b (the first letter in p₂) be found in location (i′,j′) in M2. Accordingly instead of a random selection from the set: g₁, g₂, . . . gᵥ, we shall select gⱼ′, and instead of a random selection from the set: h₁, h₂, . . . hᵤ, we shall select hᵢ′.

A recipient of the ciphertext, who is not aware of M2 will decrypt the pair: gⱼ′-hᵢ′ as a (based on his knowledge of the M1 key set). However, an intended recipient who is aware of M2 will interpret the same set (gⱼ′-hᵢ′) as the encryption of the letter a from p₁, but in parallel she will interpret the same pair as the encryption of b from p₂.

It will work similarly for the subsequent letters in p₁ and p₂. The same ciphertext c will be interpreted as p₁ by the holder of M1, M1u, and M1v, and will be interpreted also as the letters comprising p₂.

We say then that the DMC of the 2nd degree is a setup that encrypts two plaintexts p₁ and p₂ in parallel such that one key holder decrypts the ciphertext c back to p₁, and the other encrypts the same to p₁ and to p₂.

Using the 2nd degree, the randomness used to pick coordinates markers for the plaintext letter, is being replaced with a chosen pair such that this choice reflect the identity of the in-parallel plaintext letter that is encrypted with this procedure.

The idea of replacing a letter with two so called marker letters that define this letter through its coordinates in a letter matrix, may be extended indefinitely and build a set up where any number n of in-parallel plaintexts are encrypted through the same cryptogram. This can enable the discrimination between readers who know all the involved matrices and can therefore decrypt the combined ciphertext to all the n plaintexts p₁, p₂, . . . pₙ, and between other readers who don't have possession of all the keys, and assume that the selected ciphertext letters were picked randomly.

Let's Examine now the DMC Exponential of the 3rd degree:

We recall that in the 2nd degree a letter was picked (c2) from matrix M1v such that its column indication identifies the column address of letter p in M1, and its row address identifies row address of p′ in M2. Operating at the 3rd degree one does not identify c2 outright but rather relate to two adjacent matrices: M1vv and M1vu such that c2 may be identified via any element in M1vv in column j, and via any element in M1vu on row i′. Any random selection will do. Albeit, we assume the existence of a third plaintext, p3, and wish to encrypt in parallel the next letter from it. That would be letter p″. p″ is marked in M3 in coordinates (i″,j″). We will now identify i″ by choosing a letter c3 from column j in M1vv because c3 will be at row i″. And we also pick letter c4 from M1vu such that its column is j″ and its row is i′.

The respective ciphertext sequence will be c1-c3-c4, where c3-c4 is identifying p″ and c2, and c1-c2 is identifying p′ and p.

Only a writer who is aware of all the involved matrices can accomplish this feat where three plaintext sequences p1, p2 and p3 are encrypted in tandem to a single ciphertext sequence c1-c3-c4. As it is evident the number of matrices used rises exponentially and hence the name.

An intended reader of all the encrypted messages will be aware of all the matrices and decrypt the ciphertext sequence backwards. From the identity of c3 and c4, the reader will identify p″ in M2. From the same element the reader will identify c2 in M1v, and from the identity of c2 and c1 the reader will identify p′ and p, and thereby read the corresponding letters of all the three plaintexts.

An intended reader who is supposed to read only p1 and p2, and not p3, will not be aware of M2, and interpret c3 and c4 only as some random choices to identify c2. That reader will also identify c1, and from c1 and c2 the reader will identify p and p′ (and not p″), and read p1 and p2.

### DMC Exponential Illustration

Let alphabet A be comprised of 8 letters: 0,1,2,3,4,5,6,7

(000,001,010,011,100,101,110,111). Clearly this alphabet will handle all binary strings.

We set A in a u*v=2*4=8 randomly organized table:

$$M 1 = \begin{matrix}4 & 7 & 1 & 0 \\ 5 & 3 & 2 & 6\end{matrix}$$

### We Write, M1u:

$$M 1 u = \begin{matrix}5 & 4 & 3 & 6 \\ 7 & 1 & 2 & 4\end{matrix}$$

### We Write, M1v:

$$M 1 v = \begin{matrix}1 & 6 & 5 & 2 \\ 3 & 7 & 0 & 4\end{matrix}$$

Which is all we need to exercise DMC in the first degree. We then add M2 matrix to exercise DMC in a 2nd degree, and matrix M3 to exercise DMC in the 3rd degree. The following pages illustrate that practice.

Key implementation parameters are:
1. Alphabet choice
2. level management
3. Security Enhancement

### Alphabet Choice

The illustration herein is shown with a very limited alphabet of 8 letters. As mentioned this alphabet and the illustration are sufficiently robust to encrypt any size plaintext. If practiced via 1 levels, then using 31 matrices, then the practice involves a key space K of size |K|:

|K|=(8!)³l

For only two levels this amount to a whopping |K|=4.3*10²⁷ And in general for an alphabet A comprised of a=u*v letters, the key space will be:

|K|=((u*v)!)³l

It is not necessary to use DMC with 2ⁿ letters n bits long each. However it adds some simplicity and generality to the system. A base-64: 8*8 setup seems inviting. Each matrix comes with a key space of 64!=1.27*10⁸⁹.

The larger the matrices, the greater the intractability of the cipher—exponentially. Albeit the encryption decryption effort is proportional to the size the matrices, by the nature of the encryption and decryption process. It is therefore that one can choose to increase the matrix size, pay a proportional increase in nominal processing, and gain an exponential benefit in intractability. And since the encryption/decryption processes are the same regardless of the size of the matrix, one can code the encryption and decryption to be usable with any size matrix decided by the user of the cipher (who may not be a cryptographer neither a programmer). It implies that the project manager will be able to choose different strength (size) keys for different project depending on the sensitivity of the project.

The size of the matrices may be of such size that for messages of sufficiently small size the DMC cipher will offer Shannon secrecy. This can be readily figured out since for small enough messages, given a random ciphertext, one could match it with a proper size random plaintext, by filling in the rubrics in the large matrices. Namely, it is possible under such conditions to match any ciphertext with any plaintext—a property directly linked to Shannon secrecy.

The DMC Exponential may be implemented with as many levels as desired. Let there be an implementation of l levels. To increase the level to l+1, it would be necessary to add the level l+1 substitution matrix Ml+1, and two coordinating matrices M . . . v and M . . . u.

In other words, we may add 3 alphabet matrices for each level. So the total cryptographic key for l level DMC is 3l. It may be noted that as a bare minimum it is necessary to keep secret M1, M2, . . . Ml while the other (the coordinating) matrices may be put in the clear.

One may practice dec implementation in which DMC is practiced at level l, but appears to be practiced at a higher level l′>l. This practice confounds the cryptanalyst, and allows for smooth upgrade from l to l′.

In a decoy implementation one selects randomly the letters from the coordinating rows and columns (as in DMC of the first degree), and hence only M1 is needed. There is no need here for M2, M3, Ml.

Illustration: with respect to the 3rd degree illustration above: one only encrypts p=1 2 3 4. p1=1, which may be identified via M1u and M1v as: [5 4 3 6][5 0]. A random choice reduced the options to (4,0). The letter 0 in M1v is expressed via M1vv and M1vu as: [3 4 7 1][1 0], which again is reduced to a random choice of (1 1). We have thus encrypted p1=1 to c1=(4,1,1). It appears as a three level DMC implementation, but it is a decoy because there are no M2 and M3 involved, only M1.

To decrypt c1=(4,1,1) to p1=1 one would first regard the (1,1) letters. According to M1vu and M1vv (1,1) points to letter 0 in M1v, so (4,1,1) is reduced to (4,0). The combination (4,0) in M1u and M1v unequivocally points to p1=1.

When DMC is practiced with a group where different members have different level keys, then a low level key holder may practice a decoy procedure with respect to the levels above his grade. A cryptanalyst will have no means to identify such encryption is decoy, but group members who are aware of the higher level keys will readily realize that decoy is being practiced because they can't read any plaintext of a higher level (above the writer's level), since it would look as random (because decoy is practiced through random selection).

Reduced Level Implementation

It is readily possible to implement DMC over a single plaintext stream. Let a plaintext P be comprised of letters p1, p2, . . . . One could artificially define the sequence: p1, pl+1, P2l+1 as plaintext stream P1, and p2, pl+2, . . . as plaintext P2, etc. and then encrypt I letters in parallel. Similarly the levels can be reduce from l to any desired level.

### Security Enhancement

The security offered by this cipher may be enhanced via:
key replacement
linking with a randomizer cipher
Dummy levels

### Key Replacement:

If the key is switched and changed often enough, then the data used with a particular key might not be enough for a conclusive cryptanalysis. On the other hand it is so much more convenient to run a particular project with the same key from start to finish.

One powerful way to change keys is to use a ‘complete transposition cipher’: all matrices are permutations of each other. And hence, all or some of them can be transposed to another matrices every so often. The “so often” may be based on time, on rounds of use, etc.

One may note an anomaly, the higher levels are more vulnerable to cryptanalysis than the lower levels, so it may be the higher levels that may need to consider transposition.

Linking with a Randomizer Cipher
Cryptanalysis of DMC is based on the low entropy of the plaintext. For example: a raw brute force cryptanalysis where one tries one matrices configuration after the other, and used the ciphertext on each, then all configurations that result in a plaintext that does not read as a proper plain message is discarded. One would then precede the DMC cipher with any ‘randomizer cipher’ (e.g. DES) that genera a random looking ciphertext. It would be that ciphertext that would be fed as input to the DMC. Cryptanalysis of the DMC will not be possible as before, but will have to be linked with brute force analysis of the randomizer cipher. It would be the combined strength of the randomizer cipher and the DMC cipher that will determine the cryptanalytic barrier.

This security enhancement will work also work with each level independently. It is possible for example to pre-encrypt the level 3 message, and not the levels below. The key for level 3 need not be shared with other levels.

Dummy Levels: Every level of the DMC may be operating on a purely random basis. Let p1, p2, . . . pl be the l plaintexts feeding into a DMC. While each of these plaintexts may be a meaningful message, it may also be a random sequence. The way the DMC operates, each level may choose on its own to be “randomized” and meaningless, and that decision will not affect the other levels. So the whole DMC set up may be churning out meaningless messages, or perhaps only one, two or any subset of the I levels may encrypt a meaningful message. The cryptanalyst will be in the dark about this decision. It is therefore a very powerful means to enhance security. In particular one could erect a DMC for sale l=5 levels, and use only two levels meaningfully: level 1 and 3, and the rest will be randomized. At any point, stealthily some previously randomized levels will be taken up for service of a meaningful message.

### Cryptanalysis

The DMC Exponential by its nature is not based on algorithmic complexity and rather on the quantity of randomness in its key. Therefore there is no concern for some smart mathematical cryptanalysis offering an algorithmic shortcut. Cryptanalysis will proceed on the basis of the expected low entropy of the plaintext, and on the mounting constraints we more and more data is used via a fixed key. Such cryptanalysis may be appraised on combinatorics grounds.

Advantage over Common Practice

The idea of separating project data according to sensitivity and ‘need to know’ is old and in common practice. In particular one could simulate the operation of the DMC by having data at various security levels encrypted via a key known only to members of this level or of higher levels. And so achieve the same functional capability touted by DMC.

Such separate encryption scheme will artificially and tenuously tie the information from different levels to each other. Any level will be able to “fly solo”, advance to higher revision levels, irrespective of the other levels. This cannot happen in DMC. When the per level cryptography is separated from the other levels, it is necessary to manage a complicated key regimen so each level will have the updated keys for the levels below. The DMC regimen implies non-repudiation. While higher levels will be able to hide their content from lower levels, they could not deny that content, should there by a subsequent inquiry.

Also, the DMC may operate formally with l levels, but actually with 0<r<l levels only, while the other l−r levels are ‘dummy’, operate without a guiding matrix but rather through random selection of letters. And the user can readily, temporarily, add another level or more (increase the value of r), and those changes are unknown to the cryptanalyst. It creates a great measure of security to the DMC user.

Since the highest level is of the lowest security, it may be desirable to use one or more ‘dummy’ levels above the actually used highest level.

Theory: The DMC may be reduced to a nominal cipher that generates an n-letters ciphertext from n-letters plaintext. As reviewed elsewhere a DMC operating with l levels may view a plaintext stream P comprised of letters p1, p2, . . . as a merged stream of l independent streams P1, P2, . . . Pl, as follows:

$$P 1 \text{:} p 1 , pl + 1 , p 2 l + 1 …$$

$$P 2 \text{:} p 2 , pl + 2 , p 2 l + 2 …$$

$$…$$

$$P l \text{:} pl , p 2 l , p 3 l …$$

In this interpretation the DMC may be regarded as a universal cipher because every plaintext stream of size n bits which encrypts by some other cipher to a ciphertext of n bits may also be encrypted to the same ciphertext, by creating a matrix with elements of size n letters. or by finding integers l, u v such that:

n=l*2u*v

and define a DMC with l levels, comprised of 2u over 2v size matrix where the elements will be all the strings of size u*v bits. Such a DMC by construction will encrypt every n bits long plaintext to the same n bits long ciphertext that the emulated cipher encrypts to.

Accordingly, any block cipher in particular may be associated with an equivalent DMC. For example 128 bits block size AES may be constructed via a 4 levels DMC with matrices the size of 16×16 bits comprised of 4 bits long elements. The DMC version of this instance of AES will be free of the AES concern for a mathematical shortcut, (at a price of a longer key), and will also compete well performance wise the AES computation.

### Drone Targeted Cryptography

### Swarms of Tiny Surveyors Fly, Stick, Hide Everywhere, Securely Communicating Via Solar Powered New Paradigm Cryptography.

Abstract: As flying, camera-bearing drones get smaller and lighter, they increasingly choke on the common ciphers as they interpret their commands, and send back their footage. New paradigm cryptography allows for minimum power, adjustable randomness security to step in, and enable this emerging technology to spy, follow, track, and detect. E.g.: to find survivors in a collapsed structure. We describe here a cryptographic premise where intensive computation is avoided, and security is achieved via non-complex processing of at-will size keys. The proposed approach is to increase the role of randomness, and to build ciphers that can handle any size key without choking on computation. Orthodox cryptography seeks to create a thorough mix between key bits and message bits, resulting in heavy-duty computation. Let's explore simple, fast ciphers that allow their user to adjust the security of the ciphertext by determining how much randomness to use. We present “Walk in the Park” cipher where the “walk” may be described through the series of visited spots (the plaintext), or, equivalently through a list of the traversed walkways (ciphertext). The “walking park” being the key, determines security by its size. Yet, the length of the “walk” is determined by the size of the plaintext, not the size of the “park”. We describe a use scenario for the proposed cipher: a drone taking videos of variable sensitivity and hence variable required security—handled by the size of the “park”. Keywords-low-power encryption, randomness, Trans-Vernam Cipher, User-Controlled Security.

Introduction: Flying drones are inherently invasive; they see what was previously hidden. There are many laudable applications for such invasive devices, e.g. search and rescue operations, catching fugitives, the war on terror, etc. Yet, very often drones violate someone's privacy, or even endanger national security, and hence the visual vista exposed by them should be treated with proper sensitivity, namely encryption. Alas, as drones become smaller, power becomes an issue, and modern ciphers which churn and mix key bits and message bits tend to require too much power to function. This challenge is addressed herein. We extend the introduction to discuss (i) the application environment, and (ii) the principles of the proposed solutions.

Application Environment: Flying drones can network, communicate, and coordinate movements and activities in support of a surveillance goal. They need to be securely controlled, securely coordinated, and securely deliver their collected data to their customer. This implies fast, effective cryptography. Alas, the drones are mini or micro size, lightweight, and short on power, so most of the mainstay ciphers will not be practical for them. Some attributes are discussed:

Speed: High speed, high-resolution cameras fitted on flying drones may be required to transmit to an operational center, to serve an important rescue operation, or other proper assignment. Similarly, an isolated device somewhere may be activated with a large stream of commands, most of them should be further transferred to devices down the line, exploiting directional microwave communication. All in all, a swarm of drones may need to accommodate high volume, high speed information exchange. The existing popular ciphers slow down that flow rate, and are not friendly to this requirement.

Maintenance: Quite a few flying drones will be placed in hard to access locations, and no physical maintenance will be feasible. They might use a solar power source and function indefinitely. Hence the use of any specific cipher, which at any moment may be mathematically breached, is a risky practice. This applies to all algorithmic complexity ciphers. As Prof. Nigel Smith articulates in his book “Cryptography (an Introduction)”: “At some point in the future we should expect our system to become broken, either through an improvement in computing power or an algorithmic breakthrough.” Normally, cryptography gravitates towards very few ciphers considered ‘secure’. If one of them is suddenly breached (e.g. GSM communication cipher), then all the “out of reach” nodes which rely on it, have lost their security, and physical attention is not practical.

Magnetic Vulnerability: Many flying drones are placed in very harsh environment, and are subject to lightening violence, as well as man made electromagnetic impacts. Software based cipher may be at greater risk.

In summary, flying drones in particular and IOT nodes in general are vulnerable both to malicious attack, and to environmental punishment. These vulnerabilities may be remedied to a large extent if we come up with a new cryptographic approach: Cryptography of Things (CoT).

Principles of the Proposed Solution: Modern cryptography erects security around data using two parameters: (i) algorithmic complexity, and (ii) randomness. It's generally believed that the more complex an algorithm the more secure the ciphertext, and also the more randomness that is being used (the larger the key), the more secure the ciphertext. Randomness is in a way dull, and of no much interest mathematically (except of course with respect to its definition and to metrics of quality). By contrast, algorithmic complexity is an exciting math dilemma. Academic cryptographers are attracted to this challenge and develop new and newer complex algorithms. Unfortunately in today's state of affairs, we only manage to compare complexities one to the other, not to ascertain their level in an objective mathematical way. And even if it turns out that P≠NP as most complexity researchers believe, in cryptography complexity is used in combination with randomness, hence one is using a random key selected from a large key space. What is hard to know is how many specific keys when applied with specific plaintexts, offer some mathematical vulnerability, leading to effective extraction of the message. In other words, the de facto complexity, or security of algorithms cannot be ascertained. Worried about this, we come up with increasingly complex algorithms, which require more and more computational effort. They in turn require more and more power—which many IOT nodes simply don't have.

Randomness, on the other hand, is passive memory, and even the smallest and most unsophisticated devices can be fitted with gigabytes of memory, serving as key. These realities lead one to aim to develop cryptography where the role of reliable, passive, manageable, secure randomness is enhanced, while the role of doubtful complex algorithms that are power hogs, is decreased.

This thinking brings to mind the famous Vernam cipher: the algorithm could not have been simpler, and the key could easily be as large as hundreds of gigabytes. So what? Memory is both cheap and light. It may be stored without requiring power. Too bad that Vernam is so impractical to use. Yet, can we re-analyze Vernam as a source of inspiration for security through more randomness and less algorithmic complexity? Let's envision a Vernam Inspired Cipher (VIC) where at any stage the user can ‘throw in a few more key bits’ and by that achieve a large increase of cryptanalytic burden, together with a modest increase of nominal processing burden (encryption, and decryption). Let us further demand from the VIC the Vernam property of achieving mathematical secrecy at the minimum key size required by Shannon's proof of perfect secrecy. To better analyze this vision let's regard any cryptographic key, k, as the natural number represented by binary interpretation of its bit sequence. Accordingly, the Vernam key space associated with n-bits long messages, will be: 1, 2, . . . (2ⁿ−1) corresponding to {00 . . . 0}ₙ to {11 . . . 1}ₙ. We may further agree that any natural number N=K>2ⁿ−1 will be hashed to an n-bits size string. Once we agree on the hashing procedure we have managed to recast Vernam cipher as a cipher that accepts any positive integer as a key, with which to encrypt any message m comprised of n bits to a corresponding ciphertext. We regard this as natural number key representation (NNKR).

We can similarly recast any cipher according to NNKR. We consider a cipher for which the series n₁, n₂, . . . nₘₐₓ represents the allowable bit counts for the keys. E.g for DES the series has one member n₁=nₘₐₓ=56; for AES the series contains three members: n₁=128, n₂=192, n₃=nₘₐₓ=256. For a cipher where the key is a prime number then the series is the series of primes. For ciphers defined over every bit string of length nₘₐₓ all the natural numbers from 0 to 2ⁿ−1 qualify as a nₘₐₓ key. Larger keys will be hashed to a nₘₐₓ bits long hash. For ciphers where the series n₁, n₂, . . . nₘₐₓ represents discrete possible keys, we may agree to hash any natural number to highest member of the list n₁, n₂, . . . which is lower than that natural number. For all natural numbers smaller than n₁, we will “hash” them to the null key (|K|=0), and we may formally agree that the case of K=NULL is the case of no encryption (the ciphertext is simply the plaintext). With the above definition we have recast all ciphers as accepting every natural number as a key.

We define the concept of “normal cipher” i as a cipher for which any valid metric of security, sᵢ, is never lower for larger keys. Say, for two positive integers K₁ and K₂ used as keys, and where K₁<K₂, we may write: sᵢ(K₁)≦sᵢ(K₂) In other words, with normal ciphers we “buy” security, and “pay” for it with a choice of a random number. Let sᵢ(K) be the security achieved by a user of cipher i, “investing” key K. The metric s, will reflect the average computational effort required of the cryptanalyst for extracting the message m from a captured ciphertext c, computed over the distribution of mεM, where M is the message space from which m is selected. Let pᵢ(K) be the average combined processing effort (encryption plus decryption) required of a user of cipher i, while using key, K, over the distribution of message mεM.

For any cipher i, using a natural number K as key, we may define the utility of the cipher at this point as the ratio between the cryptanalytic effort and the nominal processing effort:

Uᵢ(K)=sᵢ(K)/pᵢ(K) (1)

We can now define a Vernam Inspired Cipher as one where over some range of natural numbers K (K₁ . . . K₂) as key, the utility of the cipher will be somewhat stable:

U₁,Uₖ₁₊₁, . . . Uₖ₂˜U (2)

In that case a user encrypting with K₁ will be able to increase the security he builds around the data, while still using the same cipher, by simply ratcheting up the key from K₁ to K₂. She will then—again, using the same cipher—increase its associated security from s(K₁) to the higher value of s(K₂)

s(k₂)=s(k₁)+Σ(U(k+1)*p(k+1)−U(k)*p(k)) for k=k₁ to k=k₂=s(k₁)+(U(k₂)*p(k₂)−U(k₁)*p(k₁)) (3)

which is reduced to:

s(k₂)=s(k₁)+U*(p(k₂)−p(k₁)) (4)

Recasting cryptographic keys as natural numbers leads to redefinition of the key space, #K, as a subset of the natural numbers from 1 (or formally from zero) to the highest natural number to be considered as a key, #K=Kₘₐₓ:

#K≦kₘₐₓ (5)

And hence, for messages comprised of n bits, a key max of value 2ⁿ (Kₘₐₓ=2ⁿ) will allow for a cipher where the user could simply ratchet up the integer value used as key, K′<2ⁿ, to the point of achieving mathematical security. We can define a special case of a Vernam Inspired Cipher, as a Trans Vernam Cipher (TVC), being a cipher where increase in the integer value used as key will eventually reach “Vernam Security Levels”, or say, Shannon's security, for n-bits long messages:

sₘₐₓ=s(Kₘₐₓ=2ⁿ)=s(K′)+U(Kₘₐₓ)*p(Kₘₐₓ)−U(K′)*p(K′) (6)

Existence: It's readily clear that DES, AES and their like will not qualify as Vernam Inspired Ciphers. For DES:

s(k<2⁵⁶)=0

s(k>2⁵⁶)=s(k=2⁵⁶) (7)

For AES:

s(k<2¹²⁸)=0

s(2¹²⁸≦k<2¹⁹²)=s(k=2¹²⁸)

s(2¹⁹²≦k<2²⁵⁶)=s(k=2¹⁹²)

s(k>2²⁵⁶)=s(k=2²⁵⁶) (8)

The background ‘philosophy’ to casting key spaces onto the natural numbers is discussed in reference: [Samid 2001, and Samid 2016 (b).]

### “Walk-in-the-Park” Cipher

We present here a Trans-Vernam Cipher (TVC), that runs by the name Walk-in-the-Park because both encryption and decryption is taking place by “walking”—charting a path determined by the message, and then describing it through various entities in the “park” where the walk happens. It is based on the idea that a ‘walk’ can be described either via the places visited, or via the roads taken from one visited place to another. One needs the “park” (the key) to convert one description to the other.

The cipher is defined as follows:

We employ a four-letter alphabet: X, Y, Z, and W, expressed via 01,10,11,00 respectively. The key is a table (or matrix) of size u*2v bits, which houses some arrangement of the four alphabet letters (u*v letters in total). We regard every letter as a node of a graph, and regard any two horizontally or vertically contiguous letters as connected with an edge. So every letter marked on the graph has between 2 to 4 edges connecting it to other letters on the graph. (4 edges for middle nodes, 3 edges for boundary nodes, and 2 edges for corner nodes).

We define a path on the graph as a sequence of marked letters such that any two contiguous letters on the path are connected via an edge.

Informally, the cipher works by mapping the plaintext into a sequence of X,Y,Z, and W; then using this sequence to mark a pathway on the graph. Given an agreed upon starting point, it is possible to describe the very same graph via denoting the edges traversed by the pathway. Each node, or vertex on the graph has up to four edges; let's mark them Up, Down, Right, Left: U,D,R,L, and assign the bit combinations 01,10,00,11 respectively to them. The translation of the pathway from a sequence of vertices to a sequence of edges amounts to encrypting the plaintext to the ciphertext. And respectively for the reverse (decryption).

Why is this a Trans Vernam Cipher? Because the graph may be large or small. The larger it is the more security it provides. It may be so large that it will be a Vernam equivalent, and it may be so small that brute force will extract it relatively easily. The processing effort is not affected by the size of the graph, only by the length of the pathway, which is the size of the encrypted message. By analogy given a fixed walking speed, it takes the same time to walk, say, 10 miles on a straight stretch of a road, or zigzagging in a small backyard.

### Detailed Procedure:

1. Alphabet Conversion: Map a list of symbols to a three letters alphabet: X, Y, Z. By mapping every symbol to a string of 5 letters from the {X,Y,Z} alphabet. It is possible to map 3⁵=243 distinct symbols (a few less than the ASCII list of 256 symbols).

2. Message conversion: let m=m₀ be the message to be encrypted, written in the symbols listed in the 243 symbols list (essentially the ASCII list). Using the alphabet conversion in (1) map m₀ to m₃—a sequence of the 3 letters alphabet: X, Y, Z.

3. DeRepeat the Message: enter the letter W between every letter repletion in m₃, and so convert it to m₄. m₄ is a no-repeat sequence of the letters {X,Y,Z,W}. Add the letter W as the starting letter.

4. Construct a key: construct a u*v matrix with the letters {X,Y,Z,W} as its elements. The matrix will include at least one element for each of the four letters. The letters marking will abide by the ‘any sequence condition’ defined as follows: Let i≠j represent two different letters of the four {X,Y,Z,W}. At any given state let one of the u*v elements of the matrix be “in focus”. Focus can be shifted by moving one element horizontally (right or left), or one element vertically (up or down)—reminiscent of the Turing Machine. Such a focus shift from element to an adjacent element is called “a step”. The ‘any sequence condition’ mandates that for any element of the matrix marked by letter i, it will be possible to shift the focus from it to another element marked by the letter j, by taking steps that pass only through elements marked by the letter i. The ‘any sequence condition’ applies to any element of the matrix, for any pair of letters (i,j).

5. Select a starting point: Mark any matrix element designated as “W” as the starting point (focus element).

6. Build a pathway on the matrix reflecting the message (m₄): Use the {X,Y,Z,W} sequence defined by the m₄ version of the message, to mark a pathway (a succession of focus elements) through the matrix. The “any sequence condition” guarantees that whatever the sequence of m₄, it would be possible to mark a pathway, if one allows for as much expansion as necessary, when an ‘expansion’ is defined as repeating a letter any number of times.

7. Encrypt the pathway: Describe the identified pathway as a sequence of edges, starting from the starting point. This will be listed as a sequence of up, down, right, left {U,D,R,L} to be referred to as the ciphertext, c.

The so generated ciphertext (expressed as 2 bits per edge) is released through an insecure channel to the intended recipient. That recipient is assumed to have in her possession the following: (i) the alphabet conversion tables, (ii) the matrix, (iii) the identity of the starting point, and (iv) the ciphertext c. The intended recipient will carry out the following actions:

8. Reconstruct the Pathway: Beginning with the starting element, one would use the sequence of edges identified in the ciphertext, as a guide to chart the pathway that the writer identified on the same matrix.

9. Convert the pathway to a sequence of vertices: Once the pathway is marked, it is to be read as a sequence of vertices (the matrix elements identified by the letters {X,Y,Z,W}), resulting in an expanded version of the message, m₄ₑₓₚ. The expansion is expressed through any number of repetitions of the same letter in the sequence.

10. Reduce the Expanded Message (to m₄): replace any repetition of any letter in m₄ₑₓₚ with a single same letter: m₄ₑₓₚ→m₄

11. Reduce m₄ to m₃: eliminate all the W letters from m₄.

12. Convert m₃ to m₀: use the alphabet conversion table to convert m₃ to the original message m₀.

Illustration: Let the message to be encrypted be: m=m₀=“love”. Let the alphabet conversion table indicate the following:

l—XYZ
o—ZYX
v—XYZ
e—ZYY

Accordingly we map m₀ to m₃=XYZ ZYX XYZ ZYY.

We now convert m₃ to m₄=WXYZWZYXWXYZWZYWY.

We build a matrix that satisfies the ‘any sequence condition’:

### 1 2 3 X X Y

### 4 5 6=X W Y

### 7 8 9=Z Z Z

Using m₄ as a guide we mark a pathway on the matrix:

Pathway=5,2,3,6,9,6,5,8,9,6,3,2,5,2,3,6,9,8,5,8,9,6,5,6

The pathway may be read out through the traversed edges, regarded as the ciphertext, c:

c=URDDULDRUULDULDDLUDLULR.

In order to decrypt c, its recipient will have to use the matrix (the graph, the key, or say, “the walking park”), and interpret the sequence of edges in c to the visited vertices:

### Pathway=5, 2, 3, 6, 9, 6, 5, 8, 9, 6, 3, 2, 5, 2, 3, 6, 9, 8, 5, 8, 9, 6, 5, 6.

This is the same pathway marked by the ciphertext writer. Once it is marked on the matrix it can be read as a sequence of the visited vertices:

m₄ₑₓₚ=WXYYZYWZZZYYXWXYYZZWZZYWY.

Which is reduced m₄ₑₓₚ→m₄: WXYZWZYXWXYZWZYWY; Which, in turn, is reduced to the three letters alphabet: m₄→m₃=XYZ ZYX XYZ ZYY, which is converted to m=“love”

Walk-in-the-Park as a TVC: There are various procedures, which would translate the matrix (the key) into a natural number and vice versa. Here is a very simple one. Let k be a square matrix (key) as described above, comprised of u² letters. Each letter is marked with two bits, so one can list the matrix row by row and construct a bit sequence comprised of 2u² bits. That sequence corresponds to a non-negative integer, k. k will be unambiguously interpreted as the matrix that generated it. To transform a generic positive integer to a matrix, one would do the following: let N be any positive integer. Find u such that 2(u−1)²<N≦2u². Write N in binary and pad with zeros to the left such that the total number of bits is 2u². Map the 2u² bits onto a u² matrix, comprised of 2 bits elements, which can readily be interpreted as u² letters {X,Y,Z,W}. If the resultant matrix complies with the ‘any sequence’ condition, this matrix is the one corresponding to N. If not, then increment the 2u² bit long string, and check again. Keep incrementing and checking until a compliant matrix is found, this is the corresponding matrix (key) to N.

A more convenient way to map an arbitrary integer to a “Park” is as follows: let N an arbitrary positive integer written as bit string of N_{b} bits. Find two integers u≦v such that:

18uv≧N_{b}>18u(v−1)

Pad N with leftmost zeros so that N is expressed via a bit string of 18uv bits. Map these 18uv bits into a rectangular matrix of (3u)*(6v) bits. This matrix may be viewed as a tile of uv “park units” (or “unit parks”), where each unit is comprised of 18=3*6 bits, or say 3×3=9 letters: {X,Y,Z,W}.

There are 384 distinct arrangements of park units, when the bits are interpreted as letters from the {X,Y,Z,W} alphabet, and each unit is compliant with the ‘any sequence condition’. This can be calculated as follows: We mark a “park unit” with numbers 0-8:

$$\begin{matrix}4 & 3 & 2 \\ 5 & 0 & 1 \\ 6 & 7 & 8\end{matrix}$$

Let mark position 0 as W, positions 1,2,3 as X, positions 4,5 as Y, and positions 6,7,8 as Z. This configuration will be compliant with the ‘any sequence condition’. We may rotate the markings on all letter place holders: 1-8, 8 times. We can also mark, 1 as X, 2,3,4 as Y, and 5,6,7,8 as Z and write another distinct ‘any sequence compliant’ configuration. This configuration we can rotate 4 times and remain compliant. Finally we may mark 1 as X, 2,3,4,4 as Y, and 6,7,8 as Z, and rotate this configuration also 4 times. This computes to 8+4+4=16 distinct configuration. Any such configuration stands for the 4! permutations of the four letters, which results in the quoted number 384=16*4! We can mark these 384 distinct configurations of “park units” from 0 to 383. We then evaluate the ‘unit park integer’ (Nₚ) as the numeric value defined by stretching the 18 bits of the unit-park into a string. We then compute x=Nₚ mode 384, and choose configuration x (among the 384 distinct unit-park configurations), and write this configuration into this park unit. Since every ‘park unit’ is ‘any sequence compliant’ the entire matrix of (3u)*(6v) {X,Y,Z,W} letters is also ‘any sequence’ compliant. The resultant matrix of 18uv letters will challenge the cryptanalyst with a key space of: 384^{uv} keys. Alas, the cryptanalyst is not aware of u and v, which are part of the key secret. This special subset of ‘any sequence compliant’ matrices is a factor of 683 smaller than the number of all matrices (compliant and non-compliant): 683=2¹⁸/384 It is clear by construction that Walk-in-the-Park is a TVC: the key (the map) gets larger with larger integer keys, and for some given natural number kᵥₑᵣₙₐₘ a message m will result in a pathway free of any revisiting of any vertex. The resultant ciphertext can then be decrypted to any message of choice simply by constructing a matrix with the traversed vertices fitting that message.

Cryptanalysis: A 9-letters key as in the illustration above will be sufficient to encrypt any size of message m, simply because it is ‘any sequence compliant’. A large m will simply zigzag many times within this single “park unit”. A cryptanalyst who is aware of the size of the key will readily apply a successful brute force cryptanalysis (there are only 384 ‘any sequence’ compliant configuration of a 3×3 key, as is computed ahead). Clearly, the larger the size of the key the more daunting the cryptanalysis. Even if the pathway revisits just one vertex twice, the resultant cipher is not offering mathematical security, but for a sufficiently large map (key) the pathway may be drawn without revisitation of same vertices—exhibiting Vernam, (or say, perfect) secrecy.

Proof: let c be the captured ciphertext, comprised of |c| letters {U.D.R.L}. c marks a pathway on the matrix without re-visiting any vertex, and hence, for every message mεM (where M is the message space) such that |c|≧|m|, we may write:

Pr[M=m|C=c]=0.25^{|c|}

That is because every visited vertex may be any of the four letters {X,Y,Z,W}. Namely the probability of any message m to be the one used depends only on the size of the ciphertext, not on its content, so we may write: Pr[M=m|C=c]=Pr[M=m], which fits the Shannon definition of perfect secrecy. Clearly, if the path undergoes even one vertex re-visitation, then it implies a constraint on the identity of the revisited vertex, and some possible messages are excluded. And the more re-visitation, the more constraints, until all the equivocation is washed away, entropy collapses, and only computational intractability remains as a cryptanalytic obstacle.

This “Walk in the Park” cipher, by construction, is likely using only parts of the key (the graph) to encrypt any given message, m. When a key K is used for t messages: m₁, m₂, . . . mₜ, then we designate the used parts as Kₜ, and designate the unused parts as K₋ₜ. For all values of t=0, 1, 2, . . . we have Kₜ+K₋ₜ=K. And for t→∞ Lim K₋ₜ=0. By using a procedure called “tiling” it is possible to remove from the t known ciphertexts: c₁, c₂, cₜ, any clue as to the magnitude of K₋ₜ. Tiling is a procedure whereby the key matrix is spread to planar infinity by placing copies of the matrix one next to each other. Thereby the ciphertext, expressed as a sequence of U,D,R,L will appear stretched and without repetition, regardless of how small the matrix is. The cryptanalyst will not be able to distinguish from the shape of the ciphertext whether the pathway is drawn on a tiled graph or on a truly large matrix. Mathematically tiling is handled via modular arithmetic: any address (x,y) on a tiled matrix is interpreted as x mod u, and y mod v over the u*v matrix.

This tiling confusion may be exploited by a proper procedure for determining the starting point of the pathway.

Determining the Starting Point of the Pathway: In the simplest implementation, the starting point is fixed (must be a W element by construction of the pathway), for all messages. Alas, this quickly deteriorates the equivocation of the elements near the starting point. Alternatively the next starting point may be embedded in the previous encrypted message. Another alternative is to simply expose the starting point, and identify it alongside the ciphertext. This will allow the user to choose a random W element each time. As long as t<<uv the deterioration in security will be negligible.

A modification of the above, amounts to setting the address of the next starting point in the vicinity of the end point of the previous message. This will result in a configuration where consecutive pathways mark a more or less stretched out combined pathway. A cryptanalyst will be confounded as to whether this stretched combined pathway is marked on a large matrix, or on a tiled matrix.

And hence, regardless of how many messages were encrypted using the very same key, the cryptanalyst will face residual equivocation, and be denied the conclusive result as to the identity of the encrypted message.

Persistent Equivocation: A mistaken re-use of a Vernam key, totally destroys the full mathematical equivocation offered by a carefully encrypted message. Indeed, Vernam demands a fresh supply of random bits for each message used. By contrast, the “Walk in the Park” cipher exhibits residual equivocation despite re-use of the same key. Let us assume that the cryptanalyst knows the size of the key (3u*3v letters), let us further assume that the cryptanalyst also knows that the ‘any sequence condition’ was achieved by using the “park unit” strategy. In that case the key space will be of size: 384^{uv}. Let us also assume that the cryptanalyst knows the starting points for t encrypted messages. If by charting the t pathways, no re-visitation occurrence is found, then the cryptanalyst faces mathematical security. If there are h vertices which are visited by the t pathways at least twice, then even if we assume that the park units for all those h vertices suddenly become known, then the key space is reduced to 384^{uv-h} which deteriorates very slowly with h.

This cipher targets drone as a primary application, but clearly it extends its utility way beyond. In the present state the “Walk in the Park” cipher is an evolution of the ciphers described in reference [Samid 2002, Samid 2004].

### Usage Scenarios

We describe here a use case that is taken from a project under evaluation. It relates to swarms of tiny drones equipped with a versatile video camera. Each drone is extremely light, it has a small battery, and a solar cell. It is designed to land on flat or slanted objects like roofs. The camera streams to its operators a live video of the viewable vista. The drone requires encryption for interpretation of commands, communicating with other drones, and for transmitting videos. The high-powered multi mega pixel camera may be taping non sensitive areas like public roads; it may stream medium sensitive areas, like private back yards, and it may also stream down highly sensitive areas, like industrial and military zones. The micro drone may be dropped in the vicinity of operation, with no plans of retrieval. It should operate indefinitely. Using Walk-in-the-Park the drone will be equipped with three keys (matrices, graphs): 1. a small hardware key comprised of square flash memory of 500×500 {X,Y,Z,W} letters. This will amount to a key comprised of 500,000 bits. 2. A flash memory holding 1000×1000 {X,Y,Z,W} letters, comprising 2,000,000 bits. 3. A flash memory holding 7500×7500 {X,Y,Z,W} letters comprising 112,500,000 bits.

The latter key should provide perfect secrecy for about 6 gigabytes of data.

The determination of the security sensitivity of the photographed area (and the corresponding security level used) may be determined onboard the drone, or communicated from the reception center based on the transmitted pictures.

To achieve maximum speed the “Walk in the Park” cipher is written with “Turing Machine” simplicity: minimum number of operational registers, minimum operational memory; for every state (particular focus element in the matrix), the firmware reads the identity of the neighbors of the focus to decide where to shift the focus to, and output the direction of the shift as the next ciphertext letter. Decryption is symmetrically in the opposite direction.

### Summary Notes

We presented here a philosophy and a practice for Drone Cryptography, or more broadly: “Cryptography of Things” (CoT) geared towards Internet of Things applications. The CoT is mindful of processing parsimony, maintenance issues, and security versatility. The basic idea is to shift the burden of security away from power-hungry complex algorithms to variable levels of randomness matching the security needs per transmission. This paper presents the notion of Trans-Vernam Ciphers, and one may expect a wave of ciphers compliant with the TVC paradigm. It's expected that the IoT will become an indispensable entity in our collective well being, and at the same time that it should attract the same level of malice and harmful activity experienced by the Internet of People, and so, despite its enumerated limitations, the IoT will require new horizons of robust encryption to remain a positive factor in modern civil life.

### B3

### The BitMint Bundle Buy (B³) Disruption

### Consumer Leverage in the Age of Digitized Dollars

Two critical attributes of digitized dollars may be leveraged into a new consumer paradigm whereby today's retail profits will be shared by consumers and enablers. Money in a digitized format has no allocation ambiguity—a digitized dollar at any time point, exact as it may be, is under the control of its present owner. Money drawn on check may float, may default—digital money is always clearly assigned. The second critical feature of digitized money is that it may be tethered to any logical constraint, so that its control is determined by an unambiguous logical expression. These two features open an opportunity for a disruptive consumer-oriented initiative, exploiting online shopping.

At any given point of time countless of consumer products are being explored for prospective purchase by millions of online shoppers. Let P be such a prospective purchase. P is an item that is coveted by a large number of people, and identical specimen of it are being sold by many competent competing retailers. P may be a particular brand and size of flat screen TV, it may be a best-seller book, a popular video, an ordinary toaster, a trendy suitcase, etc. For starters lets exclude items that are not perfectly identical like flowers, meals, pets, airline tickets etc. Such standard items that qualify as P are being shopped for by say n=n(t) people at any given time, t. The n shoppers check out some r retail shops. Many shoppers inquire only with one retailer and purchase P, if the price seems right. Some shoppers compare two retailers, and fewer compare three. This “laziness” on the part of the shoppers motivates retailers to offer P at a price higher than their competitors, mindful that they may lose a few super diligent shoppers who meticulously compare all the r retailers.

Now, let's imagine that the n shoppers who at a given moment are all shopping for the same P are members of some union, or some organized group. And hence they are all aware of the fact that there are n of them, all shopping for the same product. Surely they would organize, elect themselves a leader and announce to the r retailers that they represent a market of n items of the P variety. The leader, armed with the market power of his group will pitch the r retailers into a cut throat competition. Let's add now an important assumption: each of the r retailers has n P items in stock, so each retailer can satisfy the entire group represented by that leader. The larger the value of n, the greater the stake for the retailers. The more robust the current profit from the P merchandise, the deeper the discount to be offered by the competing retailers. The leader accentuates the odds by saying that the entire order will go to the winning bidder. This means that for each retailer the difference between winning and losing is very meaningful, which in turn means that all retailers are desperate to win the bid.

It is clear that the organized shoppers enjoy a big discount on account of them being organized. Now back to the surfing n online shoppers who are not organized, and are not mutually aware. These shoppers are the target of this B³ concept:

B³ is an enterprise whose website is inviting shoppers for P to browse. When they do they see a list of the r retailers and their prices. For sake of illustration let the r retailers offer consumer product P at a price range $105-$115. Each browser will be pointed out to the cheaper retailer. But she will also find a proposal: “Let us buy P for you for a price of $95, substantially cheaper than the cheapest retail price. We will buy this from one of these reputable retailers and they would contact you with respect to shipping. Since all P products are identical, the browser will have no rational grounds to refuse the offer (assuming that B³ has established its reputation). Doing the same with all n shoppers the B³ website will amass a bidding response sum of B=$95*n dollars. Armed with the bidding money, $B, B³ will challenge the r retailers to compete. Let the most competitive retailer bid for $90 per item. B³ will accept the bid, immediately pay the winning retailer $90n, and the winning retailer will soon contact the shoppers about shipping cost and other administrative matters. The difference between the price paid by the shopper, and the price paid by B³ to the retailer is the B³ profit: $(95−90)n. When done, the shoppers will have enjoyed a great discount, B³ will become nicely profitable. Indeed, the previous profit margins enjoyed by the retailers are now shared with the consumer and B³.

Now where does digital money come in? There are two modes of implementation of this B³ ad hoc grouping idea: (i) B³ secures a commitment from the shoppers to pay the agreed upon sum of $95 in the event that B³ finds a seller, and (ii) B³ collects the $95 from the shopper, expecting to find a seller later. Both modes are problematic. In the first mode, there will be a percentage of regrets. Some consumers will change their mind so B³ will not have the money to pay the winning seller who agreed on a price per a definite quantity. In the second mode, in the event that no deal is consummated, then all the shoppers will have to be reimbursed and someone will have to carry the chargeback cost.

These issues disappear with digitized money ($). The shopper will tether a digital coin in the amount of $95. The tethered coin will remain in the possession of the shopper, only that for a window of time, say 3 hours, 6 hours, 24, or alike, B³ will have the right to use this money (pay with it). If this right was exercised the owner loses the coin, (and gets the merchandise), if not, then without any further action, no chargeback, the digital coin remains as it was before, in the possession of its owner. When B³ initiates the competition among the r retailers, then each retailer knows that if its bid is the winning bid, then the money will be instantly transmitted to that retailer—the money is ready, available, and in digitized form so that the retailer may either keep it digital, or redeem it to the old accounting mode at a cost of 0.5% which is far less than the prevailing payment card fees.

Much as a car dealer will not offer a rock bottom price to a casual browser, only to a serious shopper ready to buy, so this B³ idea will not fly except with the tantalizing feature of ready money, paid on the spot to the winning retailer.

One Item Illustration:

Alice shops for a pair of sneakers, and finds them in Amazon for $95; she finds the same at Target for $91. But she buys not in either store, in turn she submits a query for these sneakers to B³. B³ fast computers quickly queries a large number of retailers for the price and availability for the same product, then the B³ smart algorithm offers to Alice to pay it $83, and in a few hours she either gets a confirmation of shipment from some reputable retailer, or the money automatically returns to her wallet. B³ quotes $83 because its algorithms predict that it could bundle the sneakers in a large list of items, and the return bid will be so low that it would amount to B³ paying for the sneakers only $79, which will leave B³ with a $4.00 revenue from which to pay for its operation, and make a profit.

Bundle Illustration:

(please refer to the table below). Let's illustrate the B³ dynamics as follows: 10 shoppers are online at the same time, each buying another widget (w1, w2, . . . w10). Each, checks one, or two of the primary three retailers who offer those widgets (Retailers: R1, R2, and R3). The actual prices for the 10 widgets by the three retailers are shown in the illustration table. A diligent shopper will check all three retailers and order (the same widget) from the best offer. But most shoppers will check one, may be two retailers, and rush to buy.

Now we imagine a world where B³ operates, and the 10 shoppers check, each their widget, with B³ website. The B³ algorithm, for each widget, quickly checks all the relevant retailers (in our illustration there are three R1, R2, R3), and based on their pricing at the moment, the B³ algorithm projects the discount price associated with the lowest bid of these retailers. So, for example for the first widget (w1) the prices offered by the retailers are: $40, $41, $39. B³ will estimate that the lowest bid will be associated with discount price for w1 of $37. Then B³ computes the price to quote to the first shopper. In our example the quoted price is 5% higher than the estimated bidding price: $38.85. The shopper is assured by B³ that the quote is lower than the best price available online right now, and then B³ offers the shopper the following deal: “You pay me my quoted price $38.85, and you are most likely to get an email from one the three retailers (R1, R2, or R3) notifying you that one count of widget w1 is being shipped to you.” The shopper is happy, she got a better price!

B³ will bundle all the 10 widgets to which similar offers have been extended, and accepted, and rush a request for bid to all three retailers (R1, R2, and R3). Retailer one computes his retails prices for the 10 widget and it comes to $332.00. The retailer will quickly evaluate its inventory situation with respect to all the widgets, and other factors, and decide how great discount to offer for each widget. Only that the per-widget discount is not forwarded to B³. The only number that is sent back is the bidding figure, which is $292.16 (see table), which is 12% summary discount for all the widgets put together.

B³ at its end, will summarize all the money it got from the 10 shoppers which according to the illustration table is $305.55, and use this figure as its threshold for acceptance. Should the best bid come higher than that figure of $305.55, then no bid will be accepted because the threshold sum is the money actually collected by B³—there is no more. If that sum is lower than the best bid, then B³ has ill modeled the pricing.

In the case in the illustration table, R3 offers the lowest bid: $285.12, and B³ instantly accept the bid, sends the BitMint digital coins to R3, and pockets the difference between what B³ collected from the shoppers, and what retailer R3 is bidding for: $324.00−$285.12=$20.43. This operating income now funds the B³ operation and generates the B³ profit. See table below:

B3 Bundle Illustration

| | | | | | B3 Bid | | B3 |
|---|---|---|---|---|---|---|---|
| Buyer | widget | R1 | R2 | R3 | Estimate | | Offer |
| 1 | w1 | $40.00 | $41.00 | $39.00 | $37.00 | | $38.85 |
| 2 | w2 | $23.00 | $23.00 | $22.00 | $20.00 | | $21.00 |
| 3 | w3 | $8.00 | $9.00 | $9.00 | $7.00 | | $7.35 |
| 4 | w4 | $55.00 | $54.00 | $52.00 | $47.00 | | $49.35 |
| 5 | w5 | $34.00 | $33.00 | $36.00 | $31.00 | | $32.55 |
| 6 | w6 | $73.00 | $71.00 | $70.00 | $66.00 | | $69.30 |
| 7 | w7 | $11.00 | $12.00 | $10.00 | $8.00 | | $8.40 |
| 8 | w8 | $40.00 | $40.00 | $40.00 | $35.00 | | $36.75 |
| 9 | w9 | $14.00 | $14.00 | $13.00 | $11.00 | | $11.55 |
| 10 | w10 | $34.00 | $36.00 | $33.00 | $29.00 | | $30.45 |
| | | | | | -′ | | --′ |
| | Retail | $332.00 | $333.00 | $324.00 | 291 | acceptance | $305.55 |
| | Price | | | | | threshold | |
| | Bid (−12%) | $292.16 | $293.04 | $285.12 | | | |

| | |
|---|---|
| B3 Income: | $20.43 |

Viability Analysis:

On its face, the B³ concept will be robbing powerful large online retailers from the bulk of their profit margins. One should expect then a serious concerted backlash. However, since B³ can be headquartered anywhere in cyberspace, it is hard to see a successful legal challenge to it.

Only in its full maturity will B³ be recognized as the disruptive development that it is, but by then it is likely to be too late for any efforts to stop it. B³ will start over limited items, say only a bestseller book, or a popular brand watch, etc. The overall impact will be minimal, the volume of the deal unimpressive. But through these small steps B³ will gradually become a shopping fixture, get shoppers hooked, and swell.

There is no reason to limit the competition between the retailers to one consumer product, “P”. B³ will assemble shopping requests to many qualified consumer products, and package them all into a single “auction” (or any other form of competition).

The B³ concept may be implemented in a rich variety, giving a large space for improvement and optimization. Obviously, the larger the shopping bid, the greater the discount to be offered by the retailers, because more is at stake, and the impact of winning or losing is greater. Also clear is that the greater the variety of products bundled together by B³, the greater the discount and the greater the profit of B³ because different retailers will have different incentives to get rid of cumulative inventory, and offer it at a lower price. In normal shopping situations retailers will be reluctant to offer too low a price for items, no matter the financial incentive, because it would annoy customers. But in the B³ format there is no disclosure of how low a price is offered per item—only the sum total is communicated by the retailer to B³.

Retailers will be queried before the price competition on their inventories. Different retailers will report different stock for different items. B³ will then define a package that represents the minimum combination such that all qualified retailers can each fulfill the entire order, to make it equal opportunity for the retailers. Of course, a retailer who consistently reports low inventories will be excluded from the competition. Same for retailers that when they win they become tardy, or difficult with the shoppers to which they need to ship the merchandise.

In the beginning B³ will work with large nationally recognized online retailers, but over time smaller retailers will apply to participate. B³ will encourage such participation—the more that compete, the greater the discount. Some specialty retailers might wish to join, and B³ will respond by tailoring packages for their capacity.

B³ will operate sophisticated computers, compiling all available relevant data to offer bolder and bolder prices for the browsing shoppers, so as to increase the B³ popularity and profits. The greater the discounts the more popular B³ will become: more retailers will opt in, and more shoppers will be tempted to use it.

The price competition may be in a form of an open auction, or reverse auction, one may say: what is auctioned off, is not any product or article, it is rather the opportunity to receive a purchase order for the supply a bundle of merchandise each to its designated shopper. The retailer who promises to fulfill this purchase order at the lowest price is the winner (among the pre-qualified retailers). It may turn out that a closed, secret price competition is more advantageous, experience will tell.

The psychological lure for a retailer is the fact that once a retailer's bid is accepted, the money is instantly passed on en bulk because B³ has the money ready for payment. The winning retailer will also receive the list of shoppers and their contact info, so that it can contact its customers. B³ paid for the listed shoppers, but these shoppers are the customers of the winning retailer. The retailer and its customer discuss shipping arrangements, warranties, etc.

Return Policy

The case of merchandise return will have to be negotiated among the retailer, B³, and the customer. In principle it has some complications, but since the percentage of return is minimal, this is not too much of a problem. Admittedly though, the ‘return’ issue may become a weak point for the B³ solution, and one which the suffering retailers might exploit.

In its maturity B³ will charge the shoppers from their digitized dollars wallet. But in the beginning the B³ customer will pay B³ via a credit card. B³ will immediately transact with the digitized dollars mint, and buy the digital coin that is owned (tethered) to the individual customer of B³, but that is spendable during the coming, say, 6 hours, by B³. If the money is not spent by B³ within that window of time, the money automatically becomes spendable and controlled by the original buyer of the digitized money.

Outlook: Today large national retailers compete mildly in a silent co-survivors balance. A cut-throat competition will rob all of them, winners included, of their present fat profit cushion. And therefore we find one item cheaper at Amazon and another cheaper at BestBuy. This situation also gives room for not so efficient retailers. A wide sweeping B³ disruption will inject a much stronger competition that would weed out the sub-efficient retailers, and benefit the consumers.

The use of digitized dollars in this B³ scheme will usher in the era of digitized payment digitized banking, and digitized saving and investment.

Cyber-Passport

### Identity Theft Prevention & Recovery Legislation

Imagine that a government report finds that 7% of US passports in use today, are counterfeits. An emergency task force will be assembled, and charged to come up with a quick and resolute solution to this gross offense to civil order. Yet, every year more than 7% of US adult population becomes victims of identity theft. Many more than, say, people infected by asthma. Why then does Asthma attract a major government counter-action, and identity theft attracts a major campaign of warnings, alarms, and hand wringing? Because too many cyber security leaders believe that outsmarting the fraudsters is imminent. Our overconfidence destroys us. It's time for a grand admission: we are losing this war. The government needs to help the victims, and carb the growth of this plague. Both should address the fundamental fact: once a person's social security number, date of birth, place of birth, mother's maiden name, and biometrics are stolen, the victim is forever vulnerable because those personal parameters are immutable. Therefore the government should issue a limited life span personal id: cyber passport, and mandate that any contact with the government, like filing taxes, would require this cyber passport code. Same for opening accounts, or withdrawing money form bank accounts, etc. A cyber passport valid for a year, when compromised, (and the theft is not detected) will serve the thief on average only for six months. Beyond that having the victim's permanent data attributes will not suffice. Anyone that realizes that his or her cyber passport was stolen, could immediately request a replacement. The legislation will not mandate citizens to sign up, but will require institutions to verify cyber passport for any listed activity. The more victims, the greater the expected participation in the program. High risk individuals could be issued a new cyber passport every six months, others may be, every two or three years. The cyber passport will be issued based on physical presence of the person to whom it is issued, with robust biometric identification. Based on the cost of the aftermath, the front-end cost of issuing the cyber passport will be minimal. Administered right, the cyber passport will void the benefit cyber frauds enjoy today from holding immutable attributes of their victims. To continue and abuse their victim, they will have to steal the fresh and valid cyber passport, and that would be harder than before.

The transmission, and storage of the newly issued cyber passports will be governed by legislation exploiting modern cryptography: (1) verification databases will hold a cryptographic image of the cyber passport (e.g. hash), so that thieves will not be able to produce the cyber passports even if they break into that database; (2) cyber passports per se will not be transmitted online. Instead, a cryptographic dialogue will accomplish the same goal, while denying an eavesdropper the chance to learn how to steal the user identity the next time around.

The Cyber Passport initiative is one for which only the government will do. It has to be nation-wide, although it can be administered by states honoring each other codes (like with driving licenses), and it must be accompanied by legislation that will enforce established security standards for data in storage and data on the move. The initiative will require an effective instant validation apparatus, much like the ones used by credit card companies to authorize payments.

Should we make progress in the war against identity theft, then the life span of those passports will be extended. What is most powerful is the ability of any citizen to request a new passport any time he or she even suspects a compromise. People will be ready to pay a modest fee to avoid the nightmare of identity theft.

The cyber passport initiative should first cover the increasing number of victims who find themselves abused time and again because their permanent personal data is in the hands of thieves. Victims who would be issued cyber passport will so inform their banks, their medical practitioners and others, who by law, will have then to request the cyber passport any time someone with that name attempts contact. The government will inform the IRS and other departments of the cyber passports, and no one with a passport will again face a situation where the IRS refunded someone else in his name. As the program works, it will gradually expand.

Should there by another “Target” or “Home Depot”, then all affected customers will be issued a fresh cyber passport, and thus greatly limit the damage.

For many years automotive designers believed that soon cars will be better engineered, safer, and accidents will ebb. We are making some progress, but we do install seat belts and air-bags, admitting that deadly crashes do happen. Similarly here, let's admit that the 7% plus of Americans falling victims annually to cyber crime is worrisome, and is not going to be cured overnight, and hence let's invest in the means to cut short the life span of each fraud event.

The cyber passport may be short enough to be memorized. For instance: a three letters string combined with five digits: ABC-12345 will allow for a range of 1.7 billions codes. The letters and the digits should be totally randomized, although one is tempted to use the code to convey all sorts of information about the person. The codes should be issued against a physical presence of a government official and the identified person. Biometrics, pictures, and documents will be used to insure correct identification. Banks and state offices will be commissioned to issue these passports. People who are sick and can't come to a code issuing station, will be visited by government officials.

Misc. Innovative Add Ons

### CrypTerminal: A Cryptographic Terminal Gadget

### Secure Reading and Writing of Data

A physical device comprised of: (1) data input options, (2) data output options, (3) a cryptographic cipher. The Terminal is positively unconnected to any network, and any other means of information exchange. The Purpose: to securely encrypt and decrypt data

### A Transposition Representation of Complete Block Ciphers

Every block cipher (blockₚₗₐᵢₙₜₑₓₜ=>block_{ciphertext}) may be represented via a positive integer as key, by transforming the block encryption to an ultimate transposition cipher. We know that transposition of any permutation to another can be accomplished via an integer, k, as a key (1<=k<=N for some finite N). We can therefore extend the plaintext block to an extended size to insure that the extended block can be transposed such that the leftmost portion of the transposition will match the designated ciphertext block. Let p be a plaintext block of t letters, drawn from an n letters alphabet. Let c be a ciphertext block of any t letters, drawn from the same n letters alphabet. Some block cipher BC will encrypt p to c. The same transformation p->c may be accomplished as follows: let us add nt letters to the plaintext block to construct the extended block so as to insure that when the extended block is properly transposed, the t leftmost letters in it will match the designated ciphertext block. The transposition key that would effect such a transposition will be the key that encrypts the plaintext block, p, into the ciphertext block, c. Illustration: we consider a four letter alphabet: X, Y, Z, W. We then consider a plaintext block p=XYY, and a ciphertext block c=YYW. We now extend p to the extended block e=eₚ, by adding nt=4*3=12 letters by order:

eₚ=XYY XXX YYY ZZZ WWW

By using a transposition key k=21, effecting the key transposition discussed in the reference [ ], the plaintext version of the extended block eₚ will be transposed to the ciphertext version of the same. e_{c}:

e_{c}=YYWZZWYYXZYXXXW

where the three leftmost letters fit the designated ciphertext block: c=YYW

By adding t instances of each of the n letters in the alphabet, one insures that whatever the desired ciphertext, there will be enough letters in the extended block to allow for a permutation of that block to construct that ciphertext.

One implication of this construction is to argue that any two t-size block, p and c may be equally “distant” from each other, since every such pair can be matched with some key, k, selected from a finite count of natural numbers. This is important in light of the perceived complexity of block ciphers. Block ciphers are regarded as high quality if flipping a single bit in the plaintext, creates a “vastly different” ciphertext, with various arbitrary metrics devised to capture that “distance”. From the point of view of the transposition representation of block ciphers, all blocks are of equal distance. A point that may suggest new avenues for cryptanalysis.

This transposition representation of block ciphers may also be further extended to serve as complete block cipher (CBC), as follows: An arbitrary block cipher operated with an arbitrary key, k, will match any given plaintext block p with some ciphertext block c. We will show how to build a transposition representation of it such that a transposition key kₜ will be equivalent to k for any pair (p,c). We start by adding nt letters to all the t letters blocks. For each such plaintext block (there are b=n^{t} such block) the extended version (comprised of t(n+1) letters), there are (tn)! transposition keys that would result in transposing the extended plaintext block eₚ to a corresponding permutation, e_{c} such that the t leftmost letters are the desired ciphertext block. A randomly selected kₜ has a chance of t=(tn)!/((t(n+1))! to encrypt a given p to a given c. And the chance for a random kₜ to encrypt each of the b=n^{t} possible p blocks to their respective c is: πₐₗₗ=((tn)!/((t(n+1))!)^{b}. However, instead of adding nt letters to p, we may add r times the same: rit, and in that case we have

πₐₗₗ=((rtn)!/((t(rn+1))!)^{nt}

Clearly one can choose r sufficiently large to insure πₐ₁₁->1 to insure that a single transposition key (integer) will emulate any arbitrary block cipher.

There is a chance π(nt) for at least a single transposition key, kₜ

proof that any two blocks are a number away so all blocks are as far apart by their pattern and order as much as two permutations are

By extended e to be sufficiently large this can be complete.

### Paid Computing—A Cyber Security Strategy

Requiring digital payment for use of every computing resource, at fair price. Bona fide users are given a tailored computing budget, and operate unencumbered. Hackers will be unable to fake the required digital money, only steal it in small measures from bona fide users who will report the theft timely, and stop the hackers.

### Shannon Secrecy

Given a tensorial cryptographic key K=TₚT_{c}, it is clear that the first n blocks will enjoy Shannon secrecy because given an arbitrary sequence of n plaintext block and corresponding n ciphertext blocks, one could build a tensorial key, K such that the n pairs will fit, namely, there exist a key that matches the arbitrary plaintext blocks with the n arbitrary ciphertext blocks, such a situation implies that given n ciphertext blocks, every possible combination of n plaintext blocks is a valid corresponding plaintext with a chance of n^{-t} to be the one used to generate the given ciphertext. This is the same probability for the set of possible plaintext blocks, calculated without knowing the identity of the ciphertext, which implies Vernam security. Accordingly a user could apply an ultimate transposition act on the conversion matrix, at which point n more blocks will be encrypted while maintaining Shannon secrecy. The t P-arrays in the key can be transposed in t! ways, so all together the user will be able to encrypt n*(t!) blocks while maintaining Shannon secrecy. When all this plaintext quantity has been exhausted, the user could apply the ultimate transposition operation over the 2t arrays, such that none of the 2t arrays will be marked by a transposition that was used before. There are n! transpositions, per array; each round of their transposition excludes 2t from them. So the user would be able to use this operation n!/2t times. Or, say, the total number of blocks that can operate with these two levels of transpositions is: (n!/2t)*n*(t!) blocks, or t(n!/2t)*n*(t!) letters. So for base-64 a letter is 6 bits long, there are 2⁶=64 letters, t=6, the number of blocks without any transposition that can be encrypted with Shannon secrecy is: n=64, or 64*6=384 letters or 384*6=2304 bits. And with transposition of the conversion matrix: 2304*(6)!=1,658,880 bits or about 0.2 megabyte. And with the secondary transposition this number will be multiplied by (n!)/2t=1.06*108, or 2.11*107 gigabyte. The motivation for these proposed cryptographic tensors is the proposed principle that any complexity that is founded on moving away from randomness into arbitrary choices may offer a cryptanalytic hurdle against expected adversarial strategies, but is equally likely to pose cryptanalytic opportunities to unexpected strategies. Only randomness offers the rational assurance that no hidden mathematical shortcuts expose our ciphers to a smarter adversary.

### Tensorial Symmetry

Given [p]TₚT_{c}[c], it is easy to see that we also have: [c]T_{c}Tₚ[p]: the plaintext block and the ciphertext block are symmetrical, and interchangeable. An alien observer who is ignorant about the language in which the plaintext (and the ciphertext) are written, would not be able to distinguish between the two blocks, which is the plaintext, and which is the ciphertext. That observer may study what the ciphertext recipients are doing as a result of receiving a ciphertext, and thereby infer, and study the “ciphertext language”. As long as the encryption key would not change, the alien observer may be equally successful deciphering the ciphertext language as deciphering the plaintext language. This suggests an avenue of research into homomorphic cryptography—the essence of the data is independent of the language it is written in.

### Tensorial Inherence

Tensorial calculus was motivated, and accomplished the description of multi-dimensional entities without tying them down to any particular coordinate system. One may conjecture that further development will cast cryptographic payloads independent of whether they are p-expressed or c-expressed.

### T-Proof Secure Communication (TSC)

### A User-Determined Security for Online Communication Between Secret Sharing Parties.

### Open-Ended Randomization Counterpart to Erosive Intractability Algorithms

Abstract: Promoting the idea that open-ended randomness is a valid counterpart to algorithmic complexity, we propose a cipher exercised over user-determined measure of randomness, and processed with such simple computation that the risk of a surprise compromising mathematical insight vanishes. Moreover, since the level of randomness is user-determined, so is the level of the practiced security. The implications are that responsibility for the security of the communication shifts to the user. Much as a speeding driver cannot point the finger at the car manufacturer, so the communication parties will not be able to lay any blame on the algorithm designer. The variable randomness protocols are much faster, and less energy consuming than their algorithmic counterparts. The proposed TSC is based on T-Proof, a protocol that establishes a secure shared fully randomized, non-algorithmic transposition key for any desired n-size permutation list. Since the users determine n, they also determine the size of the key space (n!), and the level of the exercised security. The T-Proof ultimate transposition protocol may also be leveraged to induce any level of terminal equivocation (up to Vernam-size) and diminish at will (and at price) the prospect of a successful cryptanalysis.

### Introduction

Transposition—arguably—is the most basic cryptographic primitive: it requires no separate table of alphabet, and its intractability is rising super exponentially. A list of n distinct data units may be transposed to n! permutations. So a block of say 500 bits divided to 10 bits at a time can be transposed up to 3.04*10⁶⁴ permutations. If the transposition key is randomly selected then the cryptanalytic intractability is satisfactory. Assuming two parties agree to permutations based on u bits at time (in the above example u=10). The parties may also agree on the size of the block, b bits, which will determine the permutation list as comprised of n=b/u elements. Thereby they will determine the intractability (n!) of their communication.

To accomplish this simple primitive all they need is to share a transposition key of the proper size. A transposition key, Kₜ may be expressed as a 2×n size table that identifies that the element in position i (1≦i≦n) in the pre-transposition string will be found in position j (1≦j≦n) in the post-transposition string, applicable to all the n elements in the list.

If the parties wish to make the security ad-hoc, and determined per session, they will need to find a way to share a transposition key for arbitrary n. It is theoretically possible for the parties to share a sufficiently large number of transposition keys for various values of n, but this is certainly cumbersome, complicated, and is very inconvenient for refreshing the keys once established.

Alternatively the required transposition key will be computed using some pseudo-random generator. But in this case the seed for the PRNG may be compromised and doom the cipher.

That is the background over which the TSC is proposed. The idea is to use the T-Proof protocol [Samid 2016 (C)]. This protocol allows a prover to prove to a verifier that she holds a certain ID or shared secret, s, also known to the verifier. The T-Proof protocol has two essential parts: (i) dividing the secret (s) string to some n non-repeat substrings, and (ii) using a non-algorithmic randomization process to transpose the identified n substrings to a transposed s: sₜ. Both the prover and the verifier, aware of s, will know how to divide s to the same n non-repeat substrings. The verifier will then readily ascertain that sₜ is a strict permutation of s based on these n substrings, and thereby verify that the prover indeed is in possession of the claimed shared secret s.

When this T-Proof protocol is exercised the verifier well knows how s was transposed to sₜ, and can readily build the transposition key Kₜ that corresponds to that conversion: sₜ=T(s, Kₜ). We recall that that transposition key Kₜ was gleaned from some physical source, like “white noise”, and hence is not vulnerable to compromise.

The T-Proof protocol may be used with a nonce, r that will mix with the secret s to generate a combined string q=mix(s,r). The division to substrings will take place over q instead of over s, and thereby the parties will foil any attempt to use the replay strategy to falsely claim possession of s. Accordingly, T-Proof can be mutually applied, each party chooses a different nonce to challenge the other.

Having exercised this T-Proof protocol the parties are convinced about the other party identity and about sharing the secret s. They can now proceed with symmetric communication. It would be based on the shared knowledge of the transposition key, Kₜ, that was passed from one to the other as they exercised the T-Proof protocol. A stranger unaware of s, will not be in possession of Kₜ. Yet Kₜ was derived from a physical source, not an algorithmic source, and here lies the power of this cipher method. The parties will be able to use Kt for any further communication. Either directly as we shall describe ahead, or within some more involved procedure, as they pre agree, or even agree in the open per session because the security of the method is based on the fact that Kₜ is drawn from a physical source, the chance for any key to be selected is 1/n! for n-items permutations, and Kₜ is shared only by the communicating parties.

The parties may now agree in the open on the per session unit size, u bits per substring (letter), and then compute the per session block size to be b=un bits. They will be able to communicate with each other with these blocks applying Kₜ for each block.

These choices of the number of transposed elements, and the size of the transposed element, may be made per-session, responsive to the sensitivity of the contents. Also the size of the shared secret (s) is a users' choice, which must be made earlier than when the parties are ready to communicate. The security of the cipher relates directly, and predictably to these user choices, which implies a shift of the responsibility for the uncompromised communication to the communicating parties. One might argue that other ciphers, say RSA, also exhibit a measure of security directly related to the size of the security parameters (for RSA the user may determine the size of the selected primes). However, RSA like the other ciphers which are based on algorithmic complexity, does not have the same solid probabilistic assessment of cryptanalytic intractability, and what is more, the nominal encryption and decryption effort is rising exponentially with the size of the security parameters. With TSC the relationship of operational effort to the size of the security parameters is by and large strictly proportional.

That is the essence of TSC. Its attraction is based on (i) the non-algorithmic randomness of the transposition key, and on (ii) the user determined security level—by choosing the size of transposition list.

### The Basic Protocol

Alice and Bob share a secret s. They contact each other online, and mutually apply the T-Proof protocol on each other to assure themselves that they talk to the right party.

The two applications of the T-Proof procedure resulted in having two shared transposition keys (Kₜₐ, K_{tb}). They may choose one, or choose the two such that each of them will communicate to the other using one of the two transposition keys. Alternatively they may combine these two keys to a single transposition key, Kₜ.

According to the T-Proof protocol Kₜ is perfectly randomized, created through white noise or from other real-life random source.

If n is too large or too small, the parties can agree on a different nonce, repeat the T-Proof procedure and do so as many times as necessary until they get a satisfactory value for n. They can also apply a simple procedure to reduce the number of permutation elements to the desired value (discussed ahead). Since n is larger for larger a pre-transposition T-Proof string (q), it is easy to gauge the value of the nonce (r) and the parameters of the mixing formula q=mix(s,r) to achieve the desired value of n.

The next step: Alice and Bob agree on a ‘letter size,’ namely the bit size of a substring that will be interpreted as the letters in which a given block of data is written in. That size, u bits will then be used to compute the block size of their communication: b=un.

Alice and Bob can now use Kₜ to communicate any data flow between them taken one block of b-bits at a time.

Illustration:

Alice and Bob share a secret s=7855 (s=1111010101111). Alice sends Bob a nonce rₐ=14. They both agree on a simple mix function q=mix(s,rₐ) q=s−rₐ=7841 or q=1111010100001. Alice and Bob both break up q to substrings using the incremental method where each letter is larger by one bit than the one before it (except the last one): 1, 11, 101, 0100, 001 Alice then uses a physical random number generator to generate a transposition key, Kₜ:

$$\begin{matrix}1 & 2 & 3 & 4 & 5 \\ 3 & 1 & 5 & 4 & 2\end{matrix}$$

Accordingly, Alice transposes q to qₜ=101, 1, 001, 0100, 11 and sends it to Bob: qₜ=1011001010011. Bob aware of q and of how to break q to substrings will then examine qₜ that Alice sent him in order to verify that qₜ is indeed a permutation of q based on the known substrings. To do so Bob will first look for an image of the largest letter (substring) 0100. This letter fits only in one place on qₜ=1011001 [symbol] 11 Then Bob will place one of the second largest letters: 101. qₜ= [symbol] 1001 [symbol] 11 Bob then, very easily, fits all the remaining letters (substrings) on qₜ, and by then he achieves two objectives: (i) Bob convinces himself that the counter party who claims to be Alice, is indeed Alice, since she communicates in a way that only the holder of the secret s could communicate. And (ii) Bob now has the random transposition key, Kₜ that Alice uses to transpose q to qₜ.

Bob then wishes to securely pass to Alice his bank account number: 87631-97611-89121. Using Kₜ, Bob will communicate to Alice: 68137-69117-18129, which Alice, using the shared Kₜ will readily decrypt. Alice and Bob could agree on, say, 3 bits letters, and hence the account will be written as: 876-319-761-189-121, and the encrypted version will look like: 761876121189319. Or they use the binary representation: 10101101001110110000011011100100001111101111000111, with letters of size u=2. The account number will be comprised of 25 two-bits letters, and every group of five will be communicated after being transposed with Kₜ. The parties would agree on how to handle the case where some bits must be padded from one end or the other to fit into the designated groups. Alice and Bob can also agree that when Alice writes to Bob she uses the Kₜ he used to prove his bona fide to her, and vice versa. Or, they can combine the two keys to one, applying one after the other, resulting in a third, combined key. And of course, the next time around, they will each prove their bona fide to each other again, use a different Kₜ for the purpose, and apply the new Kₜ to communicate regularly throughout that session. The small illustrative numbers are deceiving. Factorial values climb fast, and any practical transposition will pose a daunting challenge to the cryptanalyst.

### Use Cases

TSC may be used by any two parties sharing a secret; it may be used by central nodes husbanding a large number of subscribers, or registered users, and it may be used by Internet of Things (IoT) applications where one party at least operates with limited capacity (battery perhaps), and requires minimum computation. TSC can also be used by two strangers. They may establish a common secret using Diffie Hellman or equivalent, and then use TSC instead of a more common symmetric cipher.

TSC may be engineered such that the user will determine the level of security used. The size of the transposed string, (q, qₜ) is controlled by the size of the secret s, the size of the randomized nonce re, and the mix function. The size of q, and the nature of the formula to break q to n unique substrings—determines the transposition load, n. The user can also control the size of the transposed unit, u, and hence the size of the block b. In practice the user will be asked to decide on level of security, high, medium, low, and the software will pick the values listed above. The concept is the same—security is determined by the user, not by the cipher builder. Much as the speed in which a car is driven is determined by the driver, not by the car manufacturer.

For certain purpose it may be decided that the shared secret transposition key, Kₜ should be used as an element in a more involved symmetric cipher.

Group Communication:

k parties sharing a secret s may available themselves to TSC to build secure group communication. The group will come together online, and cross verify each other's bona fide. This will generate k instances of a non-algorithmic transposition key: Kₜ₁, Kₜ₂, . . . Kₜₖ. The parties could simply agree on one of these transposition keys as their choice and start group communication on its basis. Alternatively, the parties may boost the security of their protocol by combining some or all of these transposition keys. To do that the parties will have to insure that all these transposition keys operate on the same number of transposed elements, n. (which is easily done, as discussed above). Since each of the k parties can evaluate all the k keys, they can also compute a combined key by applying successively these k keys:

K^{g}ₜ=Kₜₖ*Kₜ₍ₖ₋₁₎* . . . Kₜ₁

and use K^{g}ₜ for their session communication.

Group Hierarchy:

A group as above of k parties sharing a secret s may include a subgroup of k′<k members, who will share an additional secret s′. This subgroup could communicate by using a transposition key that results from combining the k-group key K^{g}ₜ with the additional transposition key K′^{g}ₜ that emerges from applying the TSC protocol over the subgroup. (K′^{g}ₜ*K^{g}ₜ). The k′ member subgroup could have a k″<k′ members sub-subgroup in it, sharing a secret s″, exercising the TSC protocol and extracting a secret transposition key K″^{g}ₜ which can be used separately or in combinations of the previous keys: K″^{g}ₜ*K′^{g}ₜ*K^{g}ₜ. This would result in hierarchical protection for the smaller “elite” subgroup. And it may have as many layers as desired. One might note that the operational burden will be the same because however many transposition keys are applied one after the other, the result is equivalent to a single key, and can be expressed in a table of two n members lists, as seen above.

### Hardware Applications:

TSC processing suggests the possibility of extremely fast hardware implementation, which might be of special importance for industrial, and SCADA real-time control.

Comparison with Diffie-Hellman:

Commonly today two parties with a shared secret would execute the Diffie-Hellman (DH) protocol to keep their communication secure. Diffie Hellman, by its nature, is vulnerable to Man-in-the-Middle (MiM) attack. A MiM may simultaneously open two DH channels, one with Alice, the other with Bob, and pass the information through from one to the other, as the contents of that information convinces both Alice and Bob that they operate within a single protective DH channel, while in fact they operate under two channels, and all their messages are exposed to the MiM. Using TSC, Alice and Bob might as well be fooled by the MiM operating two channels, and the MiM will indeed be privy to all that passes between them, but that would not do the MiM any good since Alice and Bob pass all their messages encrypted with the per-session transposition key, which both of them computed based on their shared secret s, which the MiM is not aware of. And since the next session between Alice and Bob will use a different key, the MiM has no hope for a replay attack.

Based on this persistent security of the TSC it would make sense to apply it for all communications between a user and a central agency (a bank, a merchant, a government office). The password will not be transmitted across, but function as the shared secret s, and become the basis of secure communication where the level of security is up to the users. The secret s could be combined from, say, three secrets (passwords): s₁, s₂, s₃, such that for mere access one requires only s₁, for more serious online actions, s₁+s₂ will be needed, and for super critical actions s₁+s₂+s₃.

### Advanced Protocols

The salient feature of T-Proof is that a “key space size equivocation” lies between the pre- and post transposition images. That is, given one image, the corresponding image will be any of the n! possible candidates, where n is the count of transposed elements, and each candidate is associated with a contents-independent 1/n! probability. This state was defined by [Samid 2015 (B] as a state of Ultimate Transposition. To the extent that the shared secret s that generates the protocol is highly randomized (as a good password should be), and of unknown size, then this ultimate transposition cipher resists brute force cryptanalysis (much as most symmetrical ciphers with a random plaintext).

[Samid 2015] discusses equivocation generating protocols that may be readily used with any ultimate transposition cipher (UTC), and all of them can be used with T-Proof.

We discuss two examples: Let a message M be comprised of l words: m₁, m₂, . . . mₗ. One may find h decoy words: d₁, d₂, . . . dₕ and concatenate them in some order with M, using a separator letter, say, ‘*’, between the concatenated parts. The result, p=m₁, m₂, . . . mₗ, *, d₁, d₂, . . . dₕ is regarded as the plaintext, p.

p is being processed with T-Proof over the distinct words: transposing n=m+h+l elements, generating some permutation c:

c= . . . mᵢ, . . . dⱼ, . . . ,*, mᵤ, . . . dᵥ

of the n elements. If the decoy letters were selected such that there are e permutations which amount to a plausible plaintext candidate, then because of the ultimate transposition property of the cipher it would be impossible for a cryptanalyst to decide which of the e candidates is the one that was actually encrypted to c. The only strategy available to the cryptanalyst will be to brute force analyze the underlying shared secret s. If the size of s is unknown the cryptanalyst will have to start from the smallest possible s size and keep climbing up. If the size of s is known, the cryptanalyst will have to check the entire s-space. For each possible s the cryptanalyst will have to check whether the encrypted T-Proof message, qₜ which was sent by Alice to Bob, and presumably captured by the cryptanalyst, is a proper permutation of the q computed from the assumed s. If it is then the combined q and qₜ (the pre-image and post image permutations of the transposed list), will identify the randomly chosen transposition key, Kₜ, and if applying Kₜ to c results in a p-candidate that is a member of the e-plausible options then that p-candidate becomes a high probability candidate. If only one plausible p-candidate is netted by this brute force attack then the cryptanalyst cracked the system. But if two or more p-candidates are found in the exhaustive search, then the cryptanalyst cannot go any further because the transposition key was selected via real life measurement as opposed to via crackable algorithmic randomness.

In [Samid 2015] one finds a description of how to select the decoy words, automatically, or via human selection. The larger the decoy set and the smarter its choice, the larger the value of e, and the larger the chance that the cryptanalyst will be stopped by an unresolved equivocation.

Illustration. Let the message be: m=“Alice loves Bob”. The selected decoy words are: hates, Carla, David. The plaintext will be p=“Alice loves Bob*hates Carla David”. Using T-Proof the resulting ciphertext is: c=“hates Bob David Carla*Alice loves”. It is easy to write down e=24 p plausible candidates derived from c, and all of them are mathematically equivalent with the right message m. (e.g.: “Carla hates Alice*Bob Loves David”)

Note: The T-Proof may be implemented with various methods to break the message q to distinct substrings. In some of these methods the number of substrings, n, is determined by the bit contents of q, so it cannot be determined ahead. Yet, in the procedure described above n has to be n=m+h+1. To accomplish that it is possible to agree on a q string of sufficient size such that the number of substrings of whatever method, t, will be equal or larger than n (t≧n). And then, starting with the largest letter (bit wise) to combine it with the smallest letters by size order so that the number of substrings will be reduced until it equals n.

The other advance method will be to achieve mathematical secrecy.

### High-End Security

The specter of ultimate transposition cipher leads to ciphers that operate as close as desired to perfect Shannon secrecy. We first describe briefly the procedure that leverages ultimate transposition: Let m be a message to be encrypted, expressed as an x-bits string. We shall define a corresponding m′ string as follows m′=m⊕{1}^{m}. We now concatenate the two strings: p=m∥m′. p is a 2x bits string where by construction it is comprised of x zero bits, and x one bits. Applying an ultimate transposition over p, one generates c, which is also a 2x bits string and where also there are x zeros and x ones. It is easy to see that c can be decrypted into some p′≠p where the first x bits of p (counting from left to right) are any desired sequence of x bits. In other words, given c, then all 2^{x} possible candidates for m are viable candidates, namely there is a transposition key, Kₜ that decrypts c to any of the possible 2^{x} candidates for m.

Illustration:

let m=110010. We compute m=m⊕{1}⁶=110010⊕111111=001101. We concatenate m and m′: p=m∥m′=110010001101. p is a 12 bits long string with 6 zeros and 6 ones. We apply an ultimate transposition operation on p to generate c. Say c=011110110000. Since c has 6 ones and 6 zeros, it can be transposed back to a plaintext such that the 6 leftmost bits will be any combination from 000000 to 111111, and hence, given c, any possible m looks equally probable.

We can therefore employ the T-Proof protocol involving an ultimate transposition operation over a list of 2n transposed items, and use it to encrypt a message comprised of n bits via the above described procedure. If we have a message comprised of y bits, we can break it down to n bits size blocks, and encrypt each block with the same or with another round of ultimate transposition, and thereby achieve Shannon secrecy or any desired proximity to it. That security will be controlled by the size of the shared secret s.

### Cryptanalysis

The TSC may be attacked either from the front—the final transposition step, or from the back, at the T-Proof procedure that communicates the transposition key, Kₜ, to the recipient.

Up Front Attack:

With regard to the basic protocol, assuming the cryptanalyst knows the size of the transposed elements (u bits), the fact that the transposition was effected via a non-algorithmic random operation, will require her to apply the brute force approach and test all the n! permutations of the known or assumed n=b/u transposition elements. There is no theoretical possibility for an up front shortcut. And if the brute force analysis will net two or more plausible permutations then the cryptanalyst will end up with irreducible equivocation.

With respect to the advanced protocols, the ultimate transposition cipher will render the equivocation that was identified in an exhaustive search, non-reducible, with no fear for any algorithmic shortcuts or alike.

Back Side Attack

The cryptanalyst should start with the encrypted string qₜ communicated to the recipient. She will have to work out all possible q strings (the pre-transposition image of qₜ), and for each such q option, she will have to reverse compute the mix function, and calculate the corresponding secret s=mix⁻¹(q, r). r, the nonce is known. If s is a plausible secret, then q is plausible, and the transposition key for qₜ=T(Kₜ, q) is a viable candidate for the front-end transposition key. If going through this entire process the cryptanalyst finds exactly one plausible secret, s, then the cryptanalysis is complete. If more than one plausible s is found, but among the found s-candidates only one corresponding Kₜ will reverse transpose the TSC ciphertext c to a plausible p, then also the cryptanalysis is complete. But if there is more than one—the resultant equivocation is terminal.

To the extent that the cryptanalyst cannot determine the plausibility of s, there is no hook for the cryptanalyst to hark on, and not even brute force is a guaranteed cryptanalysis. So, two secret-sharing parties who share a high quality randomized secret s, where the bit size of s is part of its secrecy, do present a daunting challenge for the cryptanalyst.

In analyzing qₜ the cryptanalyst will assume that the substrings of q are all unique, and then will be able to compute the maximum number tₘₐₓ of such substrings: tₘₐₓ=i such that Σ2^{j}≦|qₜ| for j=1, 2, . . . i, while: Σ2^{j}>|qₜ| for j=1, 2 . . . , i+1. The cryptanalyst will have to check all tₘₐₓ! permutations for q, and then compute s from mix⁻¹, and examine s for plausibility.

If the size of s is known (say it is a four digits PIN), then a brute force cryptanalysis is possible over s-space. And if only one value of s leads to a reasonable plaintext p, then the cryptanalysis is successful. Otherwise, it terminates with the computed equivocation.

The users could select a shared secret s of any desired size. They can be prepared with several s secrets to be replaced according to some agreed schedule. It is therefore the users who have the power and the responsibility to determine the level of security for their messages. The salient feature of the TSC is that it is not dependent on algorithmic complexity, and its vulnerability in any case is credibly assessed with straight forward combinatorial calculus.

### Bit Switchable Migration Transposition

Given a bit string s, and a migration counter, r to (Equivoe-T style). s can be transposed to sₜ by migrating the bits one by one with the direction of the next count being determined by the identity of the migrating bit. 0—clockwise, 1—counter clockwise, or the opposite. This will make the resultant transposition dependent on the content of s.

Illustration: let s=1101110, and r=4. We start clockwise: s(1)=110 [symbol] 110. Since the hit bit is ‘1’ the counting direction reverses: s(2)=110 [symbol] 11 [symbol] . The new bit is zero, so the next round proceeds clockwise: s(3)=110 [symbol] 1. Again a “1” was hit, so the direction reverses again: s(4)=110 [symbol] . The direction continues counterclockwise because the hit bit is 1: s(5)=11 [symbol] . The bit hit is zero so the next round is clockwise: s(6)=1 [symbol] .

### REFERENCES

Masanobu Katagi and Shiho Moriai “Lightweight Cryptography for the Internet of Things” Sony Corporation 2011 https://www.iab.org/wp-content/IAB-uploads/2011/03/Kaftan.pdf
Ma't'e Horva'th, 2015 “Survey on Cryptographic Obfuscation” 9 Oct. 2015 International Association of Cryptology Research, ePrint Archive https://eprint.iacr.org/2015/412 Masanobu Katagi and Shiho Moriai “Lightweight Cryptography for the Internet of Things” Sony Corporation 2011 https://www.iab.org/wp-content/IAB-uploads/2011/03/Kaftan.pdf
Menezes, A. J., P. van Oorschot and S. A. Vanstone. The Handbook of Applied Cryptography. CRC Press, 1997.
Samid, G. “Re-dividing Complexity between Algorithms and Keys” Progress in Cryptology—INDOCRYPT 2001 Volume 2247 of the series Lecture Notes in Computer Science pp 330-338
Samid, G. (B) 2001 “Anonymity Management: A Blue Print For Newfound Privacy” The Second International Workshop on Information Security Applications (WISA 2001), Seoul, Korea, Sep. 13-14, 2001 (Best Paper Award).
Samid, G. 2001 (C) “Re-Dividing Complexity Between Algorithms and Keys (Key Scripts)” The Second International Conference on Cryptology in India, Indian Institute of Technology, Madras, Chennai, India. December 2001.
Samid, G. 2001(D) “Encryption Sticks (Randomats)” ICICS 2001 Third International Conference on Information and Communications Security Xian, China 13-16 Nov. 2001
Samid, G. 2003 “Intractability Erosion: The Everpresent Threat for Secure Communication” The 7th World Multi-Conference on Systemics, Cybernetics and Informatics (SCI 2003), July 2003.
Samid, G. 2015 “Equivoe-T: Transposition Equivocation Cryptography” 27 May 2015 International Association of Cryptology Research, ePrint Archive https://eprint.iacr.org/2015/510
Samid, G. (B) 2015 “The Ultimate Transposition Cipher (UTC)” 23 Oct. 2015 International Association of Cryptology Research, ePrint Archive https://eprint.iacr.org/2015/1033
Samid, G. 2016 “To Increase the Role of Randomness” http://classexpress.com/IncreaseRandomness_H6327.pdf
Samid, G. (B) 2016 “Stupidity+Randomness=Smarts” https://www.youtube.com/watch?v=TYgNdoAAfkE
Samid, G. (C) 2016: “T-Proof: Secure Communication via Non-Algorithmic Randomization” International Association of Cryptology Research https://eprint.iacr.org/2016/474
Smart, Nigel 2016 “Cryptography Made Simple” Springer.

### T-Proof

### Secure Communication Via Non-Algorithmic Randomization

### Proving Possession of Data to a Party in Possession of Same Data

Abstract: shared random strings are either communicated or recreated algorithmically in “pseudo” mode, thereby exhibiting innate vulnerability. Proposing a secure protocol based on unshared randomized data, which therefore can be based on ‘white noise’ or other real-world, non algorithmic randomization. Prospective use of this T-Proof protocol includes proving possession of data to a party in possession of same data. The principle: Alice wishes to prove to Bob that she is in possession of secret data s, known also to Bob. They agree on a parsing algorithm, dependent on the contents of s, resulting in breaking s into t distinct, consecutive sub-strings (letters). Alice then uses unshared randomization procedure to effect a perfectly random transposition of the t substrings, thereby generating a transposed string s′. She communicates s′ to Bob. Bob verifies that s′ is a permutation of s based on his parsing of s to the same t substrings, and he is then persuaded that Alice is in possession of s. Because s′ was generated via a perfectly randomized transposition of s, a cryptanalyst in possession of s′ faces t! s-candidates, each with a probability of l/t! (what's more: the value of t, and the identity of the t sub-strings is unknown to the cryptanalyst). Brute force cryptanalysis is the fastest theoretical strategy. T-Proof can be played over s, mixed with some agreed upon nonce to defend against replay options. Unlike the competitive solution of hashing, T-Proof does not stand the risk of algorithmic shortcut. Its intractability is credibly appraised.

### Introduction

Online connection dialogues normally start by Alice logging on to Bob's website, passing along name, account number, passwords etc.—data items well possessed by Bob. Such parties normally establish a secure channel beforehand but (i) the secure channel is vulnerable to man-in-the-middle (MiM) attacks, and (ii) at least some such information may be passed along before the secure channel is established (e.g. name, account number). It is very easy for Bob to send Alice a public encryption key, and ask her to encrypt her secret data s with that key, but this solution is also vulnerable to MiM attacks. Hashing is one effective solution, but it relies on the unproven hashing complexity. Here we propose a solution for which “brute force” is the best cryptanalytic strategy: T-Proof (T for transposition): Alice wishes to prove to Bob that she is in possession of a secret, s, known to Bob. Bob sends Alice random data, r, with instructions how to “mix” s and r into q which appears randomized. q is then parsed to t letters according to preset rules. And based on these t letters q is randomly transposed to generate q′. q′ is then communicated to Bob over insecure lines. Bob verifies that q′ is a permutation of q, and concludes that Alice is in possession of s. A hacker unaware of q will not know how q is parsed to t letters, and hence would not know how to reverse-transpose q′ to q. Unlike the prevailing hashing solutions and their kind, T-Proof is not based on algorithmic complexity, rather on solid combinatorics, whereby the user can credibly estimate the adversarial effort to extract the value of the proving secret s. Alice and Bob need to share no secret key to run the T-Proof procedure. T-Proof is computationally easy, operates with any size of secret s, and may be used by Alice to identify to Bob who she is, while keeping her identity secret towards any eavesdropper. It may be used by a group to prove the identities of files, and databases kept by each member of the group. Unlike hashing, T-Proof, in some versions, does not stand the risk of collision, only brute force attack, the required effort of which may be controlled by the user.

The anchor of security online is a “cyber passport” authoritatively and replaceable issued off-line, and then securely used for identification and other purposes. Inherently using an identification code to prove identity is a procedure in which the identity verifier knows what id to expect. Customarily, people and organizations have simply sent their id to the verifier, in the open. More sophisticated means include some form of encryption. Alas, If Alice sends Bob a cipher to encrypt his message to her with it, then this cipher may be confiscated by a hacker in the middle, who will pretend to be Alice when he talks to Bob, and gives him his version of “Alice's cipher”, which Bob uses and thereby reveals to the hacker his secret data (id, account number, password, etc). Bob then uses Alice's cipher to send her the same, and Alice is never the wiser.

A more effective solution is one where a stealth man in the middle cannot compromise the proving data. One such method is hashing. Hashing is based on unproven complex algorithms, and collision is always a worry. So it makes sense to come up with alternative means for a party to prove to a verifier aware of s, that the prover is in possession of s.

This proposed solution is based on the idea that the prover may parse her secret bit string s, to some t letters, where a letter is some bit sequence. The procedure to parse s to t letters is a function of s. Then the prover, randomly transposes the t letters, to create an equal length string s′. s′ is sent over to the verifier. The verifier, in possession of s will use the same parsing procedure to identify the same t letters in s, and then verify that s′ is a strict permutation of s. This will convince the verifier that the prover has s in his or her possession. A hacker, capturing s′ will not know what t letters s′ is comprised of, and anyway since s′ is a random permutation of s, the hacker will not know how to reverse transpose s′ to s.

Illustration: The prover, named John Dow, wishes to let the verifier know that he asks to log in. Using T-Proof Mr. Dow will write his name (s) in ASCII:

s=01001010 01101111 01101000 01101110 00100000 01000100 01101111 01110111

Let's parse s as follows: the first bit is the first letter “A”, the next two bits are the second letter, “B”, the third letter is comprised of the four next letters, etc:

$$A = 0 , B = 10 , C = 0101 , D = 00110111 , E = 1011010000110111$$

$$F = 000100000010001000110111101110111$$

$$s = \begin{matrix}0 & 10 & 0101 & 00110111 & 1011010000110111 & 000100000010001000110111101110111\end{matrix} \\ = ABCDEF$$

Let's now randomly transpose the t=6 letters (A, B, C, D, E, F) to write:

s′=T(s)=ECFABD=1011010000110111 0101 000100000010001000110111101110111 0 10 00110111,

Or:

s′=10110100 00110111 01010001 00000010 00100011 01111011 10111010 00110111

The verifier, in possession of s, will similarly break s to A,B,C,D,E,F letters, then, starting from the largest letter, F=000100000010001000110111101110111, the verifier will find the “F-signature” on s′:

s′=1011010000110111 0101 F 010 00110111

then the “E-signature”: E=1011010000110111

s′=E 0101 F0 10 00110111

And so on to construct s′=ECFABD. The verifier will conclude then that s′ is a perfect permutation of s, based on the six letters A, B, C, D, E, F. All letters were found in s′, and no unmarked bit left in s′.

If the verifier does not know the name John Dow, then the verifier will list all the names in its database pre-parsed by their proper letters, and compare s′ to this expression of the names.

The hacker, capturing s′ cannot parse it to the proper letters (A, B, C, D, E, F) because, unlike the verifier, the hacker does not know s. If the hacker uses the same parsing rules on s′, he gets: A′=1, B′=01, C′=1010, D′=00011011, E′=1010100010000001, F′=0001000110111101110111010. So clearly: A′≠A, B′≠B, C′≠C, D′≠D, E′≠E, F′≠F. So s′ cannot be interpreted by the hacker as a permutation of s, except after applying the prolonged brute force cryptanalysis.

Notice that the verifier and the prover need not share any secrets to collaborate on this T-Proof procedure. They just need to adhere to this public protocol.

There are many variations on this procedure to balance security and convenience, but this illustration highlights the principle.

### The T-Proof Environment

The environment where T-Proof operates is as follows: three parties are involved: a prover, a verifier, and a hacker. A measure of data regarded as secret s is known to the prover and to the verifier, and not known to the Hacker. The prover and the verifier communicate over insecure lines with the aim of convincing the verifier that the prover is in possession of s—while making it hard for the Hacker to learn the identity of s. The verifier and the prover have no shared cryptographic keys, no confidential information. They both agree to abide by a public domain protocol.

T-Proof is a public function that maps s to s′, such that by sending s′ to the verifier, the prover convinces the verifier that the prover is in possession of s, while the identity of s′, assumed captured by the hacker, makes it sufficiently intractable for the Hacker to infer s.

We are interested in the following probabilities: (1) the probability for the verifier to falsely conclude that the prover holds s, and (2) the probability for the Hacker to divine s from s′. We rate a solution like T-Proof with respect to these two probabilities.

### The T-Proof Principles

The T-Proof principle is as follows: let s be an arbitrary bit string of size n: s=s₀={0,1}ⁿ. Let s be parsed into t consecutive sub-strings: s₁, s₂, . . . sₜ, so that:

s₀=s₁s₂ . . . sₜ

Let s′ be a permutation of s based on these t substrings. Any one in possession of s, will be able to assert that s′ is a permutation of s (based on the t sub-strings), and will also be able to compute the number of possible s-string candidates that could have produced s′ as their permutation. Based on this number (compared to 2ⁿ) one will be able to rate the probability that s′ is a permutation of some s″≠s. Given that the string s is highly randomized (high entropy), then anyone in possession of s′ but without the possession of s, will face well defined set of randomized possibilities for the value of t and for the sizes of s₁, s₂, . . . sₜ such that by some order, o, these substring will construct s′:

S′ₒ=sᵢsⱼsₖ . . . sₜ . . .

T-Proof is then a method for a prover to prove that she has a measure of data s, known to the verifier, such that it would be difficult for a Hacker to infer the value of s, and where both the probabilities for verifier error and for Hacker's success are computable with solid durable combinatorics, and the results are not dependent on assumed algorithmic complexity.

Auxiliary principles: (a) to the extent that s is a low entropy string, then it may be randomized before submitting it to T-proof. For example encrypting s with any typical highly randomizing cipher. The cipher key will be passed in the open since what is needed here is only the randomization attribute of the cipher, not its secrecy protection. (b) In order for the prover to be able to prove possession of same s time and again (in subsequent sessions), she might want to “mix” s with a random bit sequence r, to generate a new string, q, and apply T-Proof over q.

### T-Proof Design

The T-Proof procedure is comprised of the following elements:
Non-Repetition Module
Entropy Enhancement Module
Parsing Module
Transposition Module
Communication Module
Verification Module

These modules operate in the above sequence: the output of one is the input of the next.

### Non-Repetition Module

In many cases the prover would wish to prove the possession of s to the verifier in more than one instant. To prevent a hacker from using the “replay” strategy and fool the verifier, the prover may take steps to insure that each proving session will be conducted with new, previously unused, and unpredictable data.

One way to accomplish this is to “mix” s with a nonce, a random data, r, creating q=mix(s,r). The mixing formula will be openly agreed upon between the prover and the verifier. The “mix” function may be reversible, or irreversible (lossy or not lossy).

Namely given q and r it may be impossible to determine the value of s, since many s candidates exist, or, alternatively, given r and q, s will be determinable. It will then be a matter of design whether to make it intractable to determine s from r and q, or easy.

One consideration for r and the “mix” is the target bit size of the value that undergoes the T-Proof procedure. That size can be determined by selecting r and ‘mix’.

Since the procedure computed by the prover will have to also be computed by the verifier, (except the transposition itself), it is necessary that r will have to be communicated between the two. Since the verifier is the one who needs to make it as difficult as possible for the prover to cheat, it makes more sense for the verifier to determine r, (different per each session), and pass it on to the prover. The mix function, too, may be the purview of the verifier.

The simplest mix option is concatenation of s with r: q=sr, and r is adjusted to get the right size q.

### Entropy Enhancement Module

Once the secret s is preprocessed to become q (the non-repetition module), it may be advisable to pump in entropy to make it more difficult for the hacker to extract the secret (s or q). Linguistic data (name, addresses) are of relatively low entropy, and can be better guessed than purely randomized data. It is therefore helpful for the users to “randomize” q. The randomization process, also will be in the open, and known to the hacker.

An easy way to randomize q is to encrypt it with a public key using any established cipher.

### Parsing Module

Given a string s comprised of n bits: s=s₀={0.1}ⁿ, it is possible to parse it to t consecutive substrings s₁s₂ . . . sₜ, where 1≦t≦n. Based on these t substrings s may be transposed up to t! permutations. So for every secret s, there are at most t! s′ candidates. Or, alternatively, given s′ the hacker will face up to t! s-candidates. Therefore, it would seem that one should try to maximize t.

The hacker facing the n-bits long s′ string does not know how the sub-strings are constructed. The hacker may or may not know the value of t. Clearly if t=1 then s′=s. If t=2, then the cut between the two substrings may be from bit 2 to bit n−1 in s′. If the substrings are all of equal size then their identity is clear in s′. If the hacker is not aware of t or of any substring size (because it depends on s, which is unknown to him), then given s′ the hacker will face a chance to guess s:

Pr[x=s]=1/C^{t-1}ₙ₋₂

where x is any s candidate, and C^{t-1}ₙ₋₂ is the number of ways that (t−1) split points can be marked on the n bits long string. This guessing probability decreases as t increases (and the substrings decrease).

On the other hand, larger t would make it more difficult for the verifier to check whether s′ is a permutation of s based on the parsed substrings. A large t, implies small sub-strings. A small sub-string of an average size of (n/t) bits will probably fit on different spots on s′, and the verifier would not know which is the right spot.

Illustration: Let s′=10101110101000101110. for a substring sᵢ=101 the verifier will identify 5 locations to place it on s′. And or sⱼ=111, there are two locations. By, contrast a larger substring sₖ=1000101 will fit only in one location on s′.

One would therefore try to optimize the value oft and the various sub-string sizes between these two competing interests.

Some design options are presented ahead:
The Incremental Strategy
The Minimum size strategy
The log(n) strategy

These strategies are a matter of choice, each with its pro and cons.

We keep here the s, s′ notation, but it should also apply to instances where the “entropy enhancement” module is applied, and then s, and s′ will be replaced by q and q′.

### The Incremental Strategy

The “minimum size strategy” works as follows: s is approached from left to right (or alternatively, from right to left). The first bit is regarded as the first letter, let's designate it as A. A is either “1” or “0”. Then one examines the second bit. If it is different from the first bit then it is set as B. If the second bit is of the same value as the first bit, then the next bit is added, and the two-bit string becomes B. Further, one examines the next two bits, if they look the same as a previous letter, one moves up to three bits, and so on. When the last letter so far was defined as l bits long, and there are only m≦2l letters left in s, then the last letter is extended to include these m bits.

This strategy increments the size of the letters, and the parsing of the string s depends on the bit value of s. And hence, knowing only s′, the hacker will not know how s was parsed out, not even the value of t—the number of sub-strings. As designed s is parsed into t non-repeat letters, and hence s will have t! permutations.

This strategy can be modified by starting with bit size of l>1, and incrementing “+2” or more instead of “+1” each round.

There might rise a slight difficulty for the verifier looking at s′ trying to verify that s substrings fit into s′.

### Illustration (Incremental Strategy)

The prover, Bob, wishes to convince the verifier, Alice, that he has in his possession Bob's PIN, which is: s=8253₁₀=10000000111101

Bob then decomposes s to a sequence of non-repeat letters, from left to right, starting with a bit size letter: The first leftmost bit is 1, so Bob marks a=1. The next bit is zero, Bob marks b=0 (a≠b). The third bit is a zero too, so it would not qualify for the next letter. Bob then increments the size of the letter to two bits, and writes c=00. (c≠b≠a). What is left from s now is:

s= [symbol] 0000111101

The next 2 bits will not qualify as d, since then we have d=c, which Bob wishes to avoid, so Bob once again increases the bit count, now to three and writes d=000 (≠c≠b≠a). s now looks like:

s [symbol] =0111101

The next three bits will qualify as e=011, because e≠d≠c≠b≠a), and the same for f=110≠e≠d≠c≠b≠a. Now:

s= [symbol] 1

One bit is left unparsed it could not be g=1 since then g=a, so the rule is that the left over bits are concatenated to the former letter, hence we rewrite: f=1101 At this point we can write:

s=abcdef

where the 6 letters that comprise s are defined above.

Bob will then randomly transpose s per these 6 letters and compute an s-transpose:

s′=dbfeac

Bob will now transmit s′ to Alice using its binary representation:

s′=000 0 1101 011 1 00

But not with these spaces that identify the letters, rather:

s′=00001101011100=860

Alice receiving s′, and having computed the letters in s, like Bob did (Alice is in possession of s), will now check whether the s′ that Bob transmitted is letter-permutation of s (which she computed too).

To do that Alice starts with the longest letter: f=1101, and moves it from the rightmost bits in s′:

s′=0000 [1101]_{f} 011100

Alice will then look if e=011 fits in s′:

s′=0000 [1101]_{f}[011]ₑ 100

Continuing with d=000:

s′=0 [000]_{d}[1101]_{f}[011]ₑ 100

And so on, until Alice, the verifier, securely concludes that s′ is a permutation of s based on the incremental parsing strategy of s.

### The Minimum Size Strategy

This strategy is similar to the incremental size strategy. The difference is that one tries to assign minimum size for each next sub-string.

Regarding the former illustration, let s=8523₁₀=q 000000111101. It will be parsed a=1, b=0, c=00, d=000, resulting in s= [symbol] 0111101. But the next letter, will be e=01, because there is no such letter so far. And then f=11. We now have: s= [symbol] 101. The next letter could have been g=10 because this combination was not used before. But because only 1 bit is left in s, we have g=101. Clearly the parsing of s is different by the two strategies, even the number of sub-strings (letters) is different.

### The Log(n) Strategy

This strategy is one where matching s′ to the sub-strings of s is very easy. But unlike the former two strategies, the parsing of s (comprised of n=|s| bits) is by pre-established order, independent of the contents of s.

Procedure: Let L^{j}ᵢ be letter i (or, say sub-string i) from the j series alphabet. For every letter series j we define, the size of the letters:

|L^{j}ᵢ|=2ⁱ

Accordingly one will parse a bit string s as follows:

s=L^{j}₁L^{j}₂ . . . L′^{j}ₜ

where L′ⱼ^{t} has the length l=|s|−(2⁰+2¹+2²+ . . . 2^{t-1}), where t is the smallest integer such that |s|≦2^{t}. Accordingly t˜log₂(|s|)=log₂(n).

Illustration: Let s=1 01 0010 00100001 0000010000001, we parse it as follows: L¹₀=1, L¹₁=01, L¹₂=0010, L¹₃=00100001, L′¹₄=0000010000001

Security and convenience considerations may indicate that the last letter L′¹ is too large. In that case it will be parsed according to the same rules, only that its sub-strings will be regarded as a second letters sequence:

L′¹ₜ=L²₀L²₁L²₂ . . . L′²_{t′}

Note that for every round of log(n) parsing there would be exactly one possible position for every substring within s′, because every sub-strings is longer than all the shorter substrings combined. This implies a very fast verification process.

Illustration, the last letter above: L′¹₄=0000010000001 may be parsed into: L²₀=0, L²₁=00, L²₂=0010, L²₃=0000001

The last letter in this sequence can be parsed again, and so on, as many times as one desires. The log(n) strategy might call for all sub-strings of size 2^{m} and above to be re-parsed.

The verifier, knowing s will be able to identify all the letters in the parsing. And then the verifier will work its way backwards, starting from the sub-string that was parsed out last. The verifier will verify that that letter is expressed in some order of its due sub-strings, and then climb back to the former round until the verifier verifies that s′ is a correct permutation of the original s string.

This strategy defines the parsing of every bit string, s, regardless of size. And the longer s, the greater the assurance that the prover indeed is in possession of s.

### The Smallest Equal Size Strategy

This strategy parses s to (t−1) equal size sub-strings (letters), and a t letter of larger size. One evaluates the smallest letter size such that there is no repeat of any letter within s.

Given a bit string s, {0,1}ⁿ, for l=1 one marks m I bits long substrings starting from an arbitrary side of s (say, leftmost) where m=(n−n mod l) l. These leaves u=n−l*m bits unmarked (u<l). If any two among these m substrings are identical, then one increments l, and tries again iteratively until for some l value all the m substrings are distinct. In the worst case it happens for an even n at l=0.5*n+1, and for an odd n at l=0.5(n+1). Once the qualified l is identified, the first (m−1) substrings are declared as the first (t−1) substrings of s, and the m-th l bits long substring is concatenated with the remaining u bits to form a l+u bits long substring. The thus defined t substrings are all distinct, and it would be very easy for the verifier to ascertain that s′ is a t-based permutation of s. On the other hand, the hacker will readily find out the value oft because applying this procedure to s′ will likely result in the same value of t. So the only intractability faced by the hacker would be the t! size permutation space.

Illustration: let s=10010011101001110. For l=1 we have several substrings that are identical to each other. Same for l=2. We try then for l=3:

s=100 100 111 010 011 10

There are two identical strings here, so we increment l=4:

s=1001 0011 1010 0111 0

Now, all the four, four bit size substrings are distinct, s is parsed into:

1001,0011,1010,01110.

### Transposition Module

The T-Proof transposition should be randomized to deny the hacker any information regarding reversal, so that given s′ the hacker will face all t! possible permutation, each with a probability of 1/t!. This can be done based on the “Ultimate Transposition Cipher [7], or by any other methods of randomization. It is important to note that the randomization key is not communicated by the prover to the verifier, so the prover is free to choose and not communicate it further.

One simple example for randomized permutation is as follows: the string s is comprised of t sub-strings: s₁, s₂, . . . sₜ. When substring sᵢ is found in position j in the permutation s′, then we shall designate this string as sᵢⱼ.

Using repeatedly a pseudo random number generator, the prover will randomly pick two numbers 1≦i≦t, and 1≦j≦t, and so identify sᵢⱼ. Same will be repeated. If the random pick repeats a number used before (namely re-picks the same i, or the same j), then this picking is dropped, and the random number generator tries again. This randomization process is getting slower as it progresses.

Another variety is to pick the next unused index (i, and j) if a used value is re-selected.

### Communication Module

The communication module needs to submit s′ and some meta data describing the protocol under which the string s′ is being sent.

The module might have also to communicate the random nonce to the prover, and the confirmation of the reception of the s information.

### Verification Module

Let's first develop the verification procedure for a simple permutation, s′ (as opposed to the several rounds of transposition as in the log(n) strategy). Procedure: the verifier first tries to fit the longest substring into s′ (or one of the longest, if there are a few). If there is no fit, namely, there is no substring on s′ that fits the longest substring checked, then the verification fails. If there is one fit, then the fitted bits on s′ are marked as accounted for. The verifier then takes the next largest substring and tries to fit it somewhere in the remaining unaccounted bits of s′. If no fit—the verification fails. If there is a single fit, the above process continues with the next largest substring. This goes on until the verification either fails, or concludes when all the substrings are well fitted into s′ and the verifier then ascertains that there are no left-over unaccounted for bits. If there are leftover bits—the verification fails.

If for any substring there are more than one places of fit, then, one such place is chosen, and the other is marked for possible return. The process continues with the picked location. If the verification fails at some point, the verifier returns to the marked alternative, and continues from there. This is repeated at any stage, and only if all possible fittings were exhaustively checked and no fit was found, then the verification as a whole fails. If somewhere along the process a fit is found then the verification succeeds.

In the case of several rounds as in the log(n) parsing strategy, then the above procedure is repeated for each round, starting from the last parsing.

Different parsing strategies lead to different efficiencies in verification.

### Applications

T-Proof may be applied in a flexible way to provide credibly estimated security to transmission of data already known to the recipient. The most natural application may be the task of proving identity and possession of identity-related data, but it is also a means to insure integrity and consistency of documents, files, even databases between two or more repositories of the same.

### Proving Identity

When two online entities claim to be known to each other and hence start a dialogue, then the two may first identify themselves to each other via T-Proof. In particular, if

Alice runs an operation with subscribers identified by secret personal identification numbers, PIN, then Bob, a subscriber, may use T-Proof to prove his identity to Alice, and in parallel Alice, will use T-Proof to prove to Bob that she is Alice, and not a fishing scheme. In that case they may each apply the entropy enhancement module with the other supplying the necessary randomness.

Alice could store the PINs or names, etc. with their parsed letters so that she can readily identify Bob although he identifies himself through T-Proof.

### Proving Possession of Digital Money

Some digital money products are based on randomized bit strings (e.g. BitMint). Such digital coins may be communicated to an authentication authority holding an image of this coin. T-Proof will be a good fit for this task.

### Acceptable Knowledge Leakage Procedures

Alice may wish to prove to Bob her possession of a secret s, which Bob is not aware of. So Bob passes Alice communication to Carla, who is aware of s, and he wishes Carla to confirm Alice's claim that she is in possession of s. By insisting on going through him, Bob is assured that Carla confirms the right s, and also it gives him the opportunity to test Carla by forwarding some data in error. Alice, on her part, wishes to prevent Bob from subsequently claiming that he knows s. She might do so over a randomized s, by extracting from s some h bits, and constructing an h bits long string over which Alice would practice T-Proof h should be sufficiently large to give credibility to Carla's confirmation, and on the other hand is should be a sufficiently small fraction of s, to prevent Bob form guessing the remaining bits.

### Cryptanalysis

Exact cryptanalysis may only be carried out over a well defined set of parameters of a T-Proof cipher. In general terms though, one can assert that for well randomized pre-transposition data (randomized q) there is no more efficient way than brute force. Proof: The hacker in possession of s′, trying to deduce s, will generally not know how s′ is parsed out: often not to how many substrings, and mostly not the size and not the identity of these substrings. But let us, for argument's sake, assume that the t substrings have all somehow became known to the Hacker. Alas, what was never communicated to the verifier is the transposition key from s to s′. What is more, this transposition was carried out via a randomized process, and hence given s′, there are t! s-candidates, and each of them is associated with a chance of 1/t! to be the right s. There is no algorithm to crack, or to shortcut, only the randomization process underlying the transposition. To the extent that an algorithmic pseudo-random process is used, it can be theoretically cryptanalyzed. To the extent that a randomized phenomenon is used, (e.g. electronic white noise) it can't be cryptanalyzed. Since the prover does not communicate the transposition key, or formula, and does not share it with anyone, the hacker faces a de-facto proper randomization, and is left with only brute force as a viable cryptanalytic strategy.

In general one must assume built-in equivocation, namely given s′ there may be more than one s-candidates that cannot be ruled out by the cryptanalyst. Such equivocation may be readily defeated by running two distinct entropy enhancement modules, to produce two distinct permutations s′₁, s′₂.

Unlike hashing, which is an alternative solution to the same challenge, T-Proof is getting more and more robust for larger and larger treated data. The user will determine the level of security over say a large file, or database, by deciding how to break it up to smaller sections, and apply T-Proof to each section separately. It is easier and faster to apply to smaller amounts of data, but security is less.

### Randomness Rising

### The Decisive Resource in the Emerging Cyber Reality

High quality, large quantities of well-distributed, fast and effective randomness is rising to claim the pivotal role in the emerging cyber reality. Randomness is the fundamental equalizer that creates a level playing field to the degree that its efficient use will become the critical winning factor, computational power not withstanding. We must adapt all our cyber protocols, and pay special attention to key cryptographic methods, to leverage this strategic turn. Our foes are expected to arm themselves with randomness-powered defense that we would be unable to crack, neither with brute force, nor with mathematical advantage. Rising randomness will also change the privacy landscape and pose new law-enforcement challenges. In the new paradigm users will determine the level of security of their communication (by determining how much randomness to use) which is strategically different from today when cipher designers and builders dictate security, and are susceptible to government pressure to leave open a back door. The new crop of ciphers (Trans-Vernam ciphers) will be so simple that they offer no risk of mathematical shortcut, while they are designed to handle large as desired quantities of randomness. The resultant security starts at Vernam-grade (perfect secrecy, for small amount of plaintext), slips down to equivocation (more than one plausible plaintext), as more plaintext is processed, and finally, comes down to intractability (which remains quite flat for growing amounts of processed plaintext). These new ciphers give the weak party a credible defense that changes the balance of power on many levels. This vision has very few unequivocal indications on the ground, as yet, and hence it is quite likely for it to be ignored by our cyber leaders, if the saying about the generals who are prepared for the last war is applicable here.

### 1.0 Introduction

Crude oil extracted from the earth has been routinely used in lighting fixtures, furnaces, and road paving, but when the combustion engine was invented, oil quickly turned to be a critical life resource. A perfect analogy to randomness today, routinely used in virtually all cryptographic devices: limited, well known quantities, of varied quality. But that is changing on account of three merging developments:
1. Modern technology brought about the collapse of the cost of memory, as well as its size, while reliability is nearly perfect.
2. Complexity-claiming algorithms are increasingly considered too risky.
3. The Internet-of-Things becomes crypto-active, and is inconsistent with modern ciphers.

Storing large quantities of randomness is cheap, easy, and convenient. An ordinary 65 gigabyte micro SD will have enough randomness to encrypt the entire Encyclopedia Britannica some 25 times—and doing so with mathematical secrecy.

Complexity-claiming algorithms have lost their luster. They are often viewed as favoring the cryptographic powerhouses, if not an out right trap for the smaller user. The New York Times [Perlroth 2013] and others, have reported that the NSA successfully leans on crypto providers to leave a back-door open for government business.

The looming specter of quantum computing is a threat, which becomes more and more difficult to ignore. The executive summary of the Dagstuhl Seminar [Mosca 2015] states: “It is known that quantum algorithms exist that jeopardize the security of most of our widely-deployed cryptosystems, including RSA and Elliptic Curve Cryptography. It is also known that advances in quantum hardware implementations are making it increasingly likely that large-scale quantum computers will be built in the near future that can implement these algorithms and devastate most of the world's cryptographic infrastructure.

The more complex an algorithm, the greater the chance for a faulty implementation, which can be exploited by a canny adversary, even without challenging the algorithmic integrity of the cipher. Schneier [Schneier 1997] states: “Present-day computer security is a house of cards; it may stand for now, but it can't last. Many insecure products have not yet been broken because they are still in their infancy. But when these products are widely used, they will become tempting targets for criminals” Claude Shannon [Shannon 1949] has shown that any cipher where the key is smaller than the plaintext is not offering mathematical secrecy. And although all mainstay ciphers use smaller (Shannon insecure) keys, the casual reader will hardly discern it, as terms like “provingly secure”, and “computationally secure” adorn the modern crypto products. At best a security proof will show that the referenced cipher is as hard to crack as a well-known problem, which successfully sustained years of cryptanalytic attacks [Aggrawal 2009]. The most commonly used such anchor problem is factoring of large numbers. The literature features successful practical factoring of numbers of size of 220-230 decimal digits [Kleinjung 2009, Bai 2016]. Even in light of these published advances, the current standard of 1000 bits RSA key is quite shaky. Nigel Smart offers a stark warning to modern cryptography: “At some point in the future we should expect our system to become broken, either through an improvement in computing power or an algorithmic breakthrough” [Smart 2016, Chap 5]

Alas, when one considers both motivation and resources, then these academic efforts pale in comparison with the hidden, unpublished effort that is sizzling in the secret labs of national security agencies around the world. As all players attempt to crack the prevailing ciphers, they are fully aware that the other side might have cracked them already, and this built-up unease invigorates the prospect of rising randomness: a crop of alternative ciphers, building security, not on algorithmic complexity, but on a rich supply of randomness.

The Internet of Things stands to claim the lion share of crypto activity, and many of those “things” operate on battery power, which drains too fast with today's heavy computational algorithms. Millions of those interconnected ‘things’ are very cheap devices for which today's crypto cost cannot be justified, yet broadcasting their measurements, or controlling them must be protected. These “things” can easily and cheaply be associated with a large volume of randomness which will allow for fast, simple and economical algorithms to insure reliable security, not susceptible to the mathematical advantage of the leading players in the field.

These three trends point to a future where randomness is rising.

A wave of new ciphers is in the offing where high-quality randomness is lavishly used in secret quantities designed to neuter even the much feared “brute force” attack, as well as withstand the coming “earthquake” of quantum computing, and resist the onslaught of open-ended, unmatched adversarial smarts. Ciphers that will deploy large amounts of randomness will wipe away the edge of superior intellect, as well as the edge of faster and more efficient computing.

A cyber war calls for communication among non-strangers and hence symmetric cryptography is mainstay. All mainstay ciphers in common use today conform to the paradigm of using a small, known-size (or several known sizes), random key, and may be a small nonce to boot. These ciphers feature algorithmic complexity for which no mathematical shortcut was published, and all known computers will crack it only in a period of time too long to be of any consequence.

As the prospect of a global vicious cyber war looms larger, the working assumption of the warriors is that these fair-day ciphers described above may not be robust enough for their wartime purpose. Mathematical complexity in principle has not been mathematically guaranteed, although theoreticians are very busy searching for such guarantee. We can prove that certain mathematical objectives cannot be reached (e.g. general solution to a quintic function), but not prove that a multi-step algorithm that is based on detecting a pattern within data cannot be improved upon, with probabilistic methods further spewing solution uncertainty. Moreover, computational objectives which are proven to be impossible in the general case, are normally quite possible in a large subset (even a majority) of cases. There are infinite instances of polynomials of degree five, and higher that can be solved by a general formula for their class, limiting the practical significance of Abel's proof.

Given the stakes in an all out cyber war, or a wide-ranging kinetic war intimately supported by a cyber war, the parties preparing for that war will increasingly harbor unease about the class of alleged-complexity symmetric ciphers, and will be turning to randomness as a strategic asset.

High quality randomness is as rare as high quality crude oil. While this is more a literary statement than a mathematical phrase, the reality is that one needs to go as far as monitoring a nuclear phenomenon, like a rate of radiation flux emerging from a long half life radioactive material, to build a “purely random” sequence. This source is unwieldy, not very conversant, and not of scale. There are numerous “white noise” contraptions, which are non-algorithmic, but are not “pure”, and any “non purity” is a hook for cryptanalysts. Third category is the algorithmic makers of randomness, commonly known as pseudo random number generators (PRNG). They are as vulnerable as the algorithmic complexity ciphers they try to supplant. The New York Times [Perlroth 2013] exposed the efforts of the government to compel crypto providers to use faulty PRNG which the NSA can crack (The dual elliptic curve deterministic random number generator). So to harvest high quality randomness in sufficient quantities is a challenge. To handle it, once harvested, is another challenge. In a cyber war randomness has to be properly distributed among the troops, and their integrity must be carefully safeguarded.

We don't yet have good and convenient randomness management protocols. The brute force use of randomness is via the 1917 Vernam cipher [Vernam 1918] which some decades later Claude Shannon has proven to be mathematically secure [Shannon 1949]. Theoretically, a cyber army properly equipped with enough randomness may safeguard the integrity of its data assets by rigorous application of Vernam. Alas, not only is it very wasteful in terms of randomness resources, its use protocols, especially with respect to multi party communications are very taxing and prone to errors. So we must re-think randomness management and randomness handling, and use effective protocols to accommodate the level of randomness reserves versus security needs.

The coming cyber war will be largely carried out with unanimated “things” exploiting the emerging tsunami of the Internet of Things. Many of the 60 billion “things” or so that would be fair game in the war, will have to communicate with the same security expected of human resources. Only that a large proportions of those warrior “things” is small, even very small, and powered by limited batteries that must preserve power for the duration of the war. These battery-operated devices cannot undertake the computational heavy lifting required by today's leading ciphers. In reality, many ‘smart things’ are remotely controlled without any encryption, easy pray for the malicious attacker. Meanwhile, memory has become cheap, small-size, and easy. A tiny micro SD may contain over 100 gigabytes, and placed in a bee-size drone operated on a tiny solar panel. The working cipher for that drone will have to use simple computational procedure and rely for security on the large amount of randomness on it.

Modern societies allow for strangers to meet in cyber space, and quickly establish a private communication channel for confidential talk, play, pay or business. Part of the modern Cyber War will be to disrupt these connections. Cryptography between and among strangers also relies on intractability-generating algorithms, and hence this category is equally susceptible to stubborn hidden persistent cryptanalytic attacks. Any success in breaching RSA, ECC or alike will be fiercely kept in secret to preserve its benefit. Recognizing this vulnerability, modern cyber actors will shift their confidential communication channel tools from today's intractability sources to tomorrow probability sources, combined with randomness. Probability procedure, like the original Ralph Merkle procedure, [Merkle 1978], buy its users only a limited time of confidentiality, and hence subsequent algorithms will have to leverage this limited time privacy to durable privacy. Probability succumbs to unexpectedly powerful computers, but is immunized against surprise mathematical smarts.

Our civil order is managed through the ingenuous invention of money. Society moves its members through financial incentives; people get other people to work for them, and serve them by simply paying them. And it so happens that money moves aggressively into cyberspace. Digital money will soon be payable between humans, between humans and ‘things’ and between ‘things and things’. Cyber criminals will naturally try to counterfeit and steal digital money. Here too, the best protection for digital money is randomness galore. [Samid 2014].

### 1.1 How Soon?

This thesis envisions a future when randomness becomes “cyber oil”, the critical resource that powers up future cyber engines. The question then arises: how soon?

Clearly today (late 2016), this is not the reality in the field. Virtually all of cryptography, for all purposes, is based on ciphers, which use small keys of fixed size, and which are unable to increase the key size too much because of exponential computational burden. So when is this vision of ‘randomness rising’ going to actually happen, if at all?

As more and more of our activities steadily migrate into cyber space, more and more nation states and other powerful organizations take notice, and realize that their very well being hinges on cyber integrity. Looking to minimize their risks, all players will be steadily guided to the safe haven of randomness. By the nature of things the arena is full of many small fish and a few big fish. The small fish in the pond are very reluctant to base their welfare and survival on ciphers issued, managed, and authorized by the big players, suspecting that these cryptographic tools have access hooks, and are no defense against their prospective adversaries. Looking for an alternative, there seems to be only one option in sight: Trans Vernam Ciphers, as defined ahead: ciphers that operate on at-will size randomness and that can be gauged as to the level of security they provide, up to Vernam perfect security. Randomness is an available resource, and it neutralizes the advantage of the bigger, smarter adversary. The more imminent, and the more critical the coming cyber war, the faster this envisioned future will materialize.

### 2.0 Randomness-Powered Variable Security Paradigm

The current security paradigm is on a collision course with ultra fast computing machines, and advanced cryptanalytic methodologies. Its characteristic, fixed size, small key becomes a productive target to ever-faster brute force engines, and ever more sophisticated adversarial mathematical insight. As cryptography has risen to become the win-or-lose component of the future wars, this looming risk is growing more unacceptable by the day. Serious consumers of high-level security have often expressed their doubt as to the efficacy of the most common, most popular symmetric and asymmetric ciphers. And they are talking about financial communication in peacetime. Much more so for a country or a society fighting to maintain its civil order, and win a fierce global war.

This pending collision is inherent in the very paradigm of today's cryptographic tools. The harm of this collision can be avoided by switching to another paradigm. The alternative paradigm is constructed as a user-determined randomness protection immunized against a smarter adversary.

The idea is to replace the current line-up of complexity-building algorithms with highly simplified alternatives. Why? Complexity-building algorithms are effective only against an attacker who does not exceed, the mathematical insight of the designer. The history of math and science in general is a sequence of first regarding a mathematical objective or a challenge of science as daunting and complex, while gradually, gaining more and more relevant insight and with it identifying an elegant simplicity in exactly the same situation that looked so complex before. One may even use complexity as a metric for intelligence: the greater the complexity one sees as simplicity, the higher one's intelligence. Theoretical mathematicians have been working hard trying to prove that certain apparent complexity cannot be simplified. These efforts are unproductive so far, but even if they are successful, they relate only to the theoretical question of complexity in worst possible case, while in practical cyber security we are more interested in the common case, even in the not so common case, as long as it is not negligible in probability. And the more complex an algorithm, the more opportunity it presents for mathematical shortcuts, and hence the current slate of ciphers, symmetric and asymmetric, is at ever greater risk before the ever more formidable cryptanalytic shops popping around the world, as more countries realize that their mere survival will turn on their cyber war weaponry.

So we are looking at a shift from complexity building algorithms to simplicity wielding algorithms: algorithms that are so simple that they live no room for any computational short cut, no matter how smart the adversary.

And since the algorithms will be simple, the security will have to come from a different source. That source is randomness. And unlike the randomness of today's paradigms, which is limited, of known quantity, and participating in a cryptographic procedure of fixed measure of security—the new paradigm will feature randomness of varied and secret quantity, where said quantity is determined by the user per case, and also said quantity determines the security of the encrypted message. This means that the users, and not the cipher designer, will determine the level of security applied to their data. The open-ended nature of the consumed randomness will neuter the last resort measure of brute force cryptanalysis. The latter only works over a known, sufficiently small size randomness.

A cryptographic paradigm calling for “as needed” consumption of randomness, is inherently approaching the mathematical secrecy offered by Vernam cipher, in which case all cryptanalytic efforts are futile. Alas, Vernam cipher per se is extremely unwieldy and uncomfortable, so much so that its use in a cyber war appears prohibitive. Albeit, when one examines Shannon proof of mathematical secrecy one notices that it is not limited to Vernam per se, it is limited by the constrain that the size of key should not be smaller than the size of the encrypted plaintext. This opens the door to paradigms in which a very large key (lots of randomness) is used to encrypt successive series of plaintext messages going back and forth. As long as the total bit count of the encrypted messages is smaller than the randomness used in the key, then the correspondents will enjoy complete mathematical secrecy. The first crop of “randomness rising” ciphers do just that.

We envision, therefore the coming cyber war where combatants are loaded with sufficient quantities of high quality randomness, and consume it as the war progresses. The combatants themselves (the users) decide for each case, and each circumstances how much randomness to use.

### 3.0 Trans-Vernam Ciphers

We define trans-Vernam ciphers as ciphers, which effectively operate with any desired level of randomness (key), such that their security is a rising monotonic function with the amount of randomness used, and is asymptotically coincident with Vernam's perfect secrecy.

The term “effectively operate” implies that the computational burden is polynomial with the size of the randomness. For most of the prevailing ciphers today this is not the case. Computational burden is typically exponential with the size of the key.

Basically, a Trans-Vernam Cipher (TVC) is changing the source of security from algorithmic complexity to crude randomness. And that is for several reasons: (i) algorithmic complexity erodes at an unpredictable rate, while a measure of high-quality randomness is by its definition not vulnerable to any superior intelligence, and its cryptanalytic resistance is directly proportioned to its quantity, (ii) ciphers based on algorithmic complexity offer a fixed measure of security, which their user cannot further tailor. So naturally some use is overuse (too much security investment), and some use is underuse (too little security investment). The user is locked to whatever measure offered by the deployed algorithm. By contrast a trans-Vernam Cipher has, what can be described as, ‘neutral algorithm’ and the security is determined by the quality and quantity of the used randomness, which is the user's choice per case. So the user can choose more randomness for high value secrets, and less randomness for low value secrets; (iii) Speed and energy: the computational burden for algorithmic ciphers is high, with great energy demand, and the speed is relatively low. By contrast. a TVC cipher is fast and enjoys low energy consumption.

### 3.1 Security Perspective

Nominal ciphers offer a fixed security expressed in the intractability they offer to their cryptanalyst. This security is largely independent of the amount of plaintext processed, and is limited by the brute force strategy that is guaranteed to crack the cipher. More efficient cryptanalysis may happen on account of unexpected highly efficient computing machines, or on account of unexpected mathematical insight. From a purely cryptographic standpoint there is no limit on the amount of text that is used by a given cipher over the same key, except to the extent that more will be compromised should the key be exposed. That means that if the intractability wall holds, the amount of text can be as large as desired.

By contrast, Trans-Vernam ciphers using a fixed key will offer an eroding level of security commensurate with the amount of plaintext used over the same key. Why then even think of replacing nominal fixed-security ciphers with TVC, which offer less and less security as more plaintext is processed? The reason is simple: the initial security offered by TVC, namely when the amount of plaintext is small, is higher than any security offered by nominal ciphers. And what is more, the growing loss of security, as the amount of plaintext grows is well gauged, and will rationally figure out into the user's risk analysis. While nominal ciphers offer a fixed intractability, TVC first offer perfect mathematical secrecy (Vernam security), then slide into “equivocation security”, and as more and more plaintext is coming through, the resultant security is effected through intractability. And of course, once the key is changed, the security readily jumps to Vernam, from there to Equivocation grade, and finally to intractability protection. We will see later that TVC keys may be replenished in an “add-on” mode where the used key is combined with new key material. Equivocation security is defined as the case where an infinitely smart and omnipotent cryptanalyst is at most facing two or more plausible plaintexts without having any means for deciding which is the plaintext that was actually used. Nominal degree of equivocation is measured by the count of plaintext options above some threshold of plausibility. Albeit, functional equivocation is more intricate, and less objective: it measures the “interpretation span” per case. For example: If the cryptanalyst faces 4 plausible plaintexts like: “we shall attack at 6 pm”, “we shall attack at 6:30 pm”, “we shall attack at 6:45 pm” and “we shall attack at 7:00 pm”, then his equivocation will be of a lesser degree compared to facing two options: “we shall attack from the north” and “we shall attack from the south”. When sufficient plaintext is going through a Trans Vernam Cipher, equivocation fades away, and plain old intractability is all that is left.

The concept of a unicity length is akin to this analysis, and in principle there is nothing new here, except in the actual figures. If Vernam (perfect) security extends only to a small measure of plaintext, and equivocation dies down soon after, in terms of plaintext processed, then there is little use for a TVC. The novelty is in finding ciphers that can offer a slow deterioration of equivocation and a similar slow deterioration of intractability. The Vernam range has been fixed by Claude Shannon: as soon as the plaintext is one bit larger than the key, mathematical secrecy is lost, and equivocation kicks in. The challenge is to create a cipher where equivocation deteriorates slowly with the amount of the plaintext, and similarly for the intractability. We will discuss ahead some sample ciphers so designed.

The simplest TVC is a slightly enhanced Vernam cipher. Given a key of size k bits, as long as the size of the plaintext (p) is smaller or equal to n (p≦k), the ciphertext is mathematically secure. For p larger, but close to k, there is no longer mathematical security but equivocation kicks in. In the simple case where the key is reused, (p=2k) then asymptotically for p→∞ equivocation evaporates. Yet, one can devise better ways for using the k key bits to encrypt a p>k plaintext.

Since a TVC can operate with very large keys without prohibitive computation, it is a serious question for the cryptanalyst as to how much key material was used. Clearly if the key is of sufficient amount compared to the plaintext then all cryptanalytic efforts are futile and wasteful. The situation is a bit better for the cryptanalyst at the equivocation zone, and more hopeful in the intractability zone.

We make a clear distinction between symmetrical and asymmetrical cryptography, and will discuss each type separately.

### 3.2 Symmetric TVC

Since Vernam is a symmetric cipher, it is natural to start the discussion of Trans Vernam ciphers with respect to symmetric species. Even within the “Vernam zone” of perfect security (p≦k) the actual use is quite inconvenient, especially in the case of group communication. Let t parties share a large enough Vernam key (size k), which they use sequentially as plaintexts are showing up. For the group to properly manage this task, it would be necessary for every party to be fully aware of all the messages that were encrypted with this key, in order to know the exact spot from where to count the next encryption. One shift, in one bit count, creates a complete nonsense at the other end because the key itself is guaranteed to be fully randomized.

Instead, one may opt for a cipher such that when used by a group, any one would be able to write to anyone else without tracking the messages others have been using with the same key, and the same cipher; mindful only of the total extent of the use. We call this the “independent use” property and the cipher “the independent use cipher”.

The following section offers some specific published Trans-Vernam ciphers in use today. One would expect a wave of similar TVC specimen to come forth and become the powerful tools for the cyber war of tomorrow. Randomness is rising, and its role in cyber defense is shaping the outcome of the emerging cyber reality.

### 3.2.1 T-Comm: Pre-Shared and AdHoc Randomness Protocol

The simplest symmetric crypto case is the case where Alice and Bob who share a secret, open a confidential line of communication passing through insecure territory. Nominally we would have them share, say, an AES key and use it until they replace it. Thereby they are vulnerable to an attacker with fast enough brute force tools, or with undisclosed mathematical insight to breach the AES complexity. Using TVC Alice and Bob might resort to T-Comm (T for transposition). In that case Alice and Bob will use a shared secret S of secret size, to create secure communication which begins with Vernam security, deteriorate to equivocation security, and ends up with intractability security—where the cryptanalyst is clueless as to which security mode he or she is facing since the size of the shared secret S is part of its secrecy. And the cryptanalyst is further clueless as to whether Alice and Bob changed their shared secret and thus have regained Vernam grade security.

The T-Comm protocol is computationally simple and it can readily handle very large size keys. T-Comm is especially of interest because on top of the shared randomness, S, it also uses ad-hoc randomness, A, which also changes as often as desired.

The T-Comm Protocol:

Alice selects a random bit sequence (nonce), R, and sends it over to Bob. Bob combines R with the shared secret, S, to form a bit sequence, Q=f(S,R). Bob then parcels Q to t consecutive non-repeat subsets. Reference [Samid 2016B] describes various ways of doing so. Bob then uses a non-algorithmic “white noise” randomness source to generate a random transposition of the t elements that comprise the sequence Q. Applying this A randomness, Bob generates a permutation of Q: Qₜ=f(Q, A), and passes Qₜ to Alice. Alice generates Q like Bob, and first she examines Qₜ to verify that it is a permutation of Q. If it is not, then either one of them made a mistake, or she is not talking to Bob. If Q and Qₜ are permutations of each other then Alice is convinced that it is Bob on the other side of the blind line. Furthermore, Alice now knows what ad-hoc randomness, A, Bob has used to transform Q to Qₜ. A can serve as the basis for Alice and Bob session communication, either as a straight transposition cipher, or as a component in a broader cipher. The off chance that Bob will be able to guess a proper permutation of Q is determined by the size of the shared secret, S, which is the choice of the user.

At any time either party may call for re-application of this so called ‘session procedure’ and continue to communicate using a different ad-hoc randomness. This is particularly called for each time the parties are mutually silent for a while, and there is a suspicion that an identity theft event got in the middle.

This T-Comm procedure is free from any heavy computation, and will work for small or large size S, R, and Q. We can prove, see [Samid 2016B] that for plaintexts P smaller than S T-Comm offers Vernam security. Above that it offers equivocation, and then gradually it drops to intractability security.

It is noteworthy that while Qₜ is exposed and hence |Q|=|Qₜ| are exposed too, and the same for R, this does not compromise S which can be larger from both R and Q.

A simple example is to construct Q such that Q=f(Sₕ,R), where Sₕ is a hash of S: Sₕ=Hash(S, R). In that case even if some n messages have been compromised and all use the same secret S, there exists equivocation as to the plaintext that corresponds to ciphertext n+1.

T-Comm is immunized from brute-force attack, and its intractability defense is determined by the user, not by the cipher designer. By choosing a nonce R of a proper size, the parties will determine the number of permutation elements, t, and with it the per-session brute force search scope for A (t!). Once a given A is tried, it may project back to an S candidate, which must then be checked against the other plaintexts for which it was used. And since S may be larger then the combined messages used with it, the cryptanalyst remains equivocated.

### 3.2.2 “Walk-in-the-Park” (WaPa) Cipher

This cipher is based on the simple idea that a trip can be described either by listing the visited destinations, or by listing the traveled roads. Anyone with a map can readily translate one description to the other. Without a map any trip with no repeat destinations can be translated from one expression to the other by simply building a map that would render both expressions as describing the same trip. So a trip described as beginning in agreed-upon starting point then visiting destinations: A, B, and C, can be matched with a trip described as beginning at the same starting point then taking roads x, y, and z. The matching map will look like:

MAP=[start]----x-----[A]------y------[B]-------z--------[C]

Cryptographically speaking, the destination list may be referred to as the plaintext, P, the list of traveled roads may be viewed as the ciphertext, C, and the map, M, may be regarded as the key that matches the two:

C=Enc(P,M);P=Dec(C,M)

Similarly to Vernam, WaPa allows for every ciphertext to be matched with a proper size plaintext, and hence, like with Vernam, possession of the ciphertext only reveals the maximum size of the corresponding plaintext, giving no preference to any possible plaintext—mathematical secrecy. See analysis in [Samid 2004, Samid 2002].

The map, or what is more poetically described as the “walking park,” is shared by the communicating parties, Alice and Bob. If the map is completely randomized then it must be of a finite size. So, inevitably, if Alice and Bob keep using this “walk in the park” cipher more and more, they, will at some point, have to revisit previously visited destinations. Once that happens then the Vernam grade of the cipher is lost. Initially the cipher will drop into equivocation mode where a given plaintext (list of visited destinations) could be matched with more than one possible ciphertext (list of traveled roads). As more and more destinations are being revisited (and hence more and more roads too) then equivocation vanishes, and sheer intractability is left to serve as a cryptanalytic wall. Exactly the TVC pattern. Alternatively, a finite size park, will be used as an arithmetic series where the next element is based on the identity of previous elements (e.g the Fibonacci series), and in that case the park may grow indefinitely, but since the fully randomized section is limited, the initial Vernam security eventually deteriorates.

It is noteworthy that the encryption and decryption effort is proportional to the amount of plaintext or ciphertext processed, regardless of the size of the map. By analogy: Walking 10 miles on a straight road takes about as much time as walking the same distance in one's backyard, going round and round. So Alice and Bob can arm themselves with a large as desired randomized park (key) to allow for a lot of plaintext to be encrypted with Vernam security followed by highly equivocated use, and the secret of the size of the park will keep their cryptanalyst in the dark as to whether any cryptanalytic effort is worthwhile or futile.

### 3.2.3 Factorial Transposition Cipher

Transposition may be the oldest and most used cryptographic primitive, but its ‘factorial’ capacity was never used in a serious way. t distinct ordered elements may show up in t! (factorial) different ways. And hence a simple transposition cipher over t elements which may use a key randomly pulled out of a key space of size t! will result in a ciphertext that may be constructed from any choice of the t! permutations. And to the extent that two or more of these permutations amount to plausible plaintexts, this simple primitive will frustrate its cryptanalyst with irreducible equivocation. It is important to emphasize that for this equivocation to play, the key space must be of size t!, which we will call ‘factorial size’, and the resultant primitive we will call ‘factorial transposition’. The practical reason why such powerful ciphers were not used is simple: t! is super exponential, it is a key space of prohibitive dimensions with respect to nominal cryptography today.

Alas, TVC is a perfect environment for factorial transposition. References [Samid 2015A, Samid 2015B] describe a factorial transposition cipher. It's intractability is proportional to the permutation size (the value of t!), clearly consistent with the TVC paradigm. Its equivocation can be readily achieved through the use of decoy: Alice and Bob share a permutation key, kεK, defined over any arbitrary number of permutation elements, t, up to a value tk!=|K|, where |K| is the size of the permutation key space K. Alice will construct a plaintext string, P, comprised of p transposition elements (p<t). She will then concatenate P with another screen to be referred to as decoy, D of size d elements, such that p+d=t. The concatenated string, Q, is comprised of q=p+d=t elements.

Applying the shared secret, k, Alice will transpose Q to Qₜ=T(Q, k) and send Qₜ over to Bob. Bob will use the shared secret k to reverse Qₜ to Q. He will then separate Q to the plaintext P and the decoy D, and be in the possession of P.

The decoy D may be so constructed that a cryptanalysts analyzing Qₜ will not be able to unequivocally determine which kεK was used because certain mixtures of P′+D′ such that P′≠P and D′≠D, will make as much sense as P and D, and the fact that the transposition is factorial keeps all plausible combinations as plausible as they were before the capture of the ciphertext. Reference [Samid 2015B] presents various ways to construct D.

By way of illustration consider a plaintext P=“We Shall Attack from the North”. Let it be parsed word-wise, and then define a decoy, D=“*South East West”. The concatenated Q=P+D=P∥D is comprised of 10 words, which requires a key space of 10!=3,628,800, from which a single key is drawn uniformly to create Qₜ, say:

### Qₜ=“South Attack*East the We North Shall West”

The intended recipient will reverse-transpose Qₜ to Q, ignore whatever is written right of the “*” sign, and correctly interpret the plaintext. A cryptanalyst will clearly find four plaintext candidates, each of which could have been transposed to Qₜ, but none of the four has any mathematical preference over the others: equivocation.

Factorial Transposition can also be extended to achieve Vernam security: Let P be an arbitrary plaintext comprised of p bits. We shall construct a decoy D as follows: D=P⊕{1}ⁿ. D will then be comprised of p bits, and the resultant Q=P+D will be comprised of 2p bits, p of them of identity “1”, and the other p bits of identity “0”. Let the parties use a factorial transposition cipher of key space, |K|=2²ⁿ and draw therefrom a random choice with which to transpose Q to Qₜ. The intended readers would readily reverse-transpose Qₜ into Q, discard the p rightmost bits in Q, and remain in possession of P. Alas, by construction each of the 2ⁿ possibilities for P (all strings of length p bits) will be a possible plaintext candidate, a homomorphic relationship with Vernam.

### 3.3 Asymmetric Ciphers

Asymmetric cryptography is the cornerstone of the global village, allowing any two strangers to forge a confidential channel of communication. In the town square, a chance meeting may result in two people whispering secrets to each other; in cyber square this happens via asymmetric cryptography. It has become the prime target of a strategic cyber warrior: to be able to disrupt this ad-hoc confidentiality in the enemy territory.

It turns out that asymmetric cryptography is based on a mathematical concept known as “one way function”. “Onewayness” is not mathematically proven, and like its symmetric counterparts is susceptible to faster computers on one hand, and greater mathematical insight on the other hand. Consequently it is not a trustworthy device in an all out, high-stakes cyber war. Randomness to the rescue.

The impressive intellectual feat to allow two strangers to forge privacy in a hostile world where adversaries listen in to any communication, has been first achieved by Ralph Merkle on the basis of sheer randomness. The Merkle solution [Merkle 1978] was a bit unwieldy and it was soon replaced by Diffie-Hellman and others [Diffie 1976] who switched from reliable but tedious randomness to unproven, but convenient one-way functions. It is time to revisit Ralph Merkle and offer a suite of asymmetric ciphers in his spirit. One way to do it, based on the “birthday principle” is presented below.

### 3.3.1 The Birthday Randomness Cipher

The well known “birthday paradox” may be expressed in a counter-intuitive result that when Alice and Bob randomly and secretly choose \sqrt{n} items from an n-items set, they have a 50% chance to have selected at least one item in common. We may offer Alice and Bob an efficient procedure to determine if they indeed have selected an item in common, and if so, which is it. If the answer is in the negative, then they try again, and repeat until they succeed, at which point that common selection will serve as a shared secret, which Eve, the eavesdropper, will eventually identify by analyzing the shared-item determination procedure vis-à-vis the known selection set. Since Eve does not know either Alice's selection, nor Bob's selection, she has to test the various options, on average, through 0.5n possibilities, which will take her more time to determine the shared selection (compared to Alice and Bob). It's that time advantage that Alice and Bob can use to create a more durable shared secret. Alice and Bob may determine the n-items set, ad-hoc, just when it is needed. The items may be well-designed mathematical constructs, featuring any number of desired properties, where each property may assume preset allowed values. The distribution of these values may be nicely randomized, to insure the probabilistic chance for hitting a common item. Also, this ad-hoc randomization will limit Eve to chasing the shared secret on purely probabilistic grounds, without any hope for some mathematical shortcut. This lavish use of randomization stands in stark comparison to the common reliance on intractability (algorithmic complexity) for establishing a confidential channel between two strangers in cyber space. [Samid 2013].

### 3.3.2 Clocked Secrets

A large variety of applications exploit the notion of “clocked secrets”: secrets that come with a credible period of sustainability. Such are secrets that are expected to be compromised through the brute force strategy. Given a known adversarial computing power, a secret holder will have a credible estimate for how long his or her secret would last. And based on this estimate, a user will exploit with confidence the advantage of his or her secret. All public-key/private-key pairs are so constructed, the bitcoin mining procedure is so constructed, etc. These very popular clocked secrets rely on the hopeful assumption that the attacker is not wielding a more efficient attack, and does not expose our secrets while we can still be harmed by this exposure. Alas, given that in most cases these clocked secrets are based on algorithmic complexity, which is vulnerable to further mathematical insight, one must always suspect that the secrets so protected, are secrets no more. Alternatively, one could ‘drown’ a secret in a large enough field of high quality randomness, relying on no algorithmic complexity, and hence limiting the attack to the brute force strategy, which is more reliably predictable than adversarial mathematical insight. So one might expect that the variety of clocked-secrets applications like trust certificates, message authentication, identity verification etc., will be based on purely randomized clocked secrets which also suffer from uncertainty regarding adversarial computing power, but are immunized against superior mathematical intelligence.

### 4.0 Randomness: Generation, Handling, Distribution

The future cyber warrior will prepare for the coming conflict by harvesting randomness, and getting it ready for the big outburst, as well as for the daily skirmishes. “Pure randomness” mined from nuclear phenomena is elaborate, expensive, and not readily scalable. White Noise randomness may easily lose calibration and quality, but the most handy source—algorithms—which is the most convenient, is also the most vulnerable. So an optimal strategy would choose all three modes, and accumulate as much as is projected to be necessary for the coming cyber war.

The Whitewood Overview [Hughes 2016] eloquently states: “The security of the cryptography that makes much of our modern economy possible rests on the random numbers used for secret keys, public key generation, session identifiers, and many other purposes. The random number generator (RNG) is therefore a potential single point-of-failure in a secure system. But despite this critical importance, there continues to be difficulty in achieving high assurance random number generation in practice. The requirements for cryptographic random numbers uniformity and independence, unpredictability and irreproducibility, and trust and verifiability are clear, but the range of techniques in use today to create them varies enormously in terms of satisfying those requirements. Computational methods are fundamentally deterministic and when used alone are not sufficient for cryptographic use. Physical unpredictability (entropy) is a necessary ingredient in a cryptographic RNG. Providing sufficient entropy with assurances that it cannot be known, monitored, controlled or manipulated by third parties is remarkably challenging.”

Randomness can be interpreted as the veil behind which human unknown lies hidden, or say, randomness is the boundary of human knowledge, and therefore anyone arming himself with randomness will be immunized from an adversarial superior intellect. But that works only for pure randomness, not for ‘pseudo randomness,’ which is a sequence that looks random but is generated with human knowledge, and reflects well-defined (although veiled) pattern.

Perfect Randomness is attributed to the prospect of a nuclear event. Niels Bohr and his pioneering cohorts prevailed against luminaries like Albert Einstein in their claim that emission of nuclear radiation is guided by no deeper cause than naked probability, and hence one can measure radiation level emitted from a radioactive isotope, and interpret it as a perfect random bit sequence. For an adversary to crack this sequence, it will have to have insight that violates the tenets of modern quantum physics, with its century old track record.

In reality, many more pedestrian phenomenon are unfolding as a combined result of numerous factors, which is safely regarded as ‘unknown’. Any such phenomenon could serve as a more convenient source of randomness for which even a wild imagination cannot foresee any compromise. A simple temperature sensor in a normal room will log fluctuating temperatures, which appear random. There are numerous schemes where physical phenomena generate entropy that eventually is weaved into high quality randomness. Any physical phenomena with sufficient unpredictability may be worked into a bit sequence, where the bits are mutually independent (so we assume). The bit stream does not have to be uniform; it may feature more ones than zeros, or vice versa. By interpreting the stream by pairs: “01”→0; “10”→1, discarding “00” and “11” such independent streams would become uniform.

Any such environmental activity measurement may be used as a seed to generate larger volumes of randomness: it is common to use a choice symmetric cipher: choosing a randomized key, K, and a randomized seed, S, the computer is reading some real time activity parameter in its environment, A, and uses it as input to the selected cipher to generate a cipher-string, C=Enc_{K}(A), then computing a randomized output: R=C⊕S, then replacing S with Enc_{K}(R⊕C).

Algorithmic randomness has seen dramatic improvements in recent years. In the late 60s and early 70s Solomonov, Kolmogorov, and Chaitin [Chaitin 1987] creatively defined a binary sequence as random, if there is no shorter program that generates it. Its intellectual beauty notwithstanding, the definition was not very useful since it is not known whether a shorter generation program does exist. The pendulum then swung to the practicality of statistical tests. A bit string was declared ‘random’ if it passed the proposed tests. Alas, these were heuristic tests that refer to the expected frequency of certain substrings in the analyzed randomized sequence. These tests are still in use today despite the fact that an adversary who knows the applied test, can easily fool it. These two approaches eventually synthesized into the notion of “indistinguishability”: Given a cryptographic procedure where the source of randomness is in one case “perfect” and in the other case “algorithmic”—is there any distinction between these cases which can be spotted in polynomial-time? The difficulty in this approach is that a cipher designer cannot dictate to its cryptanalyst the method of attack, so per-case indistinguishability is dead-ended. Indistinguishability eventually evolved on probabilistic grounds, as first proposed by Goldwasser and Micali [Goldwasser 1984].

Adi Shamir, [Shamir 1981] the co-creator of RSA, has used his cipher to build a pseudo-random sequence, starting with a random sequence R₀, and computing Rᵢ₊₁=Rᵢ^{e} MOD pq where p and q are two large primes, and e is the RSA encryption key. Odd Rᵢ are interpreted as one, and even Rᵢ are interpreted as zero. Shamir used the “indistinguishability” test to anchor the cryptanalysis of his generator to the difficulty to crack RSA.

A host of competing proposals popped up. They were known as PRNG: pseudo random number generators. Blum and Micali [Blum 1984] designed a well received algorithm adhering to Shamir's configuration: starting with a random seed R₀, one computes: Rᵢ₊₁=p^{Ri} MOD q, where p and q are primes; Rᵢ is interpreted as one if it is smaller than 0.5(q−1), zero otherwise. Blum and Micali then proved that these generators will pass the indistinguishability test, as long as the discrete logarithmic challenge remains intractable.

Subsequent PRNG based their efficacy on other well-known intractable computational challenges. All in all, such tie-in conditions cast PRNG into the same uncertainty that overshadows the served ciphers themselves. One might argue that this only increases the impetus to crack these anchor ciphers.

The “proof” of these number-theoretic ciphers comes with a price—they are slow, and heavy. Faster and more efficient PRNG were proposed, many of them are known as “stream ciphers” which lend themselves to very efficient hardware implementation: an arbitrary seed is bit-wise, XORed in some complex, but fixed circuitry, and in each cycle the rightmost bit is being spit out to join the random sequence. Comprehensive guidelines were developed for these PRNG but the embarrassing truth is that consistence with such design guidelines does not prove security—further mathematical insight may totally defang these ‘efficient’ pseudo-random number generators.

From a bird's eye view, algorithmic randomness is a randomness-expansion machine: it operates on small amount of randomness (known as seed), and it expands it to a large randomized sequence. Adopting Kerckhoffs principle, [Kerchoffs 1883] we must assume the adversary knows how this machine works, and hence will compromise it, in the worst case, by applying brute force cryptanalysis. At any rate, the seed itself should be non-algorithmic in nature, so that it would not be vulnerable to an even smaller seed. Say then that a serious cryptographic shop will have to acquire non-algorithmic randomness, and use algorithmic randomness when high-quality non-algorithmic randomness is not available.

White Noise randomness can be generated ‘when needed’, which has a clear security advantage, because it does not exist before it is actually used, and hence there is no extended storage time in which to compromise it. Other sources need to be stored, and hence need to be guarded.

Randomness can be sealed in hardware; the bits dispensed as needed. One would opt to seal the container of the randomness, secured from software hacking.

Distribution of randomness cannot be done cryptographically because it cost one random bit to transfer one. Some fanciful quantum protocol are being developed where receipt of randomness, or of any data will come with the guarantee that no one else got hold of it. But as of today randomness must be distributed off-line, in some physical form. Because of the burden of physical exchange it stands to reason that major hubs in far away places will use big bulk exchanges that would last them for a long time. Close by parties may practice distribution by installment, which has the advantage of theft-security. If front line entities are given a small measure of randomness at a time, then if they are compromised and that randomness is revealed then the damage is limited.

Randomness which comes physically stored may be kept in a secure enclosure protected by various tamper-resistance technologies. The idea is to have the randomness erase itself upon unauthorized access.

One can envision a hierarchy of tactical randomness capsules fitted into capsule-batteries, which fit into a battery-stock, and so on, with strict marking and inventory management to insure that each stock battery, and capsule are accounted for.

A headquarters stock will have to constantly build up the inventory, ready for distribution as the cyber war dictates.

### 5.0 Randomness: Selected Use Cases

In its simplest form Alice and Bob will arm themselves with twin randomness and use it in end-to-end encryption through any medium in cyber space. Deploying an effective TVC, they will be immunized against any snooping, safeguard their integrity against any fast computer, or smart cryptanalyst—however much smarter than Alice and Bob, and much faster than their computing machines. If they manufactured the randomness on their own or bought it for cash, or otherwise acquired it in untraceable means then their communication is cryptographically secure, and the only way to breach it, is to steal the randomness from either one of them. Alice and Bob will be able to use their shared randomness wisely to maximize its utility. Specifically they will designate sensitivity levels, say: low-security, medium-security, high-security, and top-security. They might use standard HTML or XML markings on their communication, like a “crypto” tag: <crypto level=high>contents </crypto>. And use different partitions of their shared randomness for each security grade. The top-security level will be dedicated to communicate what partitions of their shared randomness were used for which security grade, for the coming communications. This way their cryptanalyst will remain in the dark as to whether the following ciphertext is Vernam grade, and cryptanalysis is futile, or whether it is at ‘equivocation grade’ where some information can be extracted, or perhaps it is at intractability level where brute force computing will eventually extract the plaintext.

Alice and Bob will face an optimization challenge: how to best allocate their finite shared randomness. They will have to estimate how much communication they will have to service with the current stock of randomness, and based on that, they will dynamically allocate their randomness stock among the various security levels they use. If Alice and Bob happen to communicate more than they estimated then before running out of randomness, they will leverage and expand their residual stock, using algorithmic randomness, as a means of last resort.

If Alice and Bob run out of randomness to achieve Vernam security they will drop into equivocation, and then to intractability. Once at intractability stage their security level will level off. They will still be immunized against brute force cryptanalysis because the attacker will not know how much randomness they have been using.

It is important to emphasize that unlike today when local authorities may lean on crypto providers to gain stealth access, in this emerging ‘randomness rising’ mode, the communicators, Alice and Bob, will decide, and will be responsible for their security, and the authorities will have no third party to gain access through.

If shared randomness is to be used among a group of three or more, then the group will have to set some means of monitoring the extent of use, at least in some rough measure to insure that the deployed randomness will not be over exposed. Also dynamic randomness allocation will have to be carried out with good accountability of who used which part of it, and for how much.

Hierarchies: A hierarchical organization comprised of h echelons might have full-h-echelons shared randomness, and on top of it (h−1)-echelons shared randomness for all except the lowest echelon, and so on each echelon may be allocated an echelon specific randomness and the various communicators will use the randomness that corresponds to the lowest rank recipient.

Hub Configuration: a group of communicators might assign one of them to serve as the hub. The hub will share randomness with each of the members of the group. If Alice in the group wishes to communicate securely with Bob, she notifies the hub who then uses its per-member shared randomness to deliver twin randomness to Alice and Bob. This allows the group to maximize the utility of their held randomness, given that they don't know a-priori who will need to talk to whom. It offers a new risk since the hub is exposed to all the keys.

The new privacy market will feature anonymous purchase of twin randomness sticks, (or more than a couple) to be shared physically by two or more parties for end-to-end communication. Randomness capsules will be stuffed into ‘egg capsules’ which must be cracked in order to pull the Micro SD or other memory platform for use. Untracked, it would assure its holder that it was not compromised. [Samid 2016D]

### 5.1 Identity Management

Identity is a complexity-wolf in a simplicity sheepskin: on one hand, it is amply clear that Joe is Joe, and Ruth is Ruth, but on further thought, are people who underwent a heart transplant the same as before? What about people whose' brain has been tampered with by illness or medical intervention? If identity is DNA+life experience, would a faithfully recorded database, operated on through advanced AI, assume identity? Alan Turing himself projected that identity enigma, which is pronouncedly reflected in cyber space. The earlier strategies of capturing identity in a short code (e.g. PIN, password) have given hackers an effective entry point for their mischief. And we more and more realize that to verify identity one would have to securely acquire randomized identity data from the ever-growing data assembly that comprises identities, and then randomly query an identity claimant, to minimize the chance for a hacker to be prepared for the question based on previous identity verification sessions. The more meticulously randomized this procedure, the more difficult will it be for hackers to assume a false identity. And since falsifying identities is the foundation of system penetration, this use is the foundation for a hack-free cyber space.

### 5.2 The Internet of Things

Light bulbs, thermometers, toasters, and faucets are among the tens of billions of “things” that as we speak become ‘smart’, namely they become active nodes in the overwhelming sprawl of the Internet of Things. Such nodes will be monitored remotely, and controlled from afar. It is a huge imagination stressor to foresee life with a mature Internet of Things (IOT) where all the devices that support our daily living will come alive wirelessly. Case in point: all the complex wiring that was always part and parcel of complex engineering assemblies will vanish: transponders will communicate through IP.

This vision is daunted, though, by the equally frightful vulnerability to hackers who will see private camera feeds, maliciously turn on machines, steal drones, flood rooms, start fires, etc. The only way to make the IOT work is through robust encryption to keep the hackers barking from the sideline, when the technology parade marches on.

Unfortunately, the majority of the IOT devices are so cheap that they cannot be fitted with the heavy-duty computing capabilities needed for today's algorithmic-complexity cryptography. Here again randomness is rising to meet the challenge. Memory technology is way advanced: we can store hundreds of gigabytes of randomness with great reliability, virtually on a pinhead. No device is too small to feature a heavy doze of randomness. Any of the ciphers described above, and the many more to come, will insure robust encryption for any IOT device, large or small, industrial or residential, critical or ordinary.

Ciphers like Walk-in-the-Park are readily implemented in hardware, and may be fitted on RFID tags, and on other passive devices.

### 5.3 Military Use

Kinetic wars have not yet finished their saga, so it seems, so the next big battle will incorporate cyber war in a support posture. The combating units will be equipped with randomness capsules fitted with quick erasure buttons, to prevent falling into enemy hands. Since there would be situations where the enemy captures the randomness and compromises the communication integrity, the military will have to adopt efficient procedures to (i) minimize the damage of a compromised capsule or randomness battery, and (ii) to quickly inform all concerned of a compromised randomness pack, with associated reaction procedures.

The risk of compromised randomness can be mitigated by equipping high-risk front units with limited distribution randomness, which also means a narrow backwards communication path. Also this risk may lead to a held-back distribution strategy where large quantities of randomness are assembled in secure hubs and meted out to front units on a pack by pack basis, so that captured units will cause only minimal amount of randomness loss.

One may envision pre-stored, or hidden randomness in the field of battle. The military will likely make use of the “virgin capsule” concept, or say the “egg capsule” concept, [Samid 2016D] where a physical device must be broken like an eggshell in an irreversible fashion, so that when it looks whole it is guaranteed to not have been exposed and compromised.

### 5.4 Digital Currency

Digital money is a movement that gathers speed everywhere, following the phenomenal rise of bitcoin. In a historic perspective money as a sequence of bits is the natural next step on the abstraction ladder of money (weights, coins, paper), and the expected impact of this transformation should be no less grandiose than the former: coins-to-paper, which gave rise to the Renaissance in Europe. The present generation of crypto currencies mostly hinge on those complexity-generating algorithms, discussed before—which lay bare before unpublished mathematical insight. Insight that once gained will be kept secret for as long as possible, to milk that currency to the utmost. And once such compromise becomes public—the currency as a whole vanishes into thin air because any bitcoin-like crypto currency represents no real useful human wealth. The rising role of randomness will have to take over the grand vision of digital money. We will have to develop the mathematics to allow mints to increase the underlying randomness of their currency to meet any threat—quantum or otherwise. Much as communication will be made secure by its users, opting for a sufficient quantity of randomness, so money will have to deploy the ultimate countermeasure against smart fraud—at will high-quality randomness.

A first attempt in this direction is offered by BitMint: [Samid 2012, Samid 2016D, Samid 2015A, Samid 2015B, Samid 2014] a methodology to digitize any flat currency, or commodity, (and any combinations thereto), and defend the integrity of the digitized money with as much randomness as desired—commensurate with the value of the randomness-protected coin. Micro payments and ordinary coins may be minted using pseudo-randomness, where one insures that the effort to compromise the money exceeds the value of the coveted funds. For larger amounts, both the quality and the quantity of the BitMinted money will correspondingly rise. Banks, states and large commercial enterprise will be able to securely store, pay, and get paid with very large sums of BitMinted money where the ever growing quantities of randomness, of the highest quality will fend off any and all attempts to steal, defraud, or otherwise compromise the prevailing monetary system. Digital currency will become a big consumer of this more and more critical resource: high quality randomness.

### 5.5 Plumbing Intelligence Leaks

Randomness may be used to deny an observer the intelligence latent is data use pattern, even if the data itself is encrypted. Obfuscation algorithms will produce randomized data to embed the ‘real data’ in them, such that an eavesdropper will remain ambiguous as to what is real contents, and what is a randomized fake. For example, a cyber space surfer will create fake pathways that will confuse a tracker as to where he or she has really been. Often times Alice and Bob will betray a great deal of information about their mutual business by exposing the mere extent and pattern of their communication. To prevent this leakage Alice and Bob may establish a fixed rate bit transfer between them. If they say nothing to each other, all the bits are fully randomized. If they send a message to each other, the message is encrypted to make it look randomized, and then embedded in the otherwise random stream. To the outside observer the traffic pattern is fixed and it looks the same no matter how many or how few messages are exchanged between Alice and Bob. There are of course various means for Alice and Bob to extract the message from the randomized stream. For high intensity communicators this leakage prevention requires a hefty dose of randomness.

It is expected that in a cyber war combatants will establish such obfuscating fixed rate bit streams to suppress any intelligence leakage.

### 5.6 Mistrustful Collaboration

Over seven billions of us crowd the intimate cyber neighborhood, allowing anyone to talk to everyone. Alas, we are mostly strangers to each other, and naturally apprehensive. Cryptography has emerged as a tool that is effective in inviting two (or more) mutually mistrustful parties to collaborate for their mutual benefit. The trick is to do so without requiring the parties to expose too much of their knowledge, lest it would be exploited by the other untrusted party. “Zero Knowledge” procedures have been proposed designed to pass to a party only the desired message/data/action, without also exposing anything else—procedures that prevent knowledge leakage. These procedures might prove themselves more important historically in the welfare of the planet because they don't help one to defeat the other, but to cooperate with the other. Alas, most of the prevailing zero knowledge protocols rely on algorithmic-complexity, which we have already analyzed for its fundamental deficiencies. These protocols too will be replaced with user determined knowledge leakage randomization protocols.

Let Alice and Bob be mutually aware, be parties in some ecosystem. It is impossible for Alice not to continuously pass information to Bob. Anything that Alice could have done that would be noticed by Bob, and has been done, is information. Albeit, anything that could have been done by Alice and could have been noticed by Bob, but has not been done—also passes information to Bob. Simply put: silence is a message. So, we must limit our discussion to Alice passing a string of bits to Bob such that Bob cannot learn from it more than the size of the string, and the time of its transmission. In other words: the identities of the bits will carry no knowledge. Such would only happen if Alice passes to Bob a perfectly randomized bit string. Any deviation from this perfection will be regarded as information. We can now define a practical case to be analyzed: Alice wishes to prove to Bob that she is in possession of a secret S, which Bob is fully aware of. However, since Alice suspects that on the other side of the line the party calls himself Bob is really Carla, who does not know the value of S, then Alice wishes to pass S to her communication partner such that if she talks to Carla, not to Bob, then Carla will learn nothing about S—zero knowledge leakage.

The idea will be for Alice to pass to Bob a string of bits in a way that would convince Bob that Alice is in possession of the secret, S, while Carla would learn nothing about S. This would happen by hiding a pattern for Bob to detect in a random looking string which Carla would not be able to see a pattern therein.

We describe ahead how it can be done using a string of at-will size, where the larger the string the more probable the convincing of Bob, and the denial of information from Carla. Such procedures which allow the user to determine the amount of randomization used are consistent with the randomness rising trend.

Procedure: let S be a secret held by Alice and Bob, of which Carla is ignorant but has interest in. Let S be comprised of s=2n bits. Alice would compute the complementary string S*=S⊕{1}²ⁿ and concatenate it to S to form Q=S∥S*. Q is comprised of 2s=4n bits, 2n of them are “1” and the other 2n bits are “0”. Alice will use any randomized transposition key, Kₜ to transpose Q to Q*. She would then randomly flip n “1” bits, and n “0” bits, to generate Q*_{f}, which is also comprised of 4n bits, 2n are “1” and the other 2n are “0”. Next, Alice would convey Q*_{f} to Bob (also pass to him Kₜ). Bob, aware of S, will repeat Alice's action except for the flipping which was done through randomness which Alice kept secret. However, Bob will be able to verify that Q*_{f} and Q* are the same string, apart from n “0” in Q*_{f} which are “1” in Q*, and n “1” in Q*_{f} which are “0” in Q*. And thereby Bob will be assured with at-will probability that Alice is in possession of S. Carla, unaware of S will not be able to learn from Q*_{f} anything about S, the entropy generated by the process exceeds the a-priori uncertainty for S which is 2²ⁿ. Note that for Carla every bit in Q*_{f} has a 50% chance to be of the opposite identity. By processing the secret S to a larger string, the user would increase the relevant probabilities for the integrity of the protocol. The simplicity thereto insures against some clever cryptanalytic math.

Alice may then ask Bob to flip back some f bits from the f flipped bits that generated Q*_{f}. Bob complies, and sends back the result: Q*_{ff}. Alice will then verify that all the f flipped bits are bits which she flipped in generating Q*_{f}. This way Alice will assure herself with at-will high probability that Bob is in possession of their shared secret S—or alternatively that she talks to Bob. Carla, unaware of S, will be increasingly unlikely to be able to pick f bits that comprise a subset of the f bits Alice flipped. This mutual reassurance between Alice and Bob cost both of them some reduction of security because the Man-in-the-Middle will know that f bits out of the 2s bits in Q*_{ff} do not face any flipping probability.

### 5.7 Balance of Power

Throughout the history of war and conflict, quality had typically a limited spread between the good and the bad, the talented and the not so talented, but the quantity gap was open ended, and projected power, deterrence, as well as determined outcome of battles. As conflicts progress into cyber space, we detect a growing gap in the quality component of power, all the while quantity is less important and its gaps less consequential. It was the talent of Alan Turing and his cohorts that cut an estimated two years of bloodletting from World War II. In the emerging conflicts, whether in the military, or in the law enforcement arena, a single Alan Turing caliber mind may defeat the entire front of a big state defense, and bring empires to their knees. Strong states, and powerful organizations naturally measure themselves by their overwhelming quantitative advantage, and are likely to miss this turn where the impact of quantity diminishes, and quality rises. On the other end, the small fish in the pond are likely to conclude that superior mathematical insight is their survival ticket, and put all their effort in developing mathematical knowledge that would surprise and defeat their smug enemies. In parallel, realizing that randomness is rising, these small fish will arm their own data assets with rings of randomness, and neutralize any computing advantage and any unique theoretical knowledge used by their enemies. All in all, the rising of randomness, and its immunity against superior smarts creates a new level playing field, which the big fish is likely to be surprised by. Countries like the United States need to prepare themselves for the new terms of the coming adversarial challenges both in the national security arena, and in the criminal sector.

### 6.0 Summary

This paper points out a strategic turn in cyber security where the power will be shifting from a few technology providers to the multitude of users who will decide per case how much security to use for which occasion. The users will determine the level of security for their use by determining the amount of randomness allocated for safeguarding their data. They will use a new generation of algorithms, called Trans-Vernam Ciphers, (TVC), which are immunized against a mathematical shortcut and which process any amount of selected randomness with high operational speed, and very low energy consumption.

In this new paradigm randomness will be rising to become ‘cyber-oil’. Much as crude oil which for centuries was used for heating and lighting, has overnight catapulted to fuel combustion engines and revolutionize society, so today's randomness which is used in small quantities will overnight become the fuel that powers cyber security engines, and in that, levels the playing field: randomness eliminates the prevailing big gaps between the large cyber security power houses, and the little players; it wipes out the strategic gap both in computing speed, and in mathematical insight. It dictates a completely different battlefield for the coming cyber war—let us not be caught off guard!

This new randomness-rising paradigm will imply a new era of privacy for the public along with greater challenges for law enforcement and national security concerns. The emerging Internet of Things will quickly embrace the emerging paradigm, since many IOT nodes are battery constrained, but can easily use many gigabytes of randomness.

This vision is way ahead of any clear signs of its inevitability, so disbelievers have lots of ground to stand on. Alas, the coming cyber security war will be won by those who disengaged from the shackles of the present, and are paying due attention to the challenge of grabbing the high ground in the field where the coming cyber war will be raging.

The free cryptographic community (free to develop, implement, publish, and opine) finds itself with unprecedented responsibility. As we move deeper into cyberspace, we come to realize that we are all data bare, and privacy naked, and we need to put some cryptographic clothes on, to be decent, and constructive in our new and exciting role as patriotic citizens of cyber space.

### Pseudo QuBits (Entropic Bits)

### Gauged Entropic Communication

Mimicking a String of Qubits; Randomly flipping a varying number of bits

A string S_{q} comprised of s bits, such that for a stranger each bit is either zero or one with probability of 0.5, is regarded as a Perfect Pseudo Qu String. If the identity of some bits is determined by an uneven probability then the string is regarded as Partial Pseudo Quantum String. Unlike a regular quantum string, the Pseudo Quantum String is defined with respect to a qualified observer: a stranger who observes S_{q}, without having any more information other than his observation.

A Pseudo Quantum String (PQS) is generated by its generator from a definite string S. Unlike the stranger, the generator knows how to reduce (collapse) S_{q} to S.

The generator may communicate to the stranger the identity probabilities of the bits in S_{q}, and thereby define a set of S_{q} size bit strings to which S_{q} may collapse.

If the generator generates a Perfect Pseudo Quantum String then the stranger faces the full entropy: all 2^{s} strings may uniformly end up as the string S_{q} is collapsing to S (when s=|S_{q}|, the size of S_{q}). On the other end, the generator may inform the observer that the bits in S_{q} have a uniform 1/s chance to be opposite of their marked identity. In that case the stranger will face a minimal PQS: only s possible strings to which S_{q} may collapse into.

Illustration: let S=001110. The generator randomly flips one bit to generate S_{q}=011110 then sends S_{q} to its intended recipient, informing him that one bit was flipped. The recipient will list s=6 possible candidates for S: 011111, 011100, 011010, 010110, 001110, 111110, one of them is the right S. If the generator flips all the bits (f=s) to create: Sq=110001, and so informs the reader, then the recipient has only one candidate for S—the right one. Maximum entropy occurs when f=s/2 or close to it.

The PQS is a mechanism for the generator to pass to the stranger the value of S shrouded by a well-defined measure of entropy.

Let us now bring to the party a learned observer who has some information regarding S_{q}. For him the entropy may be lower than it is for the stranger. The learned observer may be able to exclude some of the string options listed by the stranger, and face a smaller set of possibilities.

Let's consider a perfectly learned observer, defined as an observer who knows the identity of S. Such an observer will be able to check the generator by reviewing whether S is included in the set of possibilities for S based on the equivocation indicated by the generator (by defining S_{q}).

Per the above illustration: If the recipient knows that S=000111, which is not included in the set of 6 possibilities (the case where only one bit was flipped), then the recipient questions whether the sender really knows the value of S.

By communicating S_{q} to a learned observer, the generator offers probabilistic arguments to convince the recipient that the generator is aware of S. By communicating the same to a stranger, the generator shields the identity of S from the stranger by the extent of entropy

### Introduction

A Pseudo QuBit (PQubit) is defined relevant to an observer facing a measure of uncertainty as to whether the bit is as marked (“1”, or “0”), or the opposite. Different observers may be associated with different probabilities over the identity of the same PQubit. For an observer facing boundary probability (0,1) the PQbit is said to have been collapsed to its binary certainty, or say, to its generating bit. A bit string S_{q} comprised of s PQbits will collapse to its generating string S of same length.

By communicating S_{q} in lieu of S, the sender shrouds the identity of S in an entropic cloud. Thereby this communication will distinguish between a recipient who already knows S, and thereby will have well gauged level of certainty as to the sender being aware of S, and between a recipient who is not aware of S, which would thereby gain knowledge of S in a measure, not exceeding a well defined upper bound.

This distinction may be utilized in various communication protocols to help prevent unauthorized leakage of information.

A generating bit may be communicated to an observer via several PQubits: PQB₁, PQB₂, . . . . In this case the observer will compute the combined PQubit, relying also, on the relative credibility of the various PQubit writers.

While a normal Qubit offers the same uncertainty of identity to all observers, the PQubit offers uncertainty relevant to a well defined observer, and will vary from observer to observer.

In this analysis we will focus on a particular methodology for generating PQubits and PQu strings of bits: bit randomization.

### Generating PQubits: Randomization

PQ-Randomization works over a string of two or more bits. It is executed by flipping one or more bits in the string.

Consider a string S comprised of two bits (s=|S|=2). A PQ-string generator will flip one of the bits to generate S_{q}, and pass S_{q} to a reader, along with the information that one bit was flipped. The reader will then face the uncertainty of two possible strings S to which S_{q} can collapse. This measure of uncertainty is less than the uncertainty faced by the reader when he only knew that S is comprised of two bits. In the latter case there were four S candidates, and now only two.

All the while a reader who is aware of S faces a lower uncertainty as to whether the communicator really knows S, or not. The S_{q} communicator knowing the size of S, and no more, has a chance of 50% to generate an S_{q} that will help convince the knowledgeable reader that he, the sender, is aware of S.

Similarly, if the S_{q} generator will inform its reader that 1 bit has been flipped then the S-ignorant reader will view each of the s bits of S_{q} has facing a chance of 1/s to have been flipped. And the larger the value of s, the lower the entropy facing the ignorant observer. The ignorant observer will face s possible S candidates to choose from. Similarly, the confidence of the S-knowledgeable observer in the premise that the S_{q} generator is indeed aware of S is also growing as s becomes larger. The chance of the sender to guess it right is s/2^{s}.

In the general case a PQ-string generator, generating S_{q} of size s bits, will notify its readers that f bits, uniformly chosen, have been flipped. Creating an uncertainty U=U(s,f).

We can now define a “perfect PQ string” or “maximum PQ string” as one where its reader will face maximum uncertainty with regard to the identity of each bit in the string. Namely all 2s possibilities for the collapses string S will face equal probability.

We will also define a “Zero PQ String” or a “minimum PQ string” as one where there is no uncertainty facing the identity of any of the bits of the string—their marked identity is their collapsed (true) identity: S=S_{q}(Zero).

### Use Protocols

Randomization: it is advisable to randomize the secret S before randomly flipping bits thereto. It may be done by randomized transposition of the bits, or by using some encryption, with the key exposed. That way, any information that may be gleaned from the non-randomized appearance of S will be voided.

### Zero Knowledge Verification Procedure

We describe here a solution to the problem of a prover submitting secret information to a verifier who is assumed to possess the same information, and wishes to ascertain that the sender is in possession of that information, but doing so under the suspicion that the verifier does not know that secret information and is using this dialogue in order to acquire it.

This verification dilemma is less demanding than the classic zero-knowledge challenge where the prover proves his possession of secret information regardless of whether the verifier is in possession of it, or not.

### Base Procedure

Base procedure: Let S be the secret which the prover wishes to submit to the verifier. We regard S as a bit string comprised of s bits. The prover will randomly choose f bits (f<s) to be flipped, and so generate S_{q} string of same length, but with f bits flipped. The prover will then communicate to the verifier the fact that f bits have been flipped.

The verifier, aware of S will check that S and S_{q} are the same, except that exactly f bits are flipped. And based on the values of s and f the verifier will have a known level of confidence that the prover is indeed in possession of S.

The false verifier, who is engaging in this procedure in order to acquire the secret S, ends up with unresolved equivocation comprised of all the possible S candidates that meet the criteria of having exactly f bits flipped relative to S_{q}.

This procedure allows the user to determine the probability of fraud through setting the values of s and f Given a secret S the verifier could expand it to any desired size.

### Counter Authentication

This base procedure may be extended to allow the prover to authenticate the verifier as being aware of the secret S. Of course, it is possible for the prover to exchange roles with the verifier, and accomplish this counter authentication, but it might be faster and easier to execute the following:

The prover will ask the verifier to flip back f bits out of the f bits that the prover flipped to generate S_{q}, and send the processed string, S′_{q} back to the prover. The prover will then check S′_{q} to see if the flipped back bits are indeed all selected from the f flipped bits that generated S_{q}. f′ will have to be smaller than f, since if f′=f then a man-in-the-middle (MiM) who spotted both S′_{q} and S_{q} will readily extract S.

The values of s, f, and f′ can be set such that the relevant probabilities may be credibly computed: (i) the probability that the verifier will guess proper f′ bits without knowledge of S; (ii) the probability that the MiM will be able to guess the identity of S.

The larger the value of f′ the less likely is it that a false verifier who does not know the identity of S will spot valid f′ bits. Alas, the larger the value of f′, the smaller the value of (f−f′) which is the count of remaining flipped bits in S_{q}. The MiM will also compare S_{q} to S′_{q} and identify the f′ flipped back bits, and then will only regard the remaining (s−f′) bits in the S_{q} string as PQubits.

### Zero-Leakage Procedure

The original base procedure protected a message S by shrouding it in an entropic cloud, alas some information does leak. The Man-in-the-Middle (MiM) possessing S_{q} and aware of the number of flipped bits, f, will face a set of possible S candidate S_{c} which is smaller than the maximum entropy of 2^{s} S candidates which one faces by knowing only the value of s.

If f=0 then the entropy dissipates and S_{q}=S. Same for f=s, in which cases all the bits are opposite of what they seem. The highest entropy is when f=s/2 or f=(s−1)/2, depending whether s is odd or even. In that case the MiM will associate every bit in S_{q} with a probability of 0.5 to be what it says it is, and equal probability to be the opposite. This is still less than the entropy situation facing one who knows only the value of s.

In general the number of S candidates (the size of S_{c}) is given by:

|S_{c}|=s!/f!(s−f)!

For s=20, f=10 we have: |S_{c}|=s!/(f!*(s−f)!)=184,756 out of possible 1,048,576 strings. Alas, the entropic cloud grows fast: for s=100, and f=50 the size of S_{c} is |S_{c}|=10²⁹.

In order to achieve zero leakage one may use the following procedure:

Let a secret string S be comprised of s=2n bits. We define a complementary string S* as follows: S*=S XOR {1}²ⁿ, and construct a concatenation R=S∥S* comprised of 2s=4n bits, s of them are “1” and the other s bits are “0”. The prover will then transpose R randomly to Tₜ using a non-secret transposition key Kₜ, and then the prover will flip n “1” bits in R (selected randomly), and n “0” bits in R, also selected randomly. This will create an entropic cloud (a PQstring) of size:

|S_{c}|=(2s)!/(s!*s!)

which is comprised of s multiplication pairs: (2s−i)/(s−i) for i=0, 1, . . . s−1, which is more than 2^{s}, and hence the MiM faces complete blackout (zero knowledge leak) with respect to the secret S.

### Randomized Signatures

Consider the case where a bit string S comprised of s bits carries a value via its bit count: v(s), regardless of the identity of these bits. In that case it would be possible to use a pseudo-qu-string (PQstring) to sign S.

Let S₀ be the original S issued by its generator. The generator passes S to a first recipient. Before doing so, the generator flips f=f₀ bits selected in a coded way, such that by identifying which are the flipped bits, it is possible to decode the message that this particular selection expressed. Since there are |S_{c}|=s!/(f!*f!) possible ways to flip f bits in S, there are possible |S_{c}| messages that can be expressed this way—captured in the entropic string (the PQstring), S⁰_{q}.

The recipient of S⁰_{q} reads the value of S correctly because:

|S|=|S⁰_{q}|

When the first recipient then passes the string (to pass its value v(s)) to a second recipient, he too may sign S by flipping f₁ out of the S—possibly flipping back some bits flipped by the generator of S, since the first recipient does not know which bits were flipped by the generator.

The second recipient will also ‘sign’ S with his choice of a message by selecting specific f₂ bits to flip in S before passing it further. And so on.

This way the string S, as it passes on and is distributed in the network, it carries the signatures of its ‘holders’ in a way that allows a knowledgeable accountant to take S at any trading stage, identify who passed S to the present trader, verify the trade by the signature left by that trader on S, and then go back to the trader that passed S to the latter trader, and read-verify the message, and continue to do so until the accountant will reach the point of origin (the generator of S).

There are various accountability applications arising from this procedure.

WaPa Key Management WaPa [Samid 2002, U.S. Pat. No. 6,823,068, Samid 2916C] operates on a basis of a key comprised of adjacent squares where each square is marked by one of the four letters X, Y, Z, and W. The adjacent squares, comprising the WaPa “map” are so marked as to comply with the “anywhich way” condition that says: let i=X,Y,Z, or W, and same for j=X,Y,Z, or W, with i≠j; let a step be defined as moving from one square to the next through one of the four edges of that square. For all i≠j it is possible to move from any square marked i to any square marked j by stepping only on squares marked i.

The squares may be aggregated to any shape. See FIG. 1 (a). However, as marked in FIG. 1(b) the “anywhich way” condition is not satisfied anywhere. A slightly different map as in FIG. 1 (c) is fully compliant.

The smallest compliant map is 3×3 (See FIG. 1 (d)), and FIG. 1 (e) shows two examples. It's called the “basic block”.

There is a finite number of distinct markings over a 3×3 map (a basic block). This distinct markings (1920) will be regarded as the alphabet of the basic block, A.

Let M₁ and M₂ be two compliant maps. Let M₁₂ be a map constructed by putting M₁ and M₂ adjacent with each other—that is, sharing at least one edge of one square. It is clear that M₁₂ is a compliant map. See FIG. 2. which shows three versions: M₁₂, M′₁₂, M″₁₂.

One would make a list of the A “letters”, namely all the possible markings of a basic block (1920), and then agree on a construction scheme for mounting the blocks one upon the other to create an ever larger compliant WaPa map. See FIG. 3, where (b) shows the mounting rule in the form of a spiral. Any other well defined scheme for how and where to mount the next basic block will do.

Based on the above, any natural number, K, will be properly interpreted to build a WaPa map. As follows:

Let B be the number of letters in the alphabet, comprised of distinct basic blocks. The number is equal or less than 1920 (a different number for different blocks). Let each letter in the alphabet (each distinct basic block) be serially marked: 1, 2, . . . B.

There are numerous ways to interpret K as a series of numbers x₁, x₂, . . . xᵢ, such that for all values of i 0<xᵢ<B+1. The so identified xᵢ series will determine which letter from A to choose next when constructing the WaPa map from the basic block mounted in the agreed upon procedure.

This way any natural number K will qualify as a WaPa key.

One way to parcel K to a series x₁, x₂, . . . is as follows:

Let b be the smallest number such that 2^{b}>=B. Let K be written in its binary form. Let K be parceled out to blocks comprised of b bits each. The last bits may be complemented with zeros to count b bits per that block. The numeric value of each b-bits block will be from 0 to 2^{b}. If that value, v, is zero then it would point to B, and indicate that the next basic block will be the one marked B in the alphabet of basic blocks. If it is larger than zero and smaller than B, then it would point to some basic block in the A [1, 2, . . . B] alphabet which will be the next to be assembled in building the WaPa map. If the reading of the next b bits point to a value, v, higher than B, then one computes v² mod B to identify the next basic block to be assembled.

The alphabet from which to build the map may be comprised of any set of compliant maps, and the assembly procedure may be any well defined procedure. See FIG. 4 for examples of letters in a construction alphabet.

### WaPa Subliminal Messaging

We can build a WaPa map comprised of concentric square rings of W sandwiched between square “rings” marked with X,Y, Z while insuring compliance with the “any which way” condition (FIG. 5 (a)). Such a map could depict an outgoing path from the starting point on. At some point the path (the ciphertext) could cross over to a second full compliance map adjacent to it (FIG. 5 (d)), and then cross back to first map. This can be done with the maps marked as in FIG. 5 (c) where all the walking that takes place on the second map seems pointless because it walks over W marked rubrics (squares). However a second interpreter will have his map 2 marked as in FIG. 5 (b), where the W markings in FIG. 5 (c) are replaced with a full compliant map, and hence the back and forth traversal on map 2 which the version FIG. 5 (c) interpreter, interpreted as a wasteful W walk, is coming “alive” as a new subliminal message for the Fog 5 (b) reader.

The way WaPa is constructed, the same ciphertext may be interpreted by two readers differently. A subliminal message may be hidden from the eyes of one and visible to the other.

### REFERENCE

Samid 2002: “At-Will Intractability Up to Plaintext Equivocation Achieved via a Cryptographic Key Made As Small, or As Large As Desired—Without Computational Penalty” G. Samid, 2002 International Workshop on CRYPTOLOGY AND NETWORK SECURITY San Francisco, Calif., USA Sep. 26-28, 2002
Samid 2004: “Denial Cryptography based on Graph Theory”, U.S. Pat. No. 6,823,068
Samid 2016C: “Cryptography of Things: Cryptography Designed for Low Power, Low Maintenance Nodes in the Internet of Things” G. Samid WorldComp—16 July 25-28 Las Vegas, Nev. http://worldcomp.ucmss.com/cr/main/papersNew/LFSCSREApapers/ICM3312.pdf

### The Bit-Flip Protocol: Verifying a Client with Only Near Zero Computing Power: Protecting IOT Devices from Serving the Wrong Client

Abstract: The majority of IOT devices have near zero computing power. They respond to wireless commands which can easily be hacked unless encrypted. Robust encryption today requires computing power that many of those sensors that read temperatures, humidity, flow rates, or record audio and video—simply don't have. The matching actuators that redirect cameras, open/close pipelines etc.—likewise, don't have the minimum required computing capacity, nor the battery power to crunch loaded number-theoretic algorithms. We propose a solution where the algorithmic complexity of modern cryptography is replaced with simple bit-wise primitives, and where security is generated through large (secret) quantities of randomness. Flash memory and similar technologies make it very feasible to arm even the simplest IOT devices with megabytes, even gigabytes of high quality randomness. We propose to exploit this high quantity of randomness to offer the required security, which is credibly assessed on the sound principles of combinatorics. For example: a prover will send a verifier their shared secret S, after flipping exactly half of S bits. For any third party the flipped-bits string will be comprised of bits such that each bit has 50% chance to be what it is, or to be the opposite. For the verifier the risk that the communicator of the flipped-bits string is not in possession of the shared secret S is (i) very well established via combinatoric calculus, and (ii) is getting smaller for larger strings (e.g for |S|=1000 bits, there is 2.5% chance for a fraud, and by repeating the dialogue, say 4 times the risk if less than 1 in a million

### Introduction

The magic of global access offered by the Internet, is about to be extended ten fold to 60 or 70 billion devices sharing a cyber neighborhood. The promise of the Internet of Things is mind boggling, but on second glance one wonders if the ills of cyber wrongs and cyber criminality will not also multiply ten fold. We envision a world where billions of sensors read their environment, and billions of actuators control and manipulate the same environment—all for our benefit. But alas, with so much that is done by the IOT to support our modern life, there is so much of a risk of abuse and malpractice to mis-apply the same. Recently some researchers warned about the “nuclear option” where compact clusters of IOT devices will spread malware in an “explosive” uncontrollable way [Ronen 2016]. The same authors warn: “We show that without giving it much thought, we are going to populate our homes, offices, and neighborhoods with a dense network of billions of tiny transmitters and receivers that have ad-hoc networking capabilities. These IoT devices can directly talk to each other, creating a new unintended communication medium that completely bypasses the traditional forms of communication such as telephony and the Internet”.

In the “old Internet” we build integrity and confidentiality using modern cryptography. But the IOT is not fitting for this strategy to be copied as is. The fundamental reason to it is that most of those billions of things are cheap, simple devices, which may cost a couple of bucks, and which may be installed and launched, not to be touched again. They are not designed to carry on their back a fanciful computer processor that can crunch the complicated number theoretic algorithms that underlie modern cryptography. What's more, these devices are powered by small batteries, which would be readily drained by a latched-on computer churning the prevailing algorithms.

So, what's the alternative—to step back to pre-computer simple (very breakable) cryptography?

Not necessarily. We may exploit another technological miracle—the means to store many gigabytes of bits in a cheap, tiny flash memory card. IOT devices cannot carry sophisticated computers, which drain their batteries too fast, but they can easily and cheaply be fitted with oodles of random bits.

Randomness and Cryptography.

Cryptography feeds on randomness: it takes in the ‘payload’—the stuff that needs to be protected, mixes it with some random bits, and then issues the protected version of the payload. This can be written as follows: security is generated by using some measure of randomness and applying data “mixing” over the payload to be protected, and the random input. Now, historically, researchers opted to use as little randomness as possible, and build the required security by more elaborate data mixing. Since mixing is an energy hog, while randomness is passive affordable resource, it stands to reason that to meet this new challenge we might look for easy data mixing compensated with large amounts of affordable, easy to use, randomness.

This new strategy towards IOT security will keep this sensitive network secure against even very vicious attacks.

There is a whole suite of ciphers that are a result of the new strategy. The reader is pointed to the reference citings below [Samid 2002, 2004, 2015A, 2015B, 2016C]. In this piece we focus on a simple very common task—verifying a prover.

### Verifying an IOT Client

IOT sensors and controllers serve clients who consume their readings, and who send them behavioral instructions. The IP protocol gives access to the rest of the network and it tempts all sorts of abusers either to read readings that they should not, or to issue commands that would be harmful. It is therefore necessary for the IOT device to verify that it deals with its client, and no other.

There are numerous prover-verifier protocols to choose from but they are computing-heavy, and battery hogs. We are seeking a cheap “data mixer” combined with cheap storage technology to generate the necessary security.

The sections ahead describe a proposed solution.

### Security Based on Large Secret Quantities of Randomness

Our aim is to generate security by exploiting modern memory technology, while relying on minimum computational power. We will do it by relying on much larger quantities of randomness than has been the case so far, and by limiting ourselves to basic computational primitives that are easily implemented in hardware.

Modern ciphers rely on a few hundreds or a few thousands of random bits. We shall extend this ten, or hundred fold and beyond. We have the technology to attach to an IOT device more than 100 gigabytes of randomness. On the computation side we will use simple bit-wise primitives like ‘compare’, ‘count’, and ‘flip’.

A typical IOT device will easily be engineered to add another important element for its operation: ad-hoc non-algorithmic randomness. Say, a temperature sensor, reading ambient temperature at intervals Δt. Random environmental effects will move the reading up and down. A simple computing device will generate a “1” each time the present reading is higher than the former reading, and generate a “0” otherwise. This raw bit-string will then be interpreted as follows: a combination of “01” will be regarded as a “0”; a combination of “10” will be regarded as “1”, combinations of “00” and “11” will be disregarded. This will generate a uniform randomized string. This string is not pre-shared of course, but also immunized from theft because it was generated just when it was needed, not before (ad-hoc). It is easy to see that even if the environment cools, or heats up this method will work. If the environment heats up then there will be more “1” than “0” in the raw string, or say Pr(1)>Pr(0): the probability for “1” to show up next is higher than the probability of a “0” to show up next. However the probability of a pair of zero and one is the same regardless of the order:

Pr(“01”)=Pr(“0”)*Pr(“1”)=Pr(“1”)*Pr(“0”)=Pr(“10”)

As to philosophy of operation we now build upon a modern concept of probability based security. Common protocols, like ‘zero knowledge’ types, are based on allowing the parties to replace the old fashioned message certainty with at-will probability, which in turn creates a corresponding at-will probability for adversarial advantage. We elaborate:

Cryptography is key based discrimination between those in possession of that key and all the rest. A lucky guess can produce any key and wipe out this discrimination. Security is based on the known, calculable and well managed low probability for that to happen. The unadvertised vulnerability of modern cryptography is that the apparent probability for spotting the key may be much higher than the formal one: 2⁻ⁿ for an n bits string. The complex mathematics of modern ciphers may be compromised with a clever shortcut, as has happened historically time and again. By avoiding complex algorithms one removes this vulnerability.

We also propose to exploit probability at the positive end and make greater use of it at the negative end. Nominally Alice sends Bob a message which Bob interprets correctly using his key. There is no uncertainty associated with Bob's interpretation. What if, we induce a controlled measure of uncertainty into Bob's reading of the message? Suppose we can control this uncertainty to be as low as we wish (but still greater than zero). And further suppose that in the highly unlikely case where the residual uncertainty will prevent Bob from a proper interpretation of the message, then he will so realize, and ask Alice to try again? Under these circumstances it will not be too costly for us to replace the former certainty with such a tiny uncertainty, and will do it if the pay off justifies it. It does—the tiny uncertainty described above (at Alice's end—the positive end) will loom into a prohibitive uncertainty facing Eve who tries to win Bob's false verification. And that's the trade that we propose.

Come to think about it, modern zero knowledge dialogue use the same philosophy—a small uncertainty at the positive end buys a lot of defensive uncertainty at the negative end.

### Randomness Delivers

The brute force approach to solving the Traveling Salesman problem for finding the shortest trail to visit n destinations when all n² distances are specified is O(n!)—super exponential. Yet, prospectively, it can be solved with O(n²) because the n² distances between the traveled destinations do determine the answer, which means that one must take into account the specter where a smart enough mind finds this shortcut and solves the traveling salesman problem at O(n²). The traveling salesman is regarded as an anchor problem for many intractability based security statements, and all these statements face the same vulnerability offered by yet unpublished mathematical insight.

If, on the other hand, one of the n! possible sequences of order of the n destinations is randomly selected, then there is no fear of some fantastic wisdom that would be able to spot this random selection on average in less than n!/2 trials. In short: randomness delivers guaranteed security, and is immunized against superior intelligence.

In this particular randomness bit-flipping protocol security is based on hard core combinatorics. The probability for a positive error (clearing a false prover), and the probability for a negative error (rejecting a bona fide prover) are both firmly established, The users know what is the risk that they are takings.

### The Randomness Approach to the Verifier-Prover Challenge

The simple way for a prover to prove possession of a shared secret Sec=S is to forward S to the verifier. That would insure (with nominal certainty) that the prover holds S. Alas, the verifier and prover communicate over insecure lines so Eve can capture S, and become indistinguishable from the prover. Casting this situation in terms of the present risk, ρₚᵣₑₛₑₙₜ=0, versus the future risk, ρ_{future}=1.00 where a risk ρ=1.00 is regarded as the upper bound. This is clearly a shortsighted strategy. The standard solution to this deficiency is to use a different input, d, to compute a different derived shared secret, S_{d}, for each session. It is done in the following way: Let OWF be some one-way function which takes the secret Sec=S and an arbitrary d (not previously used) to generate an output q=OWF(S,d). The verifier selects d, notifies the prover, who computes q and conveys it to the verifier. The verifier will be readily persuaded that q was computed from S, accepting a risk of ρ=1/|q| where |q| is the size of the set of all possible q values (technically true if d is randomly selected from its space). OWF and |q| may be selected to keep this risk lower than any desired level. Since each verification session is carried out with a previously unused d it so happens that Eve cannot use a former q value to cheat her way in. Ostensibly her chances to guess q right are the same each successive round: 1/|q|. Alas, this analysis ignores the possibility that the selected OWF will be cracked—namely, will become a two-way function. In that case Eve will reverse compute S from the former q, and again become indistinguishable from the prover.

We may contrast the above strategy with the one where the prover would resort to a random value, r, and use it to compute q=RND(S,r), via a random-data processing algorithm RND, then convey q (without r) to the verifier. The verifier, aware of RND and S, but not of r, will have to conclude whether the sender of q is in possession of S or not. Two kinds of mistakes are possible: verifying an imposter, and rejecting a bona fide prover. This amounts to the risk of the present ρₚᵣₑₛₑₙₜ.

Having exercised this protocol t times, Eve, the eavesdropper, would be in possession of t q values: q₁, q₂, . . . qₜ. This possession will increase the chance for Eve to successfully send the verifier qₙ₊₁. This information leakage will imply a growing future risk ρ_{future}.

Given any RND procedure the Verifier will be able to use solid combinatorics to credibly assess the two risks: ρₚᵣₑₛₑₙₜ, and ρ_{future}, and balance between them. Generally the higher ρₚᵣₑₛₑₙₜ, the lower ρ_{future}, and vice versa. It is a matter of a selection of a good RND procedure to improve upon these risks and properly balance between them.

This randomness based procedure is not vulnerable to some unpublished mathematical insight because algorithmic complexity is not relied upon in assessing security.

Whatever the present risk (ρₚᵣₑₛₑₙₜ), the randomness based procedure may be replayed as many times as necessary, and thereby reduce the risk at will. By replaying the procedure n times the risk becomes ρⁿₚᵣₑₛₑₙₜ. This “trick” does not work for solutions based on algorithmic complexity. If the algorithm is compromised then it would yield no matter how many times it is being used.

RND procedures are also computationally simple, while one way functions tend to be very burdensome from a computational standpoint, which gives a critical advantage to randomness based security when the verifier is a device in the Internet of Things, powered by a small battery or by a small solar panel. IOT devices equipped with powerful computers are also a ripe target for viral hacking, as recently argued [Ronen 2016]. Simple ad-hoc computers will neuter this risk.

### Conditions for an IOT-friendly Effective Prover-Verifier Protocol

Let Alice and Bob share a secret Sec=S for the purpose of identifying one to the other. S is a bit string comprised of s bits. Alice and Bob may be human entities or represent ‘devices’ operating within the Internet of Things (IoT). Bob needs to find a way to convince Alice that he is in possession of S (and hence is Bob), but do so in a way that Eve, the eavesdropper will not be able to exploit this event to successfully impersonate Bob.

Opting for a probability based strategy, Bob will send Alice a “proof of possession of S”, Prf=P, where P is a bit string comprised of p bits (P={0,1}^{P}). This protocol will have to comply with the following terms:

1. Persuasiveness: Alice, the verifier, receiving P will reach the conclusion that prover Bob's version of Sec=Sₚ=S:

Pr[S≠Sₚ|Prf=P]→0 for s,p→∞ (1)

2. Leakage: Eavesdropper Eve, reading Prf=P will face a sufficiently small probability to establish her version of Sec=Sₑ such that Sₑ=S:

Pr[S=Sₑ|Prf=P]]→0 for s,p→∞ (2)

Persuasiveness and leakage are the common and necessary probabilities for a prover-verifier dialogue. Albeit, we introduce a third term: abundance of proofs:

Pr[Prf=P|Sec=S]→0 for s,p→∞ (3)

Namely, there is a large number of proofs Prf=P₁, P₂, . . . that will each persuade the verifier that the prover is in possession of S.

This feature of “abundance of proofs” allows the protocol to use a durable secret S, and also to detect hacking attempts. Suppose for a given Sec=S there would have been only one proof Prf=P. In that case Eve would read P as it sails through the veins of the Internet, and replay it to Alice, persuading her that she is Bob without ever knowing the shared secret S. And because of that Alice and Bob would have to use Sec=S to generate a derived per session secret S, S′, S″ . . . so that learning the identity of P in proving possession of one (or several) session keys would not be useful for Eve to arrive at the correct value of Sec=S=Sₑ. Since the derivation formula S→S′, S″, . . . will have to be exposed, then Alice and Bob will have to rely on this formula to be a one-way type in order to benefit from this feature. “Onewayness” relies on algorithmic complexity though, and introducing it will stain the purity of the solution so far which is immunized towards further mathematical insight.

On the other hand, the abundance of proofs may be used by Bob, the prover, through randomly selecting one valid instance of the Prf set: Prf=Pᵢ i=1, 2, . . . each time he needs to prove his identity of Alice (through proving to her he holds the secret Sec=S=Sₚ). Alice will keep a log of all the proofs P₁, P₂, . . . that were used before, and if any of these proofs is replayed (“as is” or with slight modification) then Alice will first spot, it, and second will be on the alert that Eve who eavesdropped on the her previous communications with Bob, is seriously trying to hack into her.

We will now present a procedure that satisfies all these three conditions.

### The Bit-Flip Protocol

We first describe the basic idea of the “Bit Flip” protocol, then we build on it.

Alice and Bob share a secret Sec=S comprised of s bits, where the value of s is part of the secret. At some later point in time Bob wishes to communicate with Alice, so Alice wishes to ascertain Bob's identity by giving Bob the opportunity to persuade her that he is in possession of S, without ever communicating S over the insecure lines they are operating at. To that end Alice picks an even number p<s and sends that number to Bob. Bob, in turn, randomly cuts a p-bits long substring, Sₚ, from S: Sₚ⊂S. Then Bob—again, randomly—flips half the bits in Sₚ to generate the proving string P, which he sends to Alice in order to prove his possession of S.

Upon receipt of P Alice overlays the string with respect to S assuming that Sₚ starting bit was the first bit in S. She then checks if the p-bits long overlaid substring of S, S[1,p], which is stretching from bit 1 in S to bit p in S is the same as the string Bob sent her, P, apart from exactly p/2 bits which are of opposite identity. If indeed P and S[1,p] share p/2 bits and disagree on the other p/2 bits then Alice concludes that Bob is in possession of their shared secret Sec=S. If not then Alice compares P with S[2,p+1]—the p-bits long substring of S which starts at bit 2 on s and ends at bit p+1 in S. If the comparison is positive then Alice verifies Bob. If not Alice continues to check P against all the p-long substrings in S. If any such substrings evaluates as a positive comparison with P then Alice verifies Bob, otherwise she rejects him.

To build a nomenclature we define an operation Rflip as follows: Let X be an arbitrary bit string comprised of x bits. Operating on X with Rflipₙ for n≦x amounts to randomly flipping n bits in X to generate a string X_{f} also comprised of x bits:

X_{f}=RflipₙX (4)

One may note that Rflipₙ X Rflipⁿ₁X because by applying Rflip n times on X there is a chance that a previously flipped bit will be flipped back. With this nomenclature we can write that Alice will verify Bob if P satisfies the following condition:

P=Rflip_{0.5p}S[i,i+p] for some i from 1 to s−p. (5)

Since flipping is symmetric, the following equation expresses the same as the former:

S[i,p+i]=Rflip_{0.5p}P] for some i from 1 to s−p (6)

### Properties of the Bit-Flip Protocol

The salient feature of the Bit-Flip protocol is that it avoids any reliance on algorithmic complexity. The entire protocol is based on randomized processes. Which means that to the extent that the deployed randomness is ‘pure’ the chance for a mathematical shortcut is zero. Or say, the only threat for breaking the security of the BF protocol is the possibility (perhaps) of applying ultra fast computing machinery.

Furthermore, the actual security projected by the protocol is fully determined by the user upon selecting the values of |S|=s, and |P|=p, plus, of course, deploying quality randomness. As we shall see below the level of confidence to be claimed by Alice for correctly concluding that the party claiming to be Bob is indeed Bob (meaning is in possession of their shared secret Sec=S) is anchored on solid probability arguments. In other words, the BF protocol allows for an exact appraisal of the persuasiveness condition, as well as the exact appraisal of the leakage condition. As to the abundance condition it is clear by construction that Bob has a well calculated large number of possible proofs, P, to prove to Alice that he is in possessions of S.

In summary, the BF protocol satisfies the persuasiveness condition, the leakage condition and the abundance condition and thereby qualifies as an IOT-friendly prover-verifier protocol.

Combinatorics Let us first check the simple case where s=p, namely, Bob, the prover, picks the full size of S (which we assume to be comprised of even number of bits) to generate the proving string P. Bob has |Prf|=p!/(0.5p)!² possible proofs such that each of these proofs P₁, P₂, . . . Pⱼ for j=1 to j=|Prf| will be a solution to the equation:

Pⱼ=Rflip_{0.5p}S[1,s] (7)

This expression is readily derived: the first bit to flip can be selected for p (=s) options. The second from the remaining (p−1) bits, and the i-th bit to flip may be selected from (p−i) options, for i=0, 1, . . . (0.5p−1) By so listing the various bit-flipped strings, we list every string (0.5p)! times, since they appear in all possible orders. So by dividing p(p−1) . . . (p−0.5p+1) by (0.5p)! we count the number of strings that would satisfy the equation above.

This is an abundance which is fully controlled by Alice and Bob by setting up the value of s (=p). Which means that if used correctly (namely randomly selecting p bits to flip) then the chance for Bob to use the exact proof twice may be made negligible, or as small as desired, by simply selecting the value of s. Say then, that if Alice keeps track of the successful proving strings P then when she spots a replay, she will be confident that it is fraudulent.

Eve who captured a proving string P will face a 50:50 chance for each bit in P to be what it is, or to be the opposite. And so she will enjoy a very meager leak, as computed ahead:

However, Eve could try to replay a modified P (=P^{m}) that would be sufficiently modified not to be rejected as a strict replay, but sufficiently similar to P to attack the protocol with a non-negligible chance to meet Alice acceptance criteria.

Should Eve flip two random bits in a previously qualified Prf=P, she will have a 25% chance to flip the pair such that the count of flipped bits will remain 0.5p, and hence Eve′ modified string P^{m} might get her verified. However, Alice will find Eve's modified string to be too close to the P string she previously used to verify Bob. After all (p−2) bits are the same in the two strings. Alice will then deduce that Eve captured P and modified it to P^{m}. This will evoke her suspicion and she will either reject Eve outright, or use one of the methods (discussed ahead) to affirm her opinion (e.g. asking Eve to send another proving string). By flipping 4 bits, or 8 bits, Eve reduces her chance to be verified to 1/16 and 1/256 respectively, but still raise Alice's suspicion because so many other bits are the same in P and in P^{m}. Eve eventually might have in her possession some t previously verified strings, and based on this leaked knowledge, try to come up with a string that would be different from all the previous strings, but still have a non-negligible chance to be verified. Indeed so, but Alice has the same information at least. She knows the identity of the previously verified strings, so she too can appraise the chance that Eve's p^{m} string is a sophisticated replay of the old strings, and act accordingly. Both Eve and Alice in the worst case, are exposed to the same data, and much as Eve can appraise her chance to be falsely verified, so does Alice—no surprises.

If Bob uses high quality ad-hoc randomness to generate his proving string P, then it would be ‘far enough’ from all the previously used t strings (the more so, for larger P).

Since every previously verified string Pᵢ satisfies:

Pᵢ=Rflip_{0.5p}S (8)

it is also true that:

S=Rflip_{0.5p}Pᵢ (9)

This reduces the size of the set that includes S from 2^{s} to the set of all S values that satisfy the above equations for all i=1, 2, . . . t

The size of the set Fᵢ of S size strings that satisfy the Rflip equation for any Pᵢ is:

|Fᵢ|=p!/(0.5p!)² (10)

Given a previously verified string Pᵢ, Eve would be able to mark |Fᵢ| strings that include the secret Sec=S. (A-priori in the case where s=p, the secret S is known to be included in the full set comprised of 2^{s} members). After spotting the first verified string P₁, Eve would be able to limit the set that includes S to the F₁ set. The shrinking of the inclusive set of S represents the leakage.

Given t verified strings P₁, P₂, . . . Pₜ, the accumulated leakage amounts to further limiting the inclusive set for S according to the condition that S will have to be included in every one of the t Fᵢ sets (i=1, 2, . . . t):

Sε(F₁∩F₂∩ . . . Fₜ) (11)

This situation raises an interesting question. Given the set of t previously verified strings P₁, P₂, . . . Pₜ, Eve could apply the brute force approach to find good S candidates: she will randomly select an S string (out of the 2^{s} possibilities), and then check if that candidate, Sₑ, satisfies:

Sₑ=RFlip_{0.5p}Fᵢ for i=1,2 . . . t (12)

If any of these t equations is not satisfied, then the candidate should be dropped. By probing for all 2^{s} candidates Eve will generate the reduced set of S candidates from where she should randomly pick her choice. This is obviously a very laborious effort, especially for large enough s values. The question of interest is whether there is a mathematical shortcut to identify the reduced set of S candidates, based on the identity of the t verified strings. Be it what it may, for security analysis we shall assume that such mathematical insight is available and rate security accordingly.

The above attack strategy is theoretically appealing but may not be very practical if after the enormous work to identify the reduced S set, that set is still too large for Eve to have a non-negligible chance to select the right S (and hence use a successful proving string P). The ‘flip a few’ bits attack, discussed above seems a more productive strategy.

In summary, Alice is fully aware as to how much information has been leaked to a persistent eavesdropper who captured P₁, P₂, . . . Pₜ and can accurately appraise the chance that Eve sent over Pₑ based solely on leaked information. It will then be up to Alice to set up a suspicion threshold, above which she will ask Bob to send another (and another if necessary) proving string, or ask Bob to flip back a specified number of bits (see discussion ahead).

Persuasiveness: The leakage formula above implies that if the leakage so far is small enough, then the chance that Alice will regard Eve as Bob is small enough, which in turn implies that if PεPrf then the prover is Bob (or at least is in possession of the shared secret Sec=S).

In other words, Alice and Bob, using the Bit-Flip protocol, may select a secret Sec=S of size s bits large enough to insure a bound risk of compromise over an arbitrary number of captured previous proving strings.

All that was over the simple (and most risky) case where p=s. The leakage becomes increasingly smaller for p<s. Albeit, the persuasiveness is also smaller.

In the general case where s>p Bob can choose (s−p) subsets to apply Rflip over. This will imply that the Prf set is larger, and thereby the blind chance to randomly select a proving string P such that PεPrf is larger. However it can still be maintained below a desired level δ.

We concluded that for s=p the size of Prf is given by:

|Prf|ₛ₌ₚ=p!/(0.5p!)² (13)

For s>p there are (s−p) situations similar to s=p, and hence:

|Prf|_{s>p}≦(s−p)(|Prf|ₛ₌ₚ)=(s−p)p!/(0.5p!)² (14)

The probability for a per chance proving string to pass as bona fide is given by:

Pr[Prf=P|S≠Sec]=|Prf|_{s>p}/2^{p}=2^{-P}(s−p)p!/(p!)² (15)

And since both s and p are selected by Alice and Bob, so is the risk that Alice faces to be falsely persuaded.

For example for s=p=40: The number of bona fide proving strings |Prf|=137,846,528,820, and the chance for Eve to select a Pₑε|Prf| is:

ρₚᵣₑₛₑₙₜ=Pr[Prf=Pₑ|p=s=40]=137846528820/2⁴⁰=0.125 (16)

This is clearly too high for comfort, and remedy is called for. It may be in the simplest form of replay. If the verifier asks the prover to repeat the process, say 5 times then the probability for Eve to be accepted as Bob will shrink to 3.1*10⁻⁵

The leakage after one round will be quite limited. Eve, realizing that P was used to verify Bob, will then be able to limit the space from which to choose, from 2^{s} to p!/(0.5p!)², so the added risk for the verifier to be cheated is:

ρ_{future}(1)=1/p!/(0.5p!)²)−½^{s}=1/137846528820−1/1099511627776=10⁻¹¹ (17)

This negligible risk will rise dramatically after t>1 rounds, since the number of proving strings to choose from will be limited to those strings that would be admissible versus all t proving strings.

We shall now examine two add-on elements to this basic procedure: (1) s>p, and (2) The Re-Flip Strategy.

The s>p Strategy

When analyzing the case where the shared secret Sec=S is as large as the proving string P (|S|=s=|P|=p), we concluded that the accumulated list of verified strings P₁, P₂, . . . Pₜ effected a leakage that Eve could exploit to improve her chances to pass to Alice a bona fide string PₑεPrf. We concluded that by increasing the size of the proving string (equals the size of the secret), the chance for Eve to randomly pick a bona fide proving string was reduced, but at the same time the leakage increased too, threatening the future performance of the protocol.

This threat of increased leakage can be properly answered by the “s>p” strategy. Alice and Bob may share a secret S of size |S|=s bits larger than the prover string P of size |P|=p bits (s>p).

The “pure” way to accomplish this is to set |S|=n*|P|, where n=2, 3, . . . . This means that the shared secret will be a secret multiple of the size of the selected proving string. Bob will then randomly choose one of the n p-size strings, apply the RFlip_{0.5p} operator to it, and send the result over to Alice. Alice will check each one of the n strings to see if the string Bob sent qualifies as belonging to Prf for any one of the n options. If it does, then Alice verifies Bob.

A somewhat less “pure” way for accomplishing the same is to set |S|=|P|+n, where n=1, 2, . . . . Bob will then pick a subset of S (Sₚ⊂S), and apply Flip₀₅ₚ to it, to generate a proving string, P, for Alice to evaluate. Alice will check if the proving string P qualifies for any of the n subsets in S. If it does, then Alice verifies Bob. Otherwise Alice rejects him.

This simple twist will stop the leakage. As long as Eve does not know the size of the shared secret Sec=S, she cannot link the information from the t previously verified proving strings because for any two previously verified proving strings Eve would not know whether they are the result of Rflip application to the same base string or not. If Eve somehow finds out the size of the shared secret and the method in which it is being parceled out to base strings to apply RFlip over, then she can apply some useful combinatoric calculus. But even in this case, a modest over size s>p will build a very robust security, which like before, is very accurately appraised by Alice.

By allowing for every proving string, P, to qualify over any of the n options afforded by the “s>p strategy” Alice increases the risk for Eve to randomly pick a bona fide proving string PₑεPrf. The probability for such pick will be an n-multiple of the s=p probability:

Pr[PₑεPrf∥S|=n*|P|]=1−(1−(p!/((0.5p)!²*2^{p}))ⁿ (18)

which should not pose any serious problem because Alice and Bob can select S and P such that this risk will be below any desired threshold.

In summary, the “s>p” strategy, stops the leakage of the “s=p” strategy, and does so at a very reasonable cost of proper bit size for the shared secret Sec=S and for the proving string P.

Note: the above discussion is limited to Bob flipping half of the bits in the flipped string. This ratio may also be changed. Bob can be asked by Alice to flip only a quarter, or only, say 50 bits in the flipped strings. This will affect the results, but will not fundamentally modify the equations.

### The Re-Flip Strategy

Alice in essence tries to distinguish between a proving string P sent to her by Bob to prove his possession of their shared secret Sec=S, and between Eve who is using the history of the Alice-Bob relationship to successfully guess a qualifying proving string P. One way to so distinguish is to ask a follow up question that references the flipped bits in P. Bob would know which bits he flipped, but Eve will not. The question may be a simple re-flip: Alice asks Bob to flip back some f′ bits in P—that is to undo the original flipping over a random choice of f′<0.5p bits. Of course if f′=0.5p then Bob will flip back all the bits he originally flipped and thereby expose S. So f′ must be quite small, yet large enough to suppress the chance for Eve to successfully respond to this challenge.

There is an infinite number of questions that Alice can ask with relevance to the flipped bits. Some may be quite sophisticated and allow for only minimal information leakage. But again, the important point is that for any such question Alice and Bob can credibly appraise both the present risk (ρₚᵣₑₛₑₙₜ), and the future risk (ρ_{future}) of their connection.

The Re-Flip strategy comes with a cost. When Bob submits to Alice the identity of the requested f flipped bits, he also signals to Eve what the identity of these f bits is, so from now on Eve is in doubt only with respect to s−f′ bits in S. If this scheme is used some k times then the effective size of S becomes s−f′k. This cost too can be mitigated by a proper choice for s and f. If Bob successfully identifies f flipped bits then the chance that he guessed his answer is ½^{c} which should be multiplied by the previous risk for falsely verifying Bob: ρ_{after}=ρ_{before}/2^{f′} So for s=100,000, a value of f′=10 will reduce the risk for an error by a factor of 1024, and if applied, say 1000 times, then, at most the effective size of S will drop to 90,000 bits.

A more sophisticated variation on the re-flip strategy is to ask several questions with known probability of guessing, but such that they do not identify the identity of any bit. For example: (1) what is the distance in bits between the two furthest apart flipped bits, (2) how many pairs of flipped bits are x bits apart?, or (3) what is the sum of the bit position count of all the flipped bits.

Illustration: Let s=p=8, and let S=10110111. There are 70=8!/(4!)² possible proving strings for Bob to send Alice (|Prf|=70) which represents a fraction of 27% out of the 2⁸=256 possible strings of size eight bits. This is too risky, so Alice resorts to the Re-Flip strategy. In its basic form Alice asks Bob to flip back 2 bits. While Bob will do so accurately, Eve would have a ¼ chance to guess correctly, and this would reduce the risk for Alice to falsely verify Eve to 0.27/4=0.067, but then reduce the effective size of the shared secret to 6 bits. Suppose that the proving string that Bob sent to Alice was: P=10000010, namely Bob flipped bits: 3,4,6,8. If Alice asks for the sum of the positions of the flipped bits, Bob will answer: 3+4+6+8=21.

### Numbers

In this section we present the Bit-Flip protocol with numbers. We first refer to the case where s=p: |S|=|P|. The table below lists the size of Prf—the set of all the bona fide strings, namely the strings that satisfy the equation: P=Rflip_{0.5p} S, as well as the risk (ρₚᵣₑₛₑₙₜ) for Eve to randomly pick a bona fide proving string, on a single try, on five tries and ten.

ρ-present

| s = p | \|Prf\| | one round | five founds | 10 rounds |
|---|---|---|---|---|
| 20 | 184756 | 0.18 | 1.69E−04 | 2.90E−08 |
| 50 | 1.26E+14 | 0.11 | 1.78E−05 | 3.18E−10 |
| 100 | 1.01E+29 | 0.08 | 3.19E−06 | 1.01E−11 |
| 250 | 9.12E+73 | 0.05 | 3.25E−07 | 1.06E−13 |
| 1000 | 2.70E+299 | 0.02 | 1.02E−08 | 1.04E−16 |

It is clear that for |P|=1000 bits, for example, the shared secret S may be 10¹² times the size of the proving string, P, and the risk for a false verification will be in the range of 1/10000, on a protocol of Alice asking Bob to pass the test 10 times.

### Implementing the Flip-Bit Protocol

Alice and Bob may conclude that modest values of secret size (|S|=s), and proving string size (|P|=p) will deliver accepted level of security as indicated by strict combinatorics calculation. They might decide on selecting of ‘secret reservoir’ (Sᵣ) from where to chop off operational secrets of size |S|=s. The actual secret Sec=S may be pre-set for use on a fixed schedule, or perhaps be event driven. The existence of a large ‘secret reservoir’ offers Alice and Bob a great measure of operational flexibility. They can mutually decide to change (increase or decrease) the size of the verification secret, S, they can decide on changing the relationship between s and p (the size of the secret versus the size of the proving string), and of course, they can decide to use a new secret, at will.

Alice and Bob will be able to distinguish between a ‘dumb attack’, a ‘learned attack’ and a ‘smart attack’, and adjust their security accordingly. A dumb attack happens when Eve tries her luck with a random pick—against which the odds are well established. A ‘learned attack’ happens when Eve tries to replay a previously successful proving string, P. It indicates to Alice and Bob that Eve is actively tracking them. A ‘smart attack’ happens when Eve uses limited and well thought out modifications of previously played proving strings to maximize her odds to be falsely verified. This is the most serious challenge to the system, but credible combinatorics will fend it off. If a proving string appears ‘too close’ to a previously used string, then Alice may request another one. Awareness of such attacks may be very useful for (1) cyber intelligence purposes, and (ii) for optimizing counter measures, like: it's time to switch to the next secret segment from the secret reservoir.

The security gained through randomness herein, can always be augmented through algorithmic complexity, for good measure. This option will be discussed ahead. Also, the ad-hoc randomness (r) used by Bob to generate the proving string P may then be used by Alice and Bob as per-session shared secret, see ahead.

The Bit-Flip protocol also requires ad-hoc non pre-shared randomness. This can be implemented in non-algorithmic ways using white noise apparatus.

### Algorithmic Complexity Add-On

The randomness based security strategy described herein may be augmented at will with conventional algorithmic-complexity security. As indicated before, the secret, Sec=S, together with a per-session different number, d, serve as an input to a one-way function OWF to compute an outcome q, which is what Bob needs to prove to Alice he is in possession of. To the extent that OWF is compromised this strategy fails. However it is applied on top of the randomness strategy, that is the randomness strategy is applied over q, then algorithmic complexity serves as add-on security.

In choosing a robust OWF for IOT devices, the original constraint of light computation still applies. Most common OWF are number-theoretic and hard computing. A randomness based alternative is offered below:

### One-Way Transposition

Aiming for a minimal computational solution for a robust one-way function, one might focus on the primitive of transposition, as follows: Let S be a bit string of size s. Let r be a positive integer regarded as the ‘repeat counter’. Let us generate a permutation of S(=Sₜ) by applying the following procedure:

Consider a bit counting order over S such that when the count reaches either end of S it continues in the same direction but starting at the opposite end. Starting from the leftmost bit in S, count r bits left-to-right. The bit where the counter stopped will be pulled out of S, and placed as the rightmost bit of a new string, Sₜ. We keep referring to the former S string as S although it is now of size (s−1) bits S=S[|S|=s−1]. If the removed bit is ‘0’ then keep counting r more bits, in the same direction. If the removed bit is “1” then switch direction: instead of right to left, keep counting left to right, and vice versa. Each bit that stops the counter is removed in turn from S and placed as the leftmost bit in Sₜ. The counter is eventually stopped s times, and by then S is empty S=S[|S|=O] and Sₜ=Sₜ[|Sₜ|=s] is bona fide permutation of S. Without the switch of direction of counting, given the value of the repeat counter r, it is easy to revise Sₜ→S. But owing to the switching rule, it appears that brute force is the fastest way to reverse the permutation. And since the number of permutation is s!, it appears that reversing this “one-way transposition” routine is O(n!). Albeit, like other OWF, the risk of some hidden mathematical insight must be accounted for, and that is why OWF is recommended as a boost to randomized protection, not as a replacement thereto. See [Samid 2015B] for how to expand the above description to a complete transposition algorithm.

The table below summarizes the security enhancement options available for the Bit-Flip user:

### Bit-Flip Strategy Options:

IOT devices span a large canvass of situations where cost, risk, network, exposure etc. do vary. The effort to insure security must fit into the economic picture. What we have shown, and what is summarized below is that the BF protocol may be implemented using a variety of security features. The basic s=p mode may be augmented simply by increasing the size of the shared secret Sec=S, and the size of the proving string Prf=P. It can be augmented by shifting to the “s>p” mode, even on a modest basis, the effect is very strong. The protocol might invoke the ‘flip back’ option—simple, powerful, and of course one might add today's practice of algorithmic-complexity in the form of a one way function. And whatever the configuration of the above strategies, by repeating the BF dialogue n times the risk is hacked down by the power of n.

### Per-Session Shared Randomness

The verified proving string, P indirectly communicated to Alice a random element, R. This element may be used for this session communication between Alice and Bob. It can be done directly, or as a part in a more involved protocol. The proving string P when contrasted with the pre-flipped string may define a formation bit string where each flipped bit will be marked one, and each unflipped zero. This is not a non-leakage secret, but still high entropy secret, and it may be used to XOR plaintext on top of whatever cryptography is applied to it. This strategy involves the risk that if the per-session secret is compromised somehow, then it would lead to losing the pre-flipped secret.

For example, let S=100010, and let Bob flipped bit 2,4,6, counting from right to left, resulting in P=001000. The shared secret per session will be: 101010.

### Randomness Management

Considering an array of IOT devices, it is common to manage them through a hierarchy. The hierarchy will have parent nodes and child-less nodes. The child-less nodes are the ones on the front line, and most vulnerable to a physical assault. Simple devices will not have too much protection against a hands on attacher, and one must assume that the protective hardware was compromised, exposing the device randomness. More critical devices might be designed with any of several options for erasure of the secret randomness upon any assault on its physical integrity. As to Differential Power Analysis (DPA) the Bit-Flip cryptography is much less vulnerable because it does not use the modular arithmetic that exposes itself through current variations. Yet, a Bit-Flip designer must account for the possibility of a device surrendering its full measure of randomness. This will void the communication ring shared by all the devices that work on the same secret randomness. It is therefore prudent to map the randomness to the functional hierarchy of the devices, rather than have one key (randomness) shared by all. We then envision every parent node to have three distinct Bit-Flip keys (randomness): a “parent key” with which to communicate with its parent device, a “sibling key” with which to communicate with its sibling devices, and a “child key” with which to communicate with its children nodes. A child-less node, will have the same except the “child key”.

### Summary Note

The Bit-Flip Protocol offers a practical effective tool for the prover-verifier challenge, especially attractive for Internet of Things devices. It lends itself to energy efficient fast hardware implementation because the algorithm is based on bit-wise primitives: ‘compare’, ‘lip’, and ‘count’. It gives its user the power to determine and credibly gauge the level of security involved (level of risk). The Bit Flip protocol removes the persistent shadow of compromising mathematical shortcuts. The specific Bit-Flip solution proposed here is a first attempt. This field is ready to be investigated for more efficient algorithms operating on the same principle of using randomness to create a gauged, small, well controlled verification uncertainty in order to achieve an extended and overwhelming uncertainty (confusion) for any attacker of the system.

The feature of Bit-Flip of being immunized against compromising mathematical shortcut should render it attractive also for most nominal prover-verifier applications.

### REFERENCE

Aron 2016 “A Quantum of Privacy” j. Aron New Scientist Volume 231, Issue 3088, 27 Aug. 2016, Pages 16-17
Chaitin 1987: “Algorithmic Information Theory” Chaitin G. J. Cambridge University Press.
Hirschfeld 2007: “Algorithmic Randomness and Complexity” School of Mathematics and Computing Sciences, Downey, R, Hirschfeld, D. Victoria Univ. Wellington, New Zealand. http://www-2.dc.uba.ar/materias/azar/bibliografia/Downey2010AlgorithmicRandomness.pdf
Hughes 2016: “STRENGTHENING THE SECURITY FOUNDATION OF CRYPTOGRAPHY WITH WHITEWOOD'S QUANTUM-POWERED ENTROPY ENGINE” Richard Hughes, Jane Nordhold http://www.whitewoodencryption.com/wp-content/uploads/2016/02/Strengthening_the_Security_Foundation.pdf
Kamel 2016: “Towards Securing Low-Power Digital Circuit with Ultra-Low-Voltage Vdd Randomizers” ICTEAM/ELEN, Université catholique de Louvain, Belgium. http://perso.uclouvain.be/fstandae/PUBLIS/176.pdf
Niels 2008: “Computability and randomness” Niels A. The University of Auckland, Clarendon, Oxford, UK
Perlroth 2013: Perlroth Nicole, et al “N.S.A. Able to Foil Basic Safeguards of Privacy on Web” The New York Times, Sep. 5, 2013 http://www.nytimes.com/2013/09/06/us/nsa-foils-much-internet-encryption.html? r=0
Ronen 2016 “IoT Goes Nuclear: Creating a ZigBee Chain Reaction” Eyal Ronen( )*, Colin O'Flynn†, Adi Shamir* and Achi-Or Weingarten* PRELIMINARY DRAFT, VERSION 0.93* Weizmann Institute of Science, Rehovot, Israel
Samid 2001A: “Re-dividing Complexity between Algorithms and Keys” G. Samid Progress in Cryptology—INDOCRYPT 2001 Volume 2247 of the series Lecture Notes in Computer Science pp 330-338
Samid 2001B: “Anonymity Management: A Blue Print For Newfound Privacy” The Second International Workshop on Information Security Applications (WISA 2001), Seoul, Korea, Sep. 13-14, 2001 (Best Paper Award).
Samid 2001C: “Encryption Sticks (Randomats)” G. Samid ICICS 2001 Third International Conference on Information and Communications Security Xian, China 13-16 Nov. 2001
Samid 2002: “At-Will Intractability Up to Plaintext Equivocation Achieved via a Cryptographic Key Made As Small, or As Large As Desired—Without Computational Penalty” G. Samid, 2002 International Workshop on CRYPTOLOGY AND NETWORK SECURITY San Francisco, Calif., USA Sep. 26-28, 2002
Samid 2003A: “Non-Zero Entropy Ciphertexts (Stochastic Decryption): On The Possibility of One-Time-Pad Class Security With Shorter Keys” G. Samid 2003 International Workshop on CRYPTOLOGY AND NETWORK SECURITY (CANS03) Miami, Fla., USA Sep. 24-26, 2003
Samid 2003B: “Intractability Erosion: The Everpresent Threat for Secure Communication” The 7th World Multi-Conference on Systemics, Cybernetics and Informatics (SCI 2003), July 2003.
Samid 2004: “Denial Cryptography based on Graph Theory”, U.S. Pat. No. 6,823,068
Samid 2009: “The Unending Cyber War” DGS Vitco ISBN 0-9635220-4-3 https://www.amazon.com/Unending-Cyberwar-Gideon-Samid/dp/0963 522043
Samid 2013: “Probability Durable Entropic Advantage” G. Samid U.S. patent application Ser. No. 13/954,741
Samid 2015A: “Equivoe-T: Transposition Equivocation Cryptography” G. Samid 27 May 2015 International Association of Cryptology Research, ePrint Archive https://eprint.iacr.org/2015/510
Samid 2015B: “The Ultimate Transposition Cipher (UTC)” G. Samid 23 Oct. 2015 International Association of Cryptology Research, ePrint Archive https://eprint.iacr.org/2015/1033
Samid 2016A: “Shannon's Proof of Vernam Unbreakability” G. Samid https://www.youtube.com/watch?v=cVsLW1WddVI
Samid 2016C: “Cryptography of Things: Cryptography Designed for Low Power, Low Maintenance Nodes in the Internet of Things” G. Samid WorldComp-16 July 25-28 Las Vegas, Nev. http://worldcomp.ucmss.com/cr/main/papersNew/LF SCSREApapers/ICM3312.pdf
Samid 2016D: “Celebrating Randomness” G. Samid Digital Transactions November 2016, Security Notes
Samid 2016E: “Cryptography of Things (CoT): Enabling Money of Things (MoT), kindling the Internet of Things” G. Samid The 17^{th} International Conference on Internet Computing and Internet of Things, Las Vegas July 2016 https://www.dropbox.com/s/7dc0bgiwlnm7mgb/CoTMoT_Vegas2016_kulam_Samid.pdf?dl=0
Samid 2016F “Randomness Rising” http://wesecure.net/RandomnessRising_H6n08.pdf
Samid, 2016G “Cryptography—A New Era?”https://medium.com/@bitmintnews/cryptography-the-end-of-an-era-eceb6b12d3a9#.qn810eadn
Schneier 1997: “WHY CRYPTOGRAPHY IS HARDER THAN IT LOOKS” Counterpane Systems http://www.firstnetsecurity.com/library/counterpane/whycrypto.pdf
Shamir 1981: “On the Generation of Cryptographically Strong Pseudo-Random Sequences” Lecture Notes in Computer Science; 8th International Colloquium of Automata, Springer-Verlag
Shannon 1949: “Communication Theory of Secrecy Systems” Claude Shannon http://netlab.cs.ucla.edu/wiki/files/shannon1949.pdf
Smart 2016: “Cryptography Made Simple” Nigel Smart, Springer.
Vernam 1918: Gilbert S. Vernam, U.S. Pat. No. 1,310,719, 13 Sep. 1918.
Williams 2002: “Introduction to Cryptography” Stallings Williams, http://williamstallings.com/Extras/Security-Notes/lectures/classical.html
Zhao 2011 Zhao G. et al “A novel mutual authentication scheme for Internet of Things” Modelling, Identification and Control (ICMIC), Proceedings of 2011 International Conference.

### Meta Payment

### Embedding Meta Data in Digital Payment

A digital payment process is comprised of sending money bits from payer to payee.

These money bits may be mixed with meta-data bits conveying information about this payment. These so called meta-bits will be dynamically mixed into the money bits (or “value bits”) to identify that very payment. The combined bit stream may or may not be interpreted by the payee. The purpose of this procedure is to augment the accountability of payments and suppress fraud.

### Introduction

Digital money carries value and identity in its very bit sequence. In general a holder of these bits is a rightful claimant for its value. Alas, one could steal money bits, or one could try to redeem money bits he or she previously used for payment (and hence have no longer valid claim for their value). These avenues of abuse may be handled with a procedure in which money bits will be associated with meta bits. The combined bit stream will identify money and meta data regarding the transaction which moved the claim for that money from the payer to the payee.

Two questions arise:
What type of meta data would be used?
D How to mix the money bits with the meta bits?
D Use cases

### Type of Meta Data

The useful meta data may identify:
payer, Payee, time of transaction what was exchanged for the money transaction transaction category association

The latter refers to transactions that are part of a contract, arrangement, project, to facilitate tracking.

### Mixing Money Bits and Meta Bits

The Mixing may be:
Sectionalized
Encrypted

In the first mode, the overall stream is comprised of a section of money bits followed by a section of meta bits, followed again by a section of money bits, and again a section of meta bits, as many iterations like this as necessary.

In the second mode, the money bits and the meta bits are encrypted to a combined cipher stream, with a proper decryption option at the reading end.

In either mode one should address the issue of recurrent payment: how to handle the mixture upon dividing the money bits and using one part one way (paying further, or storing away) and the second part in another way.

### Sectionalized Mixing

In this mode the stream is comprised of digital coin header followed by coin payload, comprised of money bits and meta bits, followed by a digital coin trailer.

The payload stream is comprised of v₁ money bits followed by u₁ meta bits, followed by v₂ money bits, followed by u₂ meta bits, and so on, alternative sections money bit and meta bits.

The size of the sections may be predetermined to allow for the stream to be properly interpreted. Alternatively the sections will be of variable size and marked by starting place and ending place. Such marking may be accomplished using “Extended Bit Representation”.

### Extended Bit Representation (EBR)

Extended Bit Representation is a method that enables any amount of desired marking along a sequence of bits. Useful to identify sections in the bit stream of different meaning or purpose.

Let S be a sequence of s bits. S can be represented in an “n-extended bit representation” as follows:

1-->{11 . . . 1}ₙ

0-->{00 . . . 0}ₙ

This will replace S with an Sⁿ string of size sn bits. This extension will leave (2&upn-2) n-bits combinations free to encode messages into the bit stream.

For n=2, one may assign {00}->0, {11}->, {01}-beginning, b, {10}—closing, c.

And hence one could combine two S²₁ and S²₂ strings into:

bS²₁cbS²₂c

Or a more efficient way. One could also say that every “b” sequence that follows another b sequence (without having a “c” in between), will not be a beginning sign, but some other mark, say, unidentified bit (as to its binary identity).

For n=3 there would be 8−2=6 available markers to be encoded. So a string s=01101, will become a net S³=000111111000111. And it can be cut to incorporate some meta data D=000110 in it as follows:

S³+D=000-111-001-000110-100-111-000-111

where the hyphens “-” are introduced for readability only. The triple bit 001 marks the beginning of the D string, and the triple bit “100” marks its end.

### Encrypted Mixing

In this mode the money bits, M, and the data bits D are processed via a secret key K to produce an encrypted mix E. The payee may have possession of K and thus separate M from D, or the payee may not have possession of K. It may be that only the mint that is asked to redeem the digital money has the K.

### Recurrent Payment

Either mixing mode will work well for a payer who sends the bits to a payee who in turn redeems those bits at the mint, or any other money redemption center. But payment flexibility requires that a digital payment may be paid further from one payee to the next. This recurrent payment challenge must be handled differently depending on the mode.

### Recurrent Sectional Mixing

We discuss two methods. One where the sections are marked, using the extended bit marking, and the other is based on fixed building blocks.

### The Variable Size Method

Payer #1 passes to a payee a sequence S₁ comprised of money bit, M₁, and meta data bits D₁. The payee now becomes payer #2 and decides to may some of the M₁ money to one payee (M₁₁), and the other part to another payee: M₁₂. Such that M₁₁+M₁₂=M₁.

This will be done by passing D₁ to the two payees, and adding meta data D₂₁ for the first payee and D₂₂ to the second payee.

So the bit transfer from Payer #2 to his first payee will be:

M₁₁D₁D₂₁

And the bit transfer from payer #2 to his second payee will be:

M₁₂D₁&D₂₂

And so on. Subsequent transfers are done such that more of the bits are meta data and less of the bits are money type.

### Fixed Building Blocks

A money stream M may be broken down to fixed ‘atoms’ of value m. This will imply that m is the smallest exchanged value. A payment will be comprised of passing t m units from payer to payee. The payer will add to each unit its own meta data. If such meta data has a fixed bit count of d. The first payer passes to its payee m+d bits. m money bits and d meta data bits. That payee when turning payer will pass to its payee m+2d bits because the m money bits will have to have their first meta data batch, d, from the first payer and then have their second meta data batch from the second payer. The p payer will pass to its payee m+pd bits when passing the same fixed money unit, m.

### Recurrent Encrypted Mixing

Here there are two modes. If the payee has the decryption key then he applies it to separate the money bits from the meta bits. And then depending on the protocol decides whether to use those meta bits when she encrypts a payment package to her payee, or whether just to use her own meta data.

If the payee does not have the decryption key then he must regard the encrypted package en block per its nominal value. And when he pays the same further he will add his meta bits and re-encrypt what was paid him with the meta bits he has to add to pay ahead. In that mode it would be possible to split the money by proper indication in the meta data. The new payee may, or may not have the keys to unmix the bits, and if not then she would pay it further by marking in her meta bits how much of the money paid to it she pays to whom.

So the first payer pays M money bits accompanied with D meta bits, encrypted to become E=(M+D)ₑ. The payee receiving that payment will wish to pay M₁ to one payee of hiss, and M₂ to another payee (M₁+M₂=M). He will then combine E with metadata D₁, sch that D₁ will indicate that a cut of M₁ from M is to be paid to the first payee. Once E is matched with D₁, then the current payer will encrypt E and D₁ to created a subsequent encrypted package: E₁₁=(E+D₁)ₑ. He will also combine the same E with meta data D₂ to indicate that out of M a cut of M2 is to be paid to this second payee. And similarly the current payer will combined E with D₂ and encrypt them both: E₁₂=(E+D₂)ₑ.

It is clear that this arrangement could continue from payer to subsequent payer. It is a variety of the blockchain concept. The redeemer, or the proper examiner of the dynamics of payment will have all the keys necessarily to replay the payment history of this money.

### Use Cases

Meta data gives the relevant authority the desired visibility of payment dynamics. It is helpful in combatting fraud and misuse. It is a powerful accounting tool. The mint or the agent that is eventually redeeming the digital money will be able to follow on the trail of that money from the moment it was minted and put into circulation to the moment when it being redeemed. All the interim holders of that digital coin will be identifiable.

The content of the metadata may be comprised of mandatory parts and voluntary parts. Payers may choose to add metadata to help them analyze the payment if that payment eventually comes into challenge.

The meta data may involve payer identification in the clear or in some code.

### Cryptographic Tensors

### Avoiding Algorithmic Complexity; Randomization-Intensified Block Ciphers

Casting block ciphers as a linear transformation effected through a cryptographic key, K, fashioned in tensorial configuration: a plaintext tensor, Tₚ, and a ciphertext tensor, T_{c}, each of order n+1, where n is the number of letters in the block alphabet: Tₚ=T^{β}_{/1, /2,l, . . . ln}; T_{c}=T^{β}_{/T1, /2, . . . ln} All the (n+1) indices take the values: 1, 2, . . . t. Each tensor has tⁿ⁺¹ components. The two tensors will operate on a plaintext block p comprised of t letters, and generate the corresponding ciphertext block of same size, and when operated on the ciphertext block, the tensors will generate the plaintext block: We indicate this through the following nomenclature: [p]{TₚT_{c}}[c]. The tensors are symmetrical with respect to the n letters in the alphabet, and there are (t!)²⁽ⁿ⁺¹⁾ distinct instances for the key: |K|=|TₚT_{c}|

### Introduction

The chase after a durable algorithmic complexity is so ingrained in modern cryptography that the suggestion that it is not the only direction for the evolution of the craft may not be readily embraced. Indeed, at first glance the idea of key spaces much larger than one is accustomed to, sounds as a call in the wrong direction. Much of it is legacy: when cryptography was the purview of spooks and spies, a key was a piece of data one was expected to memorize, and brevity was key. Today keys are automated, memory is cheap, and large keys impose no big burden. As will be seen ahead one clear benefit from large keys is that they are associated with simple processing, which are friendly to the myriad of prospective battery-powered applications within the Internet of Things.

We elaborate first on the motivation for this strategic turn of cryptography, and then about the nature of this proposal.

### Credible Cryptographic Metric

Modern cryptography is plagued by lack of credible metric for its efficacy. Old ciphers like DES are still overshadowed by allegations of a hidden back door designed by IBM to give the US government stealth access to world wide secrets. AES: Nobody knows what mathematical shortcuts were discovered by those well-funded cryptanalytic workshops, who will spend a fortune on assuring us that such breakthrough did not happen. Algorithmic vulnerabilities may be “generic”, applicable regardless of the particular processed data, or they may be manifest through a non-negligible proportion of “easy instances”. While there is some hope to credibly determine the chance for a clear mathematical (generic) shortcut, there is no reasonable hope to credibly determine the proportion of “easy cases” since one can define an infinity of mathematical attributes to data, and each such attribute might be associated with an unknown computational shortcut. The issue is fundamental, the conclusion is certainly unsettling, but should not be avoided: Modern cryptography is based on unproven algorithmic complexities.

The effect of having no objective metric for the quality of any cryptographic product is very profound. It undermines the purpose for which the craft is applied. And so the quest for a credible cryptographic metric is of equally profound motivation.

We may regard as reference for this quest one of the oldest cryptographic patents: the Vernam cipher (1917). It comes with perfect secrecy, it avoids unproven algorithmic complexity, and its perfect security is hinged on perfect randomness. This suggests the question: can we establish a cryptographic methodology free from algorithmic complexity, and reliant on sheer randomness?

Now, Shannon has proven that perfect secrecy requires a key space no smaller than the message space. But Shannon's proof did not require the Vernam property of having to use new key bits for every new message bits. Also Shannon is silent about the rate of deterioration of security as the key space falls short of its Shannon's size. Vernam's cipher suffers from a precipitous loss of security in the event that a key is reused. Starting there we may be searching for a Trans Vernam Cipher (TVC) that holds on to much of its security metrics as the key space begins to shrink, and what is more, that shrinking security metrics may be credibly appraised along the way. Come to think about it, security based on randomized bits may be credibly appraised via probability calculus. A TVC will operate with an objective metrics of its efficacy, and since that metric is a function of sheer randomness not of algorithmic complexity, it becomes the choice of the user how much randomness to use for each data transaction.

Mix v. Many

Let's compare to block ciphers: an “open ended key-size cipher”, OE, and a “fixed key size cipher” FK. Let |p| be the size of the plain message, p to be handled by both ciphers. We further assume that both ciphers preselect a key and use it to encrypt the message load, p. The security of FK is based on a thorough mixing of the key bits with the message bits. The security of the open-ended key size is based on how much smaller the key is compared to a Vernam cipher where |k_{OE}|=|p| and secrecy is perfect. Anticipating a given p, the OE user may choose a sufficiently large key to insure a desired level of security. While the FK cipher user will have to rely on the desired “thorough mixing” of each block with the same key. It is enough that one such mixture of plaintext bits and key bits will happen to be an easy cryptanalytic case, and the key, and the rest of the plaintext are exposed. We have no credible way to assess “thoroughness of mixture”. The common test of flipping one plaintext bit and observing many ciphertext changes may be misleading. As we see ahead all block ciphers may be emulated by a transposition based generic cipher, and arguably all same size blocks may be of “equal distance” one from the other. By contrast, the OE user can simply increase the size of the key to handle the anticipated plaintext with a target security metric.

### Tensor Block Cryptography

Let p be a plaintext block of t letters selected from alphabet A comprised of n letters. We shall describe a symmetric encryption scheme to encrypt p into a corresponding ciphertext block c comprised also of t letters selected from the same alphabet A. c will be decrypted to p via the same key, K.

We shall mark the t ordered letters in the plaintext p as: p₁, p₂, . . . pₜ. We shall mark the t ordered letters of the corresponding ciphertext c as c₁, c₂, . . . cₜ. We can write:

p={pᵢ}^{t};c={cᵢ}^{t};c=enc(p,K);p=dec(c,K)

where enc and dec are the encryption and decryption functions respectively.

The key K is fashioned in tensorial configuration: a plaintext tensor, Tₚ, and a ciphertext tensor, T_{c}, each of order n+1, where n is the number of letters in the block alphabet:

Tₚ=T^{β}_{l1,l2, . . . ln};T^{β}_{l1,l2, . . . ln}

All the (n+1) indices take the values: 1, 2, . . . t. Each tensor has tⁿ⁺¹ components. The two tensors will operate on a plaintext block p comprised of t letters, and generate the corresponding ciphertext block of same size, and when operated on the ciphertext block, the tensors will generate the plaintext block: We indicate this through the following nomenclature:

[p]{TₚT_{c}}[c].

The tensors are symmetrical with respect to the n letters in the alphabet, and there are (t!)²⁽ⁿ⁺¹⁾ distinct instances for the key: |K|=|TₚT_{c}|

For each of the t arrays in each tensor, for each index i₁, i₂, . . . iⱼ, . . . iₜ we will have: iⱼ₁=1, 2, . . . d₁, iⱼ₂=1, 2, . . . d₂, . . . iⱼₜ=1, 2, . . . dₜ, where, d₁, d₂, . . . dₜ are arbitrary natural numbers such that:

d₁*d₂* . . . dₜ=n

Each of the 2t arrays in K is randomly populated with all the n letters of the A alphabet, such that every letter appears once and only once in each array. And hence the chance for every components of the tensors to be any particular letter of A is 1/n. We have a uniform probability field within the arrays.

Tₚ is comprised of t t-dimensional arrays to be marked: P₁, P₂, . . . Pₜ, and similarly T_{c} will be comprised of t t-dimensional arrays to be marked as C₁, C₂, . . . Cₜ.

Generically we shall require the identity of each ciphertext letter to be dependent on the identities of all the plaintext letters, namely:

cᵢ=enc(p₁,p₂, . . . pₜ)

for i=1, 2, . . . t.

And symmetrically we shall require:

pᵢ=dec(c₁,c₂, . . . cₜ)

for i=1, 2, . . . t.

Specifically we shall associate the identity of each plaintext letter pᵢ (i=1, 2 . . . t) in the plaintext block, p, via the t coordinates of pᵢ in Pᵢ, and similarly we shall associate the identity of each ciphertext letter cᵢ (i=1, 2, . . . t) with its coordinates in Cᵢ.

We shall require that the t coordinates of any cᵢ in Cᵢ will be determined by the coordinates of all the t letters in p. Andy symmetrically we shall require that the t coordinates of any pᵢ in P₁ will be determined by the coordinates of all the t letters in c.

To accomplish the above we shall construct a t*t matrix (the conversion matrix) where the rows list the indices of the t plaintext letters p₁, p₂, . . . pₜ such that the indices for pᵢ are listed as follows: i, i+1, i+2, . . . i+t−1 mod t, and the columns will correspond to the ciphertext letters c₁, c₂, . . . cₜ such that the indices in column cⱼ will identify the indices in Cⱼ that identify the identity of cⱼ. In summary the index written in the conversation matrix in row i and column j will reflect index j of plaintext letter pᵢ, and index i of ciphertext letter cⱼ.

Namely:

$$\begin{matrix}. & c 1 & c 2 & c 3 & & ct \text{-} 1 & ct \\ {p}_{1} & 1 & 2 & 3 & … & t \text{-} 1 & t \\ {p}_{2} & 2 & 3 & 4 & … & t & 1 \\ {p}_{3} & 3 & 4 & 5 & … & 1 & 2 \\ & & & & … & & \\ {p}_{t} & t & 1 & 2 & … & t \text{-} 2 & t \text{-} 1\end{matrix}$$

The conversion matrix as above may undergo t! rows permutations, and thereby define t! variations of the same.

The conversion matrix will allow one to determine cᵢ, c₂, . . . cₜ from p₁, p₂, . . . pₜ and the 2t arrays (encryption), and will equally allow one to determine p₁, p₂, . . . pₜ from c₁, c₂, . . . cₜ and the 2t arrays (decryption).

Key Space:

The respective key space will be expressed as follows: each of the 2t matrices will allow for n! permutations of the n letters of the alphabet, amounting to (n!)^{2t} different array options. In addition there are t! possible conversion matrices, counting a key space:

|K|=(n!)^{2t}t!

### Iteration

Re-encryption, or say, iteration is an obvious extension of the cryptographic tensors: a plaintext block may be regarded as a ciphertext block and can be ‘decrypted’ to a corresponding plaintext block, and a ciphertext block may be regarded as plaintext and be encrypted via two tensors as defined above to generate a corresponding ciphertext. And this operation can be repeated on both ends. This generates an extendable series of blocks q₋ᵢ, q₋₍ᵢ₋₁₎, . . . q₀, q₁, . . . qᵢ, where q₀ is the “true plaintext” in the sense that its contents will be readily interpreted by the users. Albeit, this is a matter of interpretation environment. From the point of view of the cryptographic tensors there is no distinction between the various “q” blocks, and they can extend indefinitely in both directions. We write:

[q₋ᵢ]{TⁱₚTⁱ_{c}}[q₋₍ᵢ₋₁₎]{T⁻⁽ⁱ⁻¹⁾ₚT⁽ⁱ⁻¹⁾_{c}}[q₋₍ᵢ₋₂₎]

The intractability to extract p from the w-th ciphertext, c^{(w)}, will be proportional to the multiplication of the key spaces per round:

|K_{c}^{(w)}_{==>p}|=|K|^{w}=((n!)^{2t}t!)^{w}

where w is the count rounds: p==>c′==>c″==>c′″ . . . c^{(w)}.

We shall refer to the above as base iteration which will lead to variable dimensionality iteration, and to staggered iteration.

### Variable Dimensionality Iteration

The successive block encryptions or decryptions must all conform to the same tensorial dimensionality, and be defined over t-dimensional arrays. However the range of dimensionality between successive tensorial keys may be different.

Let every tensorial index have t components, such that for a given set of TₚT_{c} tensors, each index is expressed through t dimensions such that the first dimension ranges from 1 to d₁, the second dimension ranges from 1 to d₂, . . . and index i ranges from 1 to dᵢ. (i=1, 2, . . . t). As we had discussed we can write:

d₁*d₂* . . . dₜ=n

When one iterates, one may use different dimensionality: d′₁, d′₂, . . . d′ₜ for each round, as long as:

d′₁*d′₂* . . . d′_{t′}=n

So for n=120 and t=2 the first application of tensor cryptography might be based on 2 dimensional arrays of sizes 20*6, while the second iteration might be based on 15*8. And for t=3 one could fit the 120 alphabet letters in arrays of dimensionalities: 4*5*6, or perhaps in dimensionalities.

It is noteworthy that dimensionality variance is only applicable for base iteration. It can't be carried out over staggered iteration.

### Staggered Iteration

Let tensor cryptography be applied on a pair of plaintext block and ciphertext block of t₁ letters each:

[p₁,p₂, . . . pₜ₁]{TₚT_{c}}[c₁,C₂, . . . cₜ₁]

Let us now build an iterative plaintext block by listing in order t₂ additional plaintext letters, where t₂<t₁, and complement them with (t₁−t₂) ciphertext letters from the ciphertext block generated in the first round: cₜ₂₊₁,cₜ₂₊₂, . . . cₜ₁ and then let's perform a tensor cryptography round on this plaintext block:

[pₜ₁₊₁,pₜ₂₊₂, . . . pₜ₁₊ₜ₂,cₜ₂₊₁,cₜ₂₊₂, . . . cₜ₁]{T′ₚT′_{c}}[cₜ₁₊₁,cₜ₁₊₂, . . . cₜ₁₊ₜ₁]

In summary we have:

[p₁,p₂, . . . pₜ₁₊ₜ₂]{TₚT_{c}}[c₁,c₂, . . . ,cₜ₂,cₜ₁₊₁, . . . cₜ₁₊ₜ₁]

A reader in possession of the cryptographic keys for both iterations will readily decrypt the second ciphertext block cₜ₁₊₁, . . . cₜ₁₊ₜ₁ to the corresponding plaintext block: pₜ₁₊₁, pₜ₂₊₂, . . . pₜ₁₊ₜ₂, Cₜ₂₊₁, Cₜ₂₊₂, . . . cₜ₁ Thereby the reader will identify plaintext letters pₜ₁₊₁, pₜ₂₊₂, . . . pₜ₁₊ₜ₂. She will also identify the identity of the ciphertext letters: cₜ₂₊₁, cₜ₂₊₂, . . . cₜ₂₊ₜ₁, and together with the given c₁, c₂, . . . cₜ₂ letters (from the first round), she would decrypt and read the other plaintext letters: p₁, p₂, . . . pₜ₁.

However, a reader who is in possession only of the key for the iteration (T′ₚT′_{c}) will only decrypt plaintext letters pₜ₁₊₁, pₜ₂₊₂, . . . pₜ₁₊ₜ₂, and be unable to read p₁, p₂ . . . pₜ₁. This in a way is similar to the plain staggered encryption, except that this is clearly hierarchical: the plaintext letters in the first round are much more secure than those in the second round. Because the cryptanalyst will have to crack twice the key size, meaning an exponential add-on of security.

Clearly this staggering can be done several times, creating a hierarchy where more sensitive stuff is more secure (protected by a larger key), and each reader is exposed only to the material he or she is cleared to read. All this discrimination happens over a single encrypted document to be managed and stored.

This hierarchical encryption (or alternatively ‘discriminatory encryption’) happens as follows: Let a document D be comprised of high-level (high security) plaintext stream π₁, another plaintext stream π₂ with a bit lower security level, up to π_{z}—the lowest security level. The π₁ stream will be assigned t₁ letters at a time to the first round of tensorial cryptography. π₂ stream would fit into the plaintext letters in the second round, etc. Each intended reader will be in possession of the tensorial keys for his or her level and below. So the single ciphertext will be shared by all readers, yet each reader will see in the same document only the material that does not exceed his or her security level. Moreover every reader that does not have the multi dimensional array corresponding to a given letter in the plaintext block will not be able to read it. Some formal plaintext streams might be set to be purely randomized to help overload the cryptanalyst.

Advantage Over Nominal Block Ciphers:

The above described hierarchical encryption can be emulated using any nominal ciphers. Each plaintext stream πᵢ will be encrypted using a dedicated key kᵢ, resulting in cipher cᵢ. The combined ciphertext c₁+c₂+ . . . will be decrypted using the same keys. A reader eligible to read stream πᵢ, will be given keys: kᵢ, kᵢ₊₁, . . . so she can read all the plaintext streams of lower security. This nominal emulation is artificial, and in practice each reader will keep only the portions of the total document that includes the stuff that she can read. Every reader will know exactly how much is written for the other levels, especially the higher security levels. And any breach of the nominal (mathematical intractability) cipher will expose all the security level scripts. By contrast, the described hierarchical encryption requires all the readers to keep the complete encryption file, and to remain blind as to how much is written for each higher security level. Also, using the hierarchical encryption, by default every reader gets the keys to read all the lower grade security material. And lastly, the described hierarchical encryption can only be cracked using brute force (no new mathematical insight), and the higher the security level, the greater the security of the encrypted material.

### Discriminatory Cryptography, Parallel Cryptography

Staggered Iteration Tensor Cryptography, is based on a hierarchy of arrays forming the key which may be parceled out to sub-keys such that some parties will be in possession of not the full cryptographic key, but only a subset thereto, and thus be privy to encrypt and decrypt corresponding script parts only. This discriminatory capability will enable one to encrypt a document such that different readers thereto would only read the parts of the document intended for their attention, and not the rest. This feature is of great impact on confidentiality management. Instead of managing various documents for various security clearance readers, one would manage a single document (in its encrypted form), and each reader will read in it only the parts he or she is allowed to read.

The principle here is the fact that to match an alphabet letter aεA, to its t coordinates: a₁, a₂, . . . aₜ in some t-dimensional array M, it is necessary to be in possession of M. If M is not known then for the given a, the chance of any set of subscripts: a₁, a₂, . . . aₜ is exactly 1/n where n is the number of letters in A. And also in reverse: given the set of coordinates: a₁, a₂, . . . aₜ, the chance for a to be any of the n alphabet letters is exactly 1/n. These two statements are based on the fundamental fact that for every arrays in the tensor cryptography, the n alphabet letters are randomly fitted, with each letter appearing once and only once.

In the simplest staggered iteration case t=2, we have 2 letters blocks: p₁p₂<->c₁c₂, where the encryption and decryption happens via 2t=4 matrices: P₁, P₂, C₁, C₂. Let Alice carry out the encryption: p₁p₂->c₁c₂. Alice shared the four matrices P₁, P₂, C₁, C₂ With Bob, so Bob can decrypt c₁c₂->p₁p₂. And let it further be the case that Alice wishes Carla to only decrypt c₁c₂ to p₁, and not to p₂. To achieve that aim, Alice shares with Carla matrix P₁, but not matrix P₂.

Carla will be in possession of the conversion table, and so when she processes the ciphertext: c₁c₂ she identifies the coordinates of both p₁ and p₂. Carla then reads the identity of p₁ in array P₁ in her possession. But since she has no knowledge of P₂, she cannot determine the identity of p₂. Furthermore, as far as Carla is concerned the identity of p₂ is given by flat probability distribution: a chance of 1/n to be any of the possible n letters.

With David Alice shared everything except matrix P₁, so David will be able to decrypt c₁c₂ to p₂ and not to p₁.

All in all, Alice encrypted a single document which Bob, Carla, and David, each read in it only the parts intended for their attention.

In practice Alice will write document D comprised of part D₁, and D₂. She will pad the shorter document. Such that if |D₁|>|D₂|, Alice will add ‘zeros’ or ‘dots’ or another pad letter to D₂ so that: |D₁|=|D₂|, and then Alice will construct plaintext blocks to encrypt through tensor cryptography. Each block will be constructed from two letters: the first letter from D₁, and the second letter from D₂. The corresponding ciphertext will be decrypted by Bob for the full D=D₁+D₂, while Carla only reads in it D₁ (and remains clueless about D₂), while David reads in the very same ciphertext D₂ only (and remains clueless about D₁).

Clearly D₁ and D₂ don't have to be functionally related. In general tensor cryptography over t-dimensional arrays (hence over t-letters blocks) may be used for parallel cryptography of up to t distinct plaintext messages.

Discriminatory tensor cryptography can be applied over non-iterative mode, where each plaintext letter in a t-letters block is contributed from a different file, or a different part of a given document (security discrimination), or it may be applied via the staggered iteration. The former is limited to t parallel streams, and its security is limited to ignorance of the mapping of one t-dimensional array comprised of n letters. The latter may apply to any number of parallel streams, files, or document parts, and the different secrets are hierarchical, namely the deepest one is protected the best. Also the staggered iteration implementation may allow for different volumes over the parallel encrypted files. The above can be described as follows: Let D be a document comprised of D₀ parts that are in the public domain, and some D₁ parts that are restricted to readers with security clearance of level 1 and above, and also of D2 parts that are restricted to readers with security level 2 and above, etc. Using tensor cryptography one would share all the t ciphertext matrices (C₁, C₂, . . . Cₜ), but only matrices P₁, P₂, . . . Pᵢ with all readers with security clearance of level i or above, for i=1, 2, . . . t. With this setting the same document will be read by each security level per its privileges.

There are various other applications of this feature of tensor cryptography; for example: plaintext randomization, message obfuscation.

In plaintext randomization, one will encrypt a document D as g letters i, j, l, . . . (i, j, l=1, 2, . . . t) by order, while picking the other (t−g) letters in the t-letters plaintext block as a random choice. Upon decryption, one would only regard the g plaintext letters that count, and ignore the rest. This strategy creates a strong obfuscation impact on the cryptanalytic workload.

In message obfuscation the various parallel messages may be on purpose inconsistent, or contradictory with the reader and the writer having a secret signal to distinguish between them.

### 3D Tensorial Cryptography Illustration

Tensorial Cryptography is not easy to illustrate with any practical size alphabets, and any reasonable block sizes. Let's therefore limit ourselves to a 12 letters alphabet: A, B, C, D, E, F, G, H, I, J, K, L, and a block size t=3. Accordingly any plaintext, say, p=BCJBDLKKH . . . would be parceled out to blocks of three: p=BCJ-BDL-KKH- . . . . To encrypt the plaintext one would need 2t=6 three-dimensional arrays: P₁, P₂, P₃, C₁, C₂, C₃, where each array contains all 12 letters of the alphabet in some random order, as shown in FIG. 1.

In addition one needs a conversion table, say:

| | C | C₂ | C₃ |
|---|---|---|---|
| P₁ | x | y | z |
| P₂ | z | x | y |
| P₃ | y | z | x |

where x, y, z represent the three dimensions of the 3D arrays. The table shows how the column under C₁ (x,y, z) says that the first letter in the encrypted ciphertext block will be the one which is found in array C₁ where the x-coordinate is the x-coordinate of p₁ as food in array P₁, and for which the y-coordinate is the y-coordinate of p₂, as found in array P₂. Finally, the z-coordinate of c₁ is the z-coordinate of p₃ as found in array P3. Since p₁=B has x coordinate of x=3 in P₁, and since p₂=C has coordinate y=2 in P₂, and since p₃=J has coordinate z=1 in P₃, c₁ is the letter with coordinate: {3,2,1} in C₁ which is c₁=L. Similarly we resolve the values of x, y, z for the rest of conversation table:

| | C₁ | C₂ | C₃ |
|---|---|---|---|
| P₁ | x = 3 | y = 2 | z = l |
| P₂ | z = 2 | x = 2 | y = 1 |
| P₃ | y = 1 | z = 2 | x = 3 |

And accordingly the block p=BCJ encrypts to the ciphertext block c=LJL. It will be exactly the reverse process to decryption: p₁ will be letter found in array P₁ where x=3, y=2, z=1 (the first row) points to p₁ in P₂. Similarly the rest of the plaintext block will be BCJ, in summary:

| | | C₁ | C₂ | C₃ |
|---|---|---|---|---|
| P₁ | B | x = 3 | y = 2 | z = 1 |
| P₂ | C | z = 2 | x = 2 | y = 1 |
| P₃ | J | y = 1 | z = 2 | x = 3 |
| | | L | J | L |

The key space owing to the six arrays is: (12!)⁶=1.20*10⁵², multiplied by conversion table permutation 3!=6:|K|=7.24*10⁵².

### Use Methods

The fundamental distinction of the use of tensor cryptography is that its user determines its security level. All predominant block ciphers come with a fixed (debatable) measure of security. The user only selects the identity of the key, not to cryptanalytic challenge. Tensor cryptography comes with a security level which depends on the size of the key, and a few algorithmic parameters which are also determined in the key package. One might view tensor cryptography as a cipher framework, which the key, selected by the user determines its efficacy.

Tensor cryptography may be used everywhere that any other block cipher has been used, and the responsibility for its utility has shifted from the cipher builder to the cipher user.

The user will counter balance speed, key size, and security parameters like life span of the protected data, and its value to an assailant. Sophisticated users will determine the detailed parameters of the cryptographic tensors; less sophisticated users will indicate rough preference, and the code will select the specifics.

Since the size of the key is unbound, so is the security of the cipher. It may approach and reach Vernam or say Shannon perfect secrecy, if so desired. Since the user is in control, and not the programmer of the provider of the cipher, it would be necessary for the authorities to engage the user on any discussion of appropriateness of the use of one level of security or another. It will be of a greater liability for the government, but a better assurance of public privacy and independence.

Staggered cryptography and staggered iterations offer a unique confidentiality management feature for cryptographic tensors, and one might expect this usage to mature and expand.

The fact that the key size is user determined will invite the parties to exchange a key stock, and use randomized bits therein as called for by their per session decision. The parties could agree on codes to determine how many bits to use. It would easy to develop a procedure that would determine alphabet, dimensionality and array from a single parameter: the total number of bits selected for the key.

Cryptographic tensors work over any alphabet, but there are obvious conveniences to use alphabets comprised of n=2ⁱ letters: i=1, 2, 3, . . . which are i=log(n) bits long. Dimensionality t, will be determined by integers 2^{X}₁, 2^{x}₂, . . . 2^{x}ₜ, such that: x₁+x₂+ . . . xₜ=i

### Cryptanalysis

Every mainstay block cipher today is plagued by arbitrary design parameters, which may have been selected via careful analysis to enhance the efficacy of the cipher, but may also hide some yet undetected vulnerabilities. Or better say “unpublished” vulnerabilities, which have been stealthily detected by some adversaries. To the best of my knowledge even the old work horse DES has its design notes barred from the public domain. The public is not sure whether the particular transpositions offer some cryptanalytic advantage, and the same with respect to the substitution tables, the key division, etc. And of course more modern ciphers have much more questionable arbitrariness.

By contrast, the cryptographic tensors were carefully scrubbed off from as much arbitrariness as could be imagined. Security is squarely hinged on the size of the key, and that size is user determined. The algorithmic content is as meager as could be imagined.

In fact, there is nothing more than reading letters as coordinates (or say indices, or subscripts), and relying on an array to point out to the letter in it that corresponds to these coordinates. And then in reverse, spotting a letter in an array, and marking down the coordinates that specify the location of that letter in the array. The contents of the array (part of the key) is as randomized as it gets, and no faster method than brute force is envisioned.

Of course, small keys will be brute force analyzed faster, and large keys slower. If the user has a good grasp of the computing power of his or her adversaries then she should develop a good appraisal of the effort, or time needed for cryptanalysis. So a user who wishes to encrypt a networked camera trained on her sleeping toddler while she is out at local cafe, then all she needs is for a cipher that would keep the video secret for a couple of hours. AES may be an overkill, and a battery drainer.

Coupling the cryptographic tensors with the ultimate transposition cipher (UTC) [ ] would allow for a convenient way to increase the size and efficacy of the cryptographic tensors to any degree desired. An integer serving as an ultimate transposition key may be part of the cryptographic tensor key. Such transposition key may be applied to re-randomize the n letters of the alphabet in each of the 2t arrays, as often as desired. It may be applied to switch the identities of the 2t arrays, even every block. So that the array that represents the first plaintext letter, P₁, will become some cipher array, i: Cᵢ, etc. The ultimate transposition number may be applied to re-arrange the rows in the conversion table. By applying this transposition flexibility as often as desired the user might readily approach Shannon security as often as desired.

The cryptographic tensor cryptanalyst will also be ignorant about the selection of an alphabet and its size (n), the size of the block (t), and whether or not iteration has been used. Given that all these parameters may be decided by the user in the last moment and effected by the user, right after the decision, it would be exceedingly difficult even to steal the key, not to speak about cryptanalysis. In reality the parties would have pre agreed on several security levels, and the user will mark which security level and parameters she chose for which transmission.

Of course iteration will boost security dramatically because the key size will be doubled or tripled. And hence the use of staggered iteration will allow for the more sensitive data to be known only to the highest security clearance people. And that data will enjoy the best security.

Randomization of plaintext letters will also serve as probability booster of cryptanalytic effort.

In summary, cryptographic tensors being arbitrariness-scrubbed, stand no risk of algorithmic shortcut to be compromised, and they allow only for brute force cryptanalysis, which in itself faces lack of any credible estimate as to the effort needed. And since every secret has a value which provides a ceiling for the profitable cryptanalysis, the lack of such a credible cryptanalytic estimate is a major drawback for anyone attempting to compromise these tensors.

### Two Dimensional Tensors

Two dimensional tensors (t=2) have the advantage of easy display, and hence easy study. We shall devote this section to this sub category of tensor cryptography.

The simplest case of tensor cryptography is when n=2, {0,1}, and t=2. There are 2t=4 arrays. For example: P₁=[0,1], P₂=[1,0], C₁=[1,0], and C₂=[0,1]. These four arrays, combined with the conversion matrix comprise the encryption key. We write the conversion matrix as:

| | c₁ | c₂ |
|---|---|---|
| p₁ | x | y |
| p₂ | y | x |

where x and y represent the horizontal and vertical dimensions respectively.

A clear advantage to two dimensionality is that the conversion table may be depicted by fitting the four arrays P₁, P₂, C₁, C₂ as a combined matrix such that the vertical (y) coordinate of p₁ will determine the vertical (y) coordinate of c₁, and the horizontal coordinate (x) of p₂ will determine the horizontal (x) coordinate of c₁. And respectively, the horizontal (x) coordinate of p₁ will determine the horizontal (x) coordinate of c₂ while the vertical coordinate of p₂ will determine the vertical coordinate of c₂. The combined matrix:

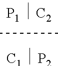

The Tensorial key in this example (4 arrays plus the conversion table) may therefore be expressed by the following construction:

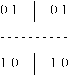

And accordingly a plaintext of any length p will be encrypted to same length ciphertext c. For example: let p=01111000. Written as blocks of 2 bits: p=01 11 10 00 and encrypted to c=10 00 01 11.

Another illustration: consider a 9 letters alphabet: A, B, C, D, E, F, G, H, I. Let's construct the combined matrix as follows:

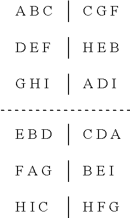

Let the plaintext, p be: p=CBAGHAAB. Dividing to blocks: p=CB AG AH AB we now encrypt block by block. First block: “CB” we therefore mark letter C in array P₁, and letter B on array P₂:

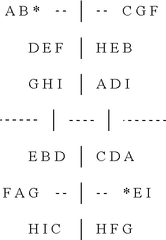

And from the combined matrix read c₁=G, and c₂=C. Similarly we mark the second block: AG, which translates to c₁=H and c₂=F.

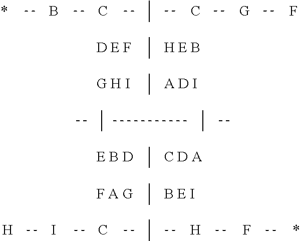

In summary plaintext p=CBAGHAAB is encrypted to c=GCHFBIFC. Decryption proceeds in reverse, using the same markings on the combined matrix.

Implementation Note (#1): Assuming that all letters are eventually expressed with binary digits, the nine letters in the above example will be expressed as four bits strings. Albeit, the full scope of 4 bits strings allows for 16 characters (letters) to be expressed. That means that in this case 16−9=7 letters will be available for meta data. For example indicating where an encrypted string starts and ends.

### Arithmetic Variety Cryptography

Abstract: The cryptographic algorithms we use are all based on standard arithmetic.

They can be interpreted on a basis of some different arithmetic where z=x+y is not necessarily the familiar addition; same for multiplication and raising to power, and similar for subtraction, division, and root extraction. By keeping the choice of such arithmetic secret one will further boost any cryptographic intractability latent in the nominal algorithm. We preset here such a variety of arithmetic based on a standard format in which any natural number N is expressed through a “power base” b, as follows: N=n₁+n₂²+ . . . n_{b}^{b}, where nᵢ (i=1, 2 . . . b) comprise a b size vector. We then define addition, multiplication, and power-raising based on respective operations over the nᵢ values. We show the formal compatibility and homomorphism of this family of arithmetic with the nominal variety, which renders the familiar cryptographic computations to be as effective in any of these arithmetic varieties.

### Power Base Arithmetic

Let every non-negative integer N be expanded to d non-negative numbers: n₁, n₂, . . . n_{d}, such that:

N=Σnᵢⁱ for i=1,2, . . . d

nᵢ will be regarded as the i-dimension of N. There are various such expansions for every N. For example, for N=14, d=3:

14=5¹+3²+0³=2¹+2²+2³

We shall define the “leftmost expansion” and the “rightmost expansion” for every N as follows: The leftmost expansion (LME) of N is the expansion for which n₁=N and n₂=n₃ . . . , n_{d}=0. The rightmost expansion (RME) is the one for which Σnᵢ i=1, 2, . . . d is minimum. If two or more expansions share that minimum, then the one where Σnᵢ i=2, 3, . . . d is minimum, will be the RME. And if two or more expansions share that minimum then the sorting out will continue: the expansion for which Σnᵢ will be minimum for i=3, 4, . . . d. And so on until only one expansion is left, which will be regarded as the rightmost expansion.

We shall refer to the rightmost expansion of N as the normalized expansion. Unless otherwise specified, the d expansion of N will be the rightmost, the normalized expansion.

In the above example, the first expansion of [5,3,0] has S_{b}=8, and the second expansion [1,2,2] has a smaller value S_{b}=5, and is the nominal expansion.

For N=33, b=3 we may write:

33=2¹+2²+3³ (i)

33=0¹+5²+2³ (ii)

where the S_{b} are the same: S_{b}=2+2+3=0+5+2=7 so one compares:

S_{b1}=2+3<S_{b1}=5+2 So the first expansion is the nominal.

More examples: N=100 b=4 maps into [2, 3, 2, 3]; N=1000 b=4 maps into [7, 5, 7, 5]. The same number for b=7 map into: [0, 2, 0, 0, 2, 2, 0] and [3, 0, 3, 3, 2, 3, 2].

For N=123456789 b=7 we write [36, 32, 28, 21, 16, 16, 14], and for N=987654321 for b=15 we write: [8, 19, 13, 9, 11, 8, 9, 7, 6, 5, 6, 5, 4, 4, 3]

Power Base Vectors:

An ordered list of b non-negative integers: u₁, u₂, . . . u_{b} will be regarded as a power-base vector of size b. Every power base vector (PB vector) has a corresponding “power base value”, U, defined as:

U=u₁¹+u₂²+ . . . u_{b}^{b}

As well as a corresponding normalized vector of size b, which is the normal expansion of U.

Properties of Power Base Numbers:

Lemma 1: every natural number, N, may be represented via any power base b. Proof: the trivial representation always applies: N=N+0²+0³+ . . . 0^{b} for any value of b.

Lemma 2: every ordered list (vector) of any number, b, of natural numbers: m₁, m₂, . . . m_{b} represents a natural number N, which is represented by some nominal power base expansion: n₁, n₂, . . . n_{b}. The transitions from m₁, m₂, . . . m_{b} to n₁, n₂, . . . n_{b} is called the normalization of a non-nominal power base expansion.

Addition

Let X and Y be two natural numbers, we may define their “power base addition”, Z=X(+)Y as follows: For i=1, 2, . . . b zᵢ=xᵢ+yᵢ, where zᵢ is the i-th member of the power base expansion of Z, xᵢ is the i-th member of the nominal power base expansion X, and yᵢ is the i-th member of the nominal power base expansion of Y.

Illustration: 14(+)33=[2, 2, 2](+)[2, 2, 3]=[4, 4, 5]=4+4²+5³=145 . . . base 3

Vector Addition:

Two power base vectors, U and V, both of size b may be PB-added: W=U(+)V as follows. U, and V will first be replaced by their normalized vector, and then the two normalized vectors will be added as defined above.

### Attributes of Power-Base Addition

Let's explore a few key properties of power base arithmetic addition:

Universality

Any two non-negative integers, X and Y are associated with a non-negative integer Z=X(+)Y under any expansion base b=1, 2, . . . . This is obvious from the definition of power base addition.

Monotony

For any non-negative integer Z=X(+)Y, we have Z>=X, and Z>=Y. This too is readily concluded from the definition of power base arithmetic

Commutativity

The definition of power base addition readily leads to the conclusion of commutativity: X(+)Y=Y(+)X

Associativity

Z=X(+)(Y(+)W)=(X(+)Y)(+)W Also readily concluded from the definition, since for any member of the power base expansion we have zᵢ=xᵢ+(yᵢ+wᵢ)=(xᵢ+yᵢ)+wᵢ

Adding Zero:

X=X(+)0=0(+)X per definition.

Adding Arbitrary Power-Base Vectors:

Let X=(x₁, x₂, . . . x_{b}), and Y=(y₁, y₂, . . . y_{b}) be two power-base vectors, namely all xᵢ and yᵢ (for i=1, 2, . . . b) be non-negative integers. These two PB vectors are readily mapped to a corresponding non-negative value integer as follows:

X=x₁+x₂²+ . . . +x_{b}^{b}

and:

Y=y₁+y₂²+ . . . +y_{b}^{b}

However these power-base vectors are not necessarily the normalized power base expressions of X and Y. So once X and Y are determined as above, they each are expressed via their normalized expression:

X=x′₁+x′₂²+ . . . +x′_{b}^{b}

and:

Y=y′₁+y′₂²+ . . . +y′_{b}^{b}

And the addition procedure is then applied to the normalized version of X and Y.

Illustration: Let X=(8,0,4) and Y=(13,1,0). We compute: X=8+4³=72, and Y=13+1=14. Normalizing: X=4+2²+4³ and Y=2+2²+2³, and hence X(+)Y=[8,0,4](+)[13,1,0]=[4,2,4](+)[2,2,2]=[6,4,6]=6+4²+6³=238

The Normalization in Addition Theorem:

Power base addition generates a normalized expansion.

The power base expansion that represents the addition of X+Y is the normalized expansion of Z=(X(+)Y).

Proof:

We first prove a few lemmas:

Lemma: in a normalized expansion of X we have xᵢ>† 1 for i=2, 3, . . . b

Proof: let xᵢ=1 for i=2, 3, . . . b: X=x₁+x₂²+ . . . 1ⁱ+ . . . x_{b}^{b}. We can then write: X=(x₁+1)+x₂²+ . . . 0ⁱ+ . . . x_{z}^{b} for which the sum Σxᵢ for i=1 to i=b will be the same. However the sub-sum: Σxᵢ for i=2 to i=b will be lower, and hence the normalized expansion cannot feature xᵢ=1 for any i=2, . . . b.

Based on this lemma for any i=2, 3 . . . b there will not be zᵢ=1. Because it would require for either xᵢ or for yᵢ to be equal to 1 (and the other equal to zero). And since xᵢ and yᵢ are listed in the normalized expansions of X and Y respectively, neither one of them will be equal to one.

Let us divide X to X_{g}, and Xₕ: X=X_{g}(+)Xₕ, where:

X_{g}=x₁+x₂²+ . . . x_{b-1}^{b-1}

Xₕ=0+0+ . . . x_{b}^{b}

And similarly: divide Y to Y_{g}, and Yₕ: Y=Y_{g}(+)Yₕ, where:

Y_{g}=y₁+y₂²+ . . . y_{b-1}^{b-1}

Yₕ=0+0+ . . . y_{b}^{b}

Accordingly we can write: Z=X(+)Y=X_{g} (+)Xₕ(+)Y_{g} (+)Yₕ, and then rearrange:

Z=(X_{g}(+)Y_{g})(+)(Xₕ(+)Yₕ)=Z_{g}(+)Zₕ

We have then Zₕ=0+0+ . . . (x_{b}+y_{b})^{b}. The normalized expansion of Zₕ cannot feature z′_{b}>x_{b}+y_{b} because that would require a lower value for at least one of the members: zₕ₁, zₕ₂, . . . z_{hb-1}. But all these values are zero, and cannot be lowered further. Similarly, the normalized expansion of Zₕ cannot feature: z′_{hb}<x_{b}+y_{b} because that would mean that some zᵢ for i=1, 2, . . . (b−1) will be higher. However, for every such value of i, which instead of zero is now t, the contribution to the value of Z will be tᵢ, which for every i will be less than the corresponding loss: (x_{b}+Y_{b})^{b}−(x_{b}+y_{b}−t)^{b}, and so the value of Z will not be preserved. We have proven, hence, that the normalized expansion of Zₕ cannot be anything else except: 0, 0, . . . (x_{b}+Y_{b}).

The remaining issue of Z_{g}=X_{g}(+)Y_{g}, we may handle recursively, namely to divide X_{g}:X_{g}=X_{gu}+X_{gu}, where:

X_{gu}=x₁+x₂²+ . . . x_{b-2}^{b-2}

X_{gv}=0+0+ . . . x_{b-1}^{b-1}

And similarly divide Y_{g}:Y_{g}=Y_{gu}+Y_{gu}, where:

Y_{gu}=y₁+y₂²+ . . . y_{b-2}^{b-2}

Y_{gv}=0+0+ . . . y_{b-1}^{b-1}

Repeating the logic above we will conclude that z_{b-1}=x_{b-1}+y_{b-1}, and so recursively prove that for every value of i=1, 2, . . . b there holds: z′ᵢ=xᵢ+yᵢ, where x′ᵢ is the value of member i in the normalized version of Z.

Subtraction

Power Base Subtraction may be defined as the reverse operation to Power Base Addition:

X=(X(+)Y)(−)Y

A non-negative integer X may be subtracted from a non-negative integer Z, to result in a non-negative integer Y defined as:

yᵢ=zᵢ−xᵢ

for i=1, 2, . . . b where X=x₁+x₂²+x₃³+ . . . +x_{b}^{b} and where Z=zᵢ+z₂²+z₃³+ . . . +z_{b}^{b}.

By definition subtraction is only defined for instances where zᵢ=>xᵢ for all values of i=1, 2, . . . b

### Power Base Multiplication

We shall define Z=X(*)Y power base (PB)=b, as the power base multiplication of two non negative integers X, and Y into a non-negative integer Z, as follows:

For all values of i=1, 2, . . . b, there holds: zᵢ=xᵢ*yᵢ

where X=x₁+x₂²+x₃³+ . . . +x_{b}^{b} and where Y=y₁+y₂²+y₃³+ . . . +y_{b}^{b}. The xᵢ and yᵢ (i=1, 2, . . . b) represent the rightmost expressions of X and Y respectively.

So for X=32, Y=111, and b=3 we have: X=1+2²+3³, and Y=11+6²+4³, and hence Z=[11, 12, 12]=11+12²+12³=1883

Power Base Multiplication (PBM) should be well distinguished from nominal multiplication (N-multiplication) where a non-negative multiplicand, m multiplies a non-negative integer X, expressed as power-base, b:

Y=m*XPBb=m*(x₁+x₂²+ . . . +x_{b}^{b})=mx₁+mx₂²+ . . . +mx_{b}^{b}

which results in Y=y₁+y₂²+ . . . +y_{b}^{b}, where yᵢ=mxᵢ

Nominal multiplication is equivalent to m power-base addition of X: Y=X(+)X(+) . . . (+)X

### Power Base Division

Power base division may be defined as the reverse operation of multiplication:

X=(X(*Y)(/)Y

If Y=Z(/)X then yᵢ=zᵢ/xᵢ for all values of i=1, 2, . . . b

where X=x₁+x₂²+x₃³+ . . . +x_{b}^{b} and where Z=z₁+Z₂²+z₃³+ . . . +z_{b}^{b}

### Generalized Division

The above definition of division applied to reverse multiplication. In general Y=Z/X (power base b) will be defined as follows:

yᵢ=(zᵢ−rᵢ)/xᵢ

where rᵢ is the smallest integer that would result in an integer division. Obviously 0<=rᵢ<=xᵢ.

This division will be written as:

Y=(Z−R)/X

or:

Y=Z/X with remainder R

where R=[r₁, r₂, . . . r_{b}] is a b-size vector.

### Prime Power Base Numbers

A number P will be regarded as power base prime, if, and only if there is no number T such that Q=P/T has a remainder R=[o, o, . . . o] (b elements), and Q is in its nominal expression. If there is a number T such that R=0, and the qᵢ expression is the nominal expression of Q, then T is considered the power base factor of P. By definition P=T*Q.

So for P=32 b=5 we have P=[0,0,0,0,2] we have P (PB=2) is prime. Same for with b=3: [1,2,3].

For P=100 b=4 we have: [2,3,2,3] it's the same (all members are primes). But with b=3 100=[0,6,4] we have, T=[0,2,2] (division 0/0 is defined as 0), which is T=12 and the [0,2,2] expression is its nominal. And Q=[0,6,4](/)[0,2,2]=[0,3,2]=17 in its nominal (or say normalized) form. So for b=3 we have 12*17=100, which makes 100 a composite, and not a prime.

A variety of prime numbers based crypto procedures could be adjusted to reflect this power base definition.

### Modular Power Base Arithmetic

Given a natural number M, a non-negative integer N′ with power base b and which is expressed as [n′₁, n′₂, . . . n′ₙ] such that:

nᵢ=n′ᵢ mod M

where nᵢ (for i=1, 2 . . . b) is <=M will be converted to N defined as:

N=n₁+n₂²+ . . . n_{b}^{b}

And one will write:

N=N′ mod M over power base b

N will then be expanded in a nominal way, which may be different from the expansion above.

Illustration: let M=5 Let N′=1234. Using power base b=3 N′ is expressed as: [9, 15, 10]. It is converted through modular arithmetics to N=[4, 0, 0] and we write:

4=1234 Mod 5 (power base b=3).

And the nominal expansion is N=4=[0, 2, 0]

Another: M=3 N′=5000 power base=4. It is expressed as N′=[6, 13, 9, 8]. Using the modular reduction: N=[0, 1, 0, 2]=17 for which the nominal expansion is: [1, 0, 0,2].

In modular arithmetics with power base b a modular M largest number will be:

Nₘₐₓ=(M−1)+(M−1)²+ . . . (M−1)^{b}

So for M=7 b=4 Nₘₐₓ=6+6²+6³+6⁴=1554=[6, 6, 6, 6]. So in modular power base arithmetics with M=7 and b=4 all natural numbers are mapped to the range 0 to 1554.

Based on the known rules for regular modularity we can define Z=X+Y mod M (PB=b), and Z=X*Y mod M (power base b). And the modularity transfers: X+Y=(X mod M)+(Y mod M) mod M (PB=b), and similarly for multiplication. Association is not valid.

### Cryptographic Implications

Modular power base arithmetics offers an alternative calculus on a modular basis. Numbers in some range 0 to (M−1) are exchanged based on some math formula and two values: M, the modular value, and b the power base value.

Unlike the common modular arithmetic math which relies on computational burdens of raising to power in a modular environment. This power base paradigm is readily computable, and is competing with speed and efficiency with the common symmetric ciphers.

A plaintext P of some bit length, p, may be interpreted as a number N&ndexp. A modular number M>2^{p} may be chosen, and a power base b may be chosen too. One could then use a number E and compute:

N_{c}=f(Mₚ,E)mod M, power base=b

where f is some agreed upon function, and E is the ‘encryption key’. The result N_{c} will be regarded as the corresponding ciphertext to Nₚ. f will be chosen such that a given other number D will reverse the process:

Nₚ=f′(Mₚ,D)mod M, power base b

where f may be close to f′ or even f=f′. If such two different numbers E and D are found then this is a basis for an efficient cipher, provided one can not easily be derived from the other. If E=D are the two are easily mutually derivable then this scheme will serve as a symmetric cipher where M, b, E and D are the secret keys.

Every modular arithmetic cipher may be adjusted and transformed to operate as a power base modular cipher. Some such conversions will be efficient and very useful, and some not.

### Dimensionality Expansion Illustration

For X=100,000 expressed in dimensionality d=1 will look like: 0, 11, 9, 7, 5, 4, 3, 3, 3, 3, 2. The same X with dimensionality d=20 will look like this: 0, 0, 0, 0, 2, 0, 2, 0, 2, 2, 0, 0, 0, 0, 2, 2, 0, 0, 0, 0. And with d=3: 63, 51, 46

### Power-Raising Power Based Arithmetics

Let's define: Y=X^{E} mod M, power base b:

yᵢ=xᵢ^{e}ᵢ mod M

where yᵢ is the i-th element in the power base expression of Y, and xᵢ is the −th element in X, and eᵢ is the i-th element in E. The expression: y₁, y₂, . . . y_{b} of Y is not necessarily the normalized expression (Yₙ). It is the t-th expression when all the possible expressions of Y (in power base b) are ranked from the right most expression (RME) to the leftmost expression (LME).

Given Y and t, it is easy to calculate the expression that is exactly the y₁, y₂, . . . y_{b} series. And then by the mathematics of RSA, there is a vector D comprised of d₁, d₂, . . . d_{b} elements such that:

xᵢ=yᵢ^{d}ᵢ mod M power base b

Hence by sharing M and b two crypto correspondents will be able to practice asymmetric cryptography, based on RSA. However, because the individual numbers xᵢ nd yᵢ are so much smaller than X and Y, there are various combinations of b and M values where the power base version of RSA shows clear advantages.

The above could also be used as a one-way function where the values of t, M, and b remain secret. The holder of Y and X will be able to ascertain that a claimer to hold E, M and b is indeed in possession of E. It is likely that there are different combinations of E, M and B that relate X to Y, but they all seem hard to identify.

### Cryptography of Things (CoT),

### Money of Things (MoT)

### Enabling the Internet of Things (IoT)

The Internet of Things (IoT) will enable an unprecedented array of services, regulated, evolved, and practiced through the same mechanism that gets people interacting: pay-as-you-go; compensate for services rendered. Incentivize growth: Capitalism-of-Things. That is how progress is experienced!

### Cryptography of Things (COT) Will Enable Money of Things (MOT) to Exploit the IOT.

Large amount of randomness can be readily stored in tiny chips.

Large amount of randomness will allow non-complicated, non-high power consuming algorithms to be used, and drain the batteries slower.

Large amount of randomness will allow for algorithmic versatility, and defense against adversaries with superior math insight.

### CoT, MoT (Sample) Applications:

Drones
Electrical Cars
Transportation Solutions
Ad-hoc Internet Connectivity

### Post Google: Knowledge Acquisition Agents

60 Billions “things” are projected to comprise the Internet of Things—all set up to serve humanity. These many ‘human servants’ will practice a lot of communication crammed into a shared network, where effective cryptography is foundational.
These 60 billion things will serve each other through due payments, giving rise to Capitalism of Things.
Drones are fast assuming a greater and greater role. They are hackable, and their reported video capture may be violated.
Swarms of drones may explore disaster areas and their inter-communication must be protected. CoT.

### Money of Things (MoT): Charging Electrical Vehicles

EV charged while speeding must pay with cryptographically secured counterflow bit money

### Money of Things (MoT): Transportation Solutions.

Cryptographically Secure Digital Money is paid between

Each car is a “thing” in the network, and it talks to various spots on the various lanes of the highway, each such spot is another “thing” or node. The communication identifies the lane where the car is moving. The “road things” will then tell the speeding car what is the rate per mile on this lane, and the car will send to the road digital money bits that would satisfy the momentary demand. This pay as you go mode will relief the need for some post action accounting, monthly statements and violation of privacy. Paying cars may have to submit a public key that identifies them to the authorities if they fake the payment or cheat in any way. A speeding car that submits a fake id and pays with fake money will be caught through the use of cameras overhead, with the possibility of painting car tags on the roof, or the hood. The per mile payment is so low that motorists will not go through the hussle of cheating. Motorists will either manually steer the car to one lane or another and watch on the dashboard their rate of payment, or they would subscribe to a driving plan that took into account the payment options, and the requirements for speed, how important they are for the motorist in this particular trip.

The rates of pay per lane will be adjusted to maximize the utility of the multi-lane highway. The idea is that the fastest lane will drive in speed close to the maximum allowed speed in this region, and the slower lanes will evenly rank in the interval between the maximum speed and the de-facto speed of the free lane on the highway at this particular moment. A fast re-adjusting per mile fare will be required to respond to the reality on the highway. The driver will set a broad policy as to how much he or she is willing to pay to arrive at their destination at a particular time or another. Based on this payment plan the car computer will use the at-the-moment per mile fares to set out a plan as to which lane to drive on. Some automatic cars the lane shift may be carried out automatically (depending on automotive progress), in less high-tech cars the driver will get an audio-visual prompter to shift lanes one way or the other.

### Ad-Hoc Internet Connection

Replacing today subscription model where light users overpay; increasing privacy by shifting between suppliers.
Works for phone and for any IoT nodes packed with digital money for the purpose. The client device will send its money bits in exact counterflow to the data bits sent to it by the connection provider. The provider will quickly validate the money at the issuing mint, and hence will have no need to identify the payer. This will allow for a privacy option that is not available in the customary subscription model.

### Payable Knowledge Acquisition Agents

Issue-smart AI agents will sort data thematically, to replace flat keyword search.
These AI agents will offer their expertise for pay to higher level subject matters agents, who, in turn, will offer their services to AI field organizers.
The Client will choose how much to instantly pay for which quality of search results (preserving privacy).
Only MOT can support this 24/7 any which topic search.

Google exploded on humanity with its free “search” service. Presenting to any inquirer a well ranked list of web pages that are designed to satisfy the knowledge and information need of the searcher. Over time Google, and its likes, have developed algorithmic capability to sort out web pages based on their popularity, and to respond to inquirers based on what Google knows about them. Alas, since this highly valuable service is free, it is subject to undue influence by those who pay Google to use this quintessential partnership with surfers for their own ends. As a result the public is unwittingly subjected to stealth manipulation, and undue influence. Some web pages and relevant information which would have been important for the searcher is not showing up, or showing up in the overlooked margins, and other pieces of knowledge that are important for someone else that the searcher sees, feature prominently. Since the unbiased acquisition of knowledge and information are the foundation of our society, the current state of affairs is not satisfactory.

It can be remedied by introducing for-pay search service, which will earn their business by their neutrality, and by keeping undue influence from the search results. This will happen if we allow for pay-as-you-go between searcher and knowledge provider. Such arrangement can be materialized by allowing the searcher computer or device to be in possession of digital money, and send it over in counterflow mode for the data, information and knowledge that is served by the paid source. This digital cash arrangement will allow anyone to pay and be paid. So the paid source will not have to be one giant “google” but ti could be small knowledge Bootiques which specialize in depth in a prtocilr knowledge area, and in their zone of exerptise know better than a ‘know it all’ Google does.

We envision bottom-feed, or bottom-grade knowledge sources (marked as trapezoids) that constantly search the web for anything related to their narrow topic of expertise. These bottom feeders will rank, sort, and combine the row web pages on the Internet so that they may develop a good fair and unbiased response to any query in that area.

These bottom feeders will eventually become the sources of information and knowledge to a higher-level knowledge acquisition agent (marked as hearts). The higher level agents will cover a broader are which is covered by the bottom feeders, and they would use the bottom feeders as their source of information. Such integration to higher and higher up knowledge acquisition agents will continue commensurate with the size of the Internet. At the highest level there will be a top agent that accepts the query from the searcher and then re-inquires the agents below, which in turn inquire the agents below them, and so on. The information gathered from the bottom feeders will be assembled, summarized, and packaged at each level up, and mostly so when responding to the searcher.

This knowledge acquisition hierarchy will constantly improve itself through searcher feed back about his or her satisfaction from the search results.

Much as the data and knowledge flows from the raw field to the inquirer, so does the satisfaction marking flow backwards from the searcher through the ranks to the bottom. Over time good agents are identified and distinguishes—they will know it, and raise their prices, while the not so good agents will reduce their price to attract business. The hierarchy will be structured with a heavy overlap, so that a searcher interested in information on topic A will have several bottom feeders sources to rely on. For example a query regarding public transportation in the small town of Rockville Md. can be responded to by a bottom feeder specializing in Rockville, as well from a bottom feeder specializing in public transportation in Maryland, and also from a bottom feeder that specialized in distribution of public funds in Montgomery county Maryland. And of course a few bottom feeders that specialize in Maryland may be established, and compete.

This pay for knowledge modality will serve as a strong incentive for individuals and organization who have accumulated great knowledge about a topic of interest. They will be able to use web crawlers, and sorting algorithms to compile their topic of interest in a most efficient way, and then just watch how their knowledge acquisition agent makes money 24/7 from searchers around the world.

This new search paradigm will spur a vibrant industry of search algorithm and web crawler and would leverage the distributed expertise of humanity.

The underlying principle is the idea of paying for value, and thereby being in control of the service one buys. Bad actors will be washed away, and good actors will be well compensated. The modality of digital payment, pay as you go, per some metric or another of the information flow, is the enabler of this vision.

### Transposition-Based Substitution (TBS)

An n-bits long plaintext, p, is concatenated with

p*p[XOR]{1}ⁿ

Into P=p∥p*

P is transposed by a key space

|K_{TBS}|=(2n)!

But unlike a Vernam key that must be of size |K_{Vernam}|=n:

0<|K_{TBS}|<log((2n)!)

TBS operates with any size key!

### Money of Things

For almost three decades the Internet evolved in stealth until it exploded on the public awareness field, and changed everything. Right now, something called “The Internet of Things” is being hatched in geeknests around the world, and it will change everything—again! Sixty billion “things” are projected to combine into a network of entities that never sleep, never tire, and are not subject to most other human frailties. These interconnected “things” will serve us in ways which exceed the outreach of today's imagination: your refrigerator will realize you are running low on eggs, and re-order from the neighborhood grocery; your car will realize you have just parked and start paying parking fee until you drive off; you will be able to beat traffic by shifting to a higher $/mile lane auto-paid from your car to the road; as you speed with your electrical vehicle on the highway, it will be charged by underground magnets while your car establishes a counterflow of “Money of Things”; your AI investment agent will pounce on investment opportunities that meet your criteria, and report to you when you wake up; today's free “Google search” will be replaced by knowledge acquisition agents (KAA) roaming in cyberspace ceaselessly compiling for-pay all the news you care about, all the knowledge you find useful; “Things” attached to your skin will report your health data to a medical center. My students add uses to this list every time we meet—our imagination is under extreme stress!

Sixty billion things interconnect, inter-inform, inter-serve: how will they self-organize? Exactly the way seven billion people manage their ecosystem: with money. Welcome to “Capitalism of Things” where we, the people, hand over our money to the things that serve us, instruct them with our terms and preferences, and set them free to negotiate, deal, pay, and get paid on our behalf.

In this new brave world the credit card, the human electronic wallet, the monthly statements will be as anachronistic as typewriters, and dial phones. Money will have to be redefined, reminted, and re-secured. And of course, like everything else in cyberspace, money will be digital. It would no longer be a fanciful nicety, not just a geeky delight. Digital money—a digitized version of the dollar, the Yuan, the euro, etc. will be the currency du jour. Much as you cannot order a meal and pay with seashells today, despite their consistent use for hundreds of years, so your speeding car will not be able to pay for the four seconds of charging it receives on the road by flashing a payment card, or running an EMV dialogue. A pay-as-you-go counterflow of bits is the one and only way to pay, which in the near future will mean to survive.

Indeed Money of Things will cut through the bitcoin debate: digital money yes, Monopoly money and Bitcoin money—no. And since the cyberworld is really integrated (while global politics is still way behind), the Money of Things will have to cut through today's currency exchange barriers. And the way to do it is to trade with a digitized “basket” that would be a combination of the prevailing flat currencies. I have discussed this technology in the Handbook of Digital Currency (Elsevier, 2015).

Money of Things, being money, will have to be easy to store (bits naturally are), will have to endure (since it is information, not a physical entity, durability is a given), and it will have to be secure. Secure? Everything bitty was hacked and smacked, beaten, robbed, and faked—how in the world will MOT be secure? The answer may be surprising: “Security by Humility”. Checking under the hood we see that today's cryptography is the opposite: it is based on arrogance. We weave complicated algorithms that we cannot undo, and assume that our adversaries will be as limited as we are, unable to solve a puzzle that frustrates us. It's time to admit this folly, and turn to the one solution, one approach that ensures parity against a more intelligent hacker: this solution is randomness. “Stupidity+Randomness=Smarts” is the title of a YouTube video that elaborates on this potent concept.

The volume of IOT transactions will steadily grow, and Money-of-Things will evolve to become Money-of-Everything. If your car can pay toll in two milliseconds why should you wait for 20 seconds for the “Remove Your Card” sign on the EMV terminal?

### BitMint Escrow

### An Automated Payment Solution to Replace Escrow Accounts

Mutually Mistrustful Buyer and Seller Use Tethered Money to Benefit from the Mutual Security Otherwise Offered by Expensive and Cumbersome Escrow Services

Increasingly, strangers across the Internet wish to conduct a one-off business, but are worried about the other side not following through on the deal. This common apprehension is properly addressed via escrow services where a trusted third party holds the payment until the buyer is satisfied, or until a resolution is reached (voluntarily or by court order).

While the escrow solution is a fitting one for business-to-business transactions of a moderate to large volume, or for buyer and seller who subscribe to a governing organization (e.g. eBay), the growing majority of ad-hoc deals where buyer and seller stumble upon each other in cyberspace, is below the threshold that justifies the effort and the expense to secure a traditional escrow solution. This is the niche to which BitMint addresses itself: offering automated escrow services via the payment system that enjoys the credibility to redeem its digitized dollars against terms specified by the users. BitMint, the payment system, is not a side in the transaction, it simply obeys the terms specified by the buyer of its digitized money, and does so automatically, cheaply, and fast.

How will it work? Buyer and Seller agree on terms; the buyer then “buys” digitized dollars from BitMint at the amount of the sale ($x). He instructs BitMint to redeem this money in favor of the seller (identified by some recurring or by one-time use ID), but only after the buyer sends the “OK to release” signal. The buyer further instructs BitMint to hold the $x unredeemed for a period of, say, six months, at the end of which the money returns to the disposition of the buyer—unless either the OK signal was given, or a court, or an arbitration agent orders the money frozen.

The above is just one option among many possible terms agreed upon by the buyer and the seller. This particular option satisfies the buyer that if the seller is a fraudster, or does not deliver as promised, then the buyer's money will automatically return to the buyer's disposal after the set time (six months). The seller is satisfied that (i) the buyer came up with the money for the deal, and (ii) that the seller has six months to approach a pre-agreed upon arbitration service, or a court, to put a hold on the money until the dispute is resolved. Like in a nominal escrow, the very fact that the money is not in the control of either party incentivizes both parties to resolve the matter, and suppresses the temptation to cheat. Even if a moderate percentage of deals that don't go through because of this mutual mistrust, will end up happening, then the net effect will be the creation of a new market that was not there before, and the first to command this market has the head start to dominate it for the foreseeable future.

Why digital money? The medium of digitized dollars allows the buyer and the seller to remain strangers to each other. The seller may choose a random ID against which BitMint will redeem the money to him. No need for any account data, no phone number, not even an email address, nor any other personal identification information, except to the extent that is mandated by the applicable law. The buyer will fill in its desired terms in a BitMint website dialogue box, buy the digitized dollars, and send them (as a binary string) to the seller (text the money, or as an email attachment). The seller will read the money string, and might even double-check with BitMint that this is good money ready to be redeemed by the seller when the redemption terms are met. The seller might also verify that the buyer cannot redeem the money for the set period (six months). This done, the seller has nothing to gain from cheating, and will be well motivated to fulfill his part of the deal.

BitMint thereby exploits the power to tether money in an automated, fast, reliable way against a small nominal charge that would accumulate across cyberspace to an impressive profit.

### The BitFlip Cipher

### Replacing Algorithmic Complexity with Large, Secret, Quantities of Randomness

Abstract: Modern cryptography is based on algorithmic intractability achieved via ever more complex computations, carried out by expensive computing devices. This trend is on a collision course with the future biggest consumer of cryptography: The Internet of Billions of Things. Most of those things are simple, and too inexpensive to support a mobile-phone size computer, which anyway can be hacked, taken over, and used for denial of service and other attacks. The IOT poses a fundamental crypto challenge which we propose to meet by offering an alternative to complex number-theoretic computation in favor of inexpensive, large (but secret) amounts of randomness. It's a new class of cryptography, reliant on Moore's Law for memory, which has made it very inexpensive to store even gigabytes of randomness on small IOT devices. The obvious “randomness galore” solution is the Vernam cipher. Alas, for a key even slightly shorter than the message, Vernam security collapses. We therefore seek “Trans Vernam” ciphers, which offer operational security commensurate with the size of their random key. The BitFlip cipher is yet another example for establishing security via large, secret, amounts of randomness, processed through basic bit primitives—fast, efficient, reliable. It is a super-polyalphabetic substitution cipher defined over an alphabet comprised of t letters, where each letter is represented by any 2n-bits string {0,1}²ⁿ, which has a Hamming distance n relative to a reference 2n-bits string associated with the represented letter. The intended reader will very quickly find out which letter is encoded by the communicated randomized 2n-bits string, by identifying the letter that has the required Hamming distance, n, from that string. A cryptanalyst examining the communicated string will regard any bit therein as having equal probability to be what it says it is, or to be the opposite. The security of an encrypted plaintext comprised of m letters is credibly appraised and dependent only upon these three parameters: m, n, t, and on the various randomized operations. The BitFlip cipher may have (n,t,m) values to offer perfect, Vernam-like, secrecy, but it maintains hi-security even when the crypto key is much smaller than the message: t*n<<m. Because the bit identity and the bit manipulation procedures are thoroughly randomized (“smooth”), it is believed that brute-force is the most efficient cryptanalysis. But even it can be rebuffed with terminal equivocation.

### Introduction

In a broad way we propose to different approach to the challenge of cryptography: to protect ciphertexts through the use of large, secret amounts of randomness. It's a parting from the common approach where ciphertexts are protected via the mathematical intractability of their reversal to their generating plaintexts. This algorithmic protection is (i) vulnerable to an attacker with a deeper mathematical insight than the designer, and (ii) it requires quite powerful computers. The first is an inherent vulnerability, and the latter is an issue with respect to the fastest growing domain for cryptography: the Internet of Things, where most of the billions of ‘things’ cannot support a “mobile phone size” computer. It is therefore of interest to explore alternative approaches. In his article “Randomness Rising” [Samid 2016R] the author lays out the thesis for this approach, and here we present a compliant cipher.

We consider a fixed substitution cipher based on alphabet A comprised oft letters, where each letter is expressed through well-randomized 2n bits. Such fixed substitution cipher is readily cracked using letter frequency analysis. However, what is interesting about it is that its user will be able to credibly appraise its vulnerability. And this appraisal will not be vulnerable to an adversarial advantage in mathematical insight. Given an arbitrary message of size m, then both user and its attacker will be able to credibly assess the probability of cryptanalysis: Pr[m,n,t]. For sufficiently small m (compared to n, t) the captured ciphertext will be mathematically secure. For a larger m, the message will be protected by equivocation, and for larger and larger m, the cryptanalysis gets better and better.

We believe that this credibility in assessing cipher vulnerability is of great importance, [Samid 2017], and we therefore propose a cipher that is derived from this simple fixed substitution cipher. The derivation is based on the standard extension of a basic substitution cipher: a polyalphabet. But unlike the Enigma or the Vigenère cipher, no arbitrary factors are added to achieve the polyalphabetic advantage. We propose to totally rely on randomness, and build a cipher where its vulnerability is fully determined by m,n and t. Only that unlike the basic fixed substitution cipher, the BitFlip Smooth cipher has a much higher security for the same values of {m,n,t}. We write then:

BitFlipCipher:SEC=SEC(m,n,t)

To say that the security of the BitFlip Cipher is credibly appraised (by both the user and by his attacker) on the basis of the values of m, n, and t. Furthermore, the BitFlip cipher is smooth with respect to all these three parameters, so that they can be readily adjusted by the user to achieve the desired security—however high. We define cryptographic ‘smoothness’ as the attribute of having a small change in the value of a cryptographic attribute be associated with a small change of the security of the cipher. For example, if the security of DES drops dramatically when the DES transposition procedure is mildly changed, then DES is not smooth with respect to this primitive. Same for changes with respect to DES S-boxes.

While most polyalphabetic ciphers have a limited number of alphabets, we may vie to employ the entire 2²ⁿ space of 2n-bits strings as ‘alphabets’. One can assign to each of the t letters some 2²ⁿ/t strings and achieve a highly secure cipher.

This attractive disposition runs into a practical issue, for even moderate size t and n the numbers of strings that would represent each letter of the alphabet would be too large to be listed in a regular computing device. For t=10, and n=50 the number of substitutions per each letter will be: 2¹⁰⁰/10=1.26*10²⁹ The alternative fashion would be to define some function that would identify the t subsets of 2²ⁿ. Alas, any such function would be (i) hard to keep secret, and (ii) would be vulnerable to cryptanalytic attack.

It is therefore that we propose to identify on the 2²ⁿ set of strings t large subsets by using a randomization approach. We define over any string S of 2n bits, a set of associated strings, {0,1}²ⁿ, with half randomly flipped bits relative to S: FlipRange(S). This is the set of all 2n-bits strings that share n bits with S, or say all the strings that have Hamming distance of n with S. Critical to our cipher is the fact that it is very easy to determine if a random 2n-bits string X belongs to FlipRange(S) with respect to a given string S (|S|=2n). Easy and fast: simply measuring the Hamming distance between the two strings.

We will prove ahead that any two {0,1}²ⁿ strings that have an odd Hamming distance between them have non intersecting FlipRange(S) set, and otherwise there is some intersection. However, for t<<n, if the t 2n-bits strings are randomly selected then the overlapping among the FlipRange sets will be minimal, and hence this solution will manage to carve out of the 2²ⁿ size set of 2n-bits strings t mutually exclusive subsets which amounts to using an astronomical size alphabet which appears to be vulnerable only to brute force attack (because of its utter simplicity) and the effort needed to crack it is readily computed by its designer, as well as by its attacker. Moreover, the security of this polyalphabetic cipher with respect to any given size message, m, can be set to any desired level by simply properly choosing the two parameters t and n. Everything else is purely randomized.

This loose description of the cipher nonetheless captures its essence. Formalities ahead.

### BitFlip Calculus

Given a bit string X comprised of |X|=2x bits, and given the fact that this string was constructed by randomly flipping x bits from an input string Y, of size |Y|=|X|=2x, the observer who is not aware of Y will be looking at the 2x bits of X, each of which has an equal chance for being what it is in X, also in Y, and an equal chance for being the opposite. The knowledge of X though, restricts the scope of possible Y strings, since X and Y must agree on the identity of half of their bits.

By straight forward combinatorics the number of Y string candidates is:

1 . . . (2x)!/(x!)²

which will be regarded as the flip-range expression. And the ratio of the number of Y candidates given X, relative to not knowing X is:

2 . . . (2x)!/((x!)²*(2^{2x}))

which will be regarded as the flip-ratio expression. The value of x then determines both (1) what is the chance to guess Y given X, and (2) what is the chance to generate X, without knowledge of Y, such that a Y holder will find that X and Y have agreement over exactly x bits. It can be easily seen that x can be selected such that both probabilities will be as low as desired.

Please study the following table 1 constructed from the equations above:

| \|2X\| | Flip-Candidates (2X) | Flip-Ratio (2X) |
|---|---|---|
| 20 | 184756 | 0.18 |
| 50 | 1.26E+14 | 0.11 |
| 100 | 1.01E+29 | 0.08 |
| 250 | 9.12E+73 | 0.05 |
| 1000 | 2.70E+299 | 0.02 |

The table shows that for an X string comprised of |X|=2x=50 bits there are 1.26*10¹⁴ candidates Y, and if Y is perfectly randomized there is no hope for a shortcut in determining it, only the brute force approach. For a string of 2x=250 bits the number of candidates is more than 10⁷³. Paradoxically, of sorts, as the flip-range grows exponentially with the size of the string, so the ratio of these candidates relative to all possible strings is getting lower.

The price paid for having lower probabilities as above (namely, better security) is the burden of handling larger quantities of randomness. But that is a very low price to pay for three reasons: (1) the mathematical manipulation involved in this process is simple bit-wise: counting bits and flipping them; (2) the cost of storing large number of bits is subject to Moore's law, and hence is very low, and getting ever lower. And (3) communication technology hammered down the price of sending a bit around the globe. (Moore's Law with respect to communication).

The BitFlip protocol [Samid 2016] describes how to use this randomized procedure for Alice to authenticate herself to Bob by proving to him she is in possession of Y through sending Bob X. Here we extend this procedure to full fledged communication.

We present a few definitions, lemmas, and some relevant theorems.

Let Rflip be a randomization function that takes a string X of size |X|=2x bits, as input, and generates as output a string X′ of size |X′|=|X|=2x bits such that the Hamming distance between X and X′ is HD(X,X′)=x.

Let the range of all possible outcomes of RFflip be defined as the FlipRange(X) set.

Rflip, being randomized, has an equal chance of 1/FlipRange(X) to pick any member of the FlipRange set.

Lemma 1:

The FlipRange set is symmetrical. Namely, if X′ is a member of the set FlipRange(X), then X is a member of the set FlipRange(X′). This is because if it takes x bits to generate X′ from X, then flipping back the same x bits in X′ will generate X:

X′εFlipRange(X)<=>XεFlipRange(X′) (4)

### Definitions

Every two random strings of same size X and Y: |X|=|Y|=2x define a set of 2x-bits strings that are members of the two FlipRanges.

The set of strings Z such that ZεFlipRange(X)∩ZΣFlipRange(Y) is regarded as the shared range: SharedRange(X,Y).

The Range Equivalence Lemma:

Every string S comprised of 2n bits, shares the same FlipRange with a ‘complementary string’, S*, defined as the string for which S⊕S*={1}²ⁿ:

For S* such that S⊕S*={1}²ⁿ FlipRange(S*)=FlipRange(S)

Proof:

S and S* have a Hamming Distance HD(S,S*)=2n. A string S′=Rflip(S) has n bits the same as S—let call this set α; and n bit opposite to S—let's call this set β. The α set finds opposite bits in S*, and the β set has same bits in S*, hence S′ qualifies as a member of the FlipRange(S*).

The Range Separation Theorem:

Every two bit strings of same even number of bits, 2x, which have an odd Hamming distance have an empty shared range.

For DH(X,Y)odd=>ZεFlipRange(X)∩ZεFlipRange(Y){|X=|Y|=2x} (5)

The Non-Separation Theorem:

Every two bit-strings of same even number of bits, 2x, which have an even Hamming distance between them, 2z, have a non empty shared range of size:

SharedRange(X,Y)=((2x−2z)!/((x−z)!)²)*(2z)!/(z)!)² (6)

Proof.

Let's divide the 2x−2z shared bits into two categories α and β, each comprised of (x−z) bits. Similarly, let's divide the 2z opposite-identity bits to two equal size categories: γ and δ each contains z bits. We shall now construct a string Z (|Z|=2x), such that Z=ΣFlipRange(X). We shall do it in the following way: (1) we first flip all the bits in the α category, then (2) we flip all the bits in the y category. Thereby we have flipped x=(x−z)+z bits, so that the resultant ZεFlipRange(X).

We shall now construct a string Z′ (|Z′|=2x), such that Z′=FlipRange(Y). We shall do it in the following way: (1) we first flip all the bits in the a category, then (2) we flip all the bits in the δ category. Thereby we have flipped x=(x−z)+z bits, so that the resultant Z′εFlipRange(Y):

It is easy to see that Z=Z′. In both strings the same a bits were flipped, and since they were the same before the flipping they do agree now, after the flipping. The γ category of bits were flipped in X. Each of these bits in X was opposite to its value in Y so now that these bits were flipped in X, they are the same as in Y. And the way we constructed Z′ was without flipping the y category in Y, so the γ bits are the same in Z and Z′. Symmetrically the δ bits are the same in Z and Z′. They were not changed in Z, and they were all flipped in Z′. And hence we have proven that Z=Z′, which means that ZεSharedRange(X,Y). To find the size of the shared range set we ask ourselves how many ways can the (2x−2z) bits be divided to α and β categories, and then in how many ways can the 2z bits be divided to the γ and δ categories, and thus we arrive at the result indicated in the theorem, Eq #6.

We can now prove the separation theorem: since the hamming distance HD(X,Y) is odd, these bits cannot be divided to two equal size categories, γ and δ. And therefore we cannot exercise here the procedure taken for the even Hamming distance case, and hence we cannot construct the same string, by flipping x bits in both X and Y. In the closest case the γ category will have (x+1)/2 bits and δ will have (x−1)/2. So at least two bits will be off when comparing Z and Z′.

Illustration: Let X=11001101 and Y=10111010. These strings have z=3; or say 2x−2z=8−6=2 bits in common: bit 1 and bit 5. We set bit 1 to be the α category, and bit 5 to be the β category. The 6 remaining bits where X and Y disagree we divide to category γ: 2,3,4 and category δ: bits 6,7,8.

We shall now generate string Z by flipping the a category and the γ category in X: 00111101. In parallel we generate Z′ by flipping the a category in Y and the δ category in Y: 00111101—resulting in the same string: Z=Z′.

However, if we use the same X but change Y by flipping its first bit: Y=00111010 then now X and Y have only one bit in common (bit 5). And since the number of disagreeing bits is odd (7), it is impossible to exercise the above protocol, and hence these X and Y above have no member in the set of their shared range.

Theorem: The Extension of an Even Hamming Distance:

Let X, Y and Z be three 2n-bits strings, such that the Hamming distance between X and Y is even, and the Hamming distance between Y and Z is even too. In that case the Hamming distance between X and Z is also even.

Proof:

Let X and Y have e bits in common, while Y and Z have f bits in common from the e set, and f from the set of bits X and Y have in opposition. The Hamming distance between X and Z will be: (e−f)+f′. Since the Hamming distances between X and Y and Y and Z are both even, we have e even and f+f′ even. If f+f′ even so is f−f′ and hence (e−f)+f′ is even too, and therefore the Hamming distance between X and Z is even.

Theorem: The Non-Extension of an Odd Hamming Distance:¹ ¹

Let X, Y, and Z be three n-bits strings, such that the Hamming distance between X and Y is odd, and the Hamming distance between Y and Z is odd too. In that case the Hamming distance between X and Z is even. In other words, three arbitrary strings of size 2n bits each cannot all be with a mutual odd Hamming distance.

Proof:

By the same logic as in the above proof, the Hamming distance between X and Z is HD(X,Z)=e−f+f′=e+(f′−f). e is given as odd, f+f′ is given as odd, so f′−f is odd too, and hence e+(f−f′) is a summation of two odd numbers, which is an even number.

### The Basic Bit Flip “Smooth” Cipher

We consider an arbitrary alphabet {A}ₜ comprised of t letters: A₁, A₂, . . . Aₜ. We associate each letter with a unique and random bit string comprised of 2n bits each: {S}ₜ=S₁, S₂, . . . Sₜ respectively. This association is shared between Alice and Bob.

Let M be a message comprised of m letters of the {A}ₜ alphabet, which Alice wishes to send Bob over insecure channels.

To do that using the “Basic BitFlip Procedure” Alice will send M to Bob letter after letter, exercising the following “per-letter” protocol:

Let L be the 2n bits string associated with Aᵢ which is the letter in turn to be communicated to Bob.
1. Alice will randomly pick a member of the FlipRange of L: L′=Rflip(L).
2. Alice will examine for j=1, 2, (i−1), (i+1), . . . t whether L′=εFlipRange(Sⱼ), where Sⱼ is the n-bits string that represents Aⱼ.
3. If the examination in (2) is negative (for all values of j) then Alice communicates L′ to Bob.
4. If the examination in (2) is positive for one or more values of j, then Alice returns to step (1).
5. Bob, upon receipt of L′, examines for j=1, 2, . . . t the relationship L′=Rflip(Sⱼ) and so identifies L, and Aᵢ.

This “per letter” protocol is repeated for all the letters in M.

### Security of the Basic BitFlip Cipher

Assuming that the bit strings {S}ₜ are randomly constructed, and assuming that the Bit Flip protocol is randomly executed, then given the flipped string L′ of L:

L′=RFlip(L) (8)

there appears to be no chance for a ‘shortcut’ to identify L from L′. The chance of every member of the FlipRange(L′) to be L is the same:

Pr[L=Lᵣ|LᵣεFlipRange(L′)]=1/FlipRange(L′)=(n!)²/(2n)! (9)

This suggests the basic (brute force) attack method: a cryptanalyst in possession of L′, and of knowledge of the values of n and t, and [A}ₜ will construct all plausible messages of size |M|=m, written in the {A}ₜ alphabet, and will check each of which against the captured ciphertext C=Enc(M), by exhaustively assigning all possible (2²ⁿ) strings in turn, to all the t letters of A, and then checking for consistency with C. For a sufficient large m, this method will leave standing only one plausible message.

It is intuitively clear that for many reasonable combinations of (t, n, m) the cryptanalyst will end up with rich equivocation—a very large number of plausible messages that Alice could have sent over to Bob. And there would be nothing in M that would help the cryptanalyst narrow down the list.

In principle, the values of n, t, and {A}ₜ may remain part of the cryptographic secret.

This basic cryptanalysis faces a credibly predictable cryptanalytic effort E, which is wholly determined by m, n, and t, and hence a user endowed with a credible estimate of the computing capability of his attacker, will credibly estimate the security of his message.

### Chosen Plaintext/Chosen Ciphertext Attacks:

The best position that an analyst may be in vis-à-vis a polyalphabetic cipher, is to launch an unrestricted “chosen plaintext attack”. Unlike common polyalphabetic ciphers where the choice of a cyphertext letter depends on other parts of the plaintext, in the BitFlip cipher that choice is independent of the rest of the plaintext, and so at best the cryptanalyst will repeatedly feed the cipher a given letter of the alphabet, until, hopefully, all the polyalphabet options are flushed out. This would not work here because the number of different strings that represent any given letter is so large that no feasible amount of plaintext will exhaust it, or even dent it. In other words: the “chosen plaintext” cryptanalyst will successfully build a list of some q strings that represent a given letter Aᵢ. However when the same letter comes forth in plaintext not controlled by the cryptanalyst the overwhelming chances would be that the string selected to represent Aᵢ will not be part of the q-list, and hence will not be readily identifies as Ai. Alas, having a set of q≧2n strings X₁, X₂, X_{J}, X_{q} all known to belong the FlipRange of a single string that represent letter Aᵢ, contain sufficient information to identify string X₀ that represents Aᵢ. The cryptanalyst will write q linear equations: Σᵢ₌₁ⁱ⁼²ⁿ(X₀⊕Xⱼ)=n for j=1, 2, . . . q, where the summation is over the bits in the XORed string. This amounts to a linear set that can be resolved via matrix inversion at O(n³). In other words, if a cryptanalyst is allowed to feed into the BitFlip cipher a given letter 2n times, and be sure that the resultant ciphertext string represents this letter then this letter will be compromised relatively easy. This theoretical vulnerability is nominally addressed by either (i) never admitting a repeat feed of same letter, or (ii) by interjecting null strings, where a null string is defined relative to an alphabet {A}ₜ as a string X that does not evaluate to any of the alphabet letters. A third, (iii) more robust defense is to associate each letter of the alphabet, {A}ₜ with more than one 2n-bits string, and each time choosing randomly, or otherwise, which string to use. The idea behind these countermeasures is to prevent the cryptanalyst from listing some q strings which are known to be members of the FlipRange set of the string L, that represents the chosen letter. It is this knowledge that allows for an efficient solution of the q linear relationships to find L. One way to do it is to randomly interject strings that are not members of FlipRange(L), they will destroy the cryptanalytic effort to extract L. Another is to associate a given letter of the alphabet with two or more distinct strings: L₁, L₂, . . . , the number and existence of these strings is part of the secret key.

It appears to the author that other than this well-addressed vulnerability all other cryptanalytic attacks are limited to brute force. The author invites challenges to this assertion.

On the other end, the “chosen ciphertext attack” is not feasible by construction because the choice of ciphertext is done randomly when needed, not earlier, so this knowledge does not exist, and therefore cannot be utilized.

Applying the brute force strategy, one is trying to fit a plausible plaintext to the captured ciphertext. Alas, under various common conditions, and for messages not too long, the cryptanalyst will be hit with terminal equivocation, namely ending up with more than one plausible plaintext that encrypts to the captured ciphertext.

In summary, the Bit Flip “smooth” cipher is building a credibly computed probabilistic security that can be tailored by the user to his needs.

### The Hamming Modified BitFlip Cipher

The basic cryptanalysis, as above, may be somewhat improved by exploiting the fact that a random assignment of the t strings will result in a situation where every string will have about half of the remaining (t−1) strings at an odd Hamming distance, which means that any captured flipped string will be suspected to represent only about 0.5t strings—the strings with which it has an even Hamming distance (See the BitFlip calculus above). This is not a big cryptanalytic break, but it can be readily avoided by insuring that all the t strings will have mutual even Hamming distances between them. This is easy to do: Procedure to Insure Even Hamming Distances within {S}ₜ:
1. Let i=1
2. Pick a random n-bit string, S₁, and assign it to A₁.
3. If i=t then STOP. Else Continue
4. Pick a random n-bit string, Sᵢ₊₁ and assign it to Aᵢ₊₁
5. Check the Hamming distance between Sᵢ and Sᵢ₊₁: HD(i,i+1)
6. If HD(i,i+1) is even then increment i to i+1 and return to step 3.
7. If HD(i,i+1) is odd then randomly flip one bit in Sᵢ₊₁
8. Check that Sᵢ₊₁≠Sⱼ for j=1, 2, . . . i. If the check is positive return to step 4
9. Check that Sᵢ₊₁≠S*ⱼ for j=1, 2, . . . i. where S*ⱼ≠Sⱼ={1}²ⁿ. If the check is positive return to step 4, ELSE return to step 3.

Step 9 is necessary because of the equivalence lemma (see above).

### Overlapping Consideration

By constructing the {S}ₜ strings with even Hamming distances between them we insure that the intersection of the respective FlipRanges of any two strings will not be empty. Obviously we can choose the values of t and n to build as much of an overlap as we may desire. Increased overlap builds more cryptanalytic defense, but it can burden the basic cipher with many rounds of trying to pick a proper flipped string that would point only to one letter of the alphabet. This burden may be eased by a slight modification of the basic protocol: the randomized string L′ constructed from string L, representing letter Ai, is sent over to Bob. If L′ points only to L, the protocol ends. If L′ also points to letter Aⱼ, (L′εFlipRange(Sⱼ)) then a second randomized string L″ will be picked and communicated to Bob. If this pick belongs only to the FlipRange of Aᵢ—the protocol ends. Bob will correctly interpret L″ to Aᵢ. If L″ points also to some Aₖ then Bob will realize that Aᵢ is the one letter that is pointed to by the two picks, and therefore this letter is the proper interpretation. In other words, Alice will send Bob several picks if necessary, until Bob has enough data to correctly interpret the incoming letter, even though all the strings point to more than one letter.

### Inherent Chaff

It is common tactics to embed cryptograms in a larger flow of randomized data where only the intended reader readily knows to separate the wheat from the chaff. In most of these schemes the means of such separation are distinct from the decryption algorithm. What is unique with the BitFlip cipher is that the chaff is inherent, namely, only by knowing the key can one separate the wheat from the chaff. Say then that for any cryptanalytic effort, the chaff will look exactly like the wheat, and will have to be treated as such.

In BitFlip there are two mechanisms to embed chaff in the flow: (i) sending strings that evaluate to more than one letter, and (ii) sending strings that do not evaluate to any letter.

It is easy to modify the basic BitFlip cipher by sending over any flipped string that projects to more than one of the letters of the A alphabet. Bob, the reader, realizing this double-pointing will simply ignore this string. The other method is to define a decoy string D=Sₜ₊₁, and send over a flipped version thereof: D′=Rflip(D) that does not evaluate to any of the t letters.

Both methods may be applied, at will, or at random rather, by Alice without any pre-coordination with Bob. Bob will faithfully discard all the chaff strings.

For the cryptanalyst any string is potentially a letter, and it participates in the cryptanalytic hunt. By adding sufficient chaff—strings that don't evaluate to any alphabet letter—the sender will build a chance for terminal equivocation where even brute force cryptanalysis will be helpless.

### Design Considerations of the Bit Flip “Smooth” Cipher

The BitFlip “Smooth” cipher will work on a binary alphabet, as well as on a large as desired alphabet 2≦t<∞. There is no limit on the high level of n. Since brute force cryptanalysis is the only envisioned attack strategy, given the extensive randomization of the data and its processing, the more bits there are to resolve, the greater the security of the cipher. Hence cipher security is proportional to 2^{t*n}. Accordingly, the BitFlip cipher designer will opt to use high t and n values.

On the other hand, the larger the values of n and t, the more randomness has to be shared between Alice and Bob, in the form of a the shared key (t*n-bits). But the larger the value of t (the size of the alphabet) the less information must be sent over by Alice to Bob. For a fixed n value, if the alphabet is binary, and one uses, say the ASCII table then 8 bits are needed to communicate an ASCII symbol, and hence an ASCII symbol will require 8n bits to pass through. The ASCII table can also be expressed by words comprised of 4 letters of an alphabet of 4 letters: 4⁴=256, and in that case a byte will be communicated using only 4n bits. If the entire table is comprised of letters, then n bits will be needed per symbol. Yet, the larger the number of letters (larger t) the more work needed for the decryption. Every incoming string will have to be evaluated against all t letters.

All in all this BitFlip cipher takes advantage of two strong trends in modern technology: (i) memory is cheap and gets cheaper, and (2) bit communication is fast and getting faster—more throughput, less cost. So Alice and Bob will likely be willing to store some more randomness, and communicate some more randomness in order to secure their data to their desired degree.

This cipher being part of the new wave expressed in “Randomness Rising” [Samid 2016R], also shifts the security responsibility from the cipher designer to the cipher user. By selecting the values of t and n, the user determines the security of his data. By operating two or more parallel sets of alphabets, the user will be able to designate some portion of his data for extra high security.

This cipher may be designed as a “shell” where the user selects, t, n, and then generates t*n random bits—the key. The processing being so minimal that there is no practical way to engineer a backdoor. What is more—the chip for the bit wise operations of this cipher may be freely designed and manufactured using commercially available chip design programs.

The processing of the data may be done in software, firmware or hardware—for extra speed. It may be done with special purpose quite primitive integrated circuits because the operations are limited to basic bit-wise instructions.

### Alphabet Variety

The BitFlip alphabet cipher works on any alphabet from a simple binary one to any size t. The binary strings associated with the letters of a given alphabet will be of the same fixed size. However, Alice and Bob may use in parallel two or more alphabets.

Consider that Alice and Bob use two alphabets: {A}ₜ=A₁, A₂, . . . Aₜ, and {A′}ₜ′=A′₁, A′₂, . . . A′ₜ′. The first alphabet is associated with strings of size 2n bits, and the second alphabet is associated with strings of size 2n′ bits.

Alice will be able to communicate to Bob encrypted messages of either alphabet. She will then have to communicate to Bob the size of the string (2n or 2n′). There are several established ways to do it. One simple way would double the size of the communicated message: The communication flow from Alice to Bob will be comprised of encrypted bits and meta bits (all the rest). The plaintext bits will be written as follows: 0→01, 1→10. For meta bits we have: 0→00 and 1→11. This way there will be no confusion as to whether the bits represent a cryptogram or some auxiliary data. The auxiliary, meta data could be used to mark the boundaries of the BitFlip Cipher blocks. This will allow the sender to shift at will from one alphabet to another, and give more security to more sensitive data within the same file.

One could, of course, extend this practice to any number of alphabets.

Use: one alphabet may be used for digits only; another for letters, and a third for a special codebook that offers shortcuts to frequently used terms. Alternatively the same alphabet may be associated with two or more strings set. A simple alphabet for non-critical encryption will have a small string size, 2n; while a more critical encryption over the same (or different) alphabet will be encrypted/decrypted with large string size, 2n′.

### Advanced BitFlip Cipher

The BitFlip cipher allows the sender to add randomized data to the plaintext, without limit, and without extra effort for decoding the stream, except that it will be proportional to the size of the incoming data flow. This reality gives rise to advanced applications of the cipher:
Parallel Mutually Secret Messages
cyber black holes.

### Parallel Mutually Secret Messages

Let us consider two alphabets, one comprised of t letters, and the other of t′ letters: {A}ₜ, {A}ₜ′. t may be equal or different from t′. Let each alphabet be associated with a key comprised of 2n-bits long strings. Let us construct the strings so that all strings are distinct. No string in one alphabet is the same as any string in the other alphabet.

Now consider the situation where Alice and Bob share the key for the first alphabet, and Alice and Carla share the key for the other alphabet. Let M be a message Alice wishes to communicate to Bob, and let M′ be a message Alice wishes to communicate to Carla.

Alice could use the BitFlip cipher to send these messages separately, but she could also mix them into one mixed string M″=per-letter-mix(M, M′). When Bob receives M″ he will readily discard all the letters that belong to M′ because all these letters will not evaluate to any of his alphabet. When Carla receives M″ she will ignore all the letters written in Bob's key, and correctly interpret her message.

For example, Alice wishes to communicate to Bob the word: ‘NORTH’, and to Carla the word: ‘SOUTH’. Marking letters sent over with Carla's key with /′/ we write: NS′OO′RU′TT′HH' or in some other mix: NOS′RO′TU′HT′H′ where Bob will interpret as ‘NORTH’ and Carla as ‘SOUTH’. Neither Carla, not Bob have to know that the letters sent to them by Alice, which all look as meaningless chaff, are indeed a bona fide message for someone else.

This concept should not be limited to two alphabets and two parallel messaging. It can be applied to any number of parallel messages. There are several advantages to this configuration. We discuss: Peer-to-Peer message distribution and Built-in Equivocation.

### Peer to Peer Message Distribution

Consider a peer-to-peer network where one peer is designated as a ‘hub’ and shares BitFlip cipher keys with all other peers. The hub could mix some q messages, each designated to another peer, and send the package to an arbitrary peer in the network. That peer will check the package for a message to itself, and if it finds any, it will strip it from the package, and pass the stripped package ahead to any other peer. This passing on will continue until the package is emptied, and there is nothing to pass on. At that point it is also clear that all q peers received their message. The peer that would empty the package will signal to the hub that this package was fully distributed. The advantage of this procedure is that it handles well off time of peers, and is very resilient against any interruptions to parts of the network. The variety of sequences that such a package can assume is astronomical: p! for a p-peers network. The hub could send several copies of the same package through different routes to build more resilience to the dispatch.

This P2P message distribution may also apply for the cases where peers are divided by blocks. Each block has the same key (the t BitFlip strings). In that case, the number of the addressed peers in each block will be indicated in the contents of the message to these peers, and each peer reading this message will decrement the counter of how many more peers need to read it. The last reader will remove that message from the package.

Every arbitrary peer will be able to take advantage of this messaging regimen. That peer will send all its messages to the hub, using its shared key with the hub, requesting the hub to put a package forward. Note that every interpreter of the ciphertext will see two classes of strings: strings that evaluate to a letter in its alphabet, and strings that do not. The peer will have no indication whether the second class is comprised of random strings, or carries a message to one or more peers.

### Built-In Equivocation

Let M₁, M₂, . . . Mₖ represent k messages that cover all the plausible messages relative to a given situation. To elaborate: A cryptanalyst is told that Alice sent Bob a message, and then the cryptanalyst is asked to list all the plausible messages that Alice could have sent. Messages that make sense given whatever the prevailing circumstances are. This list of plausible messages reflects the cryptanalyst's ignorance of the contents of the message Alice sent Bob. It only reflects his or her insight into the situation where the message took place. The aim of the cryptanalyst is to use the captured encrypted message to reduce the entropy of this set of messages, to build a tighter probability distribution over them.

Now assume that Alice sent Bob M₁, but buried it in a mixed package where all the other (k−1) messages show up. For Bob there would be no confusion. He would only regard the bit strings that evaluate to his message, and ignore all the rest. Alas, a cryptanalyst, with full possession of the ciphertext but with no possession of Bob's Key, at best, with omnipotent tools, will uncover all the keys for all the k messages and will end up with all the k messages as being plausible communications from Alice to Bob—namely the cryptanalyst will face terminal equivocation that drains any value offered by possessing the ciphertext. This equivocation will be valid, although to a lesser degree, by padding the real messages with a smaller number of decoy or ‘chaff’ strings.

### Document Management

The mutual parallel messages encapsulated in one ciphertext stream may be used for document management. A typical organizational project is comprised of data that is available to everyone, data that is exposed to managers, and not to their underlings, and then some information which is the privy of the executive echelon only. Normally there is a need to maintain separate documents fitting to each management rank. Using BitFlip in mutual parallel messages mode, one will keep track only of one document but in an encrypted form, where each management echelon will be given its echelon's keys, and the keys for all lower echelons. This will control the exposure of the project data, while allowing maintenance of only a single document.

Illustration: A project text says: “We announce the opening of a new plant, at a cost of $25, 000, 000. 00, pending a favorable environmental impact statement”. The writer may use XMP tags: “<crypto level=low>We announce the opening of a new plant, </crypto><crypto level=high>at a cost of $25, 000, 000. 00,</crypto> <crypto level=medium> pending a favorable environmental impact statement”</crypto>. The statement will be encrypted through BitFlip using three different sets of strings over the ASCII tables. {S}₂₅₆ for “low” level of encryption, {S′}₂₅₆ for “med” level of encryption, {S″}₂₅₆ for “high” level of encryption. Low level employees will decrypt the cryptogram to: “We announce the opening of a new plant”. Medium level managers will read: “We announce the opening of a new plant, pending a favorable environmental impact statement”, and the high-level people will read: “We announce the opening of a new plant, at a cost of $25, 000, 000. 00, pending a favorable environmental impact statement”.

### Re-Encryption

Given a plaintext stream of bits, P, one could use t letters in the form of t=2^{u} and a corresponding set of 2n bit strings, where 2n>u. Accordingly the plaintext stream will be chopped off to ‘letter strings’ comprised of u bits each, and each of these letters will be encrypted to a 2n bits size string. This will create a ciphertext, C, that is at least 2n/u times the size of the plaintext. C can be regarded as a plaintext and be encrypted using BitFlip via t′ letters where t′=2^{u′}, expressed with 2n′ bits long strings, and thereby create re-encryption and a resultant ciphertext C′. t and t′ may be the same or different, n, and n′ may be the same value or different, and the same for the respective strings. This re-encryption may be used iteratively as many times as desired, each time the size of the ciphertext will grow. Intuitively the more cycles of re-encryption, the greater the built in equivocation. It is interesting to note that the writer may use re-encryption without pre-coordinating with the reader. If P is humanly readable then, the reader will keep decrypting until the result is humanly readable. Otherwise the writer might imprint a label ‘plaintext’ on the plaintext, and the reader will keep decrypting until she sees the label.

### Cyber “Black Holes”

If Alice and Bob are not communicating—it says something about them. If Alice and Bob are communicating with uncracked encrypted data—they still surrender a great deal of information just through the pattern of the data flow—size of messages, frequency, back and forth relationship between Alice and Bob, etc. To stop this leakage of information flow Alice and Bob can build a “black hole” communication regimen.

In a “black hole” Alice and Bob send each other a constant stream of randomized bits. These bits may be raw randomness and carry no information—which represents the case of no communication. Or, these random bits may hide bits that carry information according to some pattern.

Alice and Bob may use the BitFlip cipher to mix bits that represent letters in their agreed upon alphabet with bits that don't evaluate to any of the alphabet letters. Only the holder of the key ({S}ₜ) will be able to separate the raw randomness from the meaningful message.

This black hole status may be extended to a multi party communication.

### Binary Alphabet and a Perfectly Random Ciphertext

We consider the case of applying BitFlip over a binary alphabet {0,1} (t=2). This will increase the size of the ciphertext to be 2n-fold the size of the plaintext, where the size of the Bitflip strings is 2n. For example: Let “0” be S₁=1110, and “1” be S₂=0110 (n=2) then a plaintext in the form of P=011, will be encrypted to a ciphertext like C=1000 0101 0000. For n sufficiently large, one can define some q sets of strings: {S₁, S₂}, {S′₁, S′₂}, {S″₁, S″₂}, . . . to express the binary alphabet. As we have seen, Alice would then be able to exchange a unique key (namely a particular set of {S₁, S₂}) with q distinct partners, and combine q messages, one for each partner, into a single ciphertext. Each partner will discard all the strings, except those that evaluate to 0 or 1 in his or her alphabet. Furthermore, there are 2^{q}, combinations of alphabets that allow for as many different interpretations of the ciphertext.

Now consider a bit stream of perfectly randomized bits, R. Alice could encode that stream using the q sets of keys she agreed upon with q partners. Each partner will decrypt the resultant ciphertext to read the plaintext Alice sent him or her. But any reader who will use all the q keys will interpret the same ciphertext into the original pattern-free perfectly randomized bit stream.

Illustration: We consider a random sequence R=1 1 0 1 0 0 0 1 0 0 10 0 1 0 0 1 1 flowing from Alice to four partners. Each partner shares a unique BitFlip binary alphabet with Alice. Namely each partner shares with Alice a pair of 2n bits strings, to cover the binary alphabet {0,1}. Alice wishes to send the four partners the following messages respectively: 1110, 0001, 1010, 0011. Alice does so over the random sequence R by picking binary letters in the correct sequence from R—each partner is assigned different bits from R. Each partner will evaluate in R only the bits that correspond to the message for him or her, while the other bits will be covered by a 2n-bits string that does not evaluate to any binary letter—as far as that partner is concerned. The table below shows with “x” marks the bits in R communicated to each partner. All the other bits are evaluated as ‘chaff’ and discarded:

A fifth partner who shares two or more of these alphabets with Alice will see all the corresponding messages. Any partner sharing all the alphabets will see the random sequence R.

### Use Cases

The BitFlip cipher seems ideal for Internet of Things applications where some simple devices will be fitted with limited bit-wise computation power to exercise this cipher. IOT devices may read some environmental parameters, which fluctuates randomly, and use this reading to build the ad-hoc flipping randomness. Smart but cheap devices may be fitted with the hardware necessary for operating this simple cipher, and no more. This will prevent attempts to hijack such a device. The simple BitFlip cipher is too meager a machine to turn around for ill purpose.

One may note that while the data flow is much greater than with a nominal cipher where the ciphertext is as large as the plaintext, once the message is decoded, it is kept in its original size. So the larger ciphertext is only a communication imposition. But since most secrets are in textual form, this will be not much of a burden, compared to communicating a regular photo today.

Because of the ultra simplicity of the cipher and its great speed, it may find a good use in many situations. Some are discussed:

The BitFlip cipher may be used for audio and video transfer, say, a store will sell a pair of headphones, or headphone attachment where each element of the pair is equipped with the same key (randomized t strings), and will be used to encrypt and decrypt the spoken word.

The cipher could be used to communicate across a network through a hierarchy of clusters where the members of each cluster share a key. Messages between random peers in the network will have to be encrypted and decrypted several times, but the speed of the operation will minimize the overhead.

The speed of the cipher could be used for secure storage. All stored data will be BitFlip encrypted before storing, and then decrypted before using. The keys will be kept only in that one computer, in a fast processing chip, likely. This option will also relax worries about the security of data, which a third party backs up in the cloud.

There are several applications where the cyber black hole mode will come in handy hiding communication pattern between two financial centers for example.

Personal privacy: most personal computing devices today allow for an external keyboard, and an external display to be attached to the machine. By fitting a BitFlip chip between these peripherals and the computer, two parties (sharing the same BitFlip chip box) will be able to communicate truly end-to-end with the BitFlip chip box (the box that houses the shared chip which has ports for the keyboard and the screen) serving as a security wall against any malware that may infect the computer itself: like keyboard loggers.

### Illustration

Let us illustrate the BitFlip cipher using a three letter alphabet: X, Y, and Z, expressed through 12 bits strings each. Namely t=3, n=12. The comprised key of 36 bits represents a space of 2³⁶=68,719,476,736 combinations.

Randomly selecting, we write:

### X=100 110 010 010

### Y=011 010 011 101

### Z=100 011 110 101

Alice and Bob share this key. Now let Alice wish to send Bob the plaintext: XZZ. To do that she will apply X′=Rflip(X) to the X string: X′=11 011 100 010, and then she evaluates the Hamming distance with respect to the entire alphabet: HD(X′,X)=6, HD(X′,Y)=8, HD(X′Z)=6. Alice then sends X′ to Bob. Bob evaluates the same Hamming distances, and can't decide whether Alice sends him X or Z because cases pass the Hamming distance test (HD=n=6). Alice then applies Rflip again: X″=Rflip(X)=100 001 000 100, and again evaluates the Hamming distances: HD(X″,X)=6, HD(X″,Y)=8, HD(X″,Z)=4, and then sends X″ to Bob. Bob evaluates the same Hamming distances, and readily concludes that Alice sent him X since Y is not the communicated letter, because its Hamming distance from X″ is not 6, and Z is not the communicated letter because its Hamming distance from X′ also is not 6.

Alice will know that by sending X′ and X″ Bob correctly concluded that the first plaintext letter in her message was X. She now applies Z′=Rflip(Z)=100 000 001 100 and finds to her dismay: HD(Z′,X)=HD(Z′,Y)=HD(Z′Z)=6. Alice sends Z′ to Bob who ends up undecided again. Alice then applies Rflip again: Z″=Rflip(Z)=111 110 010 111 and evaluates: DH(Z″,X)=4, DH(Z″,Y)=4, DH(Z″,Z)=6. She sends Z″ over, which Bob readily interprets as the letter Z.

Alice then applies Rflip again over Z: Z′″=Rflip(Z)=001 101 100 111 and computes: HD(Z′″,X)=8, HD(Z′″,Y)=8, HD(Z′″,Z)=6. Sending Z′″ to Bob, he quickly evaluates it to Z, and now is in possession of the entire plaintext: XZZ.

A cryptanalyst has the cryptogram: X′-X″-Z′-Z″-Z′″ and must consider a large array of plaintext candidates: X, Y, Z, XY, XZ, YX, YZ, XYZ, XYY, . . . XYZXY.

But this is only the basic mode. Alice could interject into the cryptogram members of the FlipRange of an unused letter Q: Say Q=111 100 111 100 selecting Q′=Rflip(Q)=110 100 000 111 where Alice finds: DH(Q,X)=5, DH(Q,Y)=7, DH(Q,Z)=7. And again: Q″=Rflip(Q)=100 110 110 010 where DH(Q″,X)=1, DH(Q″,Y)=9, DH(Q″,Z)=5, and disperses Q′ and Q″ in the cryptogram: X′-Q′-X″-Q″-Z′-Z″-Z′″. Bob is not confused by these add-ons because neither Q′ nor Q″ evaluates to any of the alphabet letters (X, Y, Z). Alas, the cryptanalyst faces a much more tedious brute force effort.

In parallel to Alice's messages to Bob, she can also communicate with Carla. Let Alice and Carla also use a three letters alphabet (perhaps the same letters) that we shall identify as U, V and W. Each letter will also be comprised of 12 bits:

Randomly selecting, we write:

### U=100 111 110 110

### V=001 010 000 111

### W=000 011 110 101

So now, Alice could co-mingle a plaintext for Bob: P_{Bob}=XYZ, and plaintext to Carla, P_{carla}=UVW. She will then apply the Rflip procedure as summarized in the following Hamming Distances table: where the matrices indicate the Hamming distances between the respective column string and the respective row string.

| | | X′ | X″ | X″′ |
|---|---|---|---|---|
| | | 000111111100 | 101100110101 | 110011011100 |
| X | ′100110010010 | 6 | 6 | 6 |
| Y | ′011010011101 | 6 | 6 | 4 |
| Z | ′100011110101 | 4 | 4 | 4 |
| U | ′100111110110 | 3 | 5 | 5 |
| V | ′001010000111 | 8 | 6 | 8 |
| W | ′000011110101 | 3 | 5 | 5 |
| | | Y′ | Y″ | Y″′ |
| | | 001100000111 | 001000110011 | 110001101101 |
| X | ′100110010010 | 6 | 6 | 10 |
| Y | ′011010011101 | 6 | 6 | 6 |
| Z | ′100011110101 | 8 | 6 | 4 |
| U | ′100111110110 | 7 | 7 | 7 |
| V | ′001010000111 | 2 | 4 | 8 |
| W | ′000011110101 | 7 | 5 | 5 |
| | | Z′ | Z″ | Z″′ |
| | | 001001000111 | 001000111100 | 001011100010 |
| X | ′100110010010 | 8 | 8 | 6 |
| Y | ′011010011101 | 6 | 4 | 8 |
| Z | ′100011110101 | 6 | 6 | 6 |
| U | ′100111110110 | 7 | 7 | 5 |
| V | ′001010000111 | 2 | 6 | 4 |
| W | ′000011110101 | 5 | 5 | 5 |
| | | U′ | U″ | U″′ |
| | | 100101001011 | 100101001011 | 000111000001 |
| X | ′100110010010 | 5 | 5 | 5 |
| Y | ′011010011101 | 9 | 9 | 7 |
| Z | ′100011110101 | 7 | 7 | 5 |
| U | ′100111110110 | 6 | 6 | 6 |
| V | ′001010000111 | 7 | 7 | 5 |
| W | ′000011110101 | 8 | 8 | 4 |
| | | V′ | V″ | V″′ |
| | | 011111101011 | 111100001101 | 110100000110 |
| X | ′100110010010 | 8 | 8 | 4 |
| Y | ′011010011101 | 6 | 4 | 8 |
| Z | ′100011110101 | 8 | 8 | 8 |
| U | ′100111110110 | 7 | 9 | 5 |
| V | ′001010000111 | 6 | 6 | 6 |
| W | ′000011110101 | 7 | 9 | 9 |
| | | W′ | W″ | W″′ |
| | | 110001000001 | 011011111010 | 110010100110 |
| X | ′100110010010 | 7 | 7 | 5 |
| Y | ′011010011101 | 7 | 5 | 7 |
| Z | ′100011110101 | 5 | 7 | 5 |
| U | ′100111110110 | 8 | 6 | 4 |
| V | ′001010000111 | 7 | 7 | 5 |
| W | ′000011110101 | 6 | 6 | 6 |

The table shows the Hamming distances between Rflip strings and the 6 reference letters. Note that any flipped string that is indicating a letter from one alphabet should not indicate a letter from the other alphabet in order not to confuse the interpreter of the other alphabet. So, for example Z″ is useless because while it tells Bob that Alice sent him letter Z, it would confuse Carla to interpret the same as letter V.

Based on the above Hamming distance table Alice will broadcast the following cryptogram:

X′-U′-X′″-V″-Y′-Y′″-W″-Z′-Z′″-W′″

Let us mark Do as any string to be discarded because it does not fit any of the reference alphabet letters, and mark Dᵢⱼ any string interpreted as either letter i, or letter j.

Accordingly, Bob will interpret the cryptogram as:

Cryptogram_{Bob}=D_{xy}-D₀-X-D₀-D_{xy}-Y-D₀-D_{yz}-D_{xz}-D₀

in which Bob will discard all the Do strings. Then interpret the D_{yz}-D_{xz} as letter Z, and decrypt the cryptogram to Plaintext_{Bob}=XYZ.

Carla will read the same cryptogram as:

Cryptogram_{Carla}=D₀-U-D₀-V-D₀-D₀-D_{uw}-D₀-D₀-W

in which Carla will discard all the Do strings. Then interpret the strings: D_{uw}-W as W, and decrypt the same cryptogram to Plaintext_{Carla}=UVW.

This packing of more than one message into a single cryptogram can be extended to three or more messages. The procedure has profound implications in file management, but also on security issues. The more discarded strings processed by each reader, the greater the cryptanalytic burden on the attacker, and the greater the chance for plaintext equivocation.

Alternative use of this illustration is for denial purposes. Alice and Bob may share the two sets of alphabet: X-Y-Z and U-V-W. Alice sends Bob “an implicating secret” using the X-Y-Z alphabet, and also she sends Bob a “harmless and embarrassing decoy statement” using the U-V-W alphabet. If either Alice or Bob (or Both) are approached by a coercer who captured the cryptogram and now applies pressure for them to disclose the key, then they would point to the U-V-W alphabet which will expose their embarrassing decoy and hide their implicating secret. The authorities may, or may not discover the X-Y-Z message, but even if they do, they will be unable to prove that the X-Y-Z message, and not the U-V-W one was the actual message communicated by Alice to Bob. In other words, this illustration depicts a case of terminal equivocation that will not surrender to any smart cryptanalyst.

### Functional Security

Information theoretic security is defined as a state where knowledge of the ciphertext has no impact on the probabilities of the possible plaintexts. We offer here an alternative, more practical definition of security—functional security (or say ‘functional secrecy’). Functional security is based on the idea that at a given situation in which an encrypted message, C, is communicated from a sender to a receiver, an adversary may prepare a list of m plausible messages: {P}ₘ=P₁, P₂, . . . Pₘ that each could have been the actual message encrypted into C. The emphasis here is on ‘plausible’ as a subset of ‘possible’ messages. And furthermore, the adversary, reflecting his or her insight of the situation, will associate each plausible message Pᵢε{P}ₘ with a corresponding probability PRᵢ for it to be the actual message encrypted into C. Accordingly, a perfect functional secrecy will be achieved if knowledge of C does not impact the probabilities {PR}ₘ=PR₁, PR₂, . . . PRₘ even if the adversary has unlimited computing capacity, such that a brute force attack can be timely accomplished. And since {PR}m fully determines the Shannon entropy of the situation:

H=−ΣPRᵢ log PRᵢ

we can define perfect functional secrecy as H=H′ where

H′=−(PRᵢ|C)log (PRᵢ|C)

where (PRᵢ|C) is the probability for message i to be the one encrypted into C, given the knowledge of C, and under the terms where the adversary has unlimited computing capacity.

And accordingly, the Functional Security Index (FSI) of any cipher may be defined as:

FSI[Enc]=H′/H

where Enc is the cipher that encrypts plaintext P to C: C=Enc(P).

We will now prove that the financial security index for the BitFlip cipher is FSI=1.00 (perfect functional secrecy). Proof. Invoking the “Parallel Mutually Secret Messages” mode described before, which is also demonstrated in the above illustration, we have shown that the BitFlip cipher may construct a ciphertext C in a format that may be called “The Blind Men and the Elephant”, or for short “The Elephant” mode. In the familiar Indian story some blind men touching en elephant reach different and inconsistent conclusions about what the elephant is: the one that scratches the tusk, the one that squeezes the ear, and the one that hugs the trunk, all see a different animal. Similarly, we have shown that the BitFlip ciphertext, C, may be comprised of some m messages, each written in its own alphabet strings (its own set of t, 2n bits strings), such that each 2n bits string in C will evaluate to no more than one letter in one alphabet set. If we assume only one intended reader, i, using one set alphabet strings, then for that reader all the 2n bits strings that evaluate to different letters in any of the other (m−1) alphabet strings will be discarded because they don't evaluate to any letter in his or her alphabet.

The sender is assumed to have at least as much insight into the situation in which the ciphertext is generated, as the adversary (usually the sender has a greater insight). And hence the sender will be able to construct the {P}ₘ list. The sender will then encrypt all the m plausible messages into C. The message intended for the sole recipient i, will be Pᵢ, written in the i-alphabet set. The intended reader will interpret C as Pᵢ, as intended. Alas, the adversary, applying his unlimited computing capacity will unearth all the m messages which in totality reflect his or hers conclusion as to what the content of C may be, and hence the probability for each message Pⱼε{P}ₘ to be the de-facto encrypted message is left unchanged. Since the full set {P}ₘ is admissible given the knowledge of C, then C does not change the probabilities distribution of {P}ₘ. And hence H_{BitFlip}=H′_{BitFlip}, or say, the BitFlip cipher may be operated in a mode such that its Functional Security Index is 1.00: perfect functional security.

Unlike Vernam's information theoretical security, where the key must be as long as the message, and any reuse of key bits precipitously drops the message security, The BitFlip functional security allows for a finite key to maintain its perfect functional security over a plaintext much larger than the key (the t 2n-bits strings). This is the bonus earned by climbing down from Vernam equivocation over all possible messages, to functional security where the equivocation is applied only to the list of plausible messages. Vernam applies regardless of the insight of the environment where the encryption takes place, while BitFlip applies to the practical situation, which dictates a list of plausible messages. For cryptography users it is perfectly sufficient to insure that the probability distribution over the set of plausible messages is not affected by knowledge of the ciphertext, even if the adversary is endowed with unlimited computing capacity.

### A Bird's Eye Overview:

We have described here a “smooth” cipher based on two arbitrary parameters (natural numbers), t and n, such that incremental changes in either, or both, result in incremental changes in the cipher's security, and where there is no vulnerability to yet unfathomed mathematical knowledge. The cipher poses a well-randomized cryptanalytic barrier, which will be chipped away according to the computing capabilities of the attacker. And to the extent that this capability is credibly appraised, so is the security of the cipher. The cipher makes use of open-ended randomness, and its user may gauge its efficacy by simply controlling how much randomness to use. The cipher is naturally disposed to bury a message needle in a large bit stream haystack, and hence to enable oblivious mixing of a host of parallel messages within the same stream. Last, but not least, the BitFlip cipher avoids the customary computation of number theoretic algorithms—it's bit flipping, simple, fast and easy.

What is claimed is:

1. A symmetric cryptographic method called ‘Trans Vernam’ where secrecy is established by use of large as desired, quantities of randomness, where both the identity and the number of random bits constitute the cryptographic key, which is processed in conjunction with the plaintext, deploying only simple bit-wise operations such that the effort of compromising the cryptogram, to the extent feasible, is credibly appraised in terms of required computational load.

2. A method as in (1) where the user insures that a cryptanalyst in possession of only the cryptogram will not be able to determine with certainty the generating plaintext of that cryptogram, even if that cryptanalyst has unlimited computational capacity.

3. A method as (1) where the user may use so much randomness that the cipher will be of Vernam grade, namely exhibit unconditional mathematical secrecy.

4. A method as in (1) where the parties exchange a durable secret key in the form of a bit string of any desired size, and where each time the parties use the cipher for a communication session then the sender randomly selects ad-hoc session keys that are processed together with the durable secret to exercise a protocol that is immunized against a re-play attack, that prevent re-play fraud.

5. A method as in (4) where one of the parties selects a size-adjusting factor in the form of a binary string, and that is operated on in conjunction with the durable secret key to generate a session base key, K_{b} which is a bit string of a desired size (bit count).

6. A method as in (5) where the parties agree on a method to parse the session base key to n unique substrings, and where the sender randomly selects a transposition key Kₜ(n) and applies it to transpose the n substrings identified on the session base key, to any of its n-factorial (n!) permutations, each permutation has a 1/n! chance to be selected, and where the transposed string is regarded as the transposed session base key, K*_{b}; and where furthermore the sender communicates the transposed session base key (K*_{b}) to the recipient, so that the recipient will verify that the transposed session base key is indeed a transposition of the session base key according to the recipient computation based on his or her knowledge of the session base key and the method of parsing it to n substrings; and where upon verification that K*_{b} is a transposed version of K_{b} the recipient (i) is assured that the sender shares the same durable secret key and then (2) finds out the value of the transposition key, Kₜ from comparing K_{b} and K*_{b}.

7. A method as in (6) where the parties use the transposition key Kₜ to encrypt all the messages in that session, whether as a stand alone cipher, or as a cipher ingredient in a larger scheme.

8. A method as in (6) where the transposition key Kₜ is determined from a physical noise, or other phenomena, and is not an algorithmic outcome.
